(19) United States
(12) Patent Application Publication
(10) Pub. No.: US 2013/0006848 A1
(43) Pub. Date: Jan. 3, 2013

(54) METHOD OF VIRTUAL TRANSACTION USING MOBILE ELECTRONIC DEVICES OR FIXED ELECTRONIC DEVICES OR A COMBINATION OF BOTH, FOR GLOBAL COMMERCIAL OR NONCOMMERCIAL PURPOSES

(76) Inventor: Avinash Kuttuva, Robbinsville, NJ (US)

(21) Appl. No.: 13/530,845

(22) Filed: Jun. 22, 2012

Related U.S. Application Data
(63) Continuation-in-part of application No. 13/295,039, filed on Nov. 11, 2011, now abandoned.
(60) Provisional application No. 61/412,919, filed on Nov. 12, 2010.
(60) Provisional application No. 61/427,381, filed on Dec. 27, 2010.

(51) Int. Cl. G06Q 20/22

(52) U.S. Cl. 705/39

(57) ABSTRACT

A payment system that enables parties to conduct financial transaction between person to person, person to business, business to business, person to a group of people, group of people to a person etc. (collectively called users) using mobile and non-mobile interfaces for online and physical points of transaction. The system also enables users to share funds between each other. Shared funds are accessible by the beneficiary user as if the funds are available in his/her account. However, when the shared funds are selected to make a payment, the funds are debited from the benefactor's account up to the set limits. The system prevents the exposure of critical account information between users while sharing or paying, to prevent fraudulent activities. In addition, the system enables users to seamlessly verify each other's identity prior to executing transaction. The system allows for real time transaction between parties, without limitations on proximity.

### CROSS-REFERENCE TO RELATED APPLICATIONS

This application is a continuation-in-part of U.S. application Ser. No. 13/295,039, filed Nov. 11, 2011, which claims priority to U.S. provisional application No. 61/427,381, filed Dec. 27, 2010 and U.S. provisional application No. 61/412,919, filed Nov. 12, 2010, each of which is hereby incorporated by reference in its entirety.

### FIELD OF THE INVENTION

The invention pertains to electronic commerce. More particularly, the invention pertains to a method and apparatus for electronic payment for goods or services. Even more particularly, the present invention relates to the completion of financial transactions via mobile and non-mobile devices, such as a smart phone, itouch, tablet computer, etc, and, more particularly, to a mobile payment transfer infrastructure and method for transferring payment. The invention relates to a financial payment platform and more particularly to a closed-loop payment system for person-to-person, consumer-to-merchant, and merchant-to-consumer transactions.

### BACKGROUND OF THE INVENTION

In traditional payment systems, a person who intends to buy and pay for an item has relied on payment instruments such as currency, checks, credit cards, or debit cards. Unfortunately, these types of payment instruments have many security issues. Fraud prevention is a significant problem and the cause of extensive losses to financial institutions. When cash is lost or stolen, there is usually no recourse but to accept the loss. With other payment instruments, loss may not be a major issue to the individual, but fraud causes significant losses for the payment industry. Credit card, debit card and check fraud continue to be major problems for the payment industry.

The reason check fraud is common at present is the difficulty in instantly verifying the source account for availability of balance as various financial institutions are not directly connected to each other or do not have access to each other's customer account data. In addition, the use of checks exposes the account holder's personal and financial information as well as a sample of the account holder's signature, for use by criminals. When a check is accepted in a financial transaction, the funds are not guaranteed. Further, it is difficult for banks to instantly recognize a fraudulent check. Banks frequently end up cashing the fraudulent check when presented to the teller through a drive thru. A check is simply a piece of paper that does not provide any details to validate the bank that it is drawn on or the available balance, and therefore must be separately verified together with the account and the signature that is used to authorize the payment.

With a credit or debit card, the user may not be authorized, but is still capable of using the cards for purchases until the owner or issuer realizes that his or her credit card has been stolen or compromised and deactivates the account. Many times, the merchants end up losing the money, since most associates do not check the payers ID due to fear of intimidating the customer.

An invention in this space is needed to make transactions more secure, reliable, convenient and mobile.

Although the existing payment instruments have functioned well in the past, mainly due to the fact that the card associations have been protecting the consumers by passing the losses on to merchants and banks, it is clear that banks, merchants and consumers desire a simple, secure method to conduct financial transactions. The mass adoption of credit cards provides ample evidence that consumers prefer to use plastic cards rather than carry around cash or write multiple checks for small purchases. As the mobile computing capabilities and development of robust wireless network infrastructure merge, it is clear that there is an increasing desire for faster, cheaper, secure and more convenient electronic payment systems to conduct financial transactions similar to cash transactions.

There is also a great need for conducting financial transactions between individuals without having to depend on institutional assistance.

Most people have access to mobile or non-mobile computing devices, such as smart phones, tablets, computers, and similar devices. These devices have grown in capability to perform multiple functions, such as text messaging, photography, and listening to music as mobile devices have evolved to include integrated PDA, MP3, paging, player, and e-mail capabilities, which, at one point in time, required multiple devices. The computing devices that exist today not only replaced the other devices but outperformed the devices that are dedicated to specific tasks while adding convenience in many ways.

People seem to be willing and remember to carry their smart phones and other personal portable electronic devices with them, even as they forget to carry their wallet or car keys. Smart computing devices are becoming ubiquitous in the U.S. and in many countries around the world. As a result, there is a great need for a system to permit mobile phones to send and receive payment, just like cash, and provide other financial and mobile banking transactions.

There have been attempts to create a mobile payment system using cellular devices with mixed success primarily because cell phones in the past were not as sophisticated as today and needed additional circuit devices (or “chips”) that were used to store user account data. Also, the majority of the phones were feature phones with limited features; wireless infrastructure was in its infancy, which made mobile activities inefficient and less desirable.

Credit cards use proprietary networks with high costs. The cost of a credit card transaction is also affected by the involvement of multiple parties, namely the issuer, acquirer, merchant, gateway and other marketing entities.

Merchants account holders pay high monthly service charge in addition to transaction charges to accept credit cards and provide convenience to their customers, and are left exposed to chargebacks. Many smaller merchants are unable to justify the combination of the monthly service charge and the per-transaction interchange charge. For larger merchants, the interchange fee may be tolerable but still eats into their profits.

Credit and debit cards also leave the merchant subject to substantial fraud and abuse. For example, if a credit card is stolen, it may be used online or at a POS terminal by anyone wanting to commit fraud. To prevent this, many POS terminals now include a request that the consumer enter his/her postal zip code for added security. Unfortunately, postal information is not a replacement for a password and an ID theft expert is not discouraged by the additional information request to complete the transaction. However, the owner of the account is annoyed to enter the zip codes, especially since the practice is not consistent at every place.

Finally, the credit card system is not adaptable to peer-to-peer transactions and the interface is unintuitive, unlike a mobile computing payment interface that can continuously evolve to accommodate intuitive features.

Therefore, a consumer oriented innovative mobile payment system with a mobile wallet that enables an account holder the flexibility to conduct financial transactions any time anywhere and have the following features, user friendly, secure, and freely distributable software application for mobile devices, and that can facilitate at least the most common and simple financial tasks is needed.

### SUMMARY OF THE INVENTION

One aspect of the present invention (sometimes referred to herein as Payintele or the Payintele system) is a compelling alternate payment tool that solves security flaws of the existing payment methods such as credit cards, checks, cash and also upcoming technologies such as NFC's and card scanners.

Payintele users can store their encrypted banking and credit card information (in third party payment processing companies that are linked to Payintele servers) and make personal and business transactions with minimal effort.

The system is designed to prevent exposure of financial or personally identifying information of the paying parties to the receiving parties. This, by itself, has the potential of eliminating or significantly reducing fraudulent activities in addition to significantly reducing the time and steps required to process payments. The users will have the option to authorize each transaction with a PIN (Personal Identification Number); the merchants will receive payment notification with the picture of the payer to verify identity.

Aspects of the invention include:

Hardware—No additional hardware other than common personal accessories already owned by the majority of the population, such as smart phones, tablets or similar devices with camera interfaces, and business/personal computers with internet connectivity;

Software—Free mobile and desktop applications for individuals and businesses available for download via the internet, app stores and market place;

Adding money to Payintele accounts (preloading)—In order to use some services, users need to have money in their account. The invention offers various methods to users to preload funds to their Payintele accounts. This includes via credit card, bank account and payments from other users;

Withdrawing money from Payintele accounts—It is expected that users, especially businesses, will wish to move their money from their Payintele account to their bank accounts. This is facilitated by ACH. There is no cost for this transaction;

A consumer mobile application that enables users to access their account details, such as account balance, real time payment notifications, real time alerts, send and receive payments to and from other users (both businesses and consumers), control and manage account settings, add friends, conduct financial interactions, review payment activities, keep users engages in their day to day financial activities and allow the user to be in full control of their finances;

New users can create accounts by registering themselves and creating their usernames, passwords and PIN codes by visiting the website from the mobile phone application. New users have limited privileges (such as illustrated by FIG. 7, last screen, which shows a new user's initial home screen) associated with a limit to the transaction. Users may upgrade their account by confirming their identity by going through an ID verification process and/or taking the challenge to prove that the user is, in fact, the owner of the bank account through an instant account verification process or micro deposit method.

The user may access his or her account control panel (FIG. 9, first screen) through an application that is executed on a compact mobile device, such as a smartphone and from web browsers of mobile and non mobile computing devices, such as computers, tablets and other devices connected to the internet.

The mobile application will allow users to perform actions similar to what they perform with their traditional wallet or pocketbook. Since users carry their phones with them all the time, users may have fewer reasons to carry their normal wallets. Users can send and receive money anytime and anywhere they wish and do much more than what they are used to in the past. Users will be able to make payments for services and purchases, split lunch expenses, chip in for office parties, send cash gifts, send or receive money in case of emergency instantly from friends and family, add money from credit cards or bank accounts to pay an individual or merchant that does not accept credit cards due to high merchant account costs, withdraw money from their intele accounts to their banks, etc.

The problems that this invention addresses include, providing an alternate to carrying cash, functional versatility compared to the un-interactive credit cards and checks, facilitation of transactions in a secure manner, and prevention of exposure of personal and financial data.

Transactions may be executed between users where each party is identified by a unique ID created by the system, which, by itself, is not sufficient to infer any other information about the user.

A percentage of the transaction is charged to merchants for each payment received, similar to a credit card system. However no monthly recurring fees or equipment expenses may be incurred. Since merchants do not receive critical financial information, merchants are relieved from Payment Card Industry Data Security Standards (PCI DSS) issues. The system is comprised of (1) a mobile or non-mobile application that functions as an interface, on which users can carry out their actions, such as sending and receiving money to and from other users and making payments to businesses for purchases and services, receiving notifications, checking balances, adding and withdrawing funds, etc., (2) a server to host the service, database systems and a backend application to facilitate transactions between user interfaces, (3) a web browser interface to connect the users to the system from devices that do not have the client application, (4) a reserve (float) account, in which funds received from the users are deposited and withdrawn when users would like to transfer the funds back to their banks, (5) a payment gateway, partner bank and accounts to contain the money, (6) user's electronic device or devices, owned by the users, and used to access the online application (which serves as the platform to carryout various functions of this method.)

Most mobile devices today have a variety of rich features, like a front facing camera in addition to mic and speakers. The consumer interface may involve voice and facial recognition features by taking advantage of these biometric input devices, mainly the front facing camera and the mic, to (1) enable execution of financial tasks with voice commands in addition to providing voice reports and feedbacks, (2) accept a user's face and voice as biometric authentication methods to enable login, (3) access account data and execute transactions, and (4) enter into standby mode as soon the authorized user moves away from the front facing camera's field of capture.

Other features and benefits of the invention will become more obvious upon consideration of the descriptions and drawings.

### BRIEF DESCRIPTION OF THE DRAWINGS

FIG. 1 is a block diagram illustrating the entity relationships for a single user in the Payintele environment.

FIG. 2 is a diagram illustrating a number of virtual transactions between domestic users in the Payintele system.

FIG. 3 is a diagram illustrating a number of virtual transactions between international users using the Payintele system.

FIG. 4 shows a series of exemplary, self-explanatory user interface screens for a mobile device in a process for making a payment in accordance with an embodiment of the Payintele system.

FIG. 5 shows a series of exemplary, self-explanatory user interface screens for a mobile device of a user for making merchant selection, funds selection, and payment confirmation in accordance with an embodiment of the Payintele system.

FIG. 6 illustrates a series of exemplary, self-explanatory user interface screens for a mobile device for launching the Payintele application on a user device in accordance with an embodiment of the Payintele system.

FIG. 7 illustrates a series of exemplary, self-explanatory user interface screens for a mobile device for signing up for a Payintele account in accordance with an embodiment of the Payintele system.

FIG. 8 illustrates a series of exemplary, self-explanatory user interface screens for a mobile device for login and payment in accordance with an embodiment of the Payintele system.

FIG. 9 illustrates a series of exemplary, self-explanatory user interface screens for a mobile device for creating a user profile in accordance with an embodiment of the Payintele system.

FIG. 10 illustrates a series of exemplary, self-explanatory user interface screens for a mobile device for adding funds from external sources to a Payintele account in accordance with an embodiment of the Payintele system.

FIG. 11 illustrates a series of exemplary, self-explanatory user interface screens for a mobile device for verifying a Payintele user in accordance with an embodiment of the Payintele system.

FIG. 12 illustrates a series of exemplary, self-explanatory user interface screens for a mobile device for adding a bank account to an upgrade account in accordance with an embodiment of the Payintele system.

FIG. 13 illustrates a series of exemplary, self-explanatory user interface screens for a mobile device for issuing alerts and friend requests in accordance with an embodiment of the Payintele system.

FIG. 14 illustrates a series of exemplary, self-explanatory user interface screens for a mobile device for adding and deleting friends in accordance with an embodiment of the Payintele system.

FIG. 15 illustrates a series of exemplary, self-explanatory user interface screens for a mobile device for sharing money with other Payintele users in accordance with an embodiment of the Payintele system.

FIG. 16 illustrates a series of exemplary, self-explanatory user interface screens for a mobile device for reviewing recent transactions and searching transactions in accordance with an embodiment of the Payintele system.

FIGS. 17A and 17B collectively illustrate a series of exemplary, self-explanatory user interface screens for a mobile device for configuring account settings, automatic withdrawals, setting funding orders, and managing passwords in accordance with an embodiment of the Payintele system.

FIG. 18 illustrates a series of exemplary, self-explanatory user interface screens for a mobile device for issuing authorization requests for payment from one user to make a payment from an account for which that user does not have authority to withdraw funds to another user who has authority to make payments from the account in accordance with an embodiment of the Payintele system.

FIG. 19 illustrates a series of exemplary, self-explanatory user interface screens for a mobile device for issuing alerts in the form of payments requests for services in accordance with an embodiment of the Payintele system.

FIG. 20 illustrates a series of exemplary, self-explanatory user interface screens for a mobile device for issuing alerts in the form of authorization requests from merchants to increase a transaction amount of a previous transaction in accordance with an embodiment of the Payintele system.

FIG. 21 illustrates a series of exemplary, self-explanatory user interface screens for a mobile device for linking external accounts to a Payintele account, managing external account settings, and adding funds from linked accounts in accordance with an embodiment of the Payintele system.

FIG. 22 illustrates a series of exemplary, self-explanatory user interface screens for a mobile device for adding a new business account associated with a Payintele account in accordance with an embodiment of the Payintele system.

FIG. 23 illustrates a series of exemplary, self-explanatory user interface screens for a mobile device for creating a business profile and management interface, upgrading account status, and adding bank accounts in accordance with an embodiment of the Payintele system.

FIG. 24 illustrates a series of exemplary, self-explanatory user interface screens for a mobile device for editing a business profile interface in accordance with an embodiment of the Payintele system.

FIG. 25A illustrates a series of exemplary, self-explanatory user interface screens for a mobile device for adding a new business location, or sublocation in an existing business account in accordance with an embodiment of the Payintele system.

FIG. 25B illustrates a series of exemplary, self-explanatory user interface screens for a mobile device for adding business partners or additional account owners in accordance with an embodiment of the Payintele system.

FIG. 26 illustrates a series of exemplary, self-explanatory user interface screens for a mobile device for adding employees to business accounts and/or subaccounts and managing employee privileges in accordance with an embodiment of the Payintele system.

FIG. 27 illustrates a series of exemplary, self-explanatory user interface screens for a mobile device for adding terminals for a business location and generating QR codes for display in accordance with an embodiment of the Payintele system.

FIG. 28 illustrates a series of exemplary, self-explanatory user interface screens for a mobile device for searching previous business transactions in accordance with an embodiment of the Payintele system.

FIGS. 29A and 29B collectively illustrate a series of exemplary, self-explanatory user interface screens for a mobile device for setting business account settings, searching for transactions, making payment from business owner accounts, withdrawing funds, and transferring funds to another Payintele account under the same ownership in accordance with an embodiment of the Payintele system.

FIG. 30 is a series of panels illustrating an exemplary point-of-sale transaction, including payment flow in accordance with an embodiment of the Payintele system.

FIG. 31 is a series of panels illustrating an exemplary point-of-service transaction, including payment flow in accordance with an embodiment of the Payintele system.

FIG. 32 illustrates an exemplary, self-explanatory user interface screen for a desktop computer for merchants for logging into the Payintele system in accordance with an embodiment of the Payintele system.

FIG. 33 illustrates an exemplary, self-explanatory user interface screen for a desktop computer for merchants for payment notification into the Payintele system in accordance with an embodiment of the Payintele system.

FIG. 34 illustrates an exemplary, self-explanatory user interface screen for a desktop computer for merchants for searching previous transactions in accordance with an embodiment of the Payintele system.

FIG. 35 illustrates an exemplary, self-explanatory user interface screen for a desktop computer for merchants for searching previous results in accordance with an embodiment of the Payintele system.

FIG. 36 illustrates an exemplary, self-explanatory user interface screen for a desktop computer for merchants for modifying transaction in accordance with an embodiment of the Payintele system.

FIG. 37 illustrates an exemplary, self-explanatory user interface screen for a desktop computer for merchants for editing transactions in accordance with an embodiment of the Payintele system.

FIG. 38 illustrates an exemplary, self-explanatory user interface screen for a desktop computer for merchants for displaying the results of transaction modifications in accordance with an embodiment of the Payintele system.

FIG. 39 illustrates an exemplary, self-explanatory user interface screen for a desktop computer for merchants for printing QR codes in accordance with an embodiment of the Payintele system.

FIG. 40 illustrates an exemplary, self-explanatory user interface screen for a desktop computer for merchants for exporting QR codes in accordance with an embodiment of the Payintele system.

FIG. 41 illustrates an exemplary, self-explanatory user interface screen for a desktop computer for merchants for displaying notifications in accordance with an embodiment of the Payintele system.

FIG. 42 illustrates an exemplary, self-explanatory pop-up payment notification message for a desktop computer for merchants for when the Payintele software application is minimized to alert someone of one or more payments in accordance with an embodiment of the Payintele system.

FIG. 43 is a graphic illustration of a point-of-sale scenario in accordance with an embodiment of the Payintele system.

FIG. 44 illustrates an exemplary sub-account hierarchy in accordance with an embodiment of the Payintele system.

FIG. 45 is a series of panels illustrating an exemplary gift related scenario in accordance with the prior art involving a conventional gift card as compared to a similar situation in accordance with one embodiment of the present invention.

FIG. 46 is a series of panels illustrating use of an embodiment of the Payintele system in connection with an exemplary gift giving scenario.

FIG. 47 is a block diagram illustrating network architecture in accordance with an embodiment of the Payintele system.

FIG. 48 illustrates an exemplary, self-explanatory user interface screen for a banking partner in accordance with an embodiment of the Payintele system.

FIG. 49 illustrates an exemplary, self-explanatory user interface screen of a mobile device for a payment transaction including at least one credit account of the user in accordance with an embodiment of the Payintele system.

### DETAILED DESCRIPTION OF THE INVENTION

The main objective of the Payintele system is to facilitate a secure, convenient and reliable financial instrument that people can use on-the-go to accomplish various financial tasks. The financial tasks include sending money to and receiving money from other users of the Payintele system, making payments to businesses for purchases and services, generating notifications and alerts pertaining to the users' financial activities, real time account activity updating, checking balances, functioning as a mobile wallet, adding and withdrawing funds to and from the wallet, assembling all liquid financial assets, local and international denominations, in one place to manage them more efficiently, prevent exposure of personal and financial data, and provide peace of mind to its users.

The invention is a computer system comprised of hardware and software infrastructure that acts as a platform to which users can connect using their mobile devices and a client application that is executed in their devices.

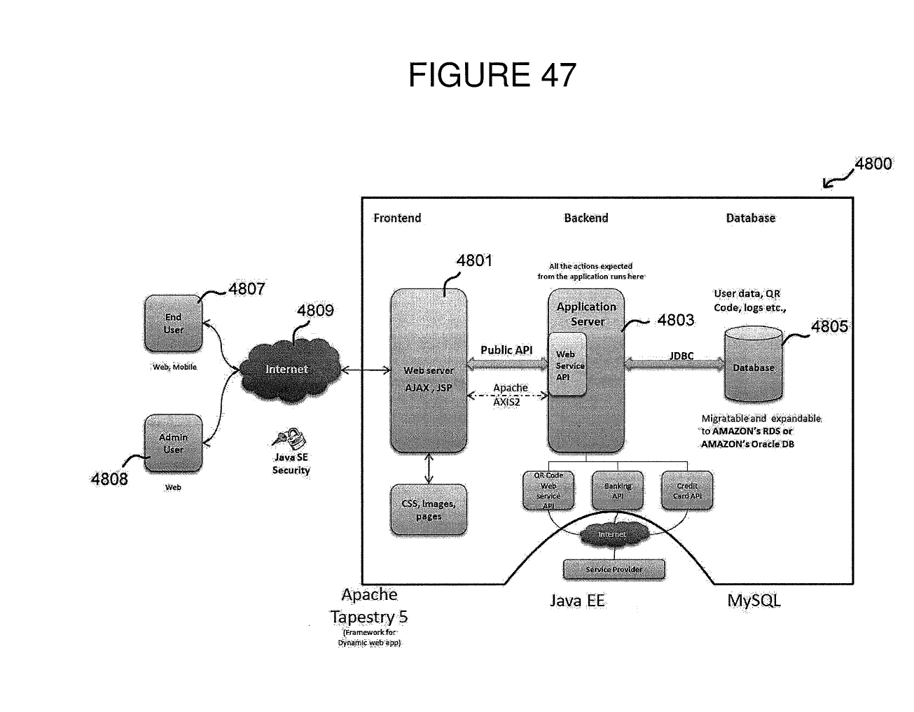

With reference to FIG. 47, the platform 4800 is made of a front end web server 4801, a back end application server 4803, and database 4805. The front end server 4801 facilitates connection between the end user 4807 and the back end application server 4803 through an internet connection.

The web server 4801 also facilitates connection between the administrative modules 4808 and the application server 4803. An administrative interface is desirable so that staff can monitor activities, make adjustments, provide customer support, etc.

The backend infrastructure also has security modules (not shown in FIG. 47) that prevent unauthorized access to the database, malware, spyware and other vulnerabilities.

A web and proprietary mobile client interface (not shown separately) to provide users access to their account details via web browsers is loaded on the end user's device.

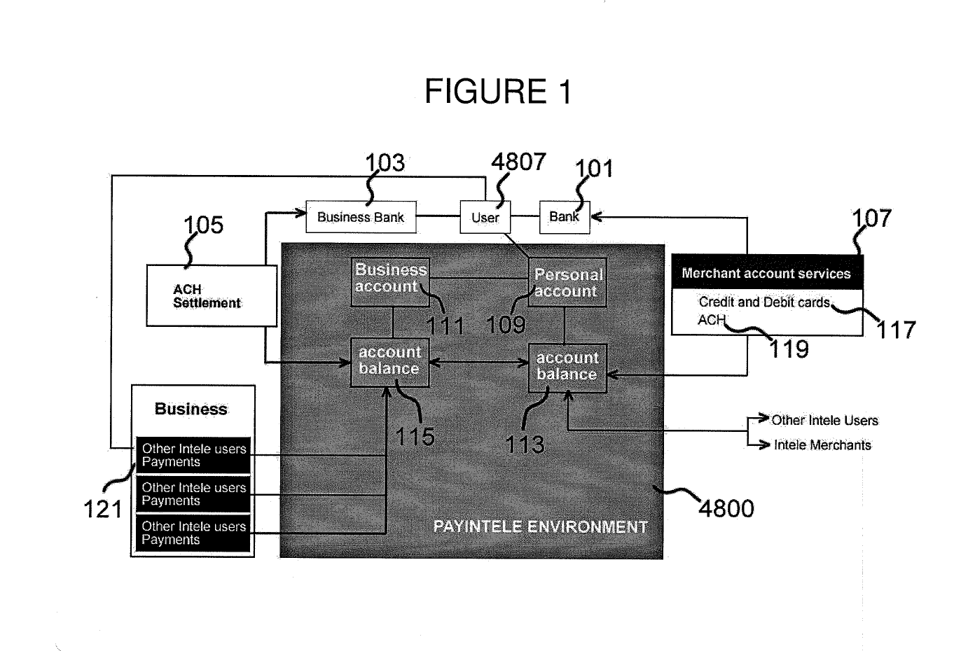

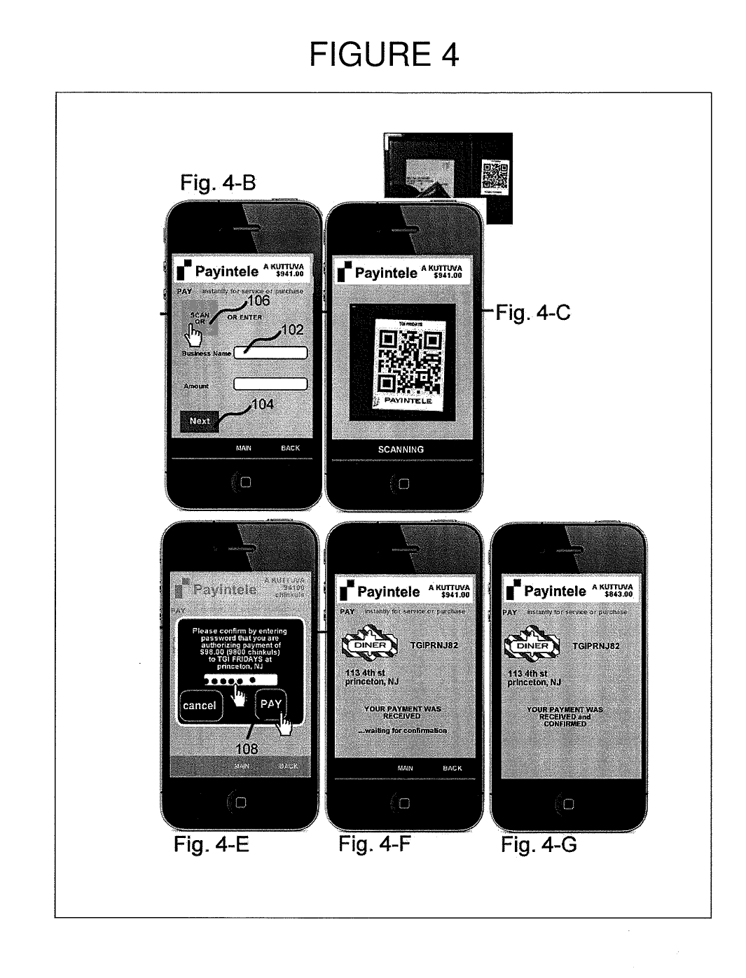

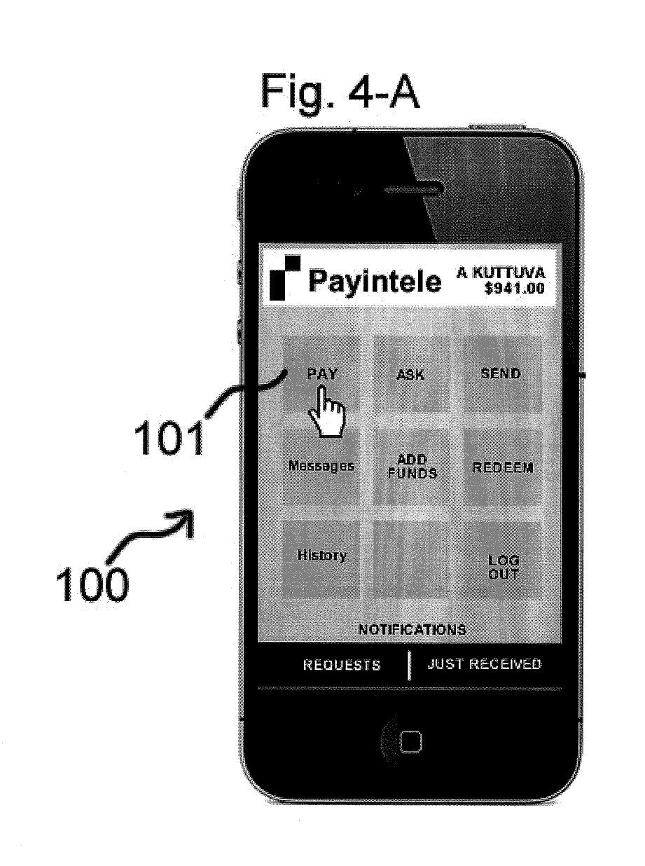

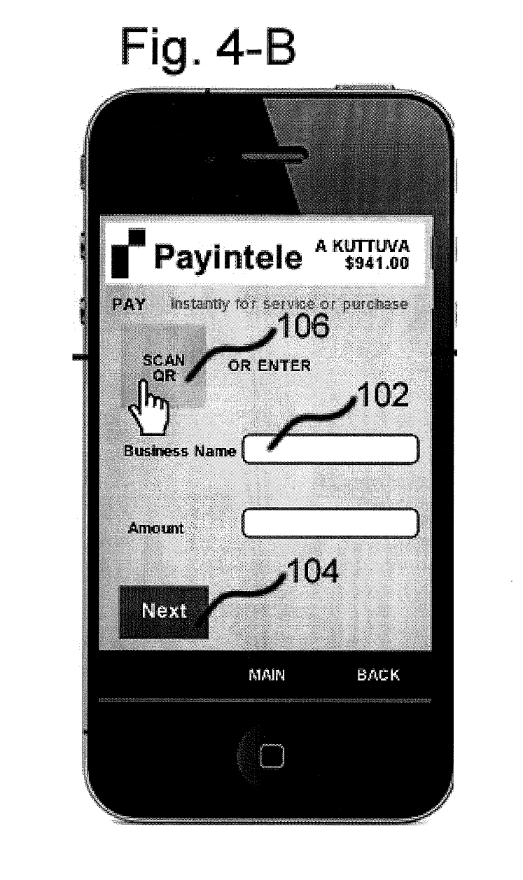

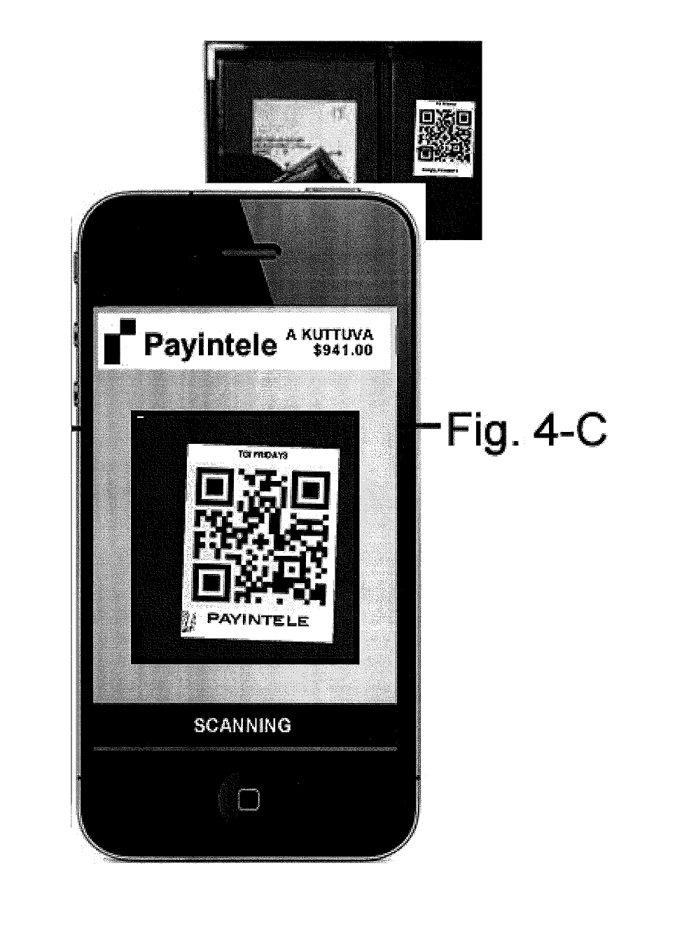

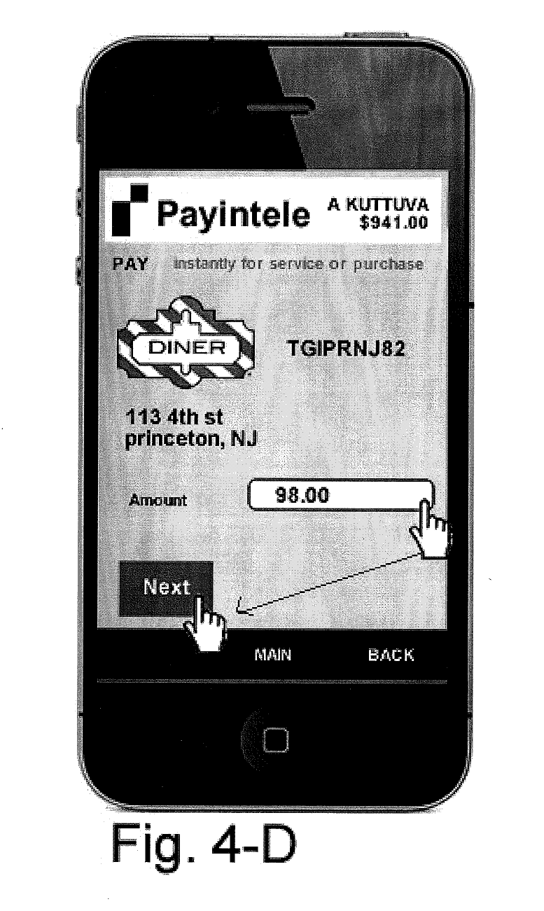

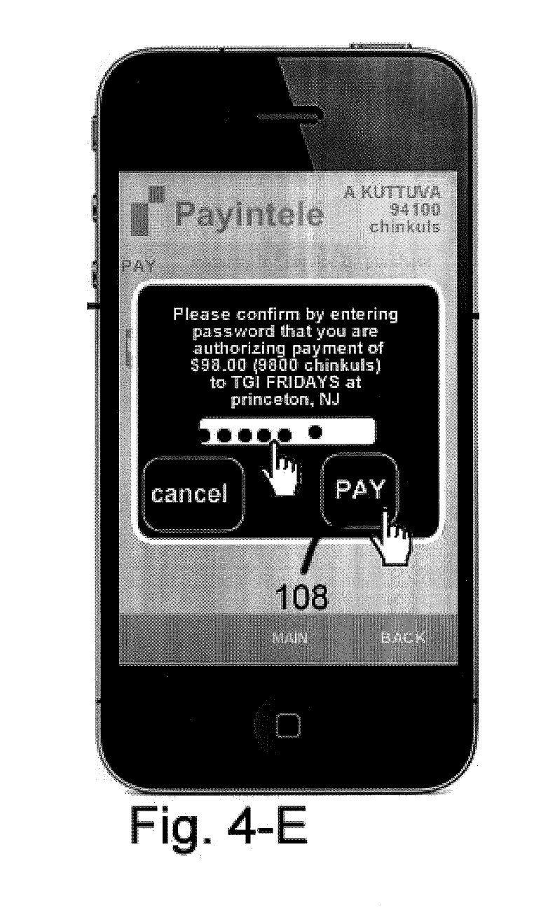

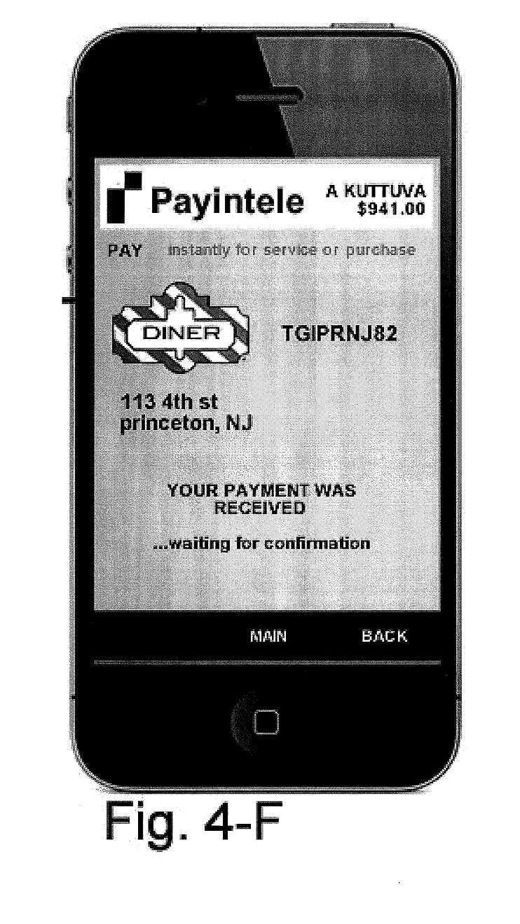

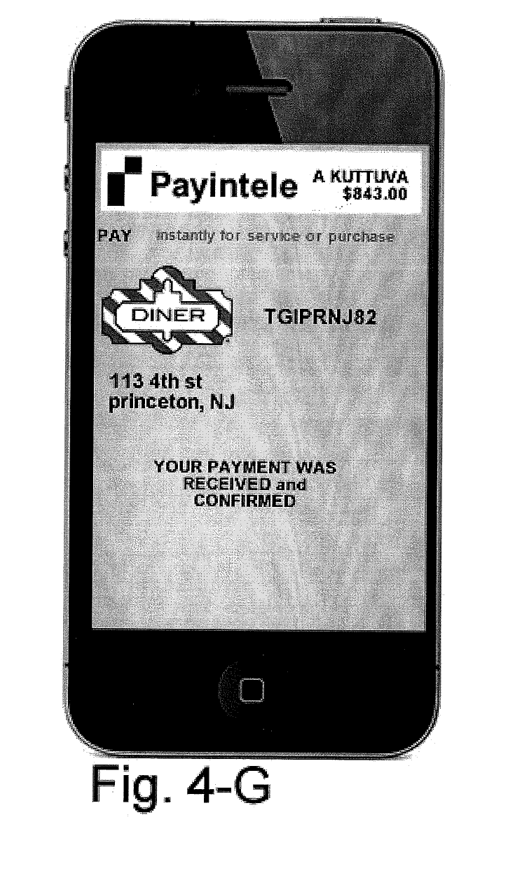

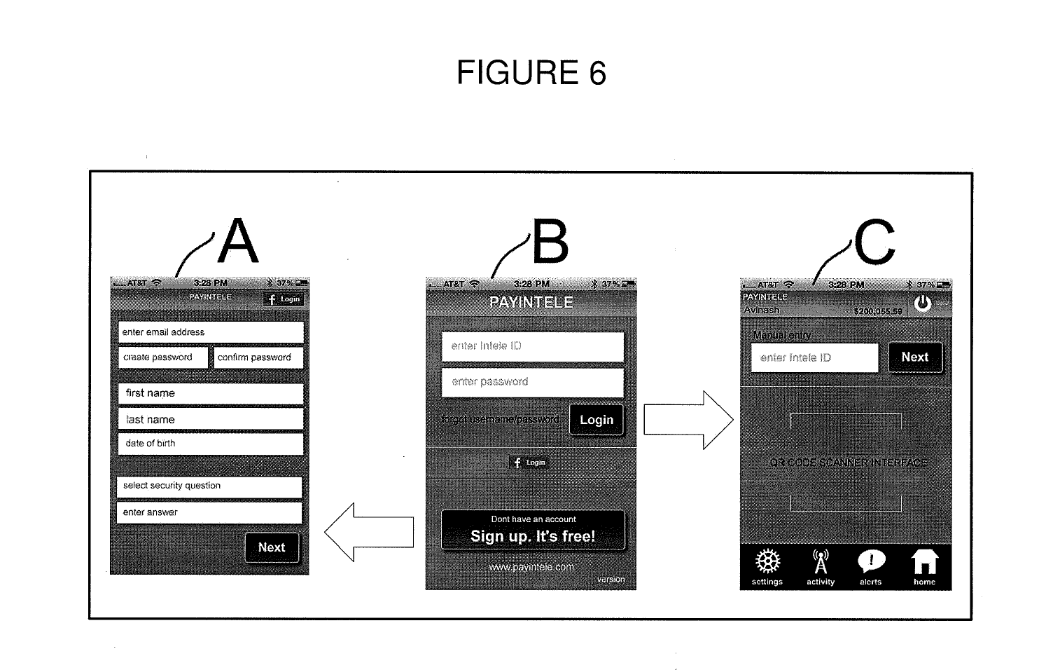

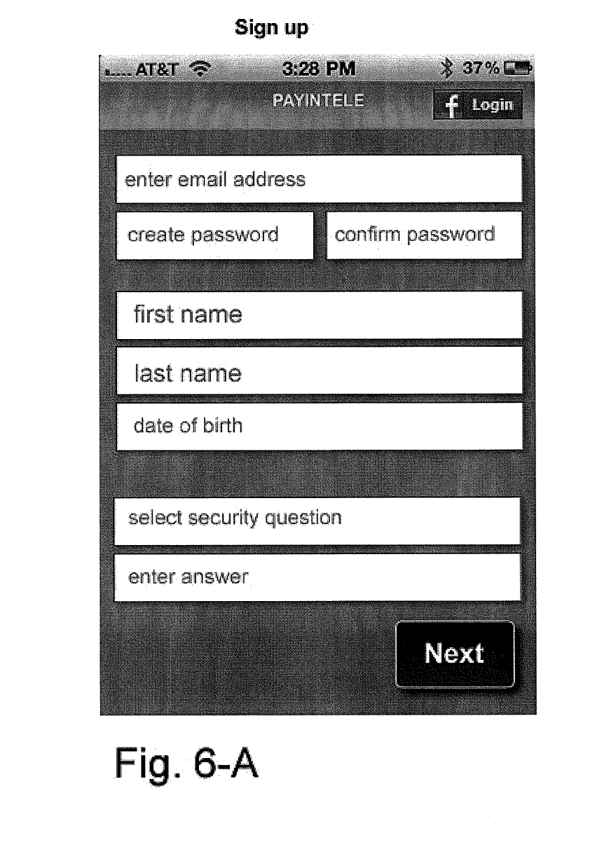

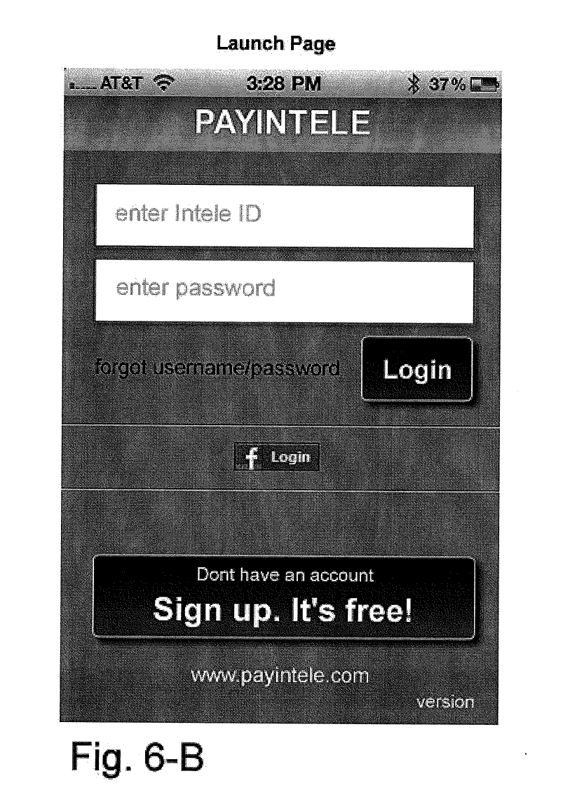

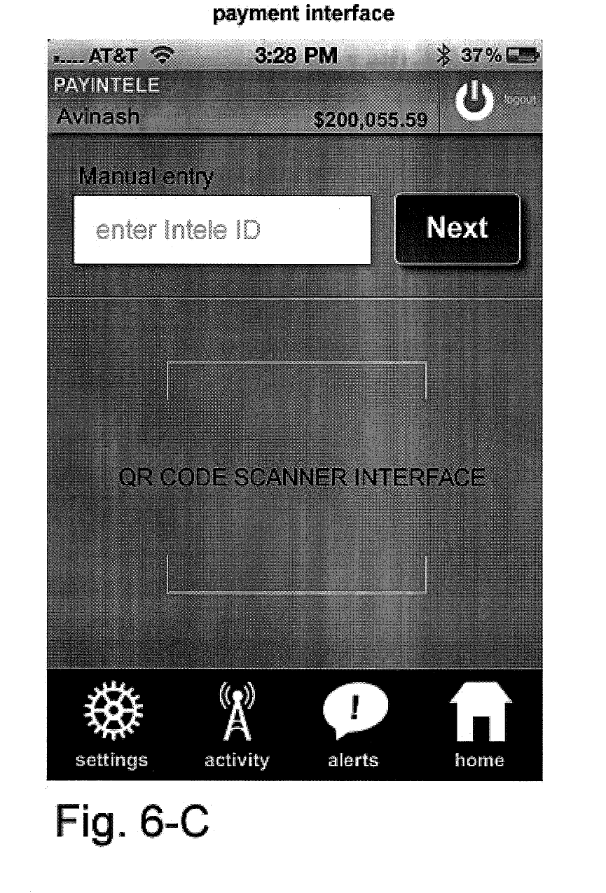

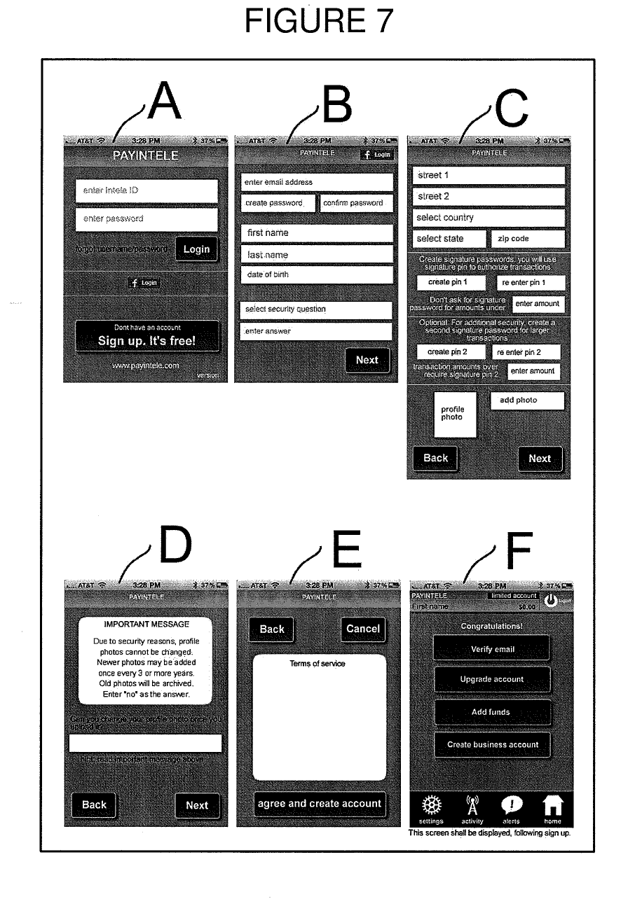

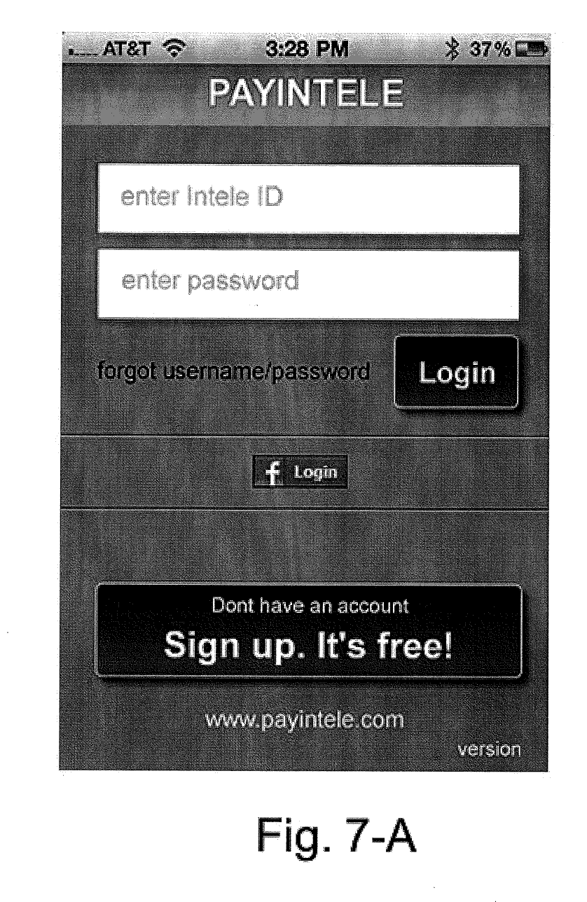

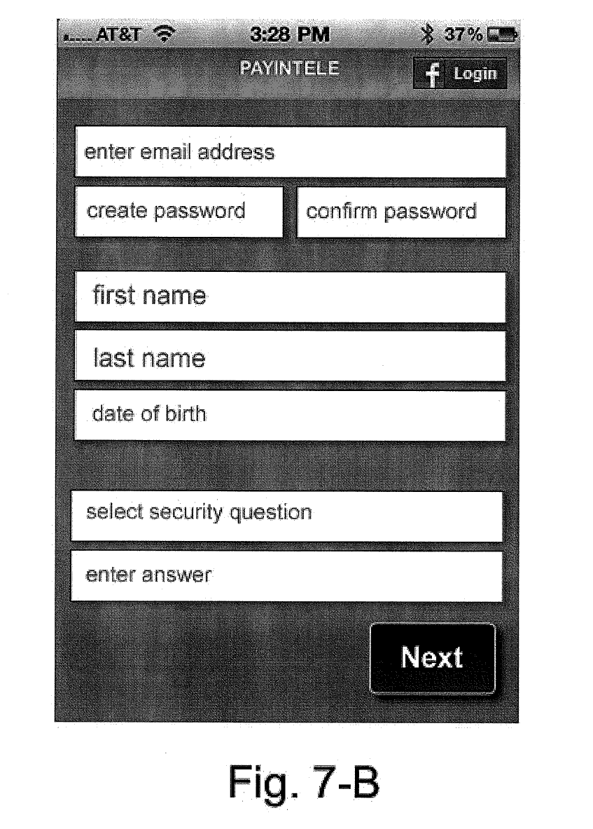

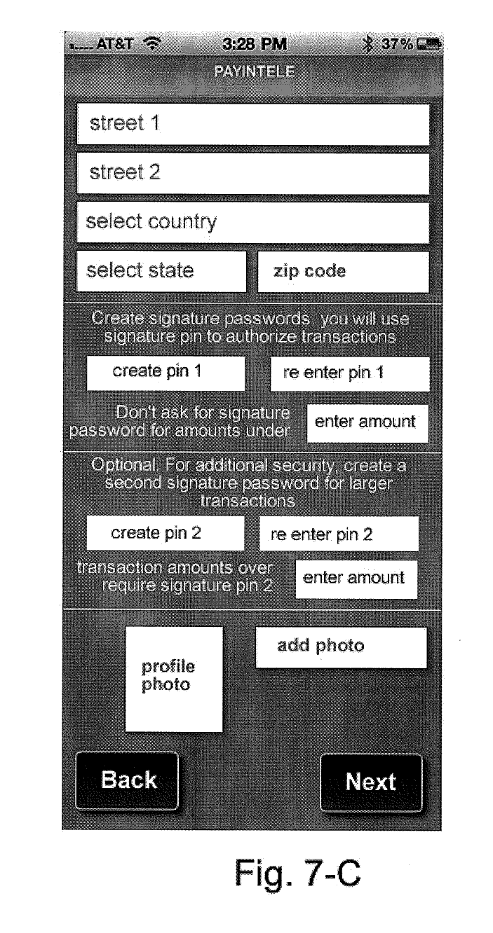

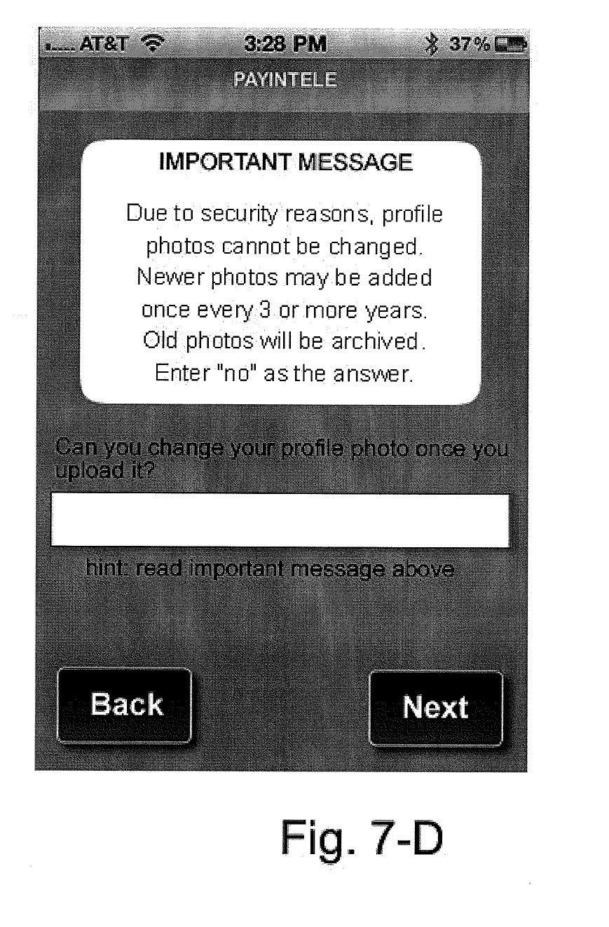

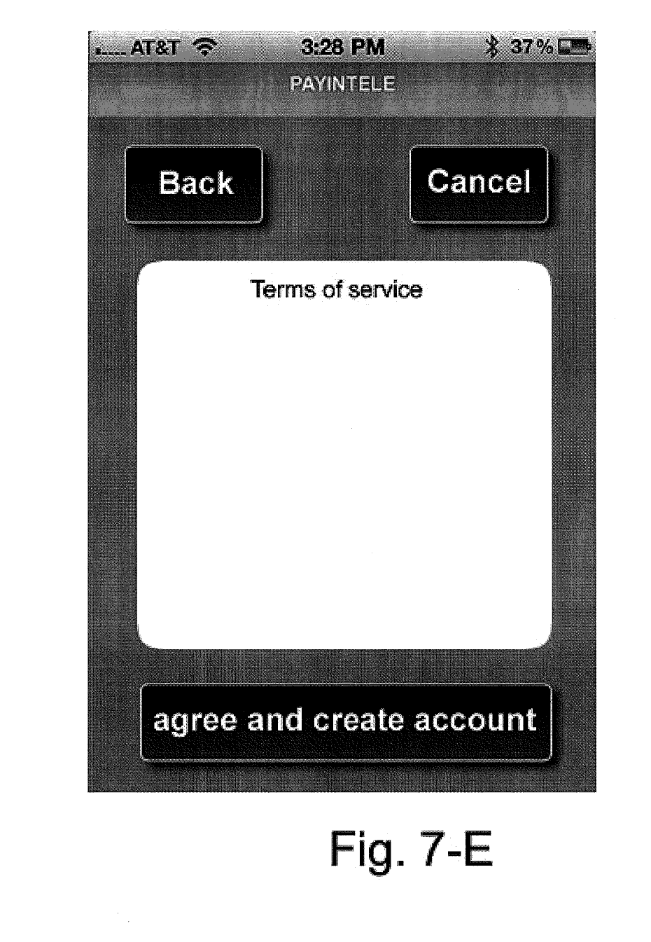

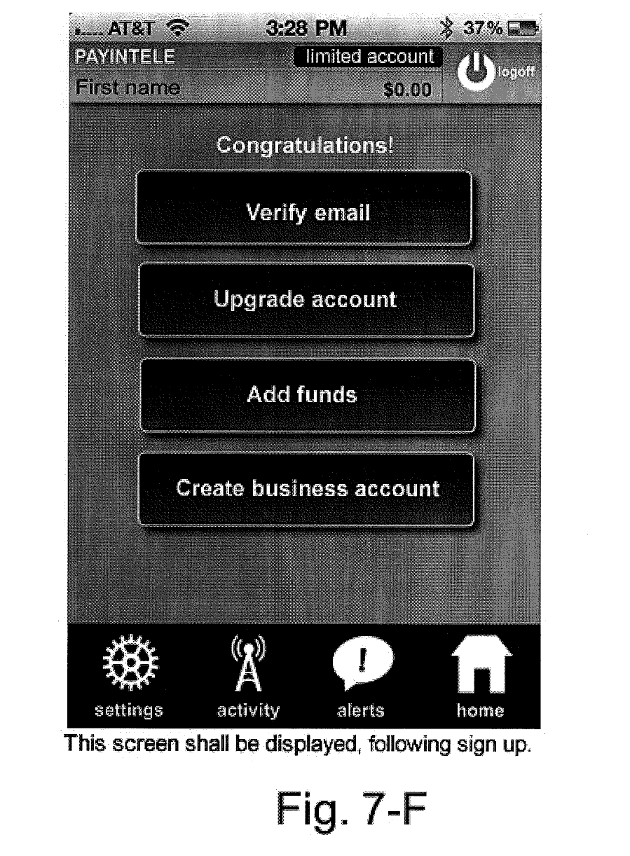

With reference to FIG. 1, which illustrates the entity relationships for a single user in the Payintele system, the platform is also connected to external entities such as partner banks 101, 103, payment gateways 105, 107 and other entities that may be required to provide various services. Users 4807 can create accounts 109, 111 by registering themselves and creating their usernames and passwords by visiting the Payintele website or from a Payintele mobile phone application installed on a mobile device. FIGS. 6 and 7 illustrate exemplary user interface screens for launching the Payintele application and registering with the Payintele system, respectively. Referring to FIG. 6, when the mobile app is opened, it presents the login form 601 with options to sign up, which takes you to form 602. If the user already has an account; he can login and proceed to either the home screen (as in FIG. 4) or the payment interface 603 in FIG. 6, based on user settings. If the user does not have an account, then the signup option shall be selected to take the user to initial sign up screen 602. If the user has forgotten the password, a password recovery link 604 can be selected.

The aforementioned user interface screens are self-explanatory and do not require additional discussion. However, some points to be noted include:

1) Password—in FIG. 7, interface screen (b), a password is created. This is used to login to the account;

2) PIN creation—in FIG. 7, interface screen (c), during sign up two PIN numbers can be created, for different transaction limits;

3) Photo upload (FIG. 7, interface screen (d)—The application warns the user that the user's photo cannot be changed due to security reasons. The uploaded photo will be used at the point of sale to verify payer's ID.

Returning now to FIG. 1, after a “User” 4807 registers for a Payintele account, an account 109 is created and the “user” 4807 may then perform several functions, such as:

Add funds to “account balance” from “user's” bank accounts via “Credit and Debit cards” 117 and/or “ACH” (Account Clearing House) 119 through “Merchant account services” 107.

Share funds with “Other Intele Users”

Make a payment to “other Intele Users” and “Intele Merchants”.

Withdraw funds from “user's” “account balance” 113 to “user's” “Bank” 101 account via Automated Clearing House “ACH” service 119.

Create one or more “business account(s)” 111 of which the “user” 4807 is the owner.

Accept “business” payments 121 from “Other Intele Users”. “Business” payments are credited to users “business account's” 111 “account Balance” 115, which can then be transferred to “users” personal account 109 within the Payintele environment, or to “user's” “business bank” 103 through “ACH settlement” 105 upon request, using Payintele's mobile or non mobile interfaces.

In this system, each user can only have one personal account 109, but one or more business accounts 111. Business accounts may have one or more owners and the funds in such business accounts may be controlled by multiple owners, similar to multiple check signers for checking accounts.

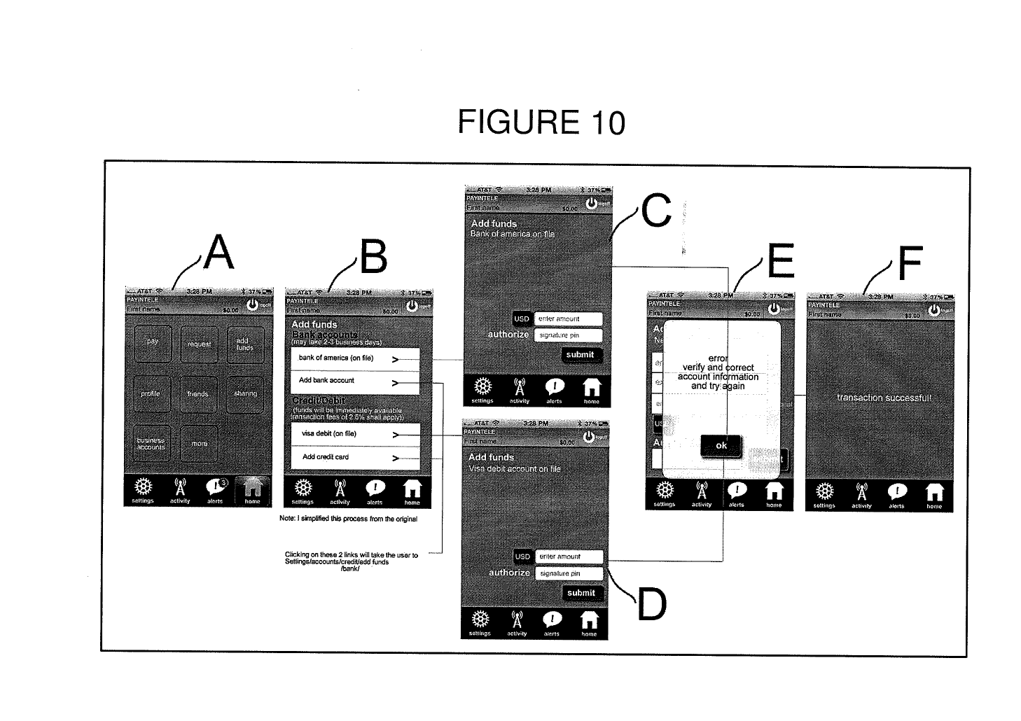

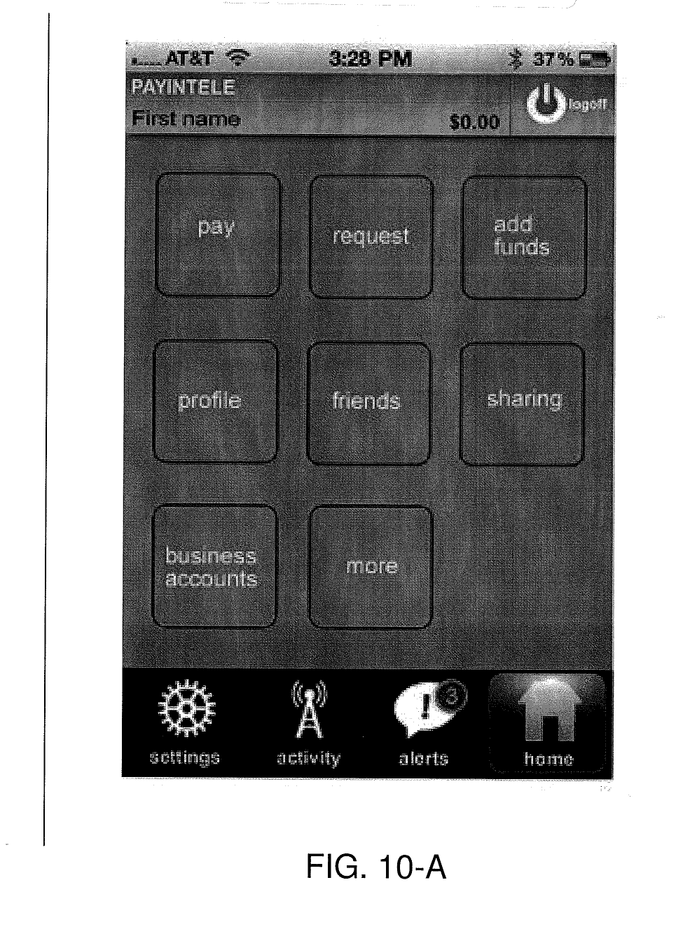

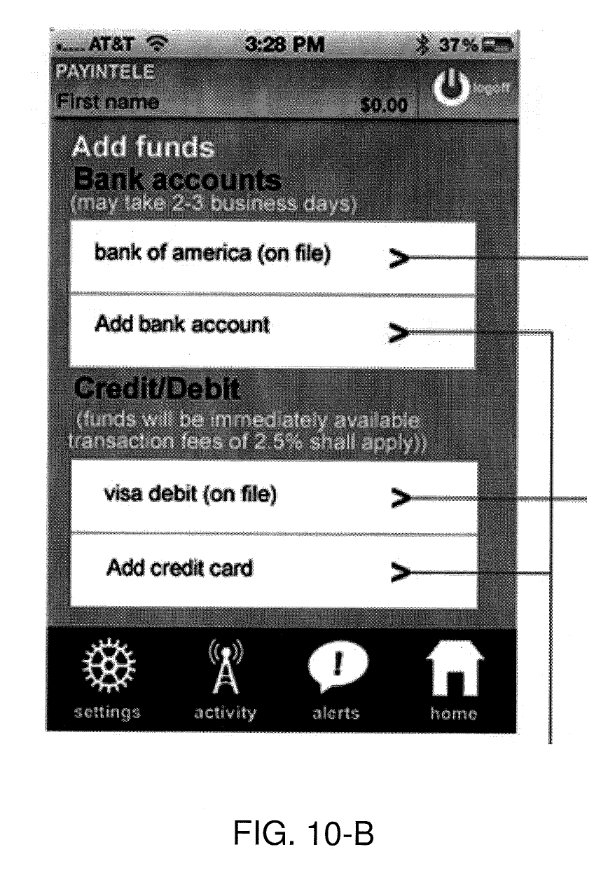

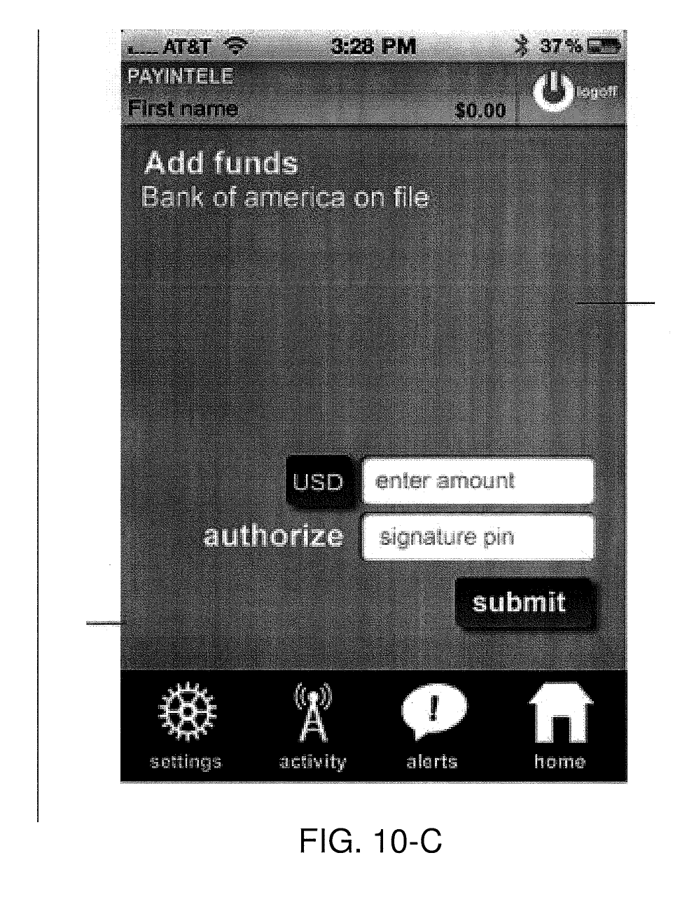

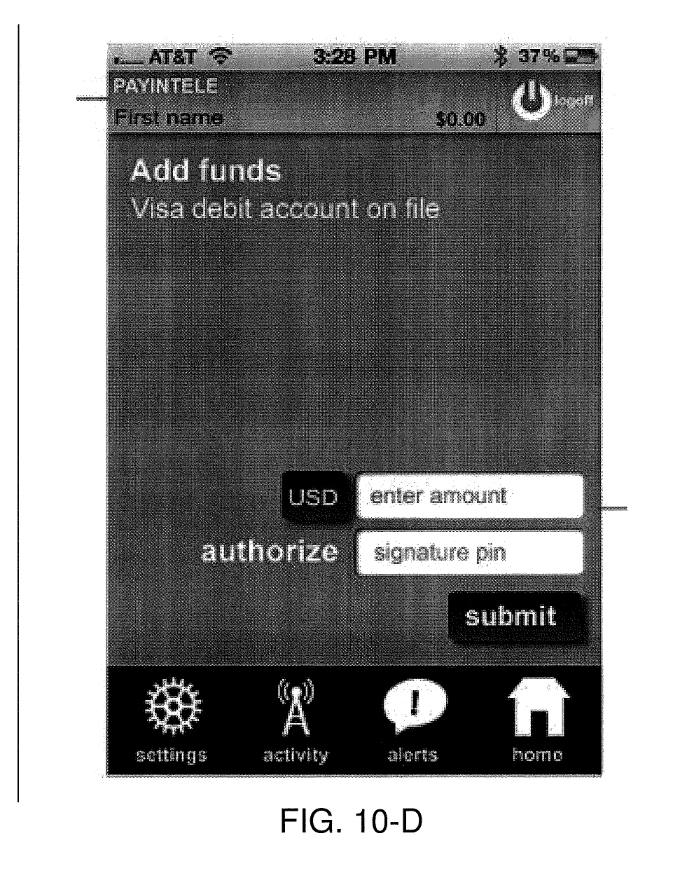

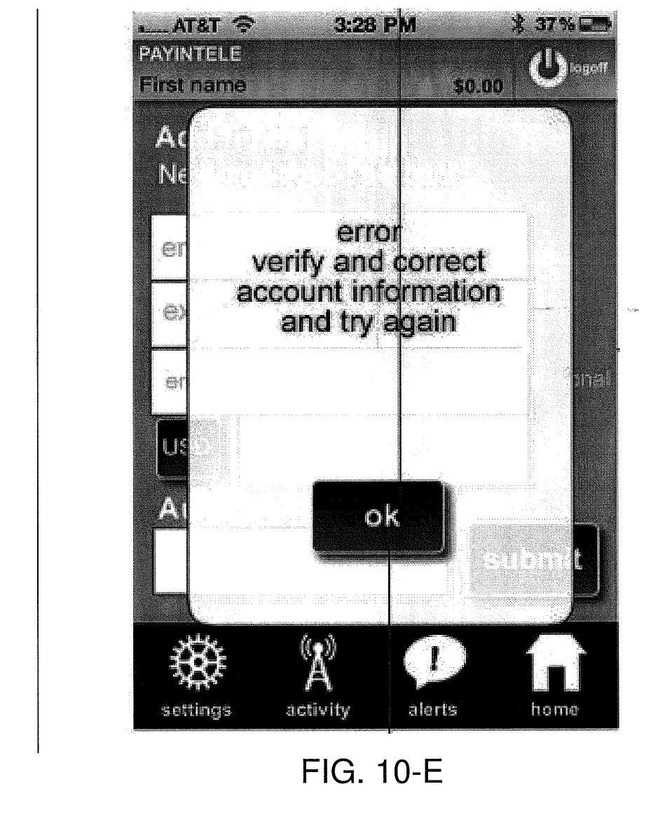

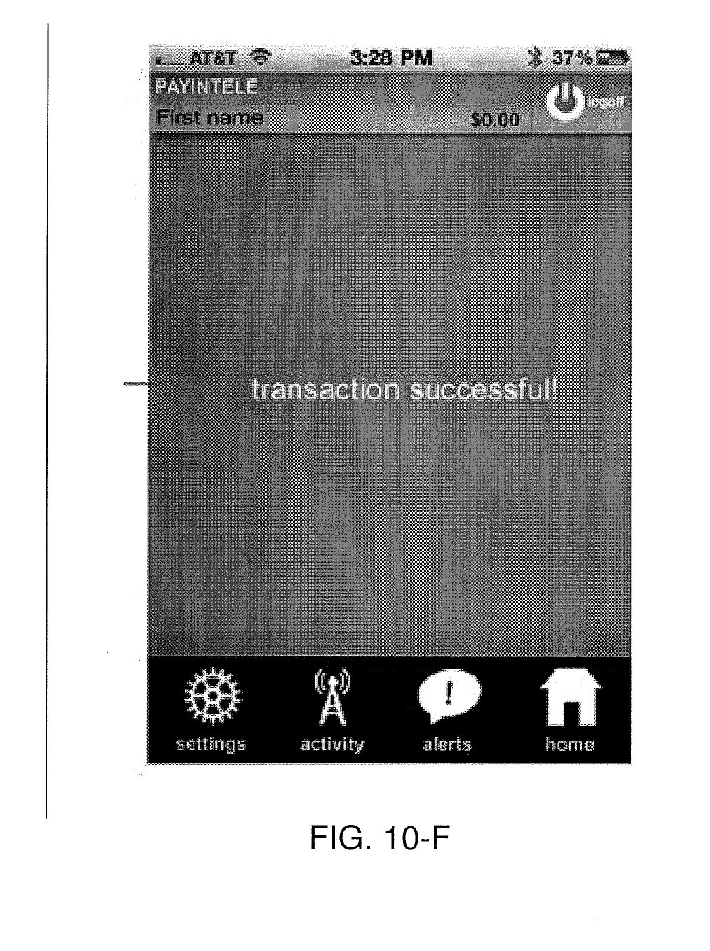

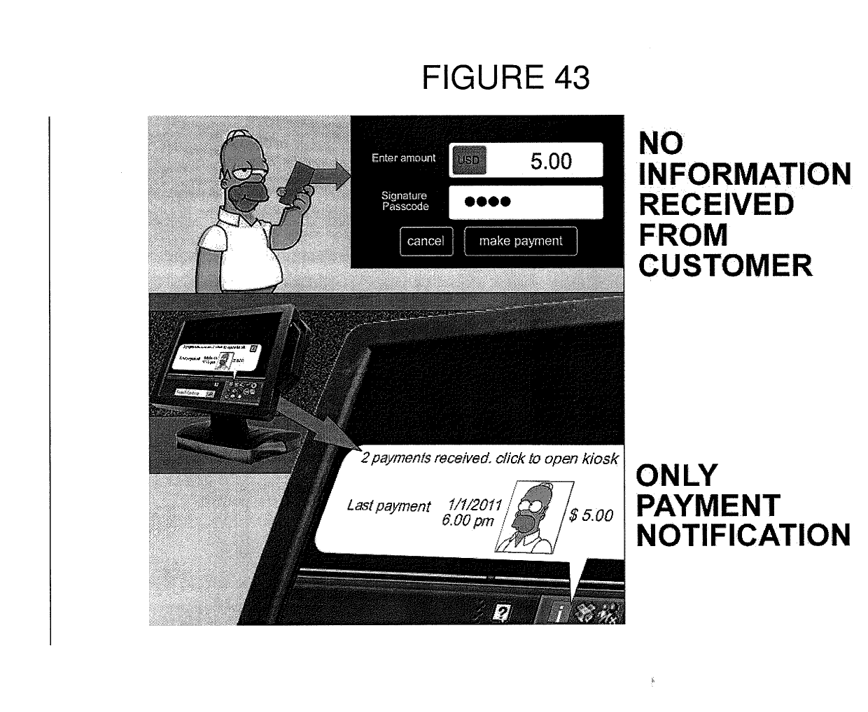

While registering for an account, users shall be required to upload a facial photo, which will be used as a means of identification at point of sale transactions (as illustrated in FIG. 43). Once a user 4807 is registered and meets all registration requirements, he/she shall be able to preload the account 113 with funds through the user's bank account, credit or debit cards 117 (see also FIG. 10), or may receive funds as gifts or payments from other users. The term “users” shall collectively represent individuals and/or businesses. Only registered users can exchange funds and complete the transaction successfully.

Payment information can be sent to a non-registered user through a phone number, email address, etc. However, in order to claim the funds, the user must either become a registered user to complete the transaction or select from options as to how to handle the funds. The options for users that do not want to register shall include a) deposit in receiver's bank account or 2) reject the payment. If the user chooses to deposit the money in a bank, the user shall also supply the banking information by clicking a secured link only accessible from the email sent to the user. When the payment is sent via a phone number, the Payintele system will instruct the user to reply with an email address where the secure link can be sent. A temporary password shall also be sent via the telephone number that will be required to temporarily log in to the system. If the user rejects the payment, the funds will be simply sent back to the sender.

When money is sent to non-registered user, it is sent as an electronic payment voucher, called an “Intele check”. The receiver may elect to accept the Intele check, however, the user will have the option to keep it as such without redeeming. This may be helpful in the case of a cross border receiver, because, the receiver of the Intele check does not have to pay any foreign transaction fees unless the Intele check is redeemed. The Intele check may be considered equivalent or similar to a travelers check. As an alternate, the receiver may provide the address and simply request a paper check.

Once a user has funds in the user's account, payments can be instantly sent to anyone around the world.

New users may be subject to limits on numbers of sending and receiving activities and or maximum limits on amounts, until the user upgrades the account and confirms that the user is legitimate. To prove this, the user shall be provided with one of a variety of challenges, which include 1) successful completion of third party ID verification service, 2) successful addition of a bank account, 3) proof that the bank account does in fact belong to the user, which can also be performed via a 3^{rd} party service such as the instant account verification challenge or a micro deposit method. The third party ID verification test consists of a series of personal legal questions that may only be known to the actual user.

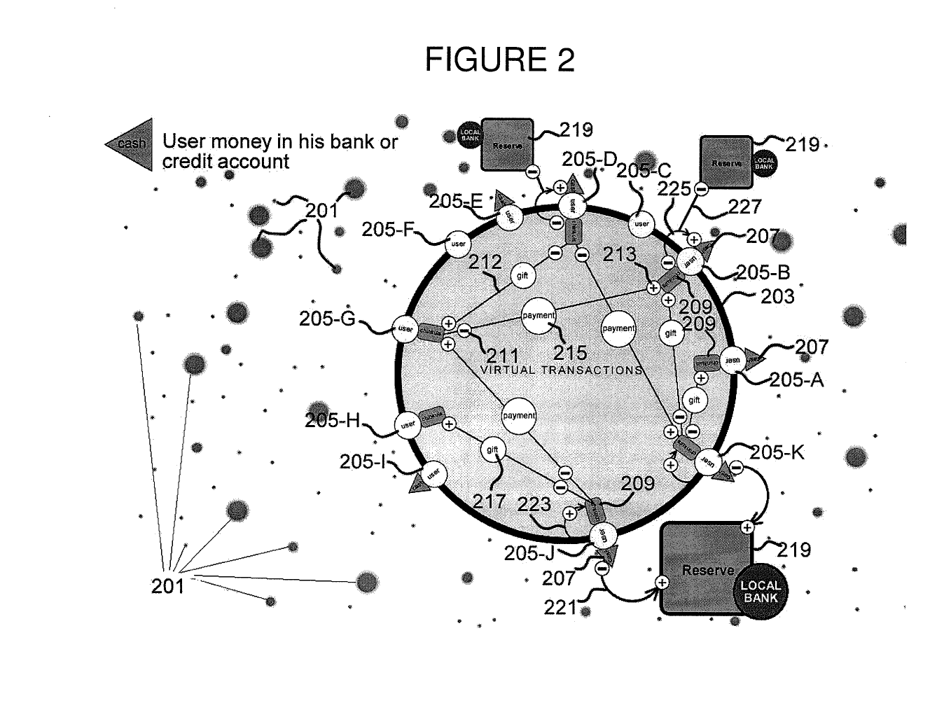

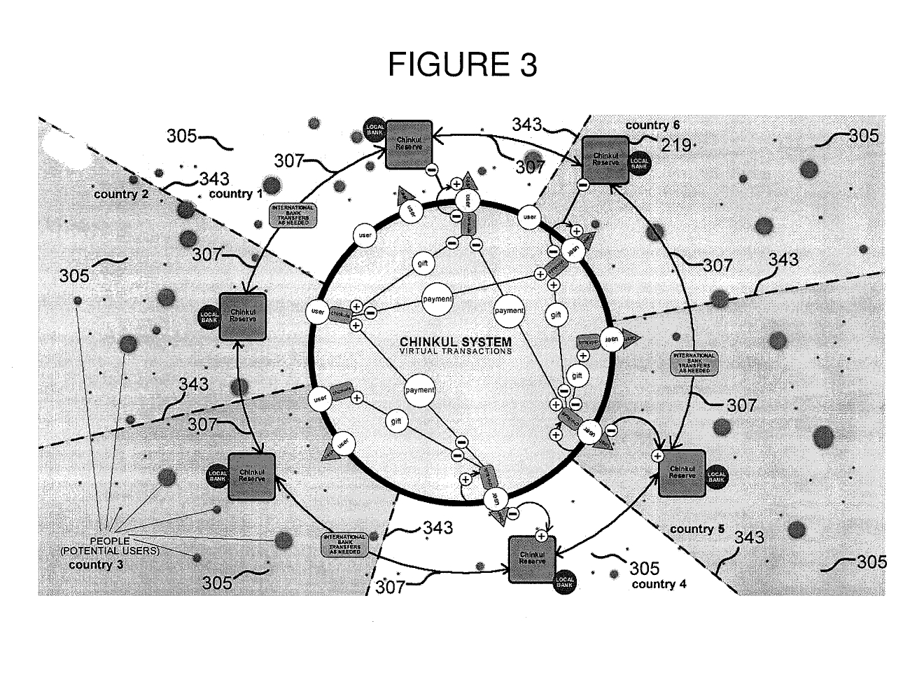

FIGS. 2 and 3 help illustrate how the present system may work in a single country embodiment and in an international environment, respectively. In these figures, unregistered users are represented by the dots 201 outside of the circle 203. Registered users are represented by circles 205 on the circle 203. Everything inside the circle 203 corresponds to transactions occurring within the Payintele environment. Everything outside of the circle 203 is occurring outside of the Payintele environment. As can be seen, registered users 205 may or may not have a bank account or other payment source 207 tied to their Payintele account 209 for purposes of placing funds into or extracting funds from their Payintele funds accounts 209 into the real world. In FIG. 2, transactions are represented by lines between users' Payintele fund accounts 209. The minus symbol at one end of each such line indicates that the corresponding user is making a payment to the person at the other end of the line corresponding to the plus sign, which is the person who is receiving payment. The circles intermediate the line indicate whether the transfer is a payment for goods and services 215 or a gift 217 and are merely exemplary. As can be seen, some users may be registered and have no external funds source attached to their account and may have no funds 209 within the system. However, such users may receive payments from other users, at which point they will have an Payintele funds account 209. Also, if they wish to remove funds from the Payintele environment, they will need to tie a bank account, credit card, etc. to their Payintele account. While the transactions in the circle 203 may be considered virtual in some sense, they of course correspond to real money in the real world. Thus, the Payintele system maintains one or more bank accounts, herein termed float accounts 219 in which the money that is inside the virtual system, e.g., in Payintele fund accounts 209, is actually deposited.

Transactions 212 occurring inside the Payintele system between two Payintele users do not require any interaction with actual funds outside of the virtual environment. That is, in one sense, a transaction between two users inside of the Payintele virtual environment can be recorded and maintained simply through proper recordkeeping. However, when a user wishes to remove funds from his Payintele funds account 209, an actual transaction outside of the Payintele system must occur. This is illustrated, for instance, in connection with users 205b, 205d, 205j, and 205k. Taking user 205j as an example, when user 205j decides to place funds into his Payintele fund account 209, the actual transaction that occurs outside of the Payintele environment causes funds to be removed from the user 205j's outside bank account (or other fund source) and placed into the float account 219, which is a real account at a real bank outside of the Payintele system. This is represented, for instance, by transaction 221 in FIG. 2 where money is removed from user 205j's fund source 207 and placed in the Payintele float account 219. Inside the Payintele virtual system, a virtual transaction 223 occurs in which Payintele 203 adds those funds into the user 205j's Payintele funds account 209. In actuality, of course, the funds simply remain in the float account 219.

The situation when a user withdraws funds from the Payintele system is illustrated in connection with user 205b in FIG. 2. Particularly, when user 205b decides to take funds out of the Payintele system, he uses his mobile device to execute a transaction 225 in which funds are removed from his Payintele funds account 209 and placed in his real world bank account or other funds source/deposit entity. However, in actuality, the money is stored in a Payintele float account 219 and, in actuality, the money is deposited into user 205b's bank account 207 via a transaction 227 sending the money from the Payintele float account 219 into the user 205b's bank account 207.

FIG. 3 is very similar to FIG. 2 except showing country boundaries 343 and the fact that Payintele might maintain float accounts 219 in various different countries, and when funds need to be transferred internationally between users, the funds would be withdrawn from or deposited into Payintele float accounts in banks in the country corresponding to the user and Payintele could transfer the funds via international transactions 307 between its various float accounts 219 in the different countries 305.

### How Payments Work, Various Situations Samples

A) Personal Payment:

A user who has funds in his account can click on the link that is used to send to another person, who may or may not be a registered user.

1) Payment to a Registered User

The user enters the name, e-mail, or telephone number or the unique user ID of the receiver in the appropriate field and submits. The system displays the receiver's photo to the sender to verify the receiver's identity (and make sure that is in fact the person to whom he intends to send the virtual points). Following verification, the sender enters the amount of payment in dollars or other currency in the appropriate field and submits. The system stores the transaction as pending and deducts the amount of virtual points from the sender's balance. A text message to the receiver's phone or email or a notification on the user's account's website interface or a combination of all is received by the receiver depending on how the receiver personalizes his account, and the user may or may not be required to confirm that he accepts the funds to complete the transaction. Then, until the receiver accepts the funds, the sender has the option to cancel the payment at any time. In such an event of cancellation of transfer, a notice is again sent to the receiver regarding the cancellation of the payment by the sender.

The transactions are recorded in the database for future use in the user's account history.

In case of a personal payment, senders may choose to place a hold on a transaction, for security purposes. If a hold is placed on a transaction, the receiver shall also be informed that the sender has the capability to cancel the payment until the hold is removed by the sender. This feature shall add more security and provide an opportunity to revoke a personal transaction, if the virtual points were sent to a wrong person or by mistake.

2) Payment to an Unregistered User.

The user will be notified by the method chosen by the sender depending on what contact information the sender has for the receiver. The notifications will also provide required information such as the URL and information about the system and encourage the unregistered user to register for an account and accept the funds. Once the user registers and meets the requirements, he or she can then accept the funds. In this case, the sender receives another notification that the person has accepted the funds with the receiver's photo to confirm that this is in fact the right person, (mainly when the sender and the receiver are known to each other) and works just like a “hold” as discussed in the preceding paragraph (i.e., the funds will not actually be transferred until the sender removes the hold).

A) An Instant Payment to a Merchant Account Holder at a Point of Sale/Service

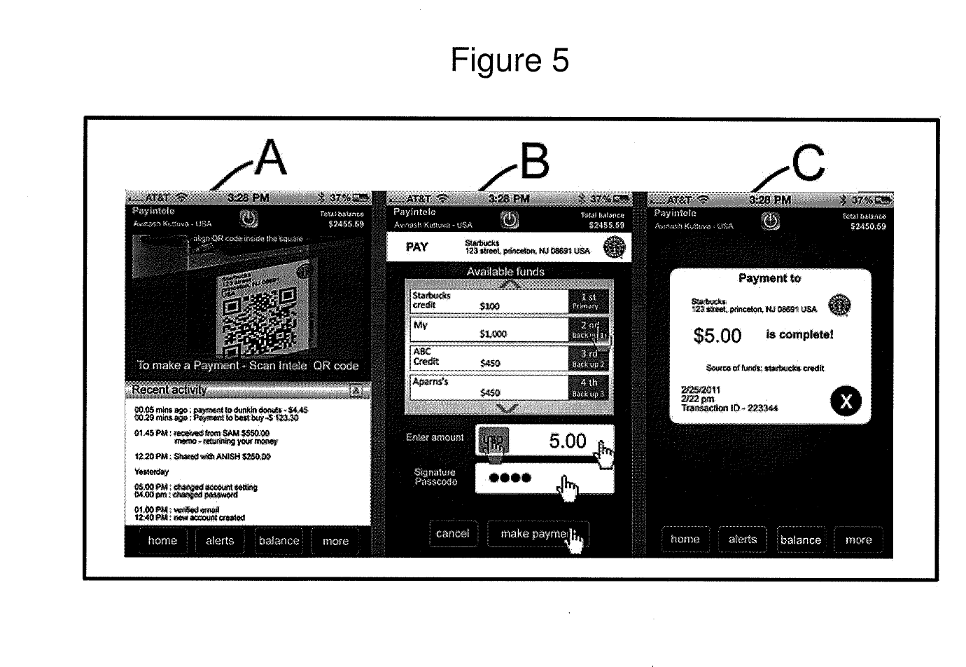

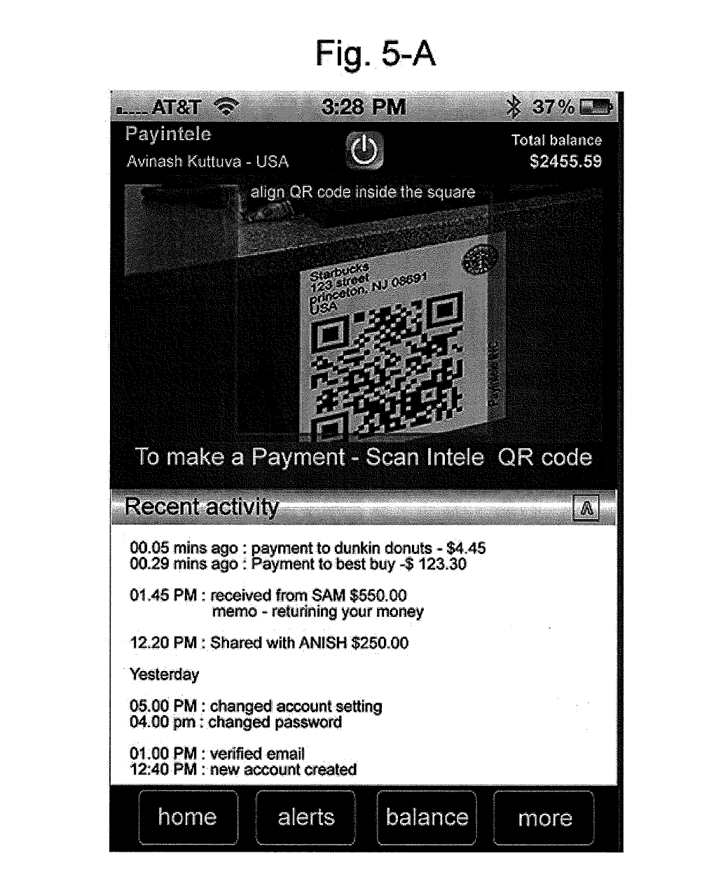

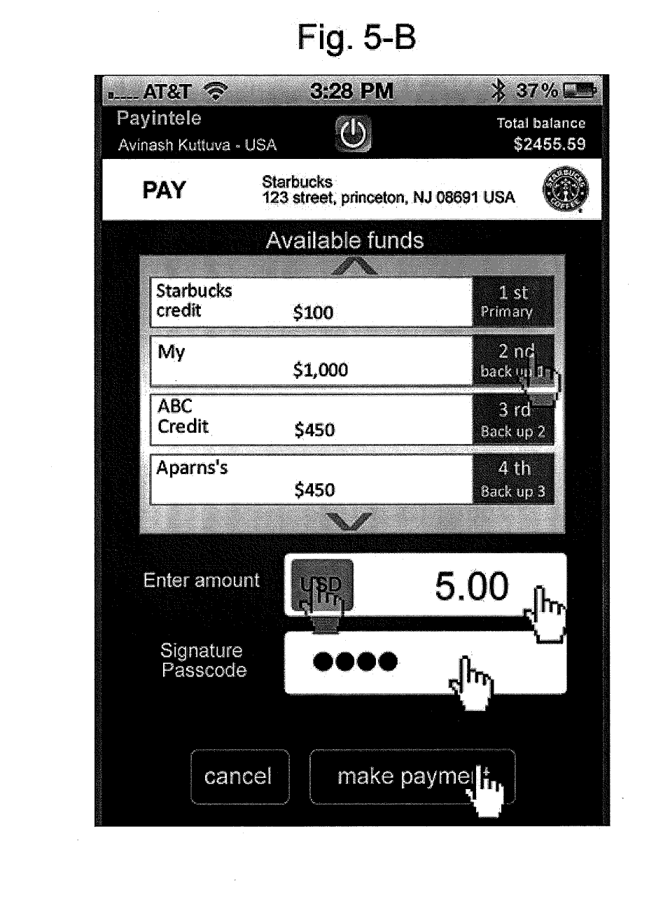

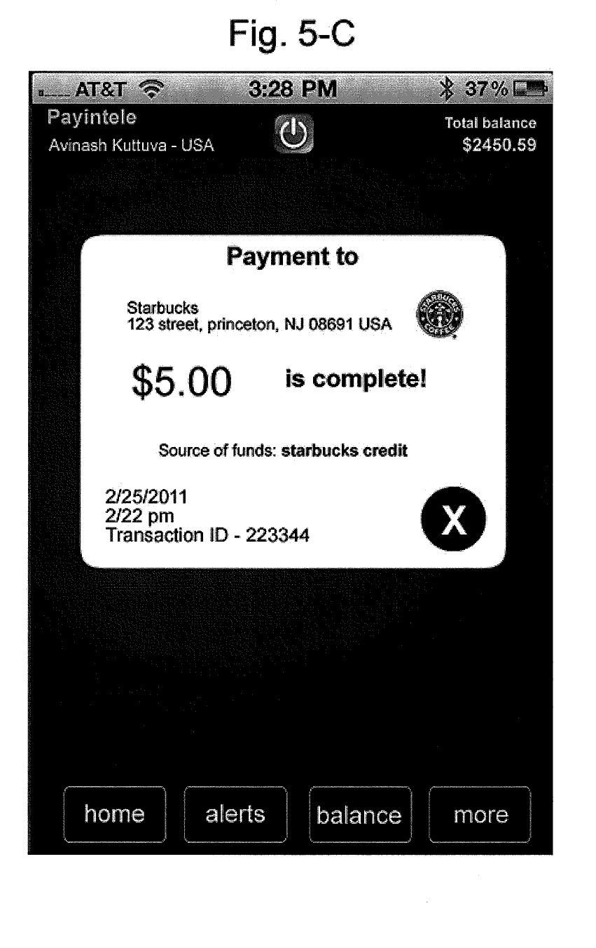

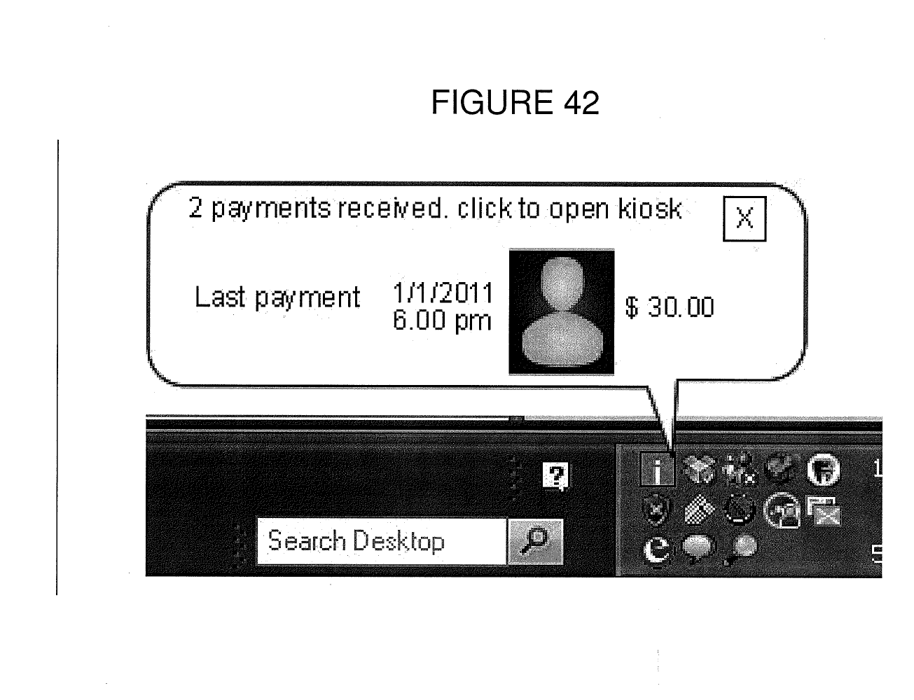

Requirements for Instant payment—See FIG. 4, FIG. 5, FIG. 42, FIG. 43.

A) All merchant account holders are provided with a QR code for each account and sub account, which they can display at their check-out locations and on their websites.

B) A mobile electronic device such as an Iphone, Android, etc. with a camera interface or a device capable of sending and receiving text messages (additional steps may be required in case of a non-smart phone).

C) A mobile or smart phone client app. which shall be available for everyone to freely download on their mobile device to facilitate a transaction.

D) Internet connection.

In the absence of an electronic device capable of scanning the QR code, any device that is capable of texting can be used. (Additional steps may be required in case of a non-smart phone).

In the absence of any device at all from the customer, a device that may be provided by the merchant can also be used by the user to login into their account and complete the transaction. Alternatively, a software feature, where the merchant scans the user's QR code (or manually enters the user's account number) to charge the customer that the customer authorizes by entering the password in the merchant's device may be used.

The customer completes shopping and presents the items to the cashier, who then calculates and tells the customer the total. The customer uses his mobile electronic device with Payintele application and scans the merchant's Payintele QR code, which may be displayed at the checkout. The mobile app instantly recognizes the merchant and asks the customer how much to pay. The customer enters the amount and PIN(s) and submits for authorization. The transaction information is transmitted via the wireless connection to Payintele servers 4803 (FIG. 47) for processing. The application in the server verifies that the information matches and that the customer has enough balance and the correct PIN is entered, etc. Once all check points are verified, a success or failure message is sent wirelessly to the customer's mobile device and also to the merchant module. This tells the merchant that the customer's payment was successfully received. The merchant also receives the picture of the payer for ID verification. If the picture and the person match the merchant may accept the transaction and deny if it does not match.

FIG. 4 illustrates an exemplary set of user interface screenshots that may be employed to effect the transaction.

With reference to FIG. 4, when the app is executed on the mobile device, a variety of options are available. FIG. 4 illustrates how a payment is executed. As shown in screen shot (a), the user selects “pay” 108 on the main screen. The next two screens (b) and (c) demonstrate the process of selecting the merchant. Referring to screen shot (b), this can be accomplished either by entering the merchant's ID manually in the appropriate field 102 and clicking next 104 (screen (b)) or clicking “scan” 106 to scan the QR code as shown in screen shot (c). Automatically, the next set of screens are presented to enter the amount (screen (d)) and PIN code screen (e) and click “pay”. This completes the execution of payment and a confirmation screen (screen (f)) is displayed to indicate that the payment was received and a second confirmation screen (screen (g)) is displayed after the merchant confirms receipt.

FIG. 5 demonstrates exemplary user interface screens for the process of selecting the funds to make a payment. In the first screen (a), the user scans the QR code. The app recognizes the merchant as “Corner deli” with its respective address and presents this information in the next screen (b) so the user can verify that the merchant information is correct and select the funds from the displayed list of fund sources. The list has several available funds including store credit. The app looks for matching store gift, charge cards and coupons and assembles at the top of the list and suggests the user to use this fund as the primary fund to complete this transaction, followed by the user's default fund selection. The user may however override the app's recommendation and select a different source of funds to complete the transaction by clicking on the blue buttons, that's labeled 1^{st}, 2^{nd}, 3^{rd} and so forth. The user can also scroll down to see all the funding sources and select the desired source to fund the transaction. If the user wishes to use the funding source selected by the application, the user may then proceed to complete the transaction as discussed previously. When the transaction is completed as previously described, the user is presented with confirmation screen (c).

On the other hand, if the customer has a basic SMS-only device, a text can be sent from the user's registered phone number to the server, and the server shall process the request the same way as above, however; the functionality may be limited depending on the capabilities of the device utilized by the user.

In case of a text only device, the steps may be as follows;

step one: user sends a text with the merchant's unique ID to a specific number provided to the user;

step two: the system requests a user name and password to verify the login credentials;

step three: once the login credentials are verified, the system sends another text message requesting the amount of transaction and authorization password;

step four: the system sends authorization confirmation and payment notification to the merchant with the picture of the payer. The alternate is to send all information at once, to avoid the back and forth.

A business to business transaction may also be processed in the same way. In a business to business transaction, the unique ID is mainly used to identify the business and photos are replaced with logos (if available). A business may share the funds with other users, and specify limits for each user. For example a manager of the business who may be responsible for accounts payable or business purchases etc.

How Gifting with Virtual Points Works in Today's World

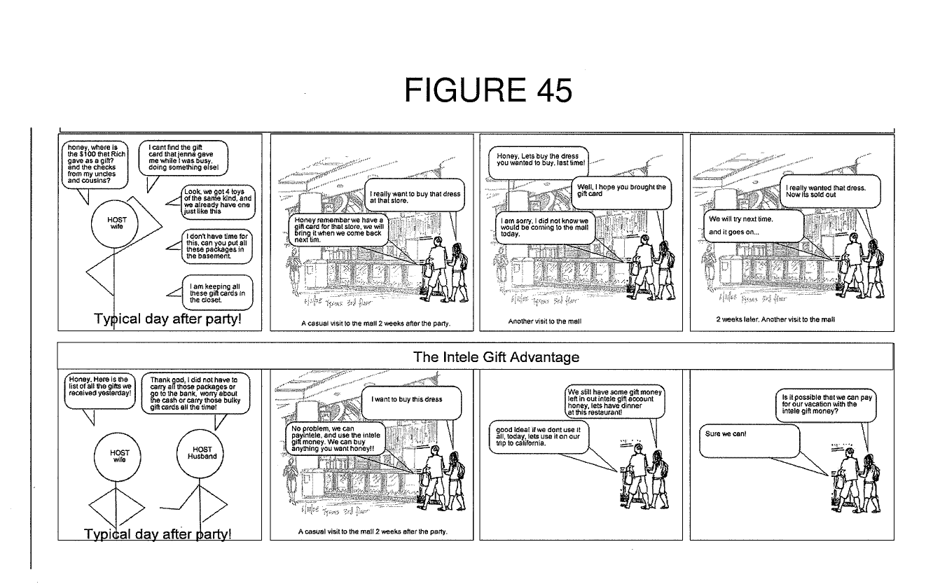

A typical scenario for gift giving is illustrated in FIG. 45. Typically, most people celebrate occasions by inviting people over. Guests bring gifts! However in today's world, many individuals have almost everything they need. Gifters are aware of this and are usually not sure what to bring. Therefore, they have to think and make a fair judgment and select gifts or gift cards. Many people receive the same gifts many times. Therefore, gift registries came into existence. But, there are limitations to this also. People are limited to one or two stores and register items from what the merchant has for sale, not really what they want. The conclusion is that cash is the best gift, but some people feel uncomfortable taking cash from a guest and it is difficult to get organized or remember who gave what. Another solution may be a check. However, when a check is given, the gifter's account details are exposed and needs to be kept safe by the receiver. In addition, the receiver must organize and take a trip to the bank. Sometimes people delay depositing the checks, which can lead to bounced checks with fees to both parties. The present invention solves all of these problems.

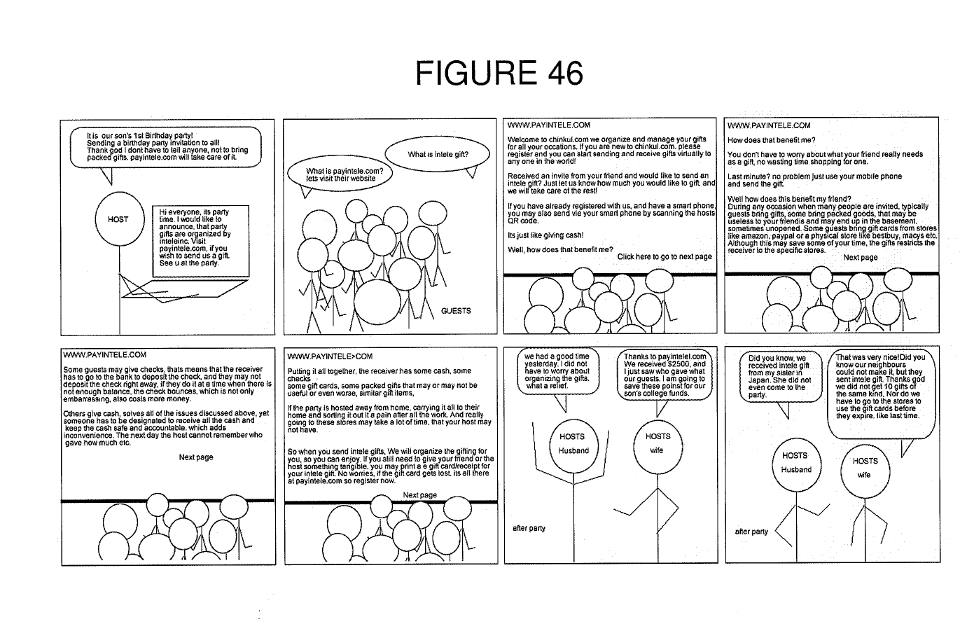

Gift cards create a different problem, as illustrated in FIG. 46. Using the Payintele system instead of gift cards, the host shall just send his personal QR code along with the invitation, and the guests can just scan the QR code and make a gift anytime, whether the person can attend the event or not. With Payintele, gifts can be received as cash conveniently, the gift receiver has a record of who gifted what and the gift receiver may be more organized.

The user who invites people typically sends invitations to all the guests. In the same invitation, the host can mention their preference to receive all gifts through Payintele. The gifters may also print a gift certificate if they would like to take something tangible, or just to remind the host about their gift (although not required). The receiver does not have to keep them safe or worry about losing these paper certificates as they have not value themselves, comprising essentially nothing more than a printed receipt for a transaction that occurs inside the Payintele system.

### System Specification

The mobile client application receives the logged in users' data directly from the server. To achieve faster response, the application may transiently store data locally; however, user date is never kept on the mobile devices permanently, which provides high security and prevents fraudulent activities even when the device is lost or stolen.

Transactions may be made between users not known to each other personally. This includes all other users except Payintele friends. People may be known to each other outside of Payintele. However, if they are not Payintele friends, the system does not consider them friends.

No personal or financial information is transmitted as noted in FIG. 43. The merchants only receive payment notification with the amount and the picture of the payer. This information is considered sufficient to process the transaction and verify the identity. Since users are unable to change their pictures, it also makes it impossible for a thief to simply change the photo and use someone else's account. However, if the transaction requires that the merchant know the user name and other details, it can be voluntarily provided by the payer.

The system creates a unique ID for all registered users. Unlike bank account number, phone number, or email addresses, this unique ID may be provided to other people without much hesitation because not much can be done with just this unique ID. Examples, exploit the user's privacy, commit a fraudulent activity, or make cold calls, etc. Although money can be sent with this ID, that is not such a bad thing for the recipient and that is not necessarily a benefiting act for the sender. It can be safely assumed that people do not send money to others unless they are required to.

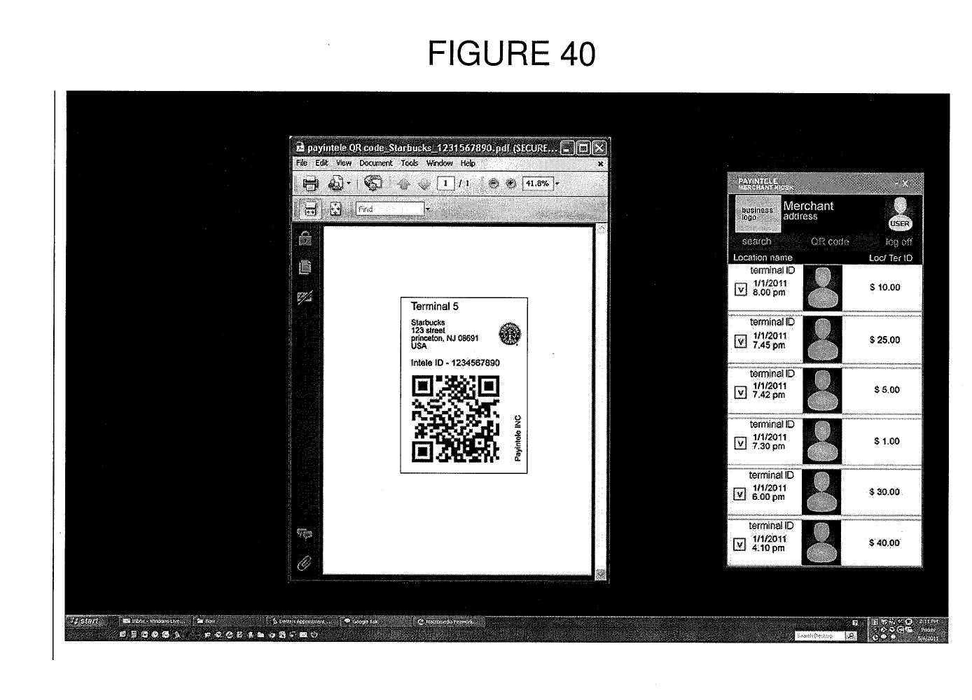

For businesses, the QR code shown in FIG. 40 consists of the business name, address, website, phone number and the business logo or the URL for the logo. When a customer scans the business QR code, all necessary information is instantly transmitted to the user's mobile device for faster response and to avoid unnecessary back and forth communication between the server and the mobile device. This process does not require internet connectivity except if the logo has to be downloaded from the server. However, the application is programmed in such a way that this does not interfere with the performance.

The user may submit the transaction to be executed by the server after entering all required information pertaining to the transaction. At this time, the application bundles all information to the server for verification and either completion or failure, if information supplied fails the validity test. This can include, wrong transaction PIN code(s) business information does not match the business' Payintele ID, not enough balance in user account, etc.

For a personal QR code, only the user's Payintele ID is contained in the QR code. Since this information is not considered critical, much care is not required to protect exposure of this information. In addition, human beings are not able to readily decode the contents of the QR code at this time. Therefore, when someone scans the personal QR code, no personal information of the user is displayed. If the person uses the Payintele application to scan a personal QR code, it gives him the option to send money or add as friend.

Users may report other soliciting users who send friend request, unless known to each other. Although this does not cause loss or damage, the type of solicitation is considered annoying, and users who send unwanted friend requests may be temporarily or permanently suspended from sending friend requests.

Users may add other users, friends and family, as their Payintele friends, provided both users mutually agree, for the purposes of financial interaction.

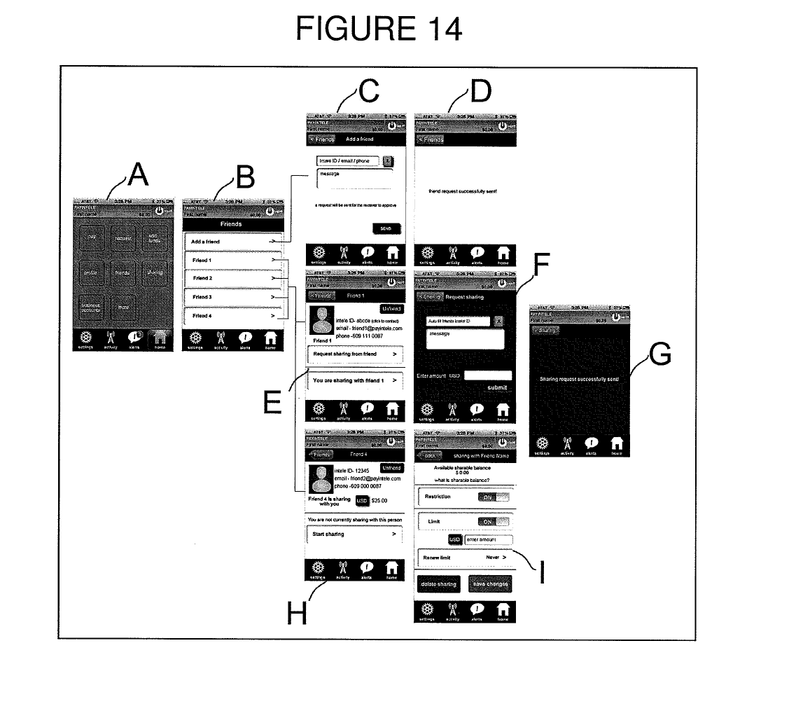

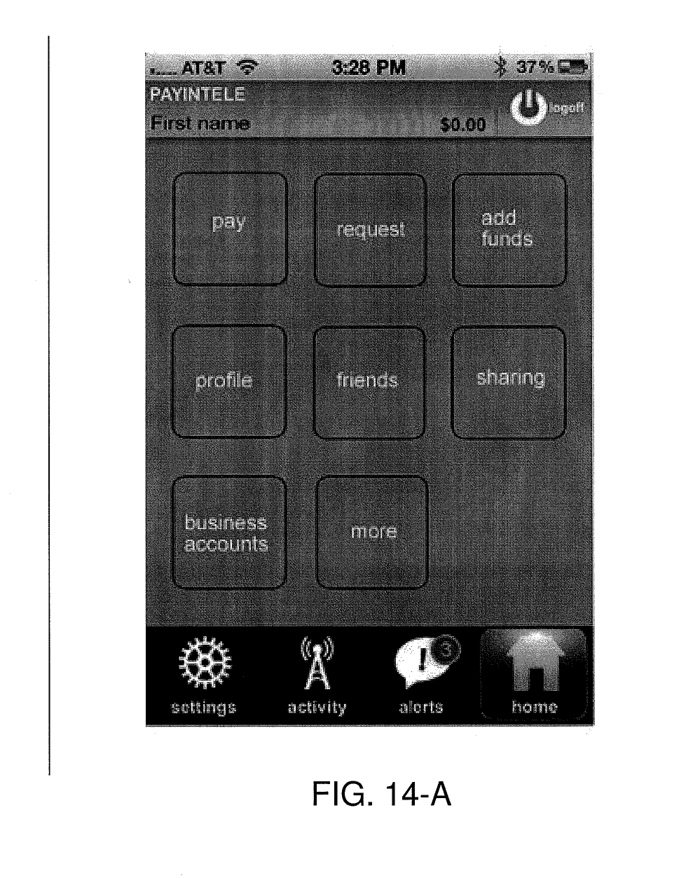

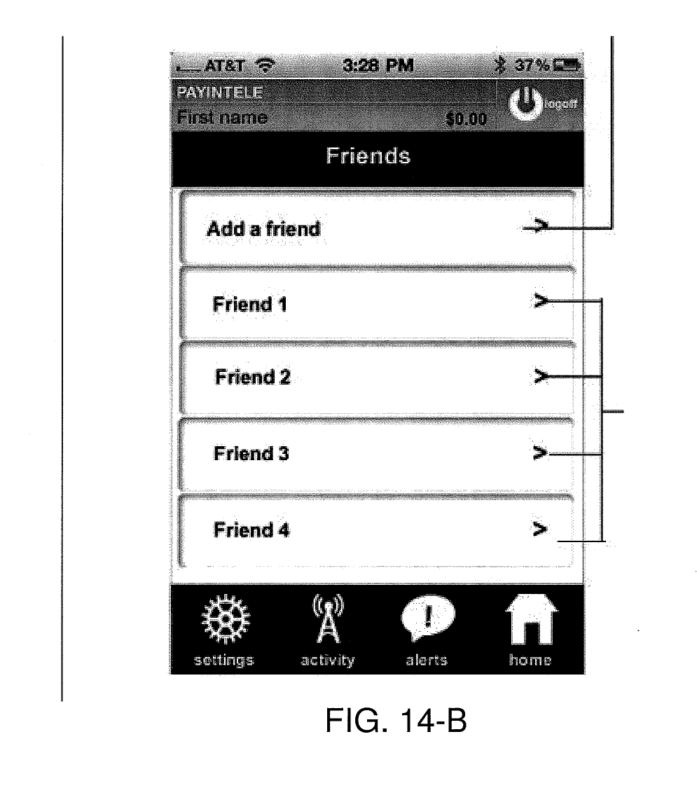

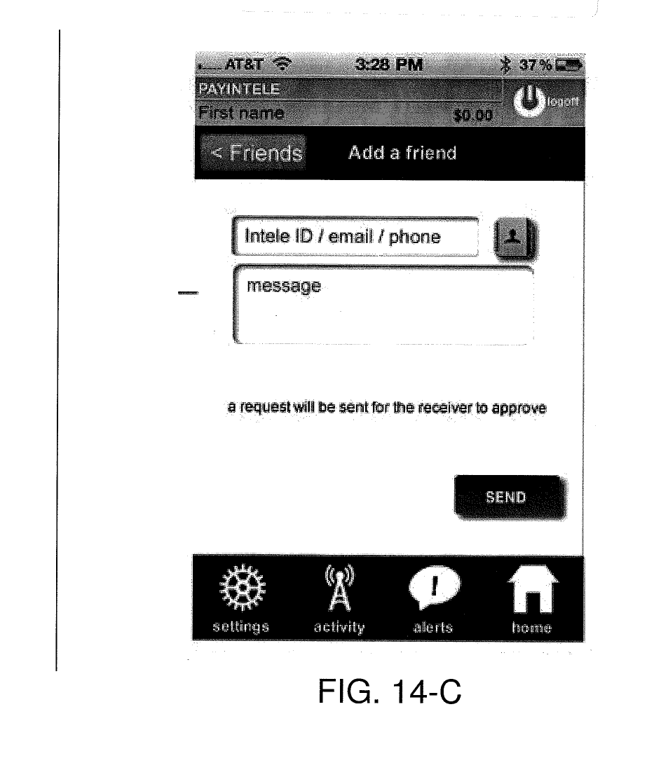

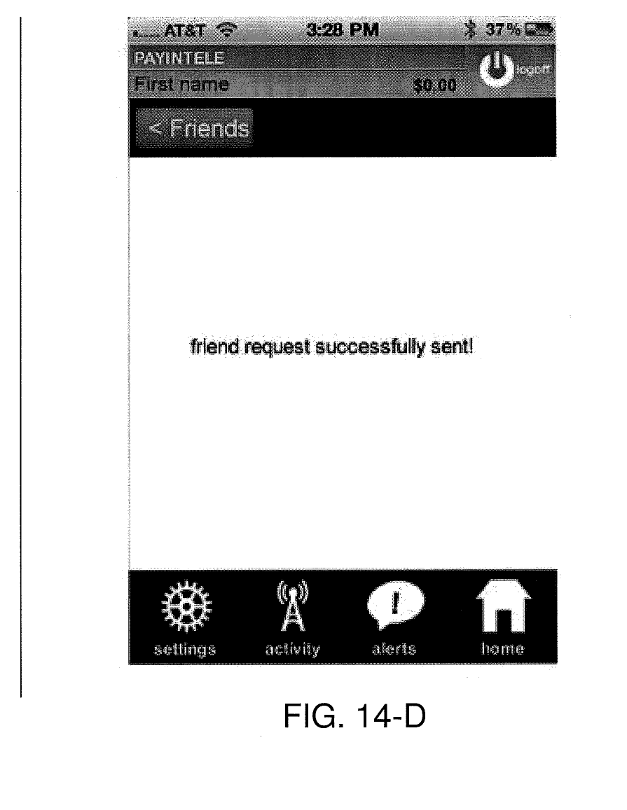

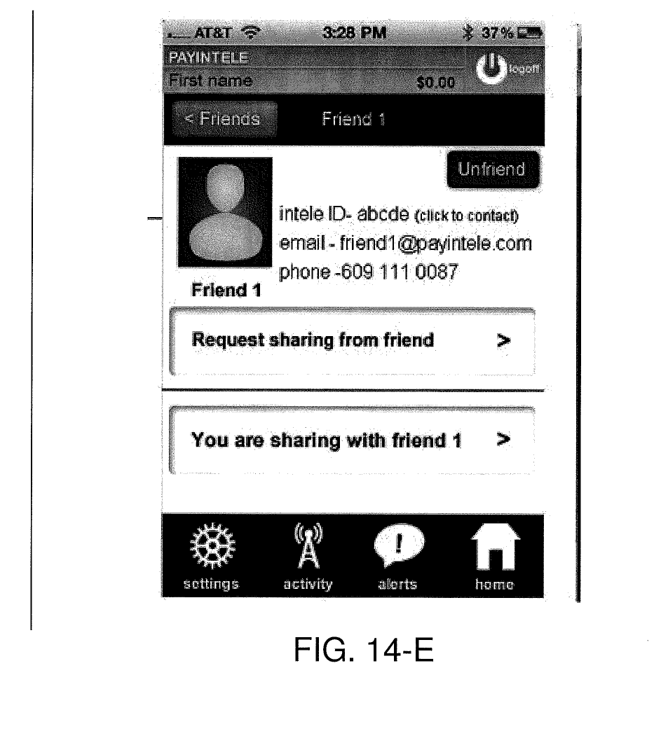

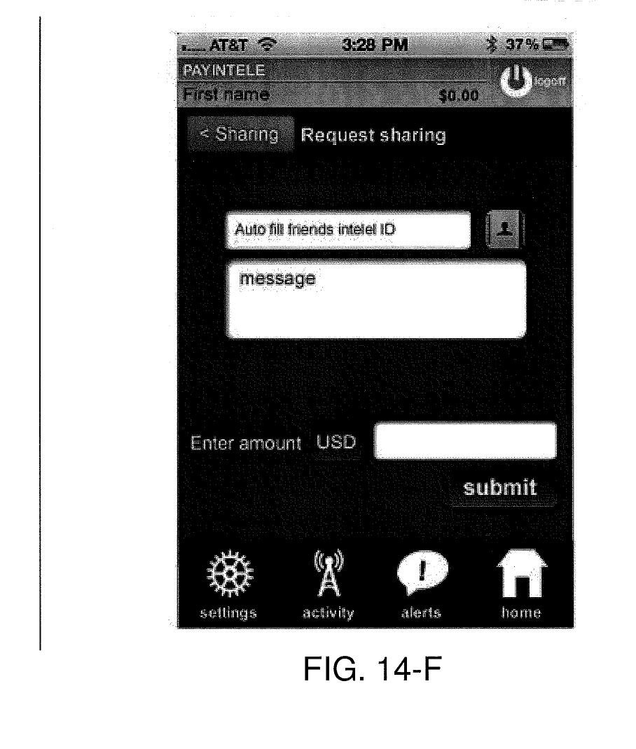

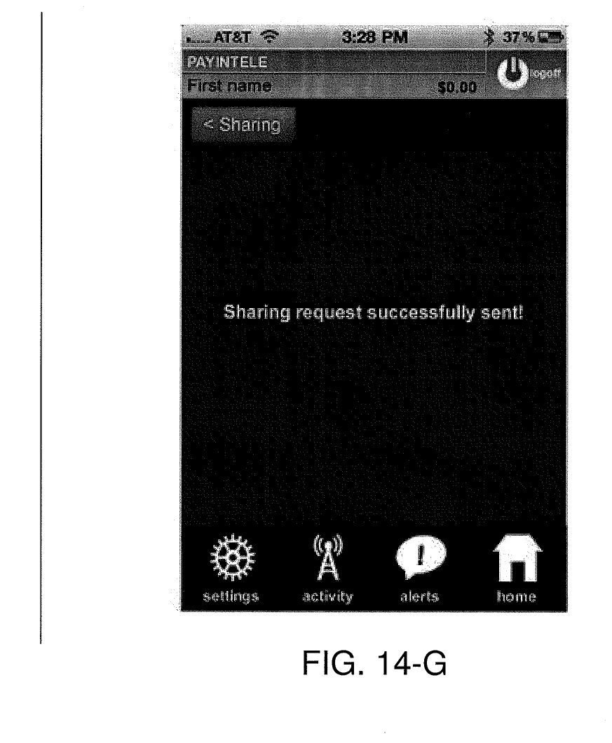

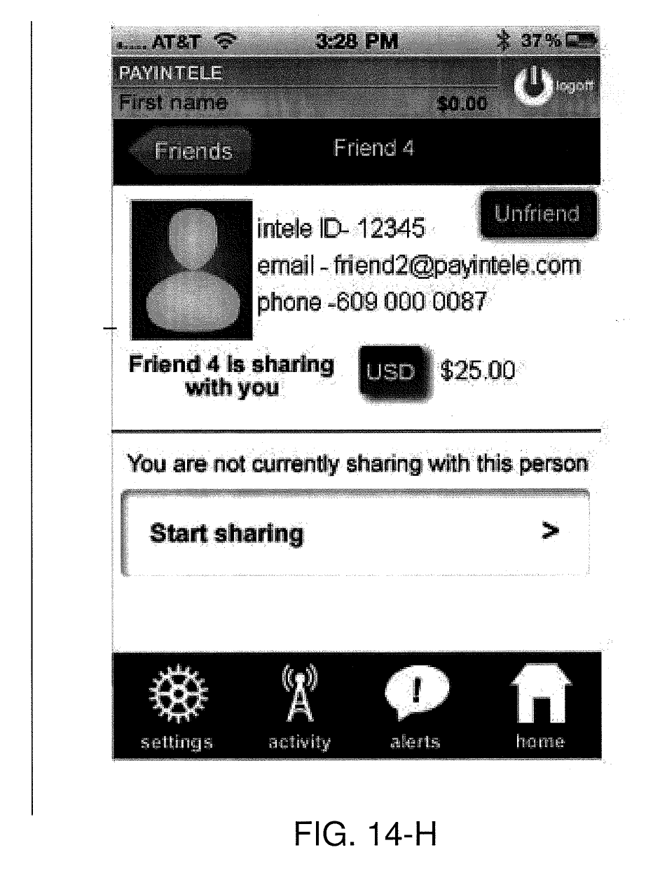

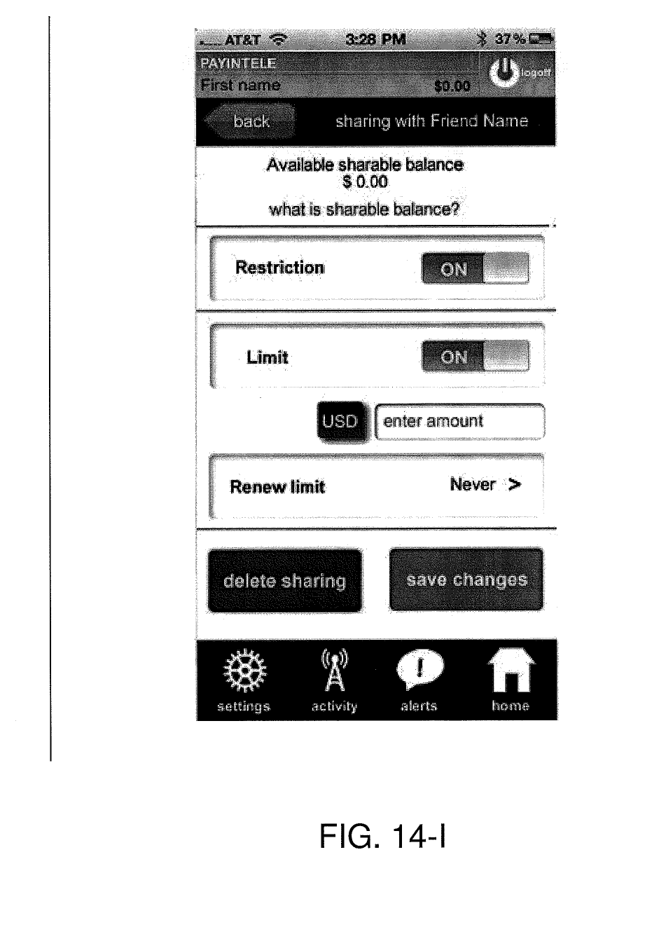

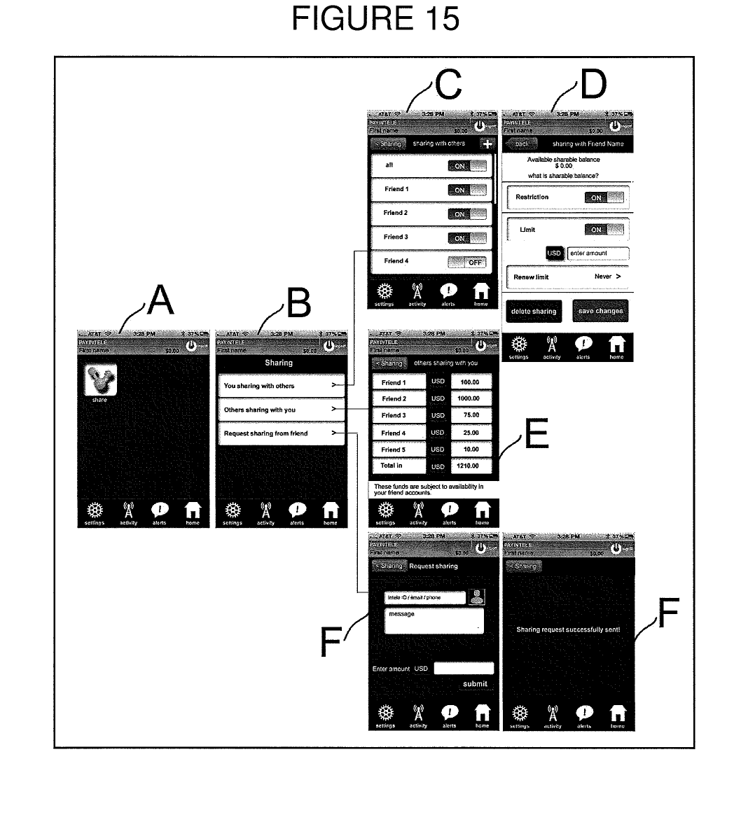

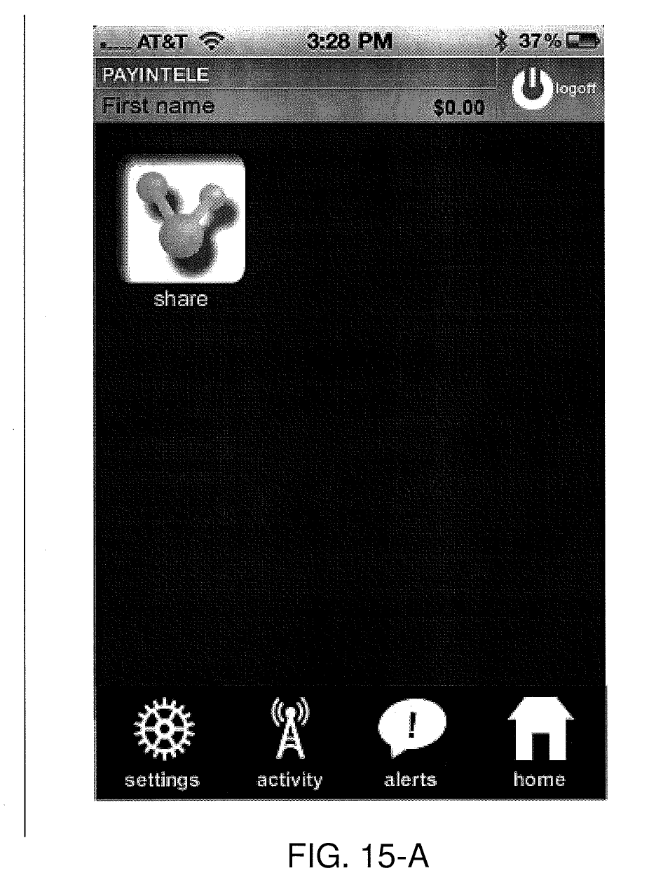

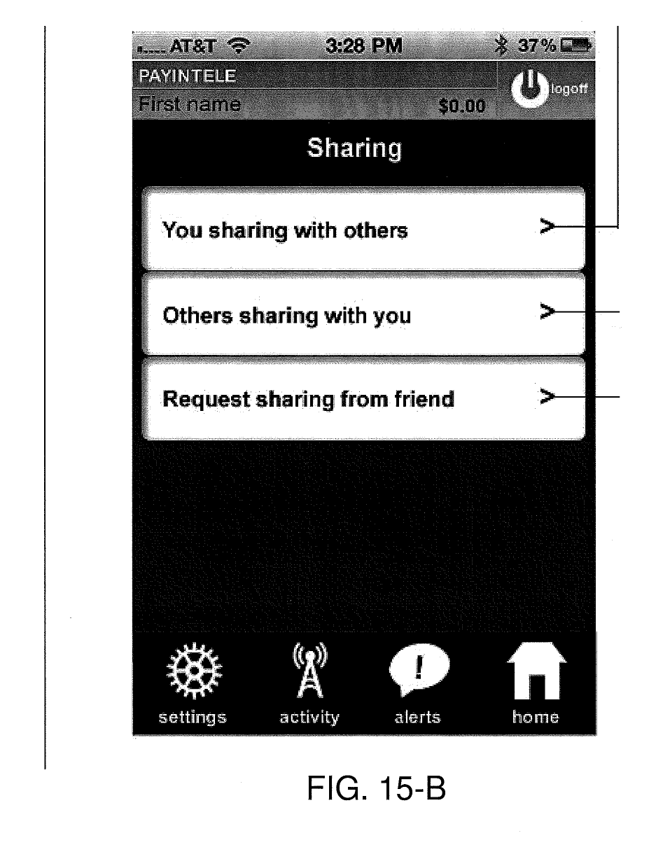

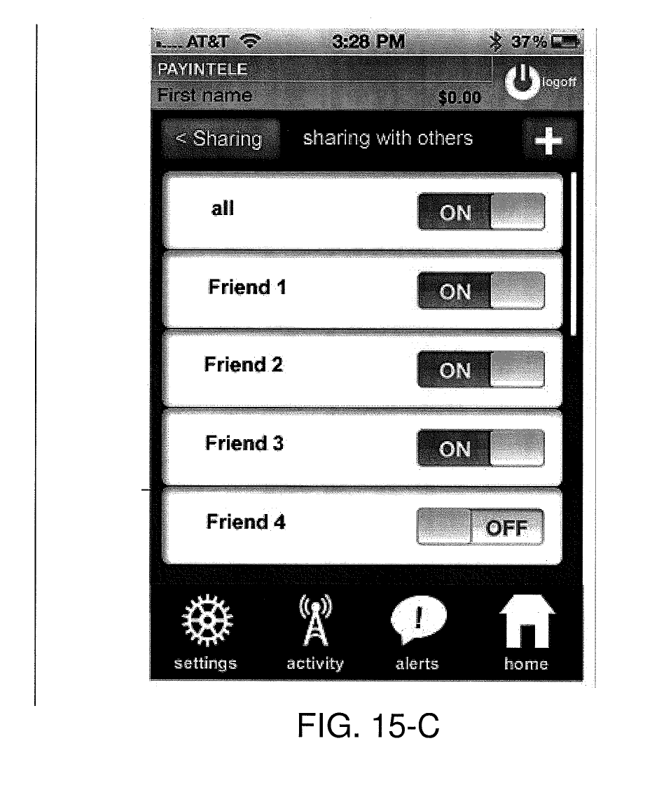

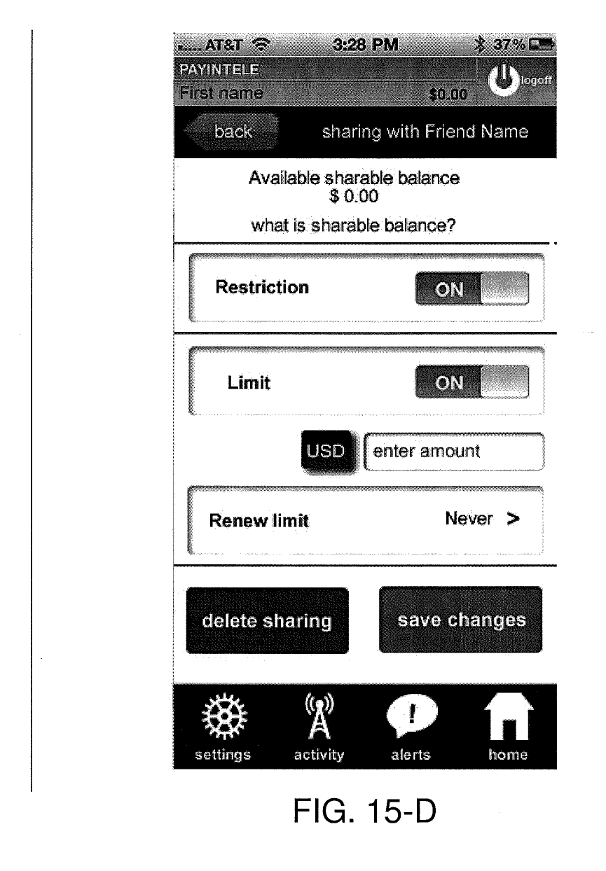

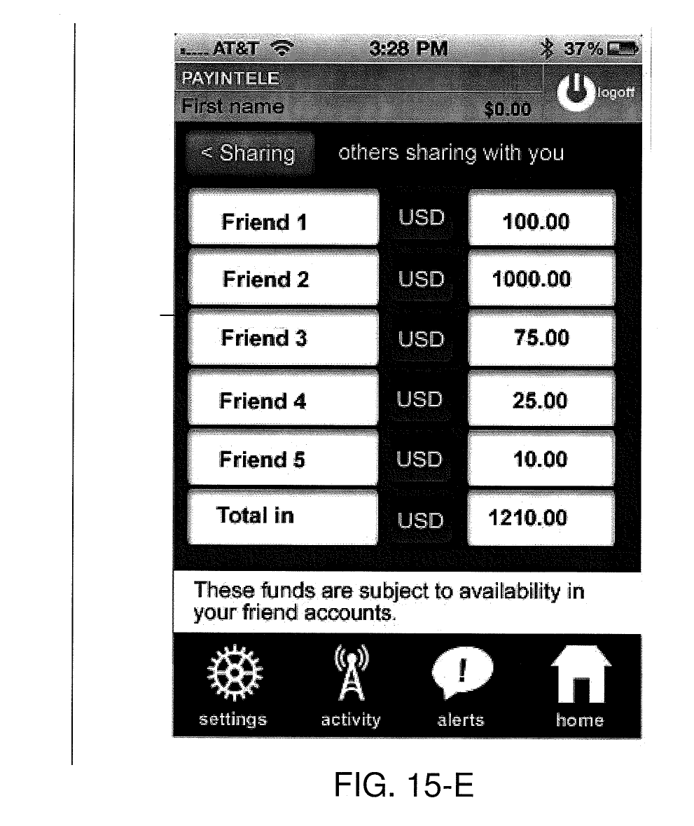

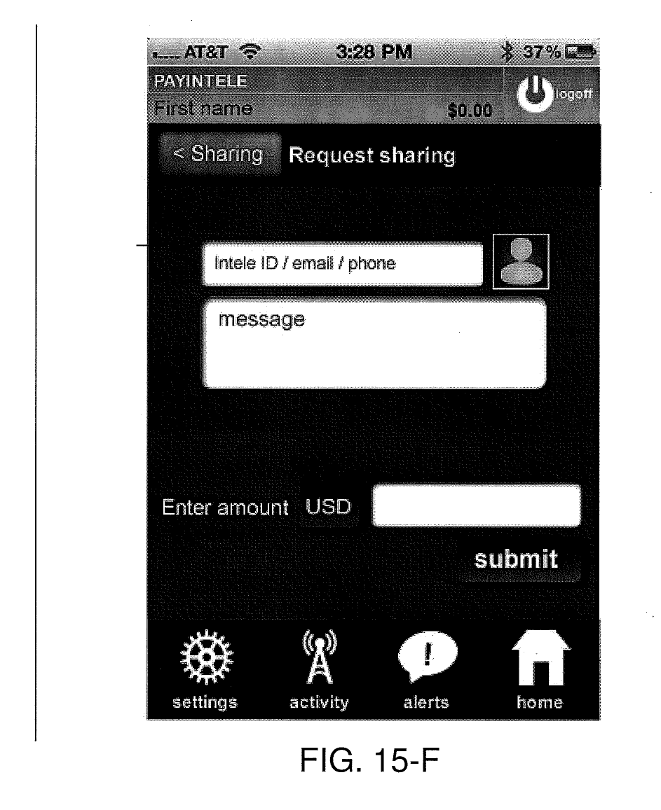

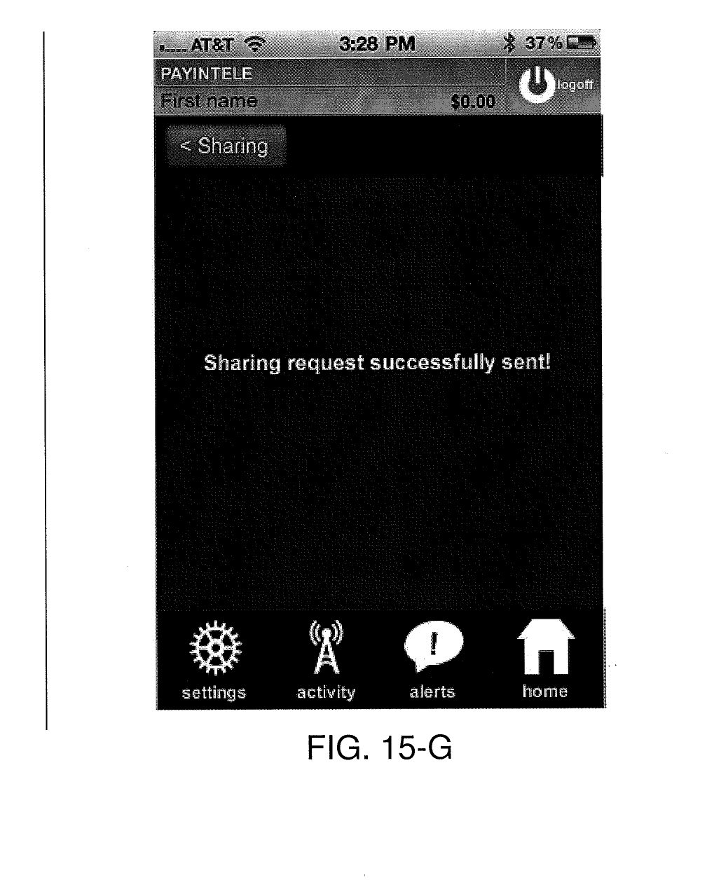

Adding a friend enables the users to send payments more easily and confidently. In addition, friends may also share money with each other. FIG. 14 illustrates a series of exemplary, self-explanatory user interface screens and screen flow for adding friends. FIG. 15 illustrates a series of exemplary, self-explanatory user interface screens and screen flow for sharing money. Shared money is available in the beneficiary's list of funds as if the money is actually there in the beneficiary's account, although it is not. When shared funds are used to complete a transaction, the money is directly debited from the benefactor's account. The benefactor can limit the amount of money the beneficiary has access to.

Users may also share accounts for the purpose of money management, without providing access to mobilize the funds, such as paying for purchases. This is called “restricted sharing”. Restricted account sharers may initiate a payment transaction; however, the payment has to be authorized by the account owner to complete the transaction as illustrated in FIG. 15.

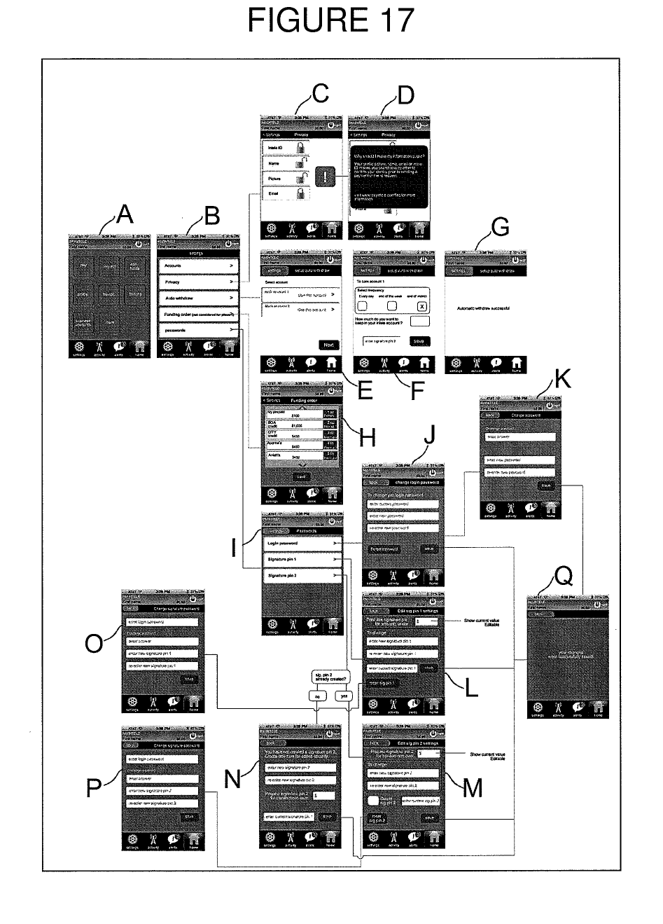

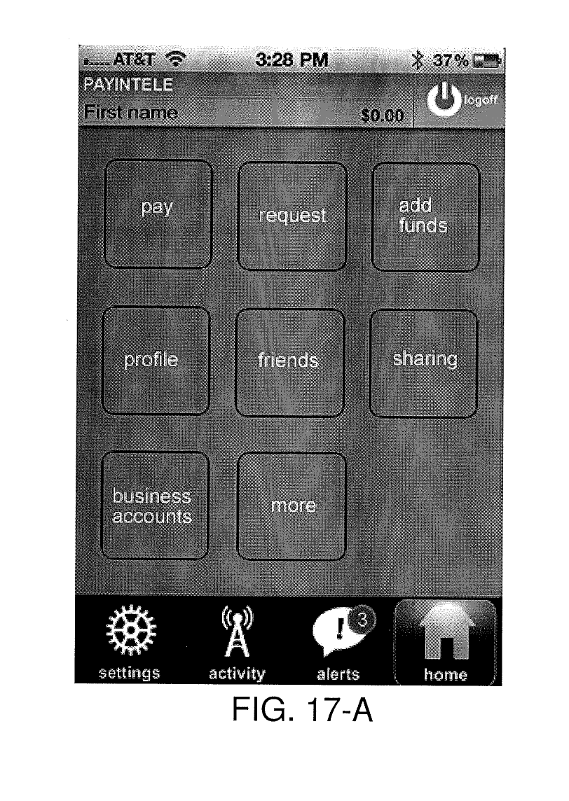

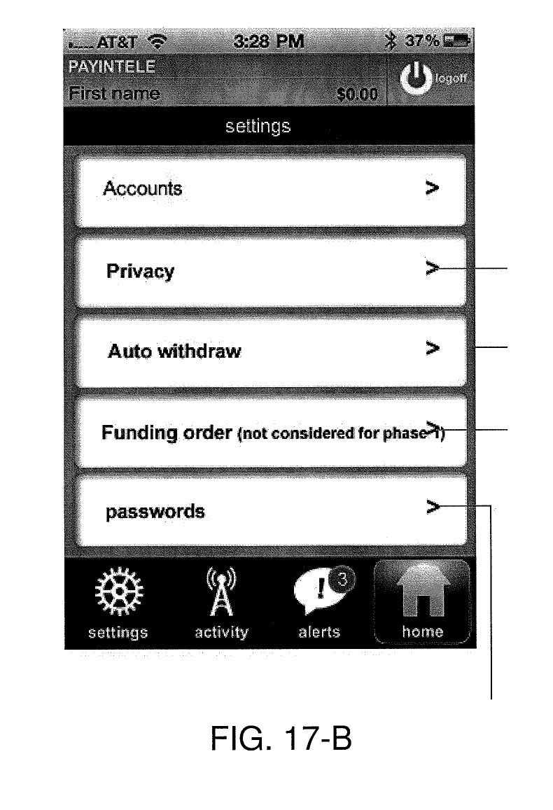

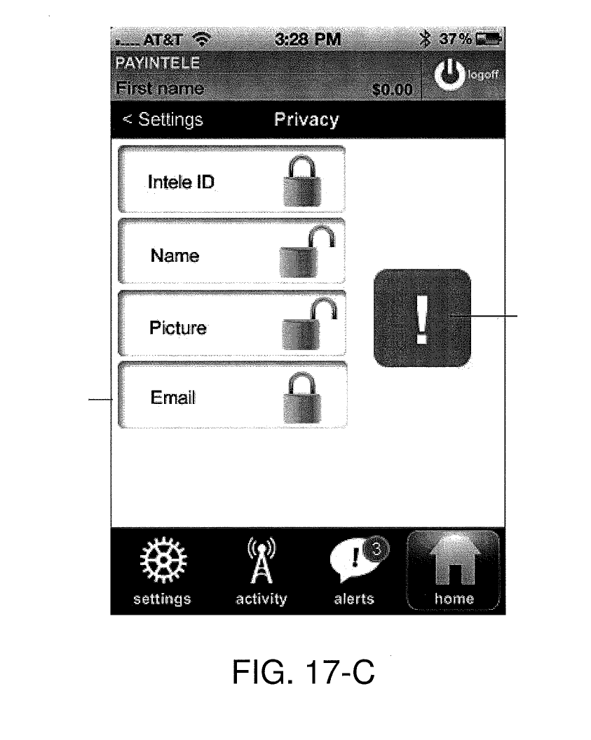

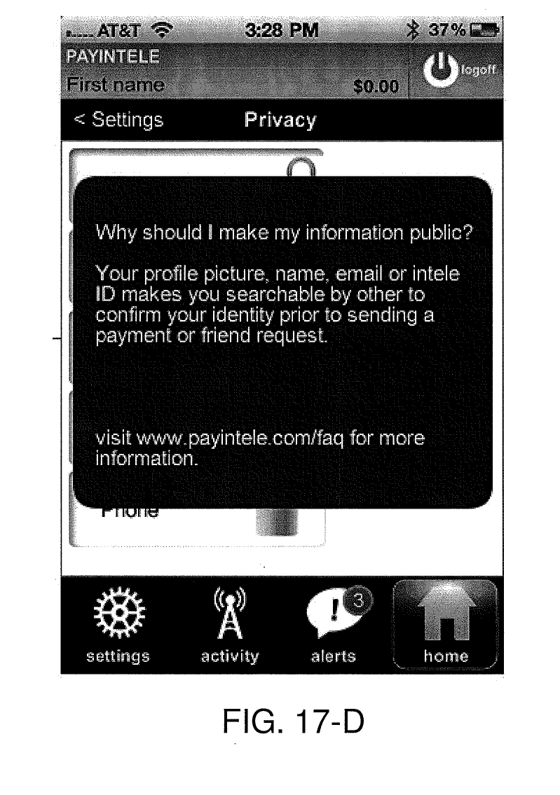

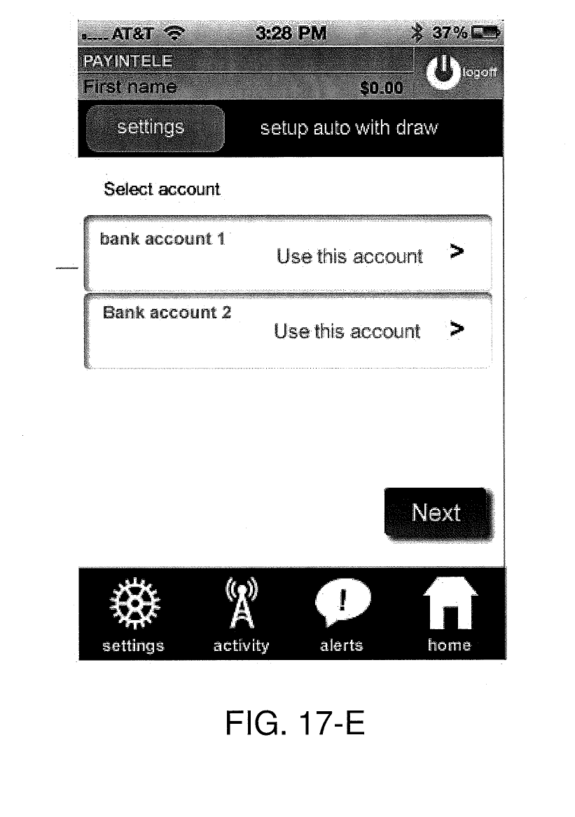

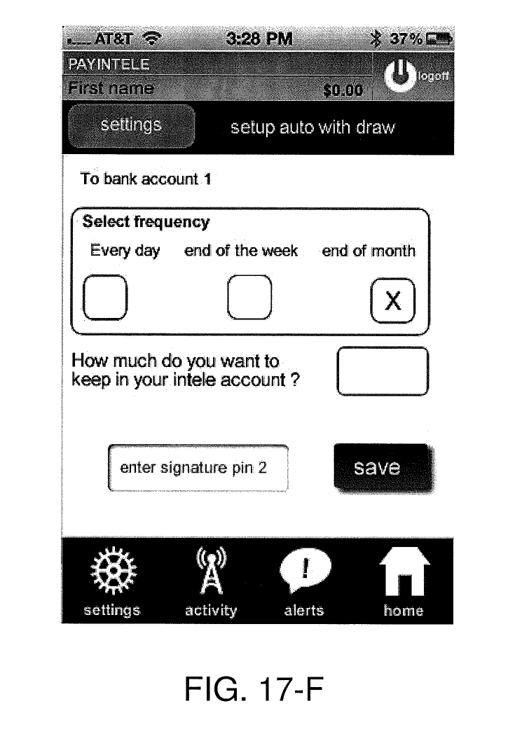

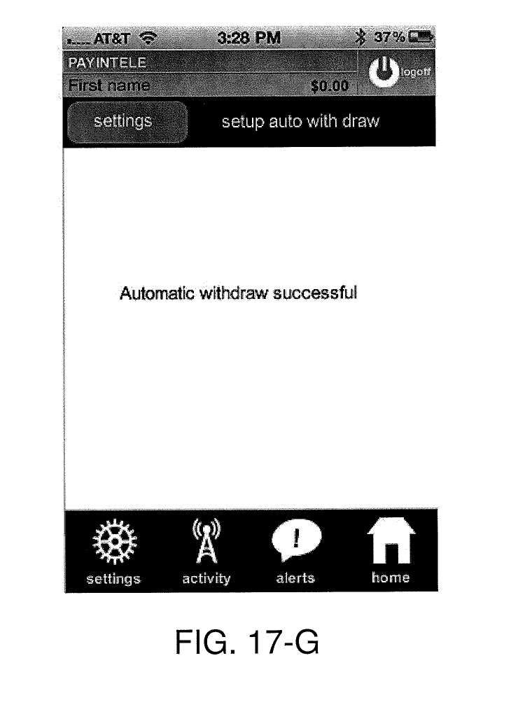

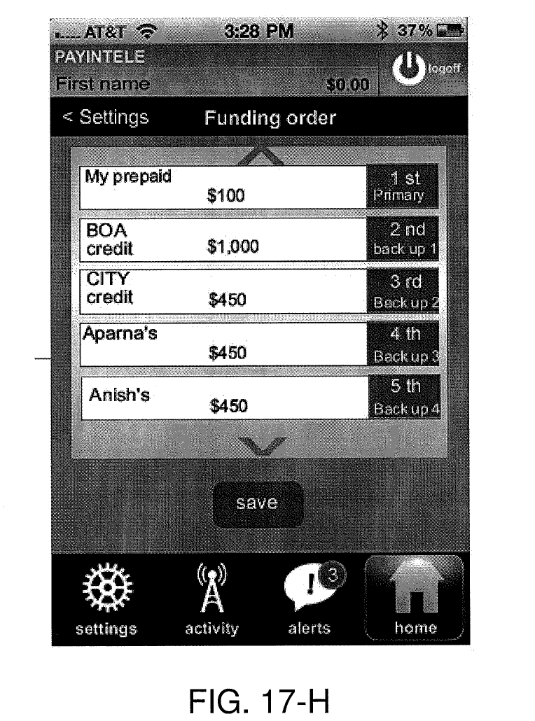

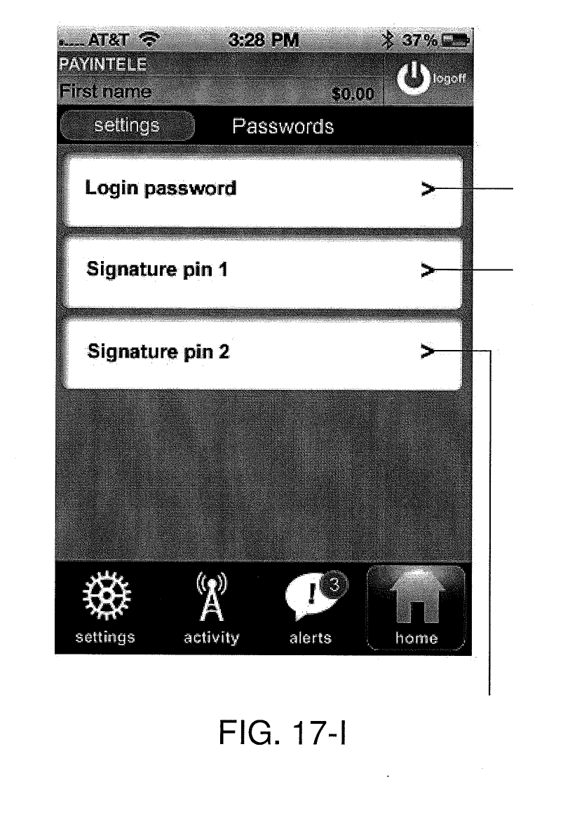

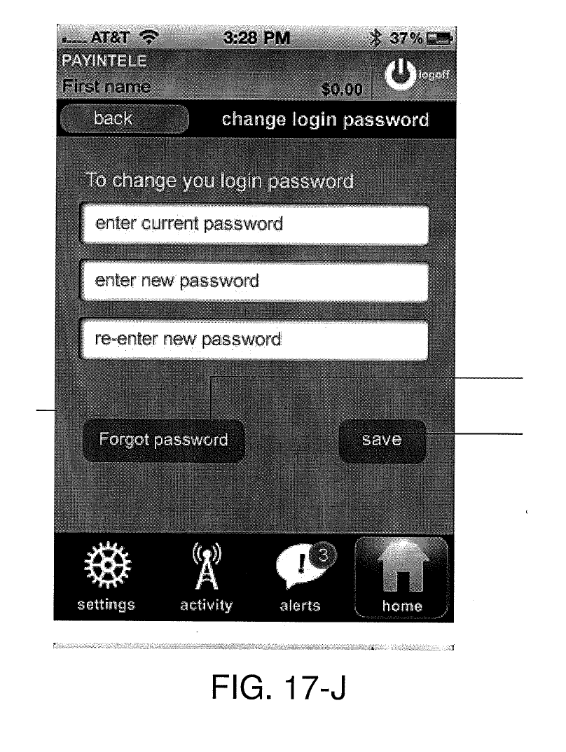

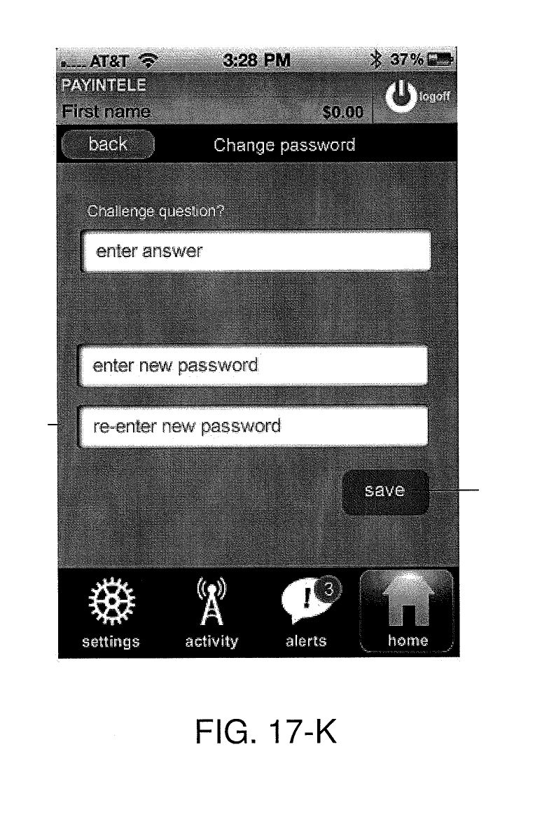

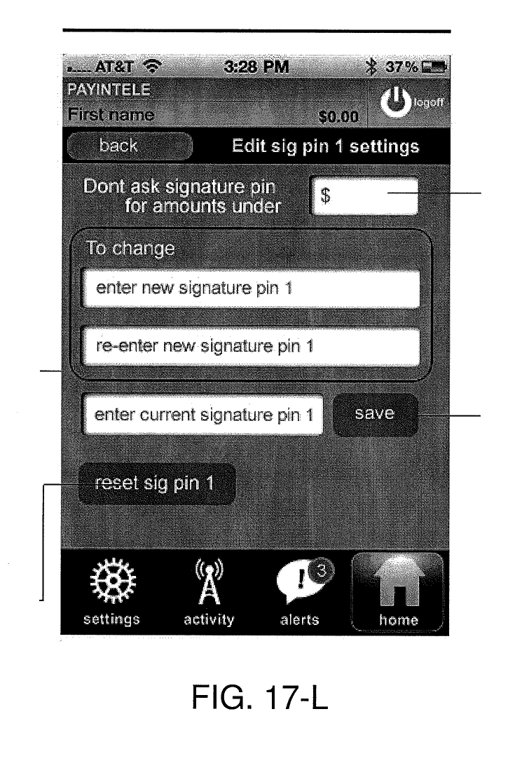

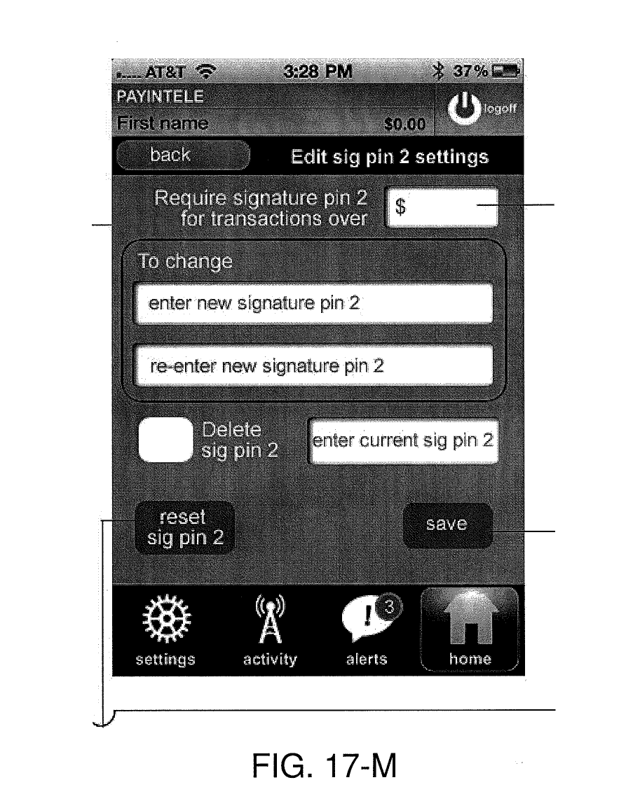

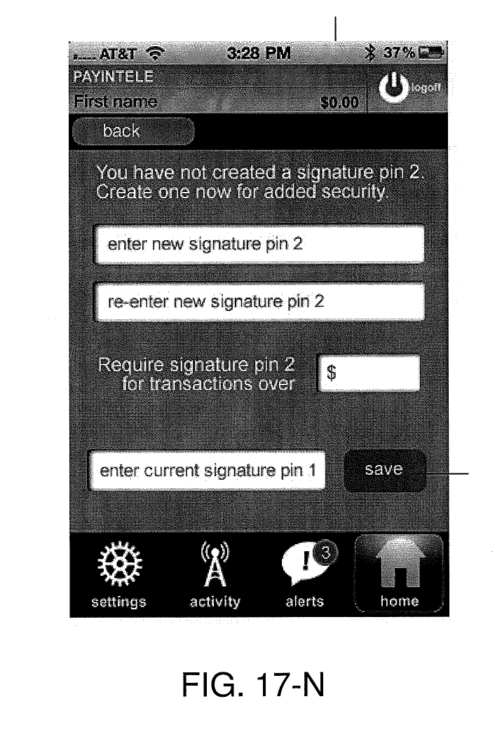

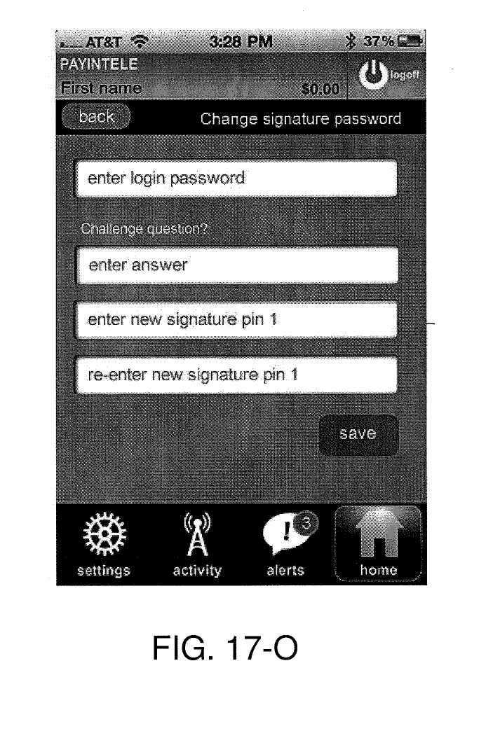

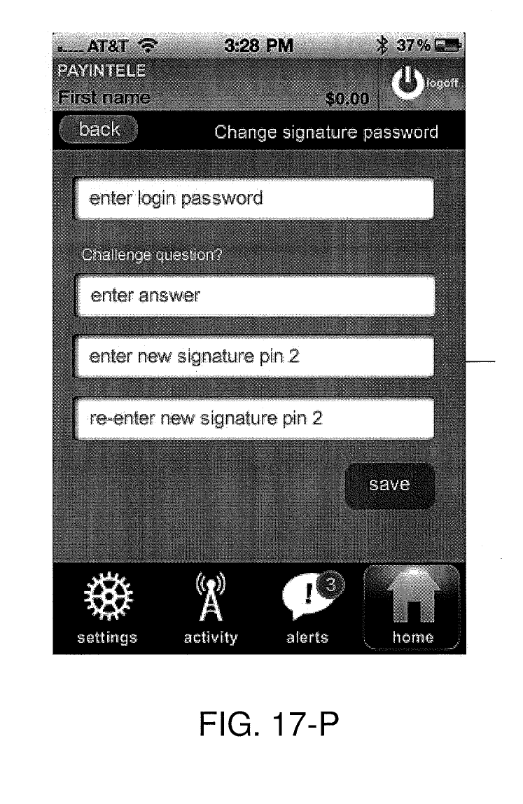

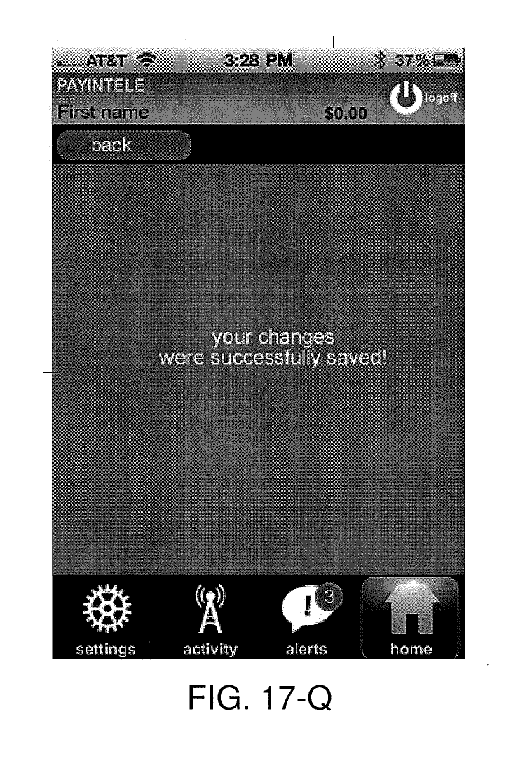

Businesses may receive money from customers and non business users may receive money from other users, such as friends and family. The money received via the Payintele system may be used to pay for services and purchases within the Payintele system or may be withdrawn to a user's bank account from the account settings (as illustrated by the screen sequences in FIG. 17).

Business kiosk interfaces will also have the option to scan the customer's QR code to initiate the transaction, which will still require the customer to enter his or her PIN, if applicable. This method shall be helpful, especially when the customer's cell phone does not have charge or is unavailable.

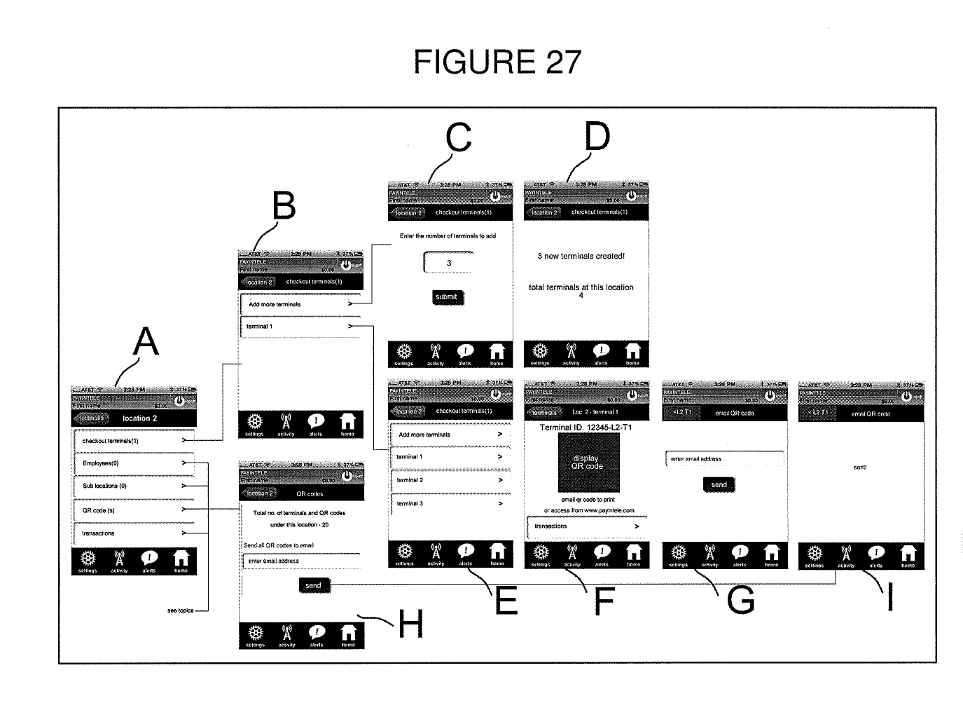

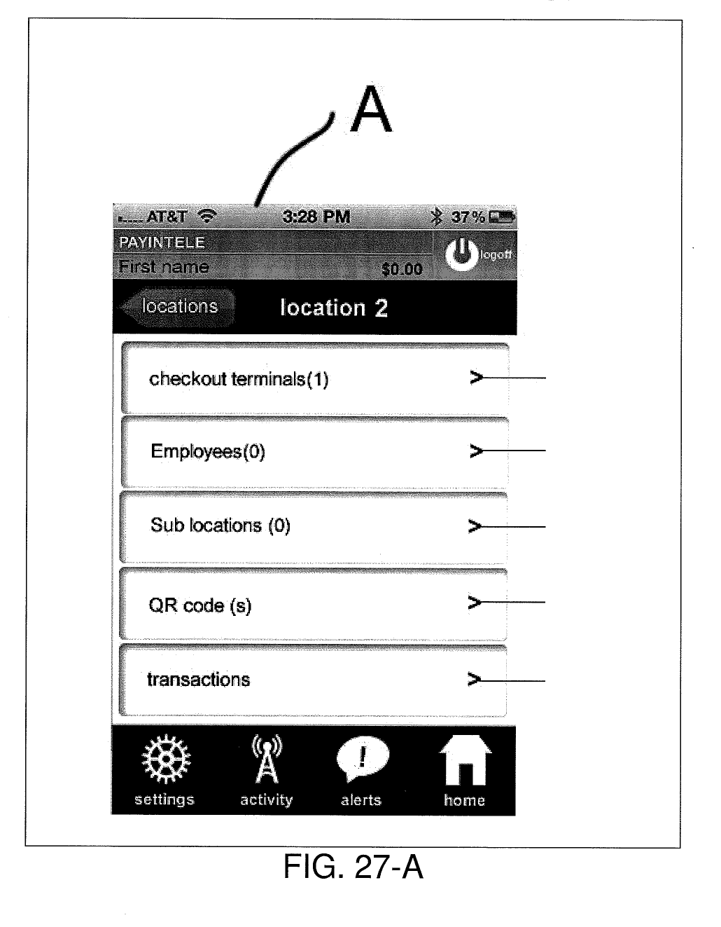

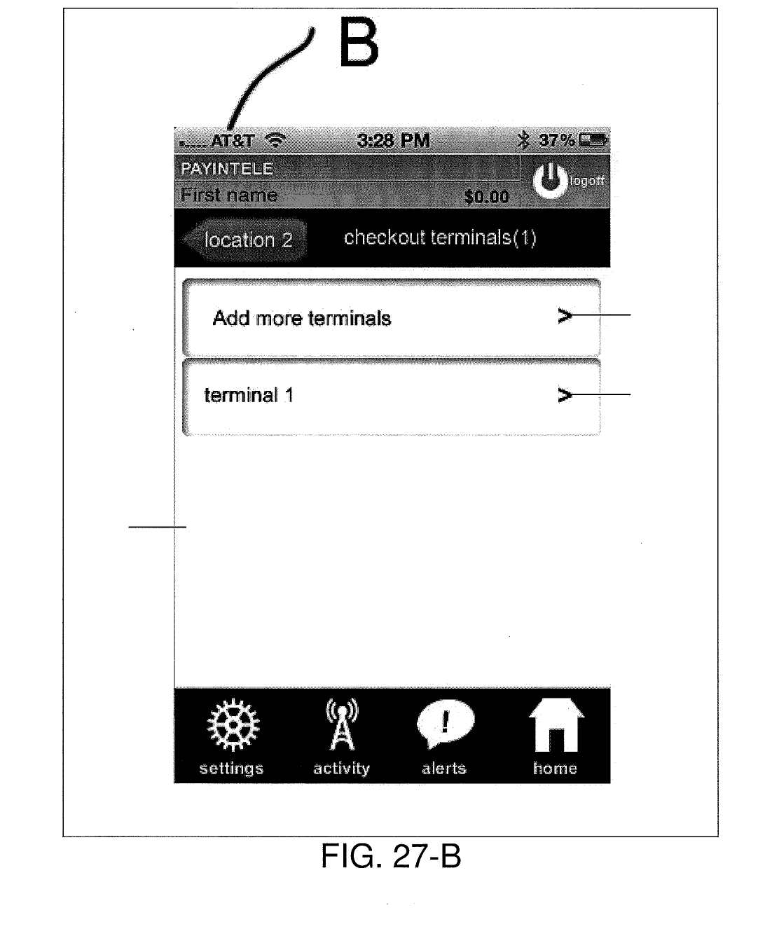

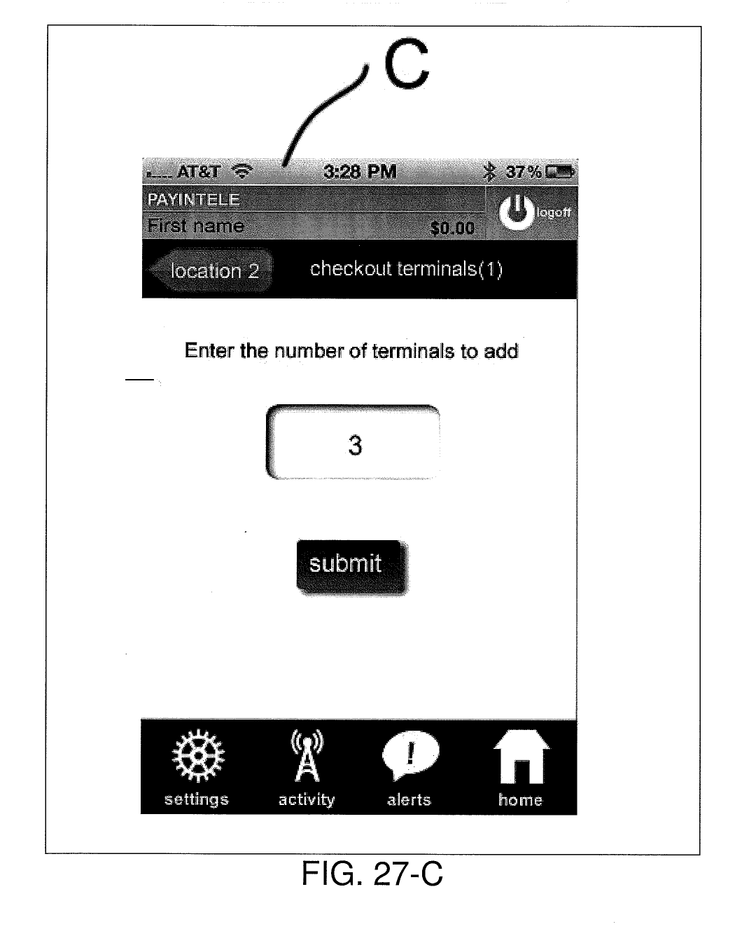

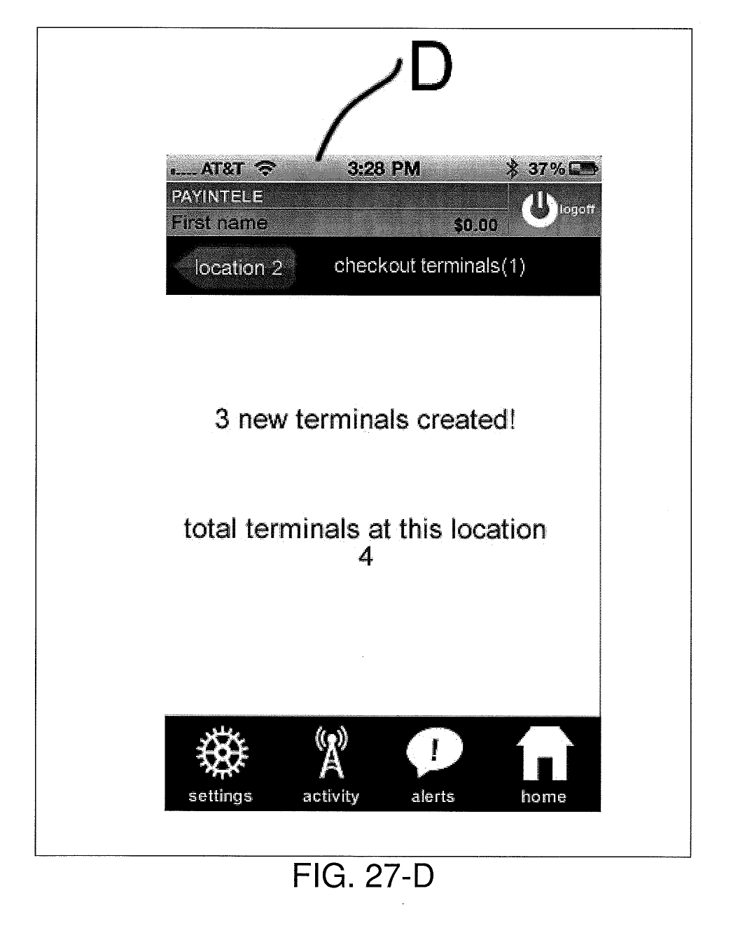

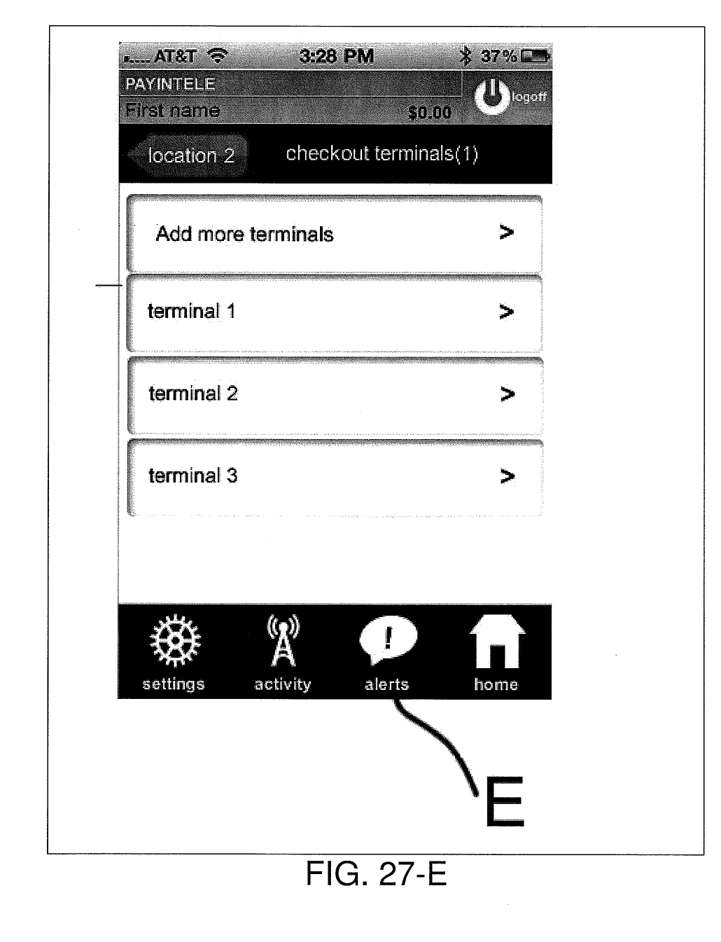

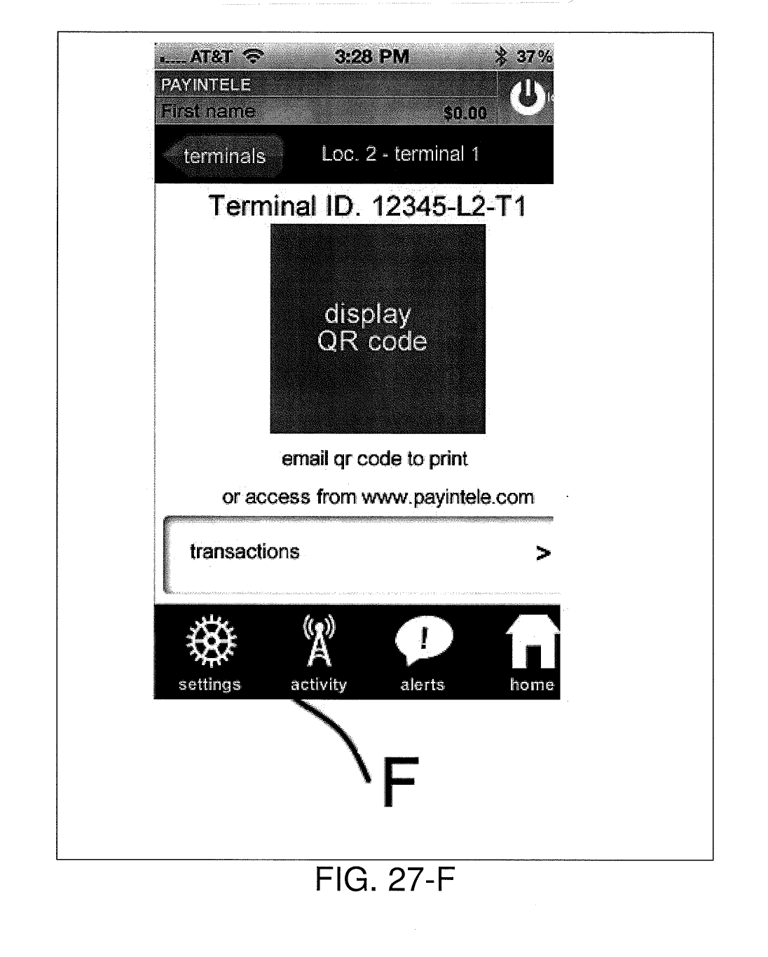

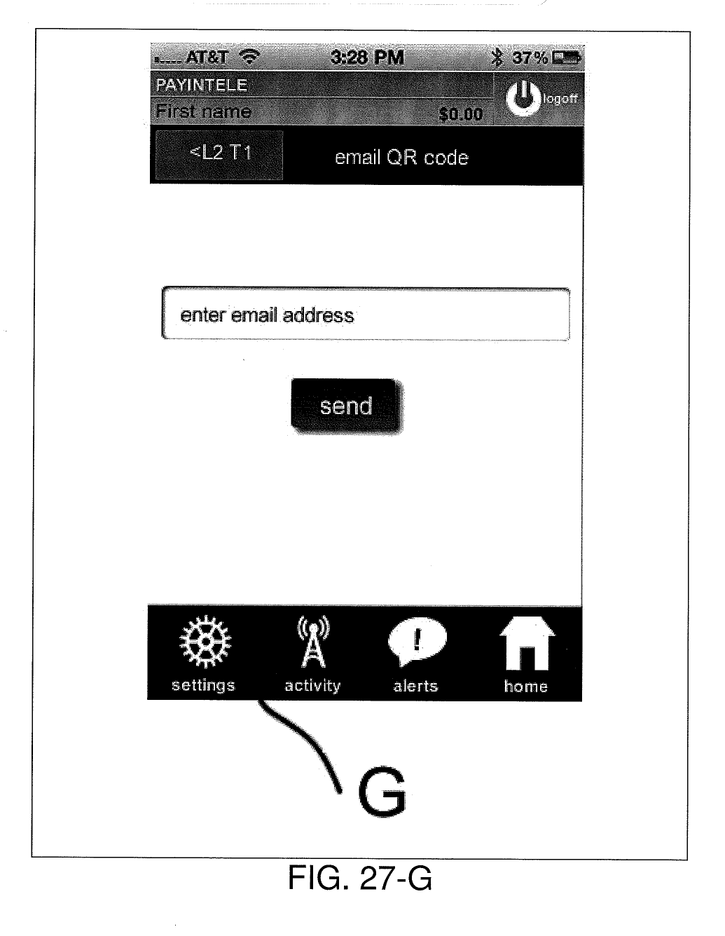

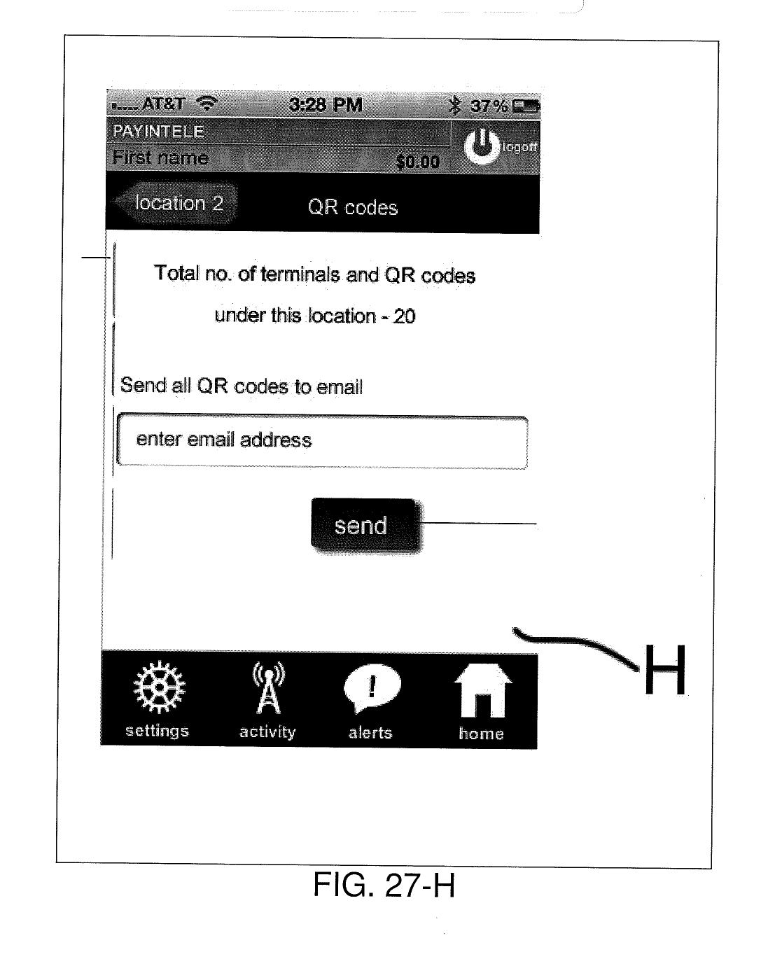

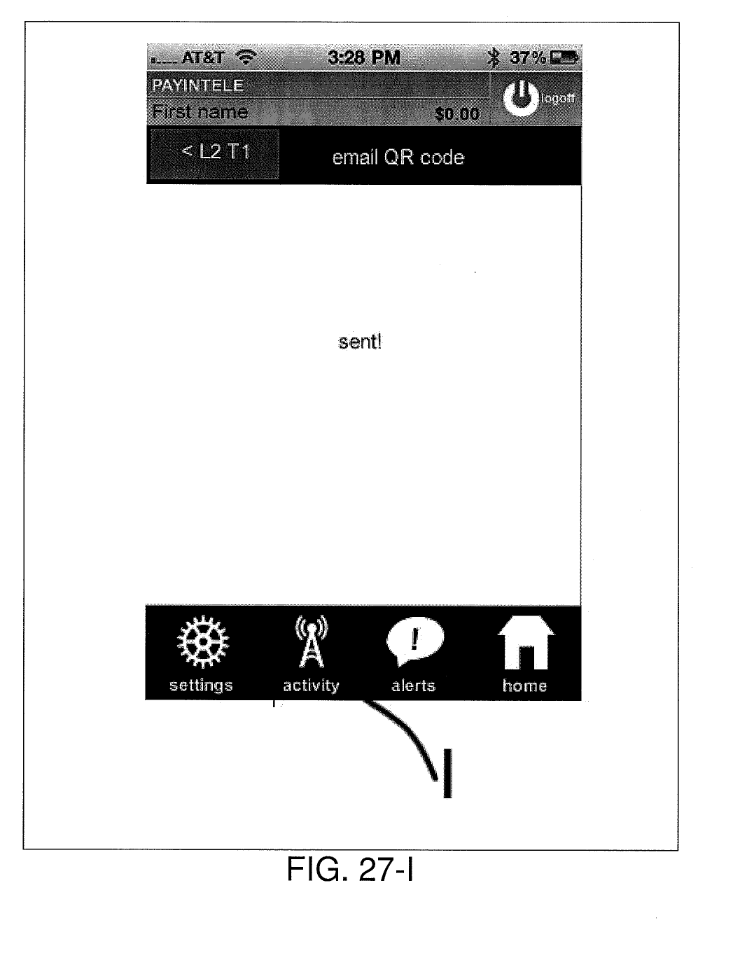

Businesses may have the capability to accept payments at multiple locations by creating sub-locations and terminal accounts. FIG. 27 illustrates a series of self-explanatory user-interface screens and screen flow for creating sub- and terminal accounts.

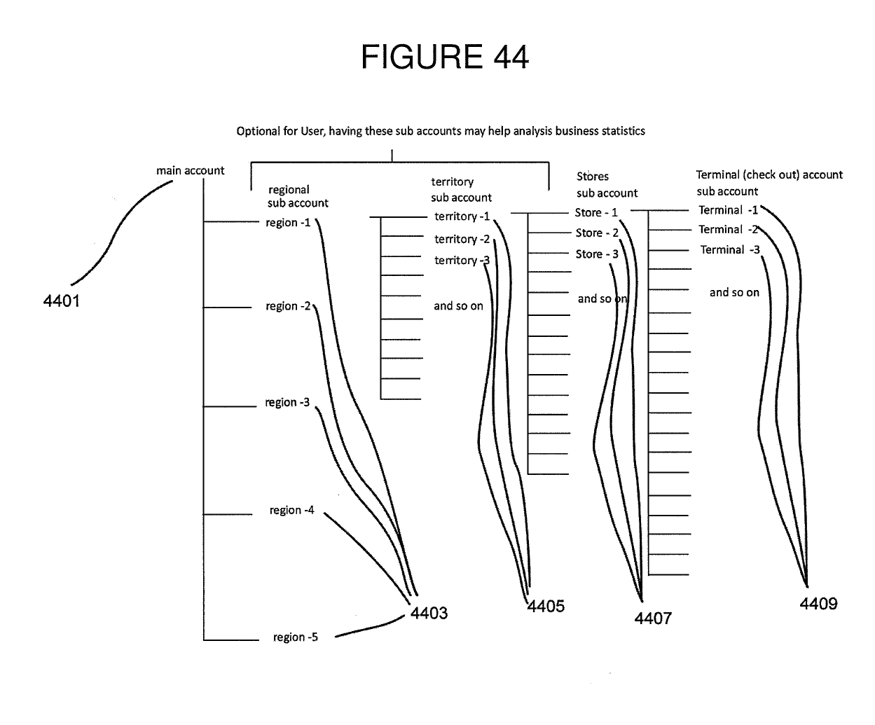

Businesses may have the capability to create as many sub-accounts as required to accommodate large numbers of branch locations, as illustrated by FIG. 44. This feature will enable cashiers to receive notifications at the point of sale terminal, however, the money will be credited in the main account.

Sub-accounts are used to facilitate payments and payment notifications in a manner that allows the payment notifications to be sent to the terminal account modules.

FIG. 44 helps illustrate the Payintele sub-account hierarchy. All accounts, including the main-account 4401, sub-accounts 4403, 4405, 4407 and terminal accounts 4409 shall be assigned IDs. For example, ABC12345 may be the ID of the main business account module 4401, ABC12345US, and ABC12345CAN may be the Payintele accounts for USA sub-account and Canadian sub-account 4405. respectively. Under the USA sub accounts, each state's or regional sub accounts 4407 may be identified as ABC12345USNJ and so on. The terminal account 4409 ID may be ABC12345NJ08691T1.

When a customer wants to make a payment for a purchase or a business, the customer scans the ID of the point of sale checkout kiosk and completes a payment transaction. The Payintele system deposits the payment in the ABC store's main account, but sends the payment notification with the customer's photo ID only to the terminal account, and so the cashier at the terminal is informed that payment is received from the customer and can complete the checkout process.

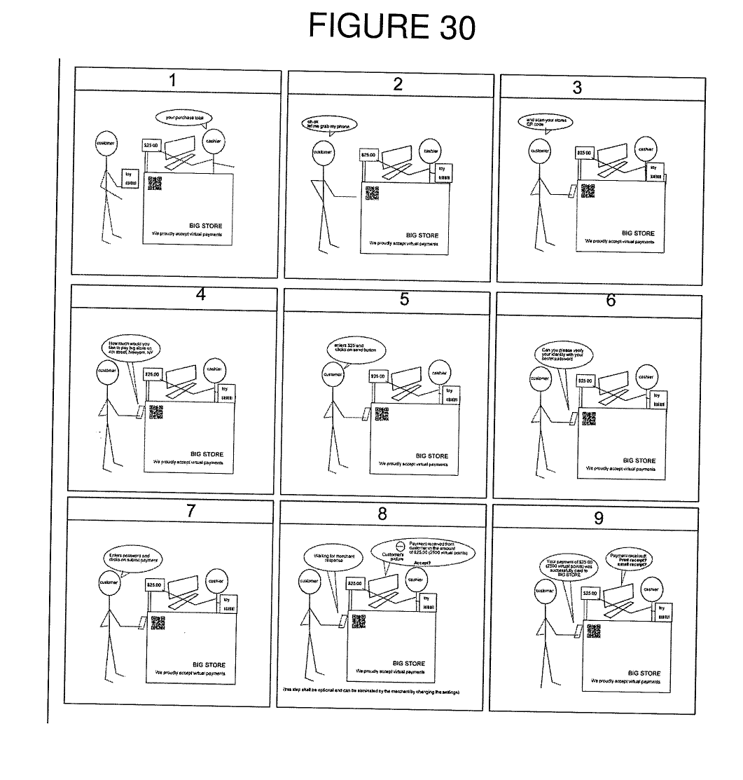

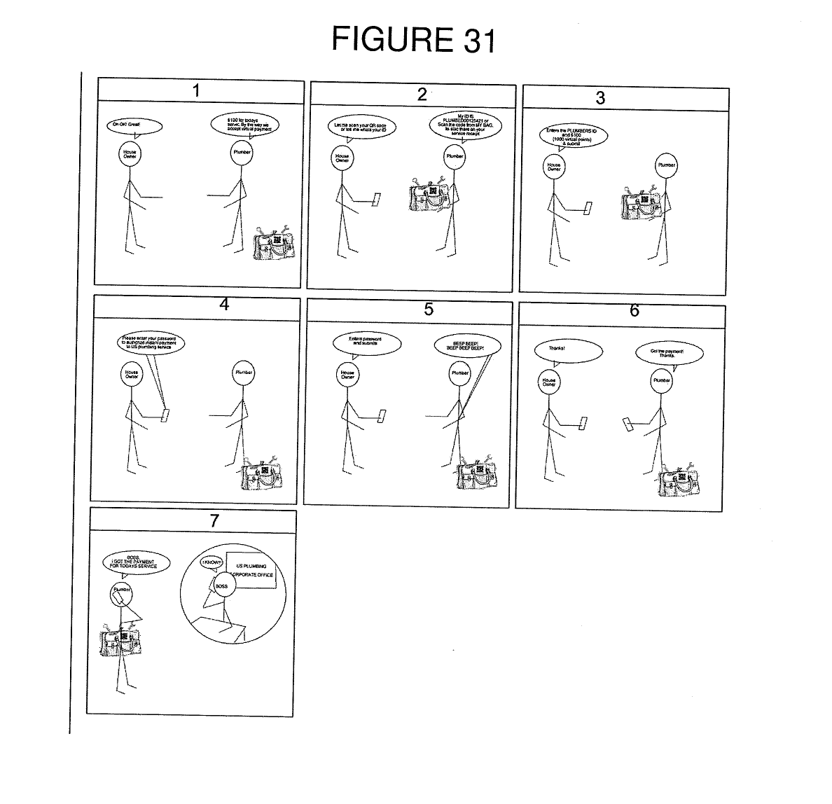

FIG. 30 and FIG. 31 are illustrative panels that represent typical scenarios of payments at point of sale and services, respectively. Notice that there is no exchange of customer information directly between the customer and merchant. All notifications to payer and receiver are received from the server directly.

A payment gateway infrastructure may support the transfer of funds from credit and debit accounts from which users may fund their Payintele account as well as withdraw from their Payintele account to their bank accounts. In addition, the payment gateway may store users' card and banking information.

A merchant account service provider 107 (see FIG. 1) processes credit cards from users who wish to instantly preload their Payintele account.

ACH service provider 105 (see FIG. 1) may support transfer of funds to and from user's bank accounts 101. Merchants who accept Payintele may be able to transfer their receipts to their business bank accounts 103 under this method.

This platform can function as an open source for banking institutions and credit card companies to provide their customers access to the customer's credit and deposit accounts so the money can be spent through this platform's mobile and non-mobile interfaces, instead of using credit cards, debit card or checks.

A concept of this system is to eliminate any physical component other than a mobile phone for a point of sale transaction. However, there is a real need for credit. With the existing features of the Payintele system, consumers may also integrate their credit cards to their Payintele account in the following method.

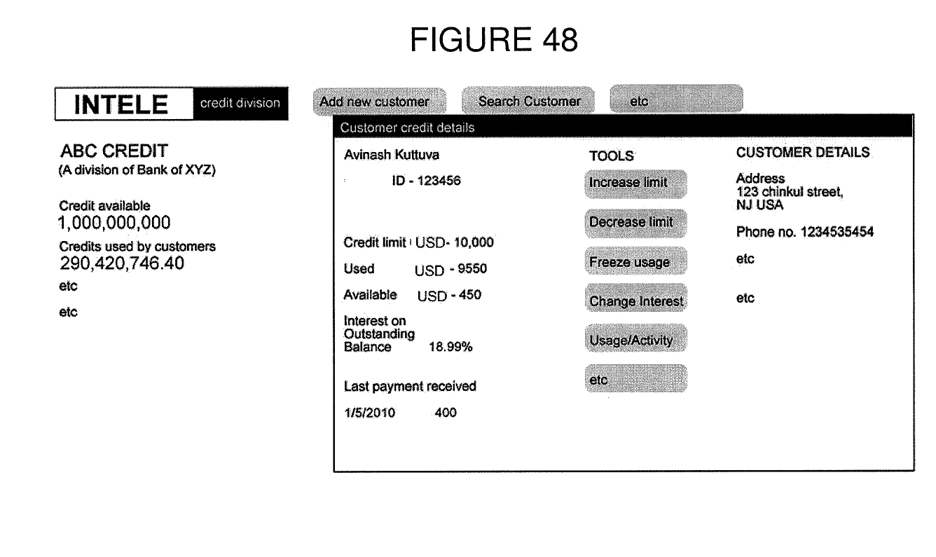

A bank or a credit card company that wants to provide credit to its customers may open a Payintele business partner account and name it “Credit Advantage” or any other name and request a desired amount of credit from Payintele. Payintele shall provide credit in the company's account. FIG. 48 shows an exemplary, self-explanatory interface screen for such a banking partner. This figure shows the issuing bank's interface, including a view of a customer profile and management controls.

The credit issuing bank or entity would follow its routine protocols and procedures to determine if a particular user is credit worthy or not. Once a decision is made, the person applying for credit shall be simply added to the “Credit Advantage” account to share the credit and a credit limit can be set (limited sharing).

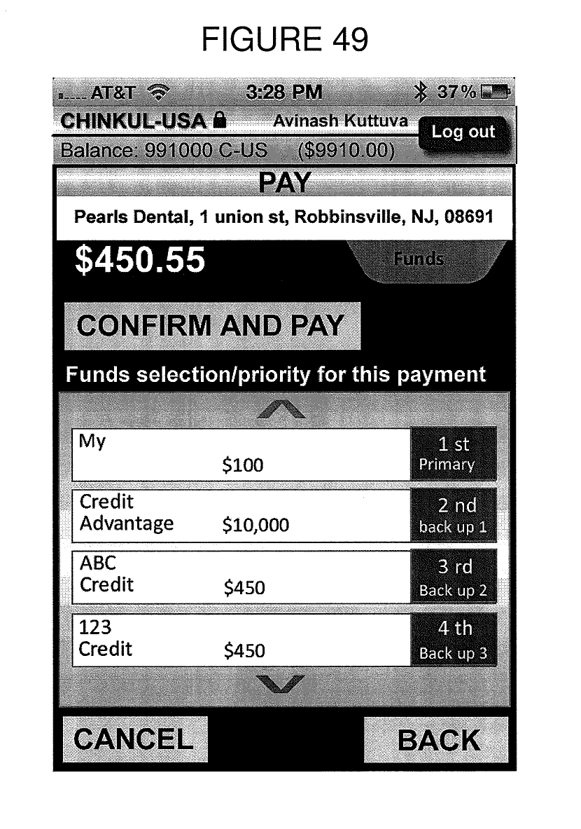

FIG. 49 shows an exemplary user interface screen in which at least one of the user's funds sources is such a credit account as discussed above in connection with FIG. 48. When the user is making a payment, the credit issued by ABC credit (issuing bank) appears on the user's funds selection, which may be chosen to fund the payment or used as a backup funding option. On the Payintele user's account balances, “Credit Advantage” will appear and the balance will be displayed. When a user funds a transaction using “Credit Advantage”, Payintele shall pay the merchant the proceeds of the transaction (minus fees similar to merchant fees). The credit issuing bank shall pay Payintele the amount paid to the merchant plus applicable fees and collect the entire amount of transaction from the customer. The credit issuing bank may charge interest on the customer's outstanding balance, if not paid in full.

Example: Customer uses ABC credit to pay “Noodle King Restaurant, Princeton, N.J.”. The amount of the transaction is $100.00. The Payintele system will deposit $100 in Noodle King's Payintele account, and charge Noodle King $2.00 as transaction fees. The ABC credit shall pay Intele $99.00 or setup automatic withdrawal from ABC credit's bank account. ABC credit shall charge the customer $100 (+ interest, if applicable). The customer shall pay ABC credit with his bank account.

Additional figures are provided herein that illustrate the various exemplary user interface screens for users of the Payintele system, including (1) users who primarily purchase goods and services using the system, (2) merchants who primarily provide goods and services and receiving payment using the Payintele system, and (3) financial institutions that provide services to the users on the Payintele system, such as credit and banking services. These figures, as well as some of the figures that have already been discussed above are self-explanatory, but nevertheless are briefly discussed below.

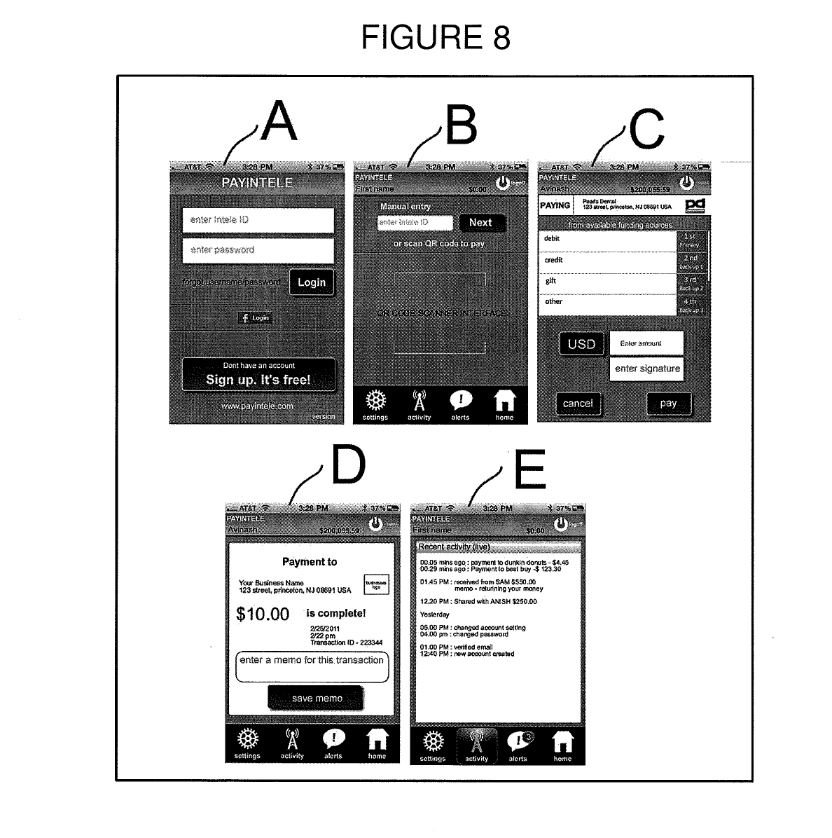

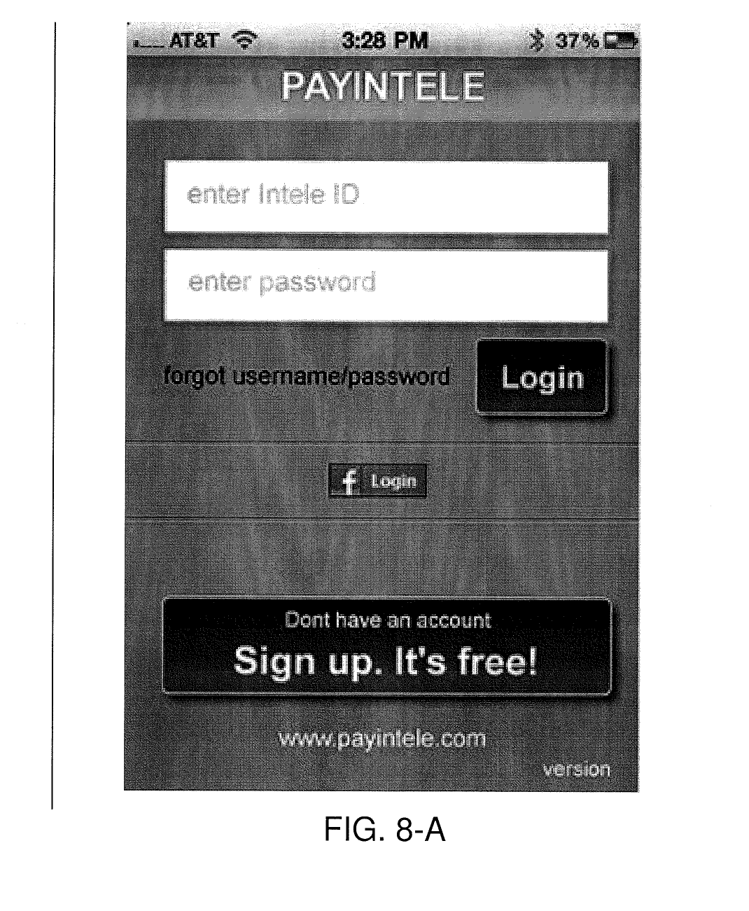

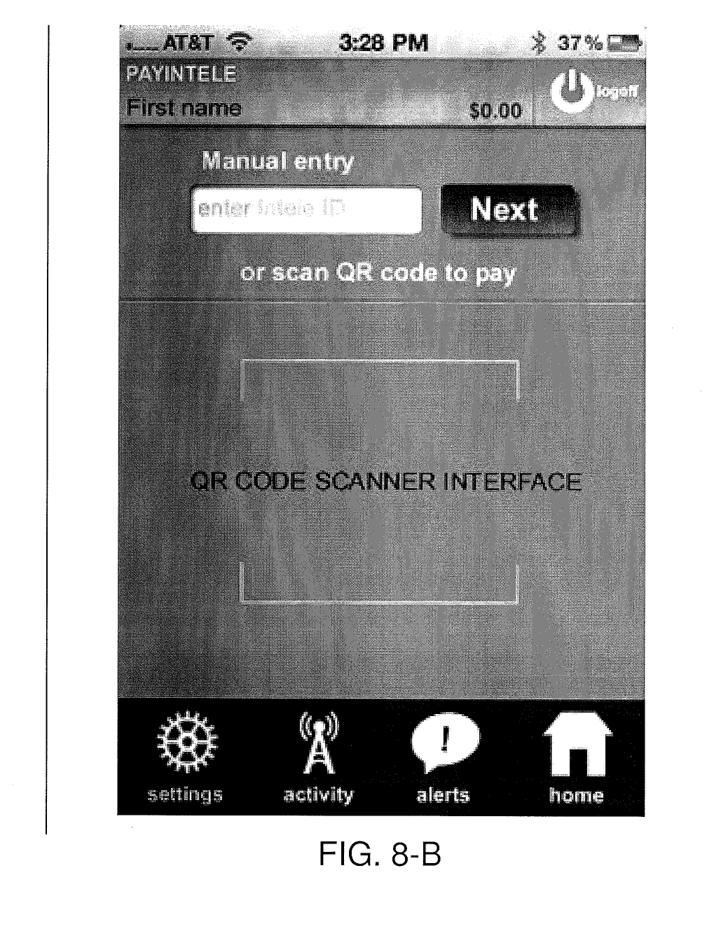

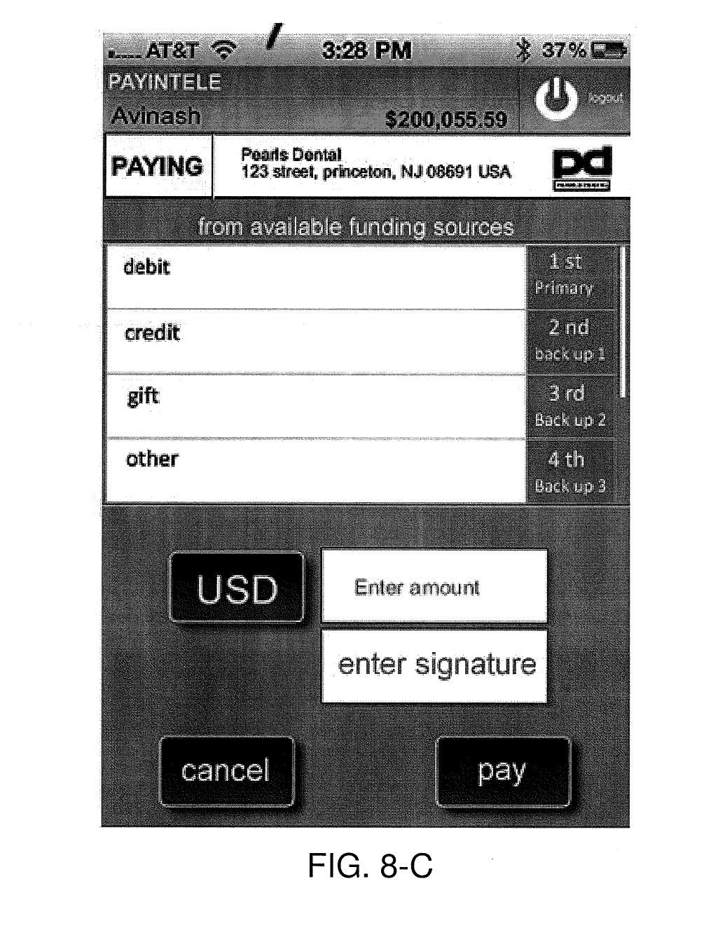

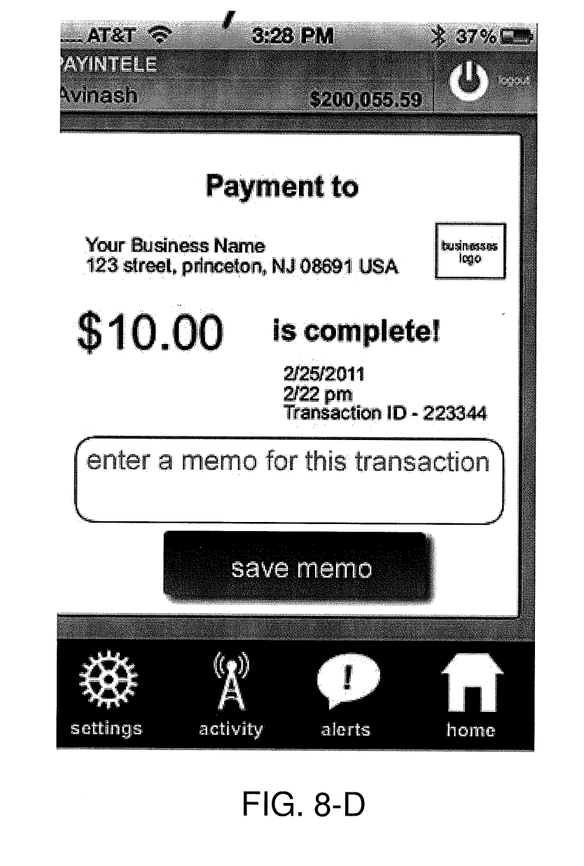

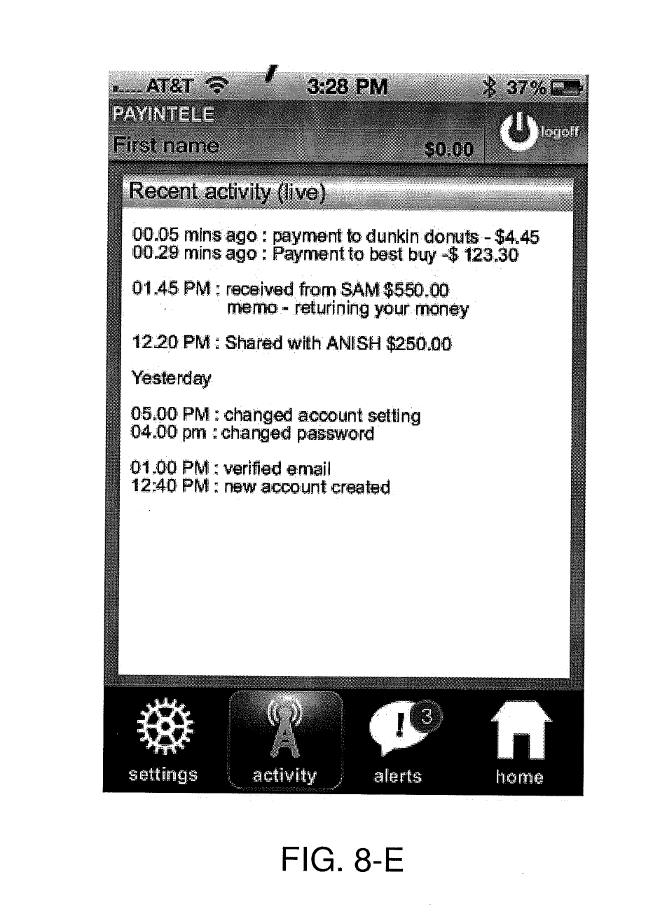

FIG. 8 illustrates a plurality of exemplary user interface screens for login and payment. The first three screens of this figure have been discussed before. In the 4^{th} screen, there is payment confirmation and an option to enter a memo. The memo shall be entered immediately after completion of the payment or at a later time by selecting the transaction details from the history or recent activity items. The memo may be a voice, video, picture or text recording (although only the text memo is shown in the picture.)

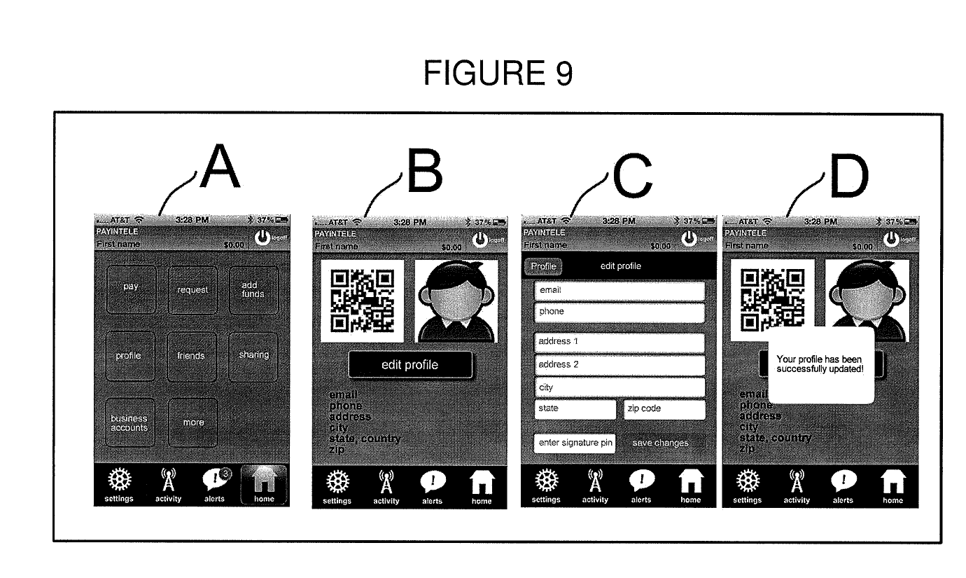

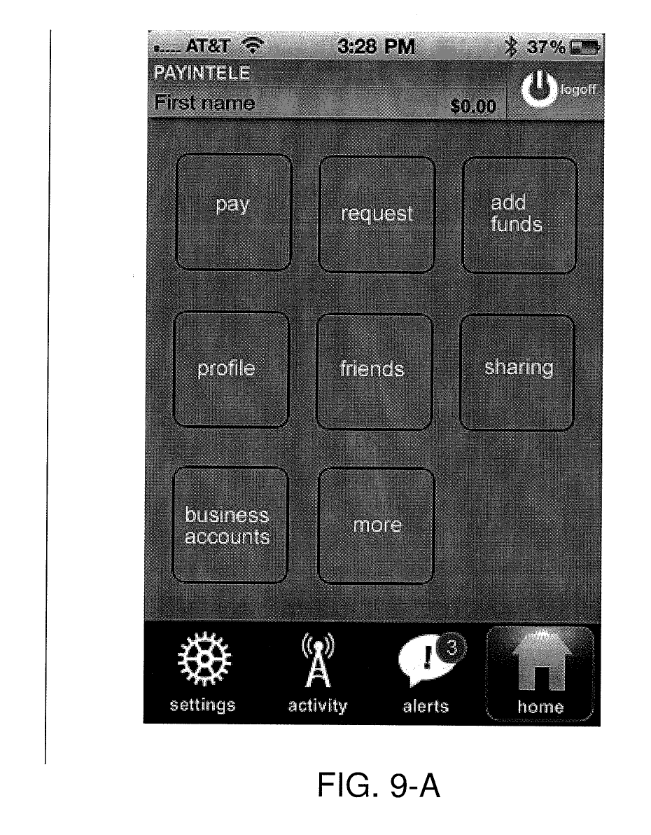

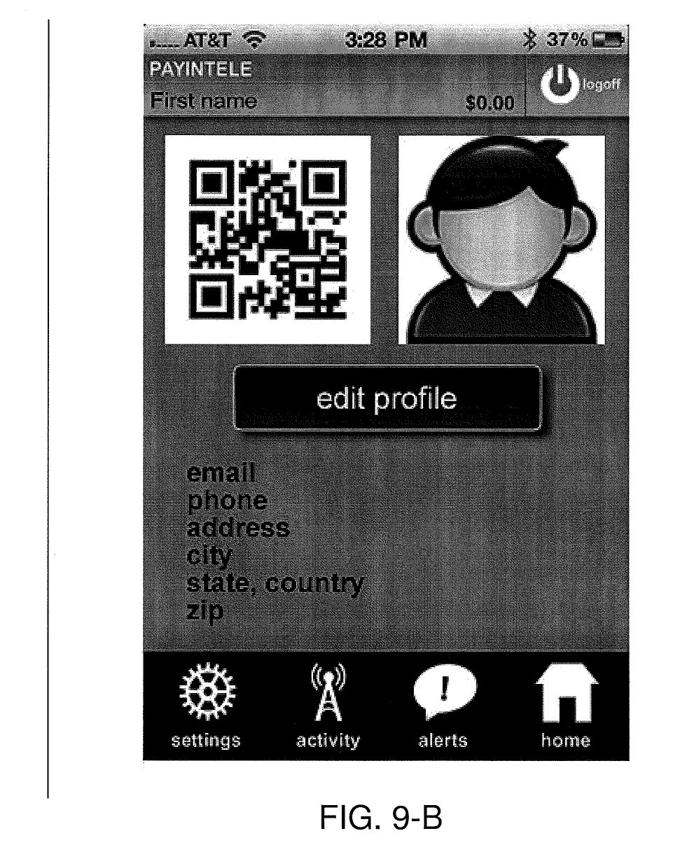

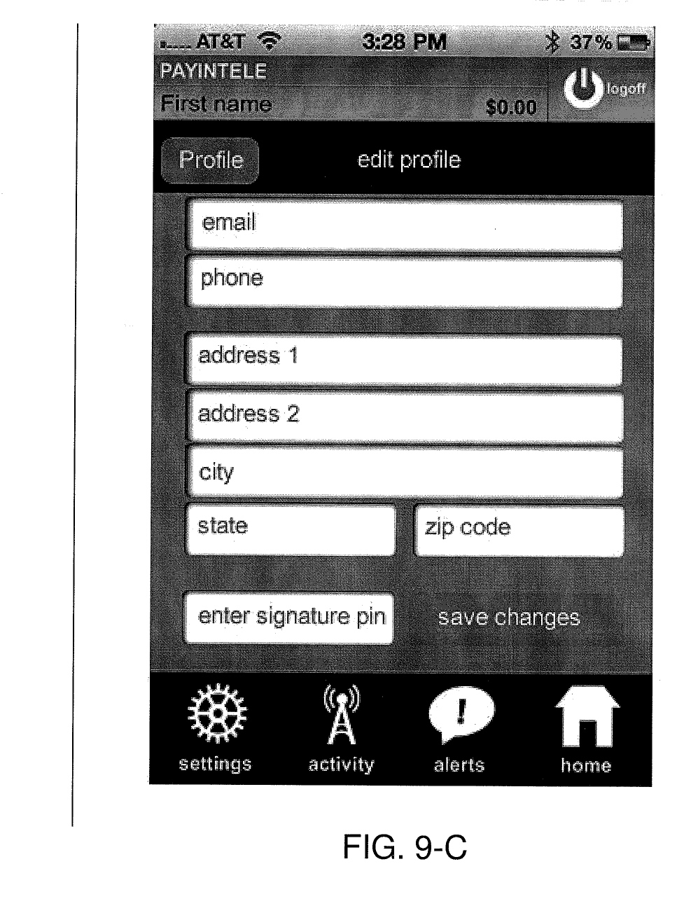

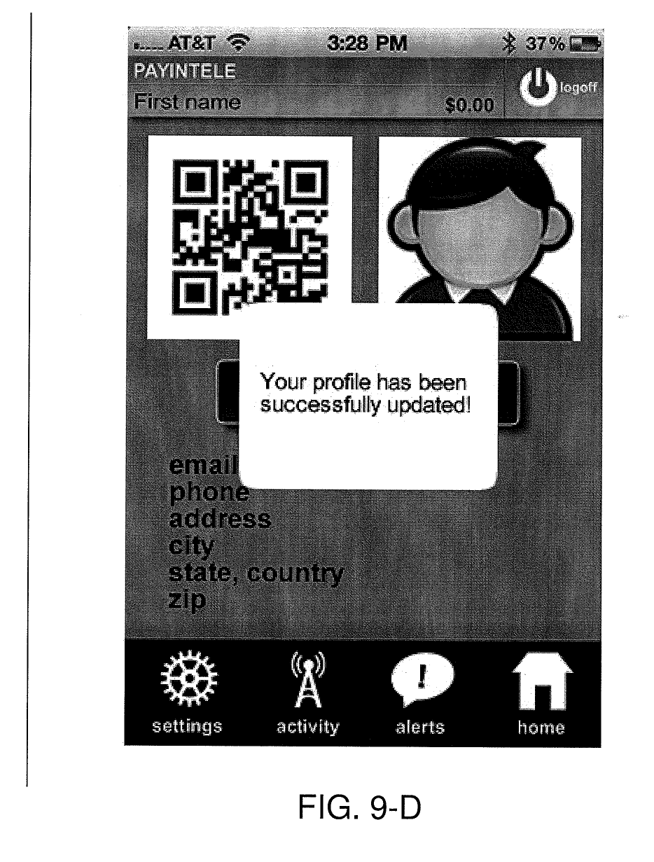

FIG. 9 illustrates a series of exemplary, self-explanatory user interface screens for a mobile device for creating a user profile in accordance with an embodiment of the Payintele system.

FIG. 10 illustrates a series of exemplary, self-explanatory user interface screens for a mobile device for adding funds from external sources to a Payintele account in accordance with an embodiment of the Payintele system.

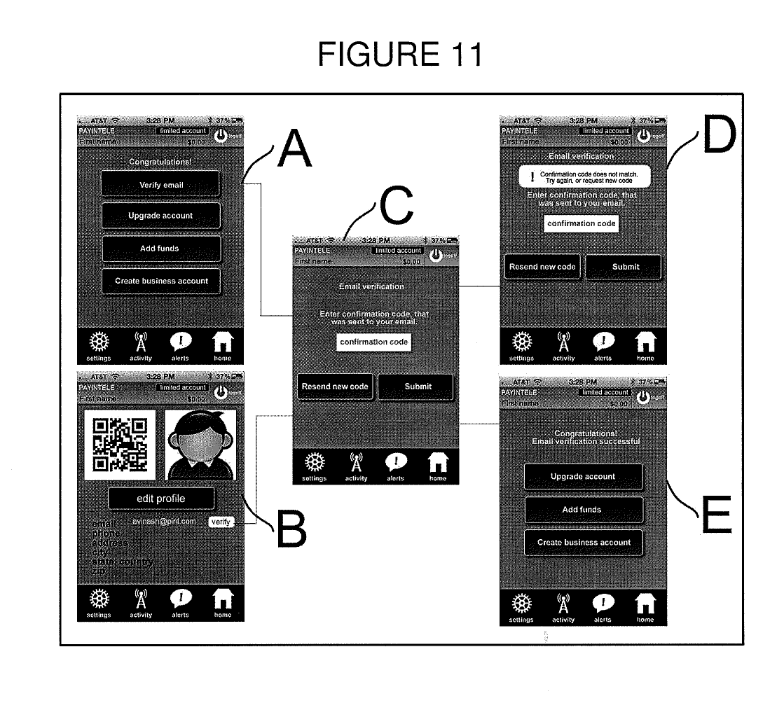

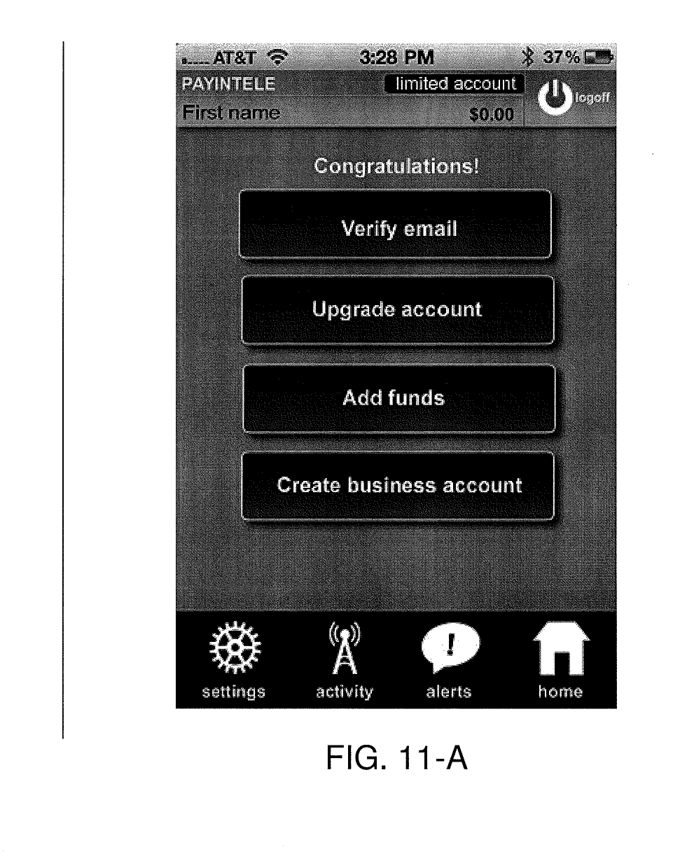

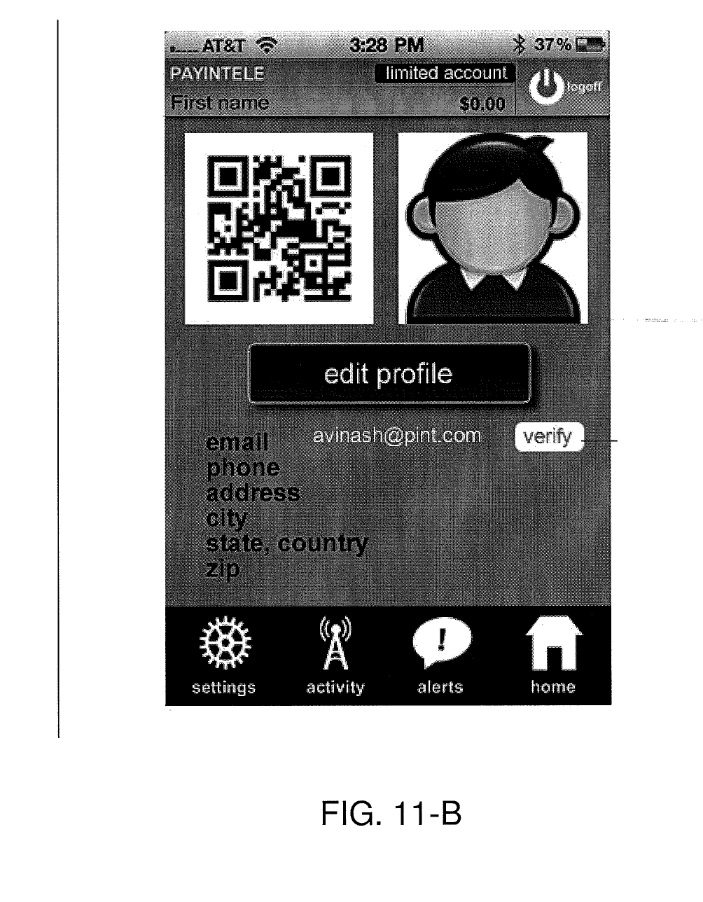

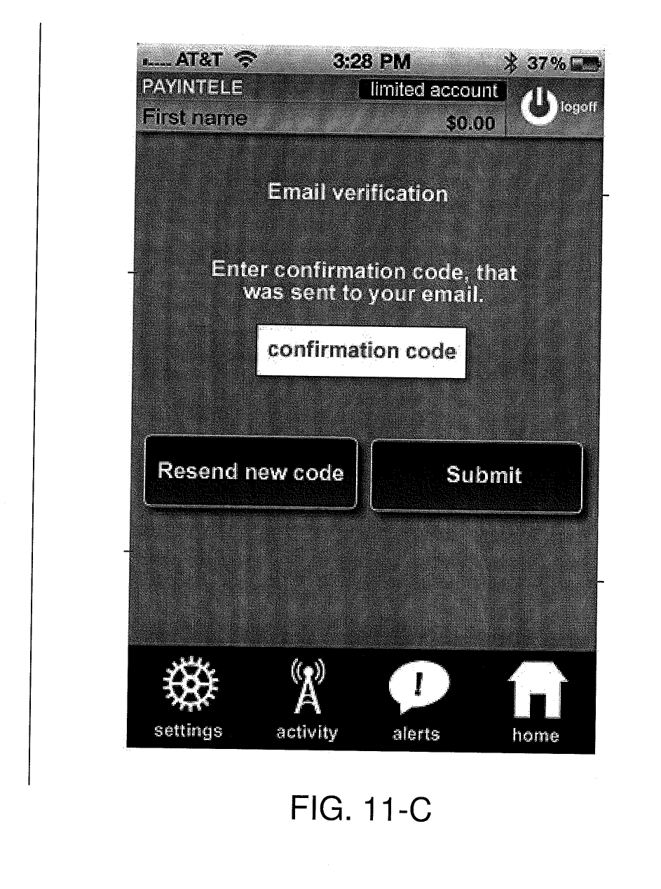

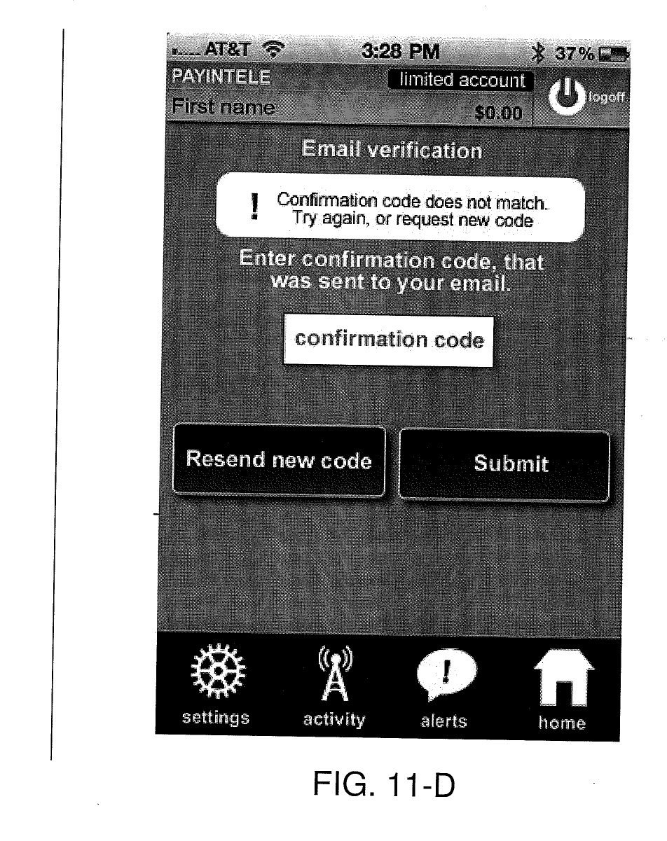

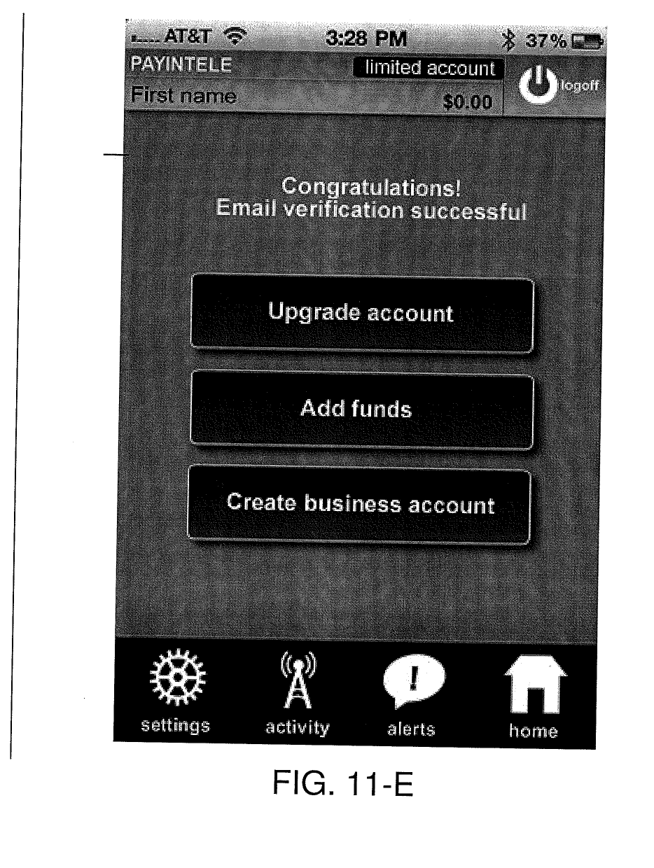

FIG. 11 illustrates a series of exemplary, self-explanatory user interface screens for a mobile device for verifying a Payintele user in accordance with an embodiment of the Payintele system.

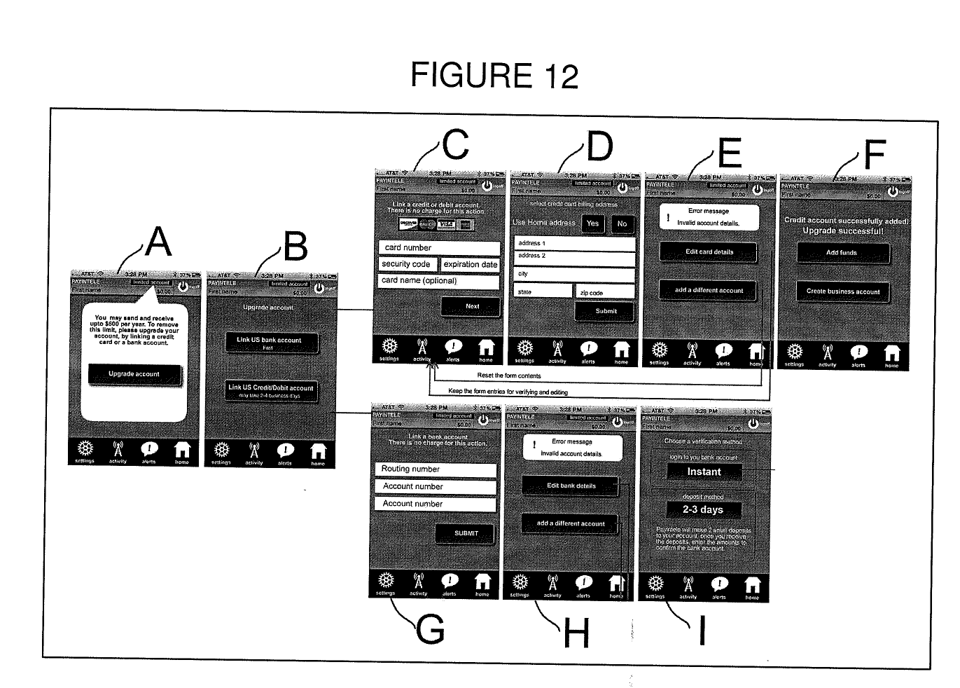

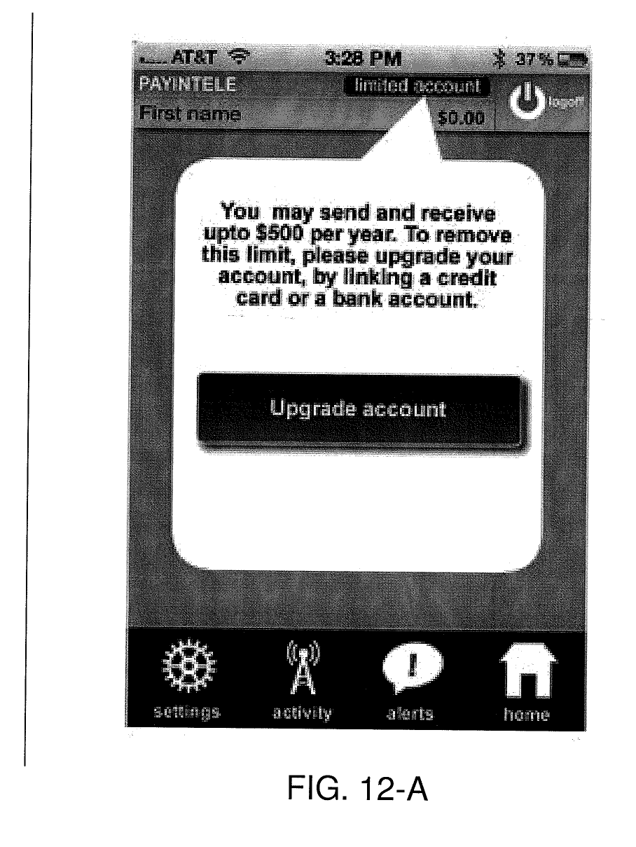

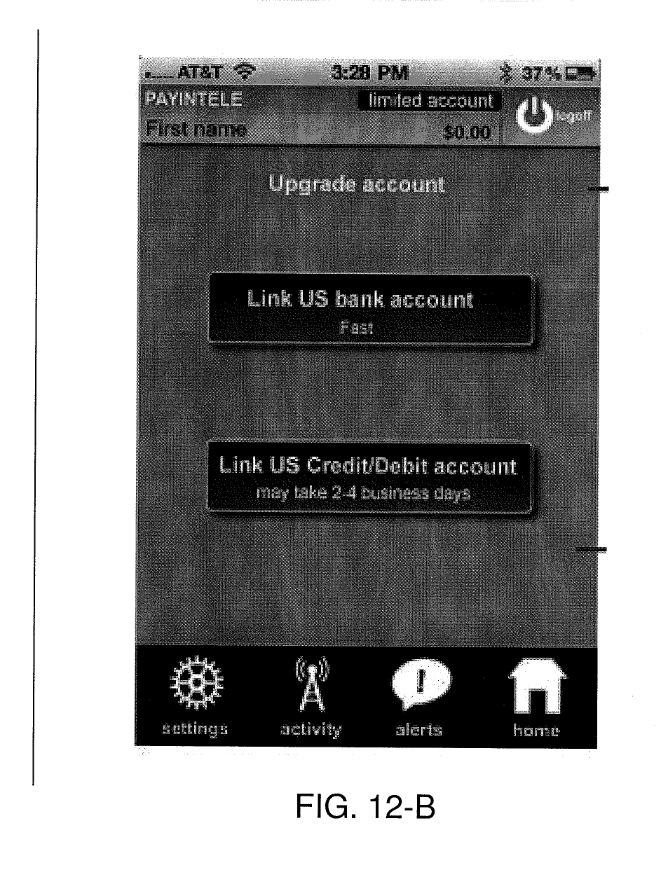

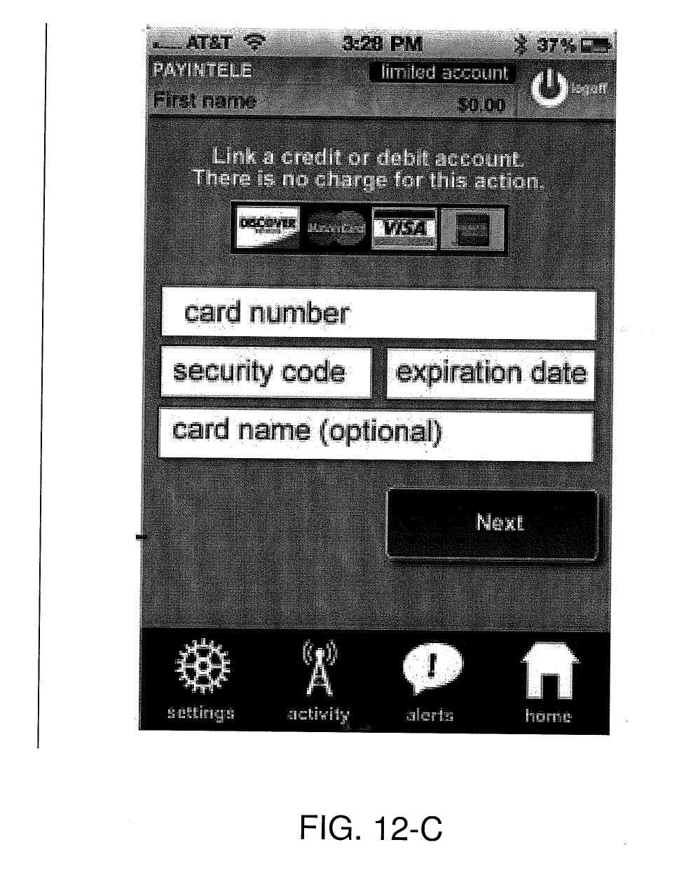

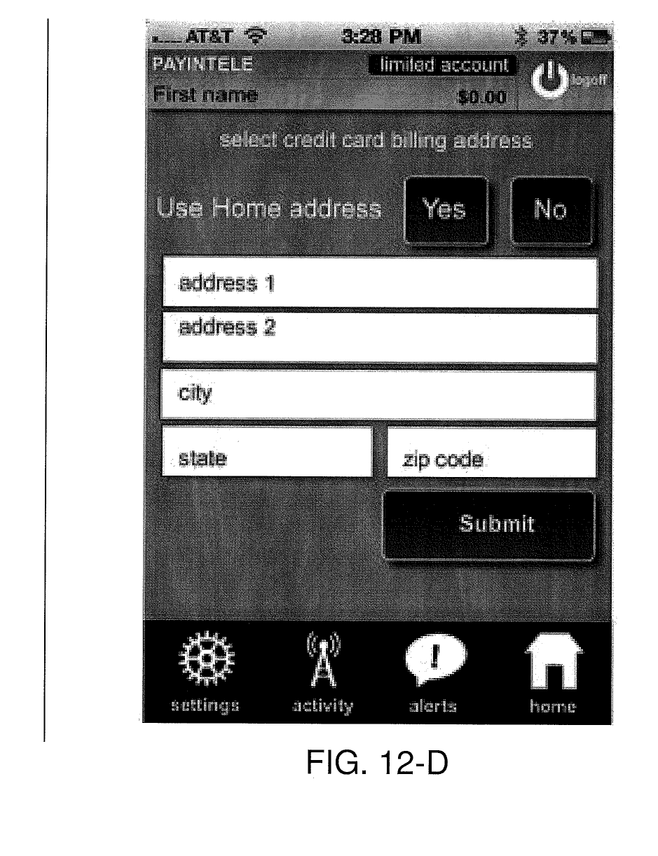

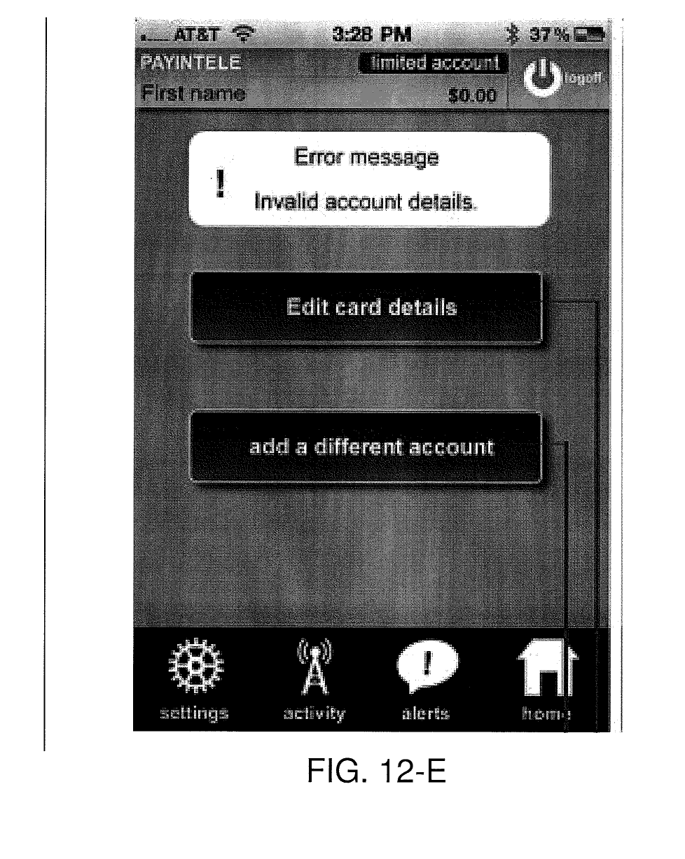

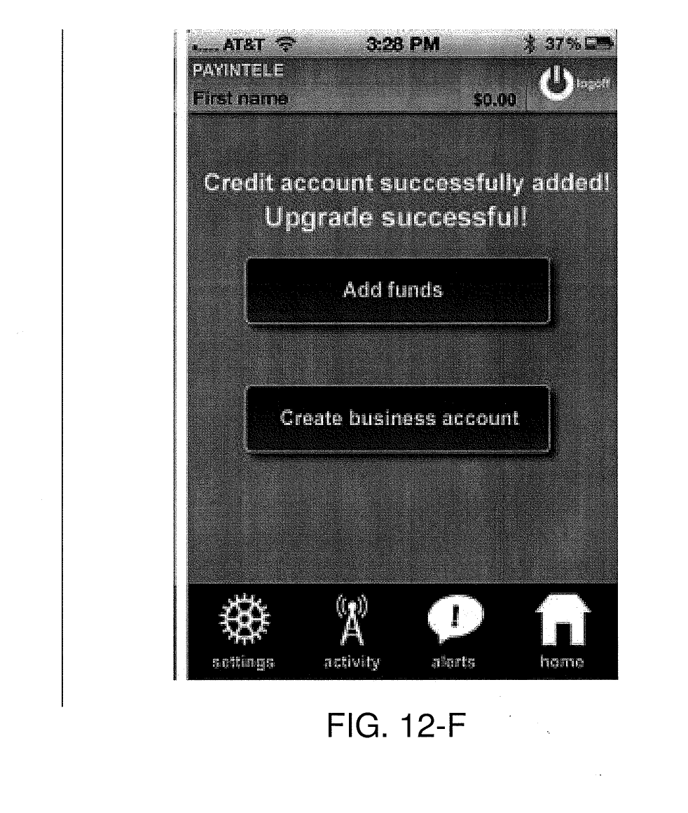

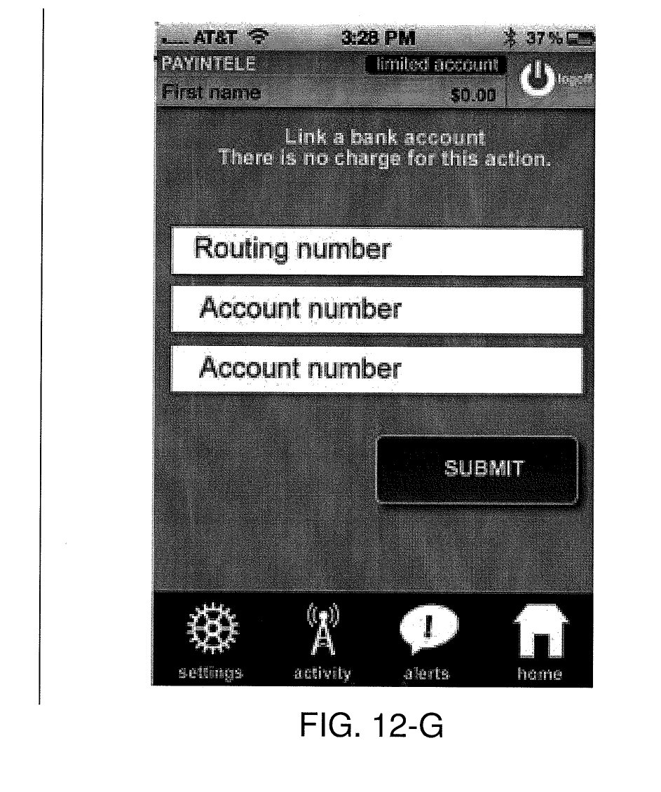

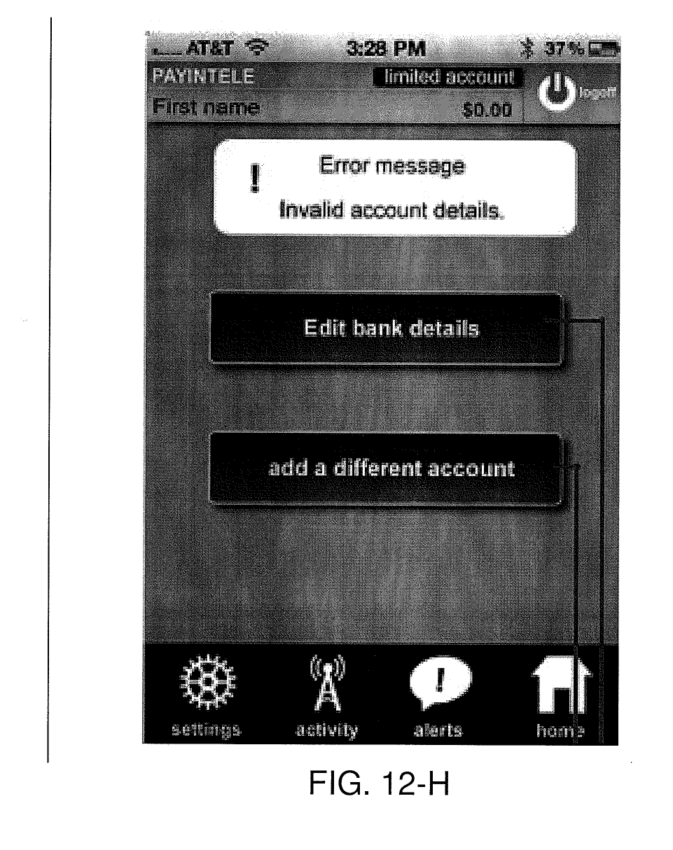

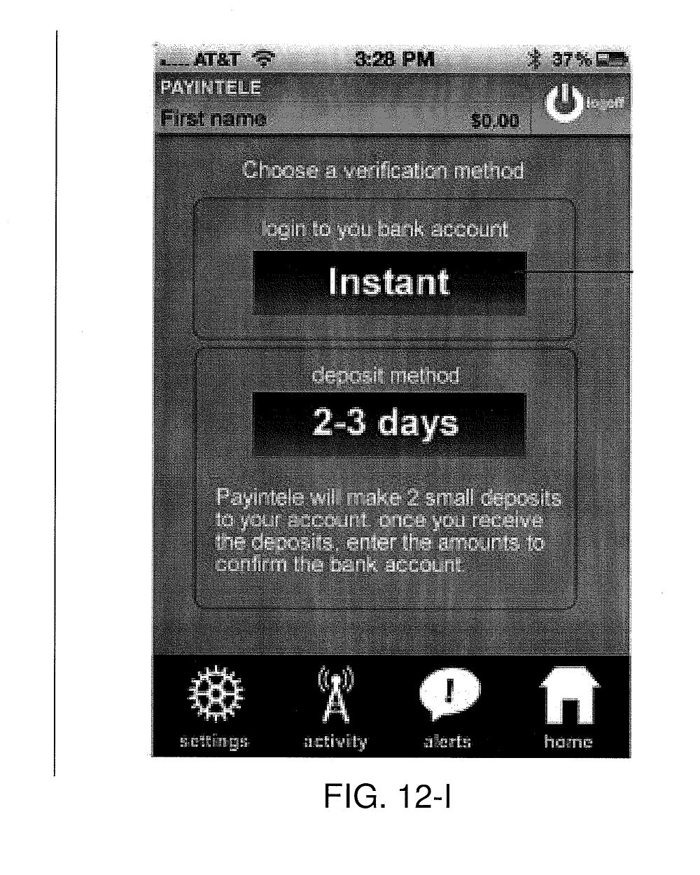

FIG. 12 illustrates a series of exemplary, self-explanatory user interface screens for a mobile device for adding a bank account to an upgrade account in accordance with an embodiment of the Payintele system.

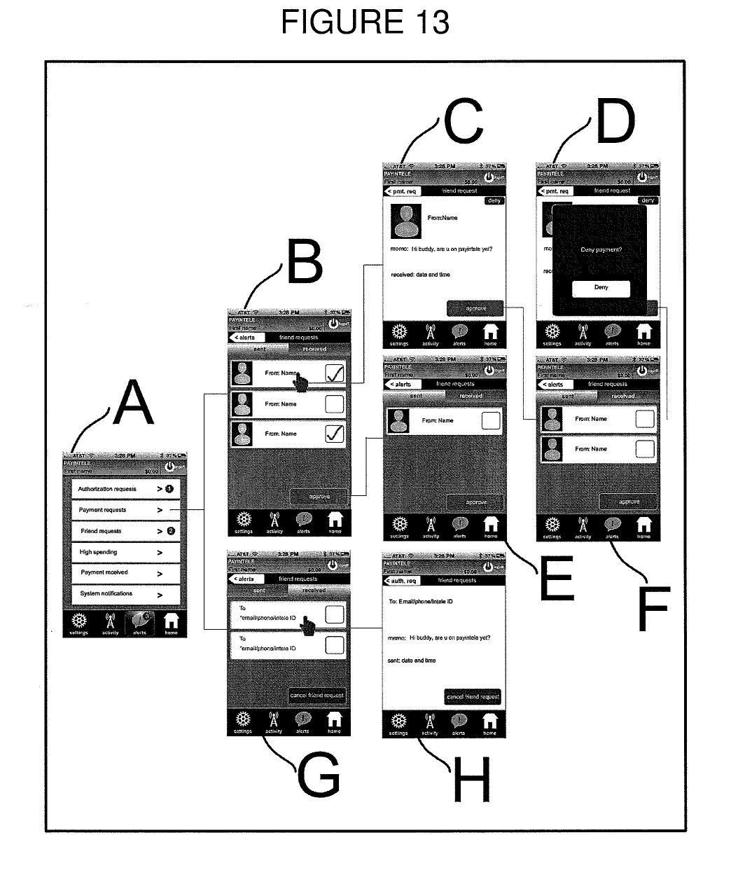

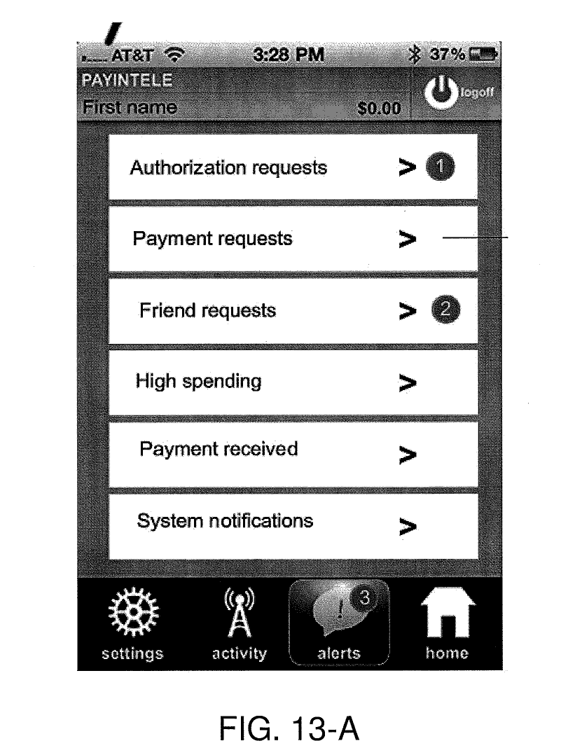

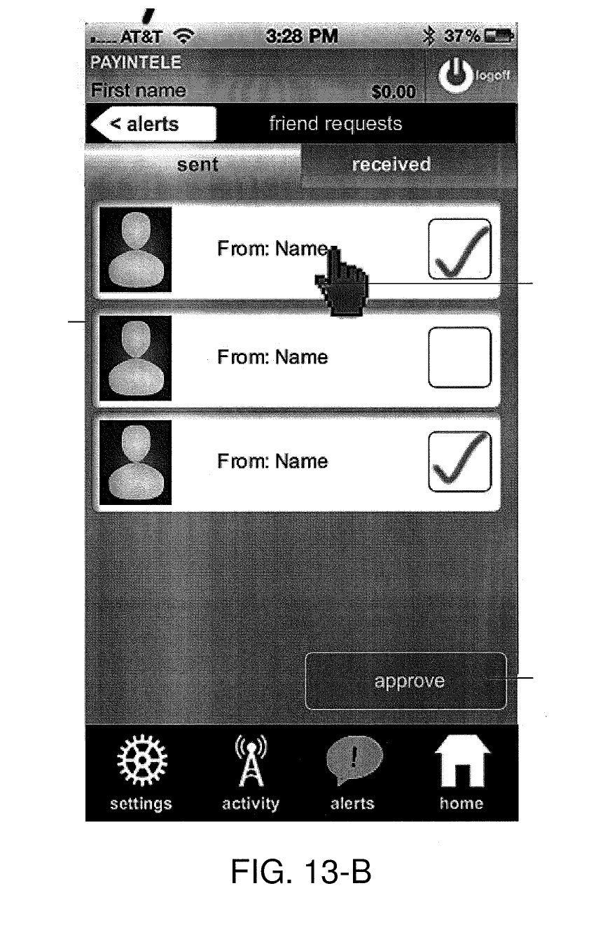

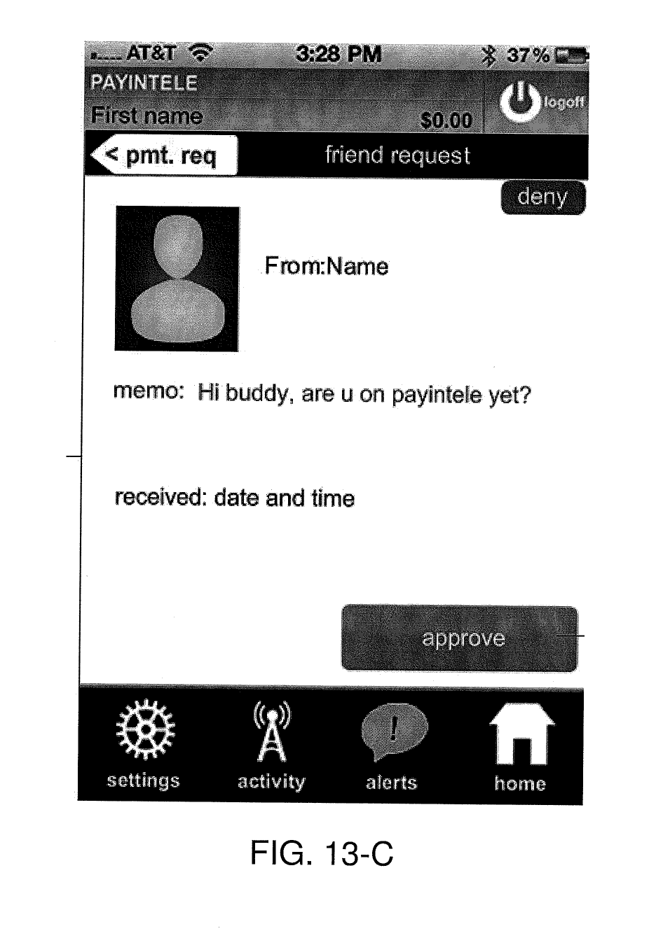

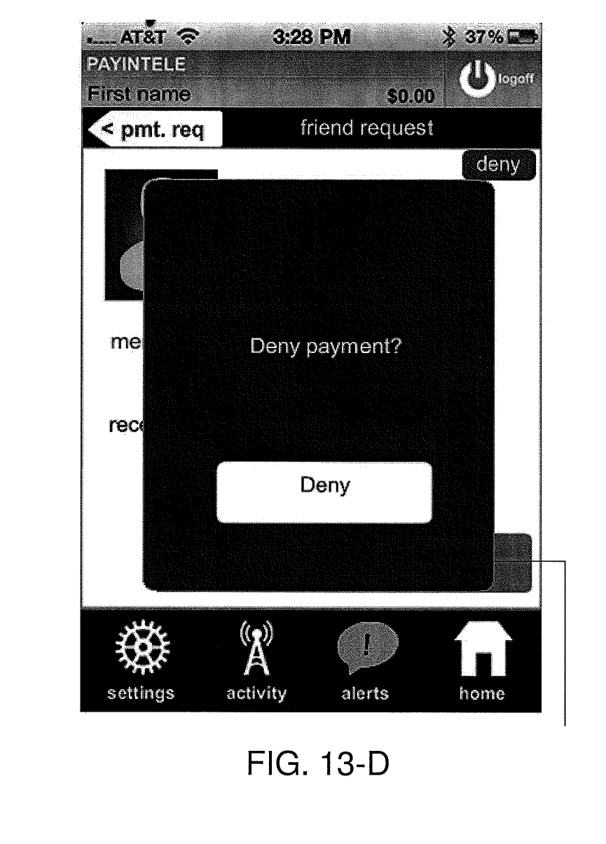

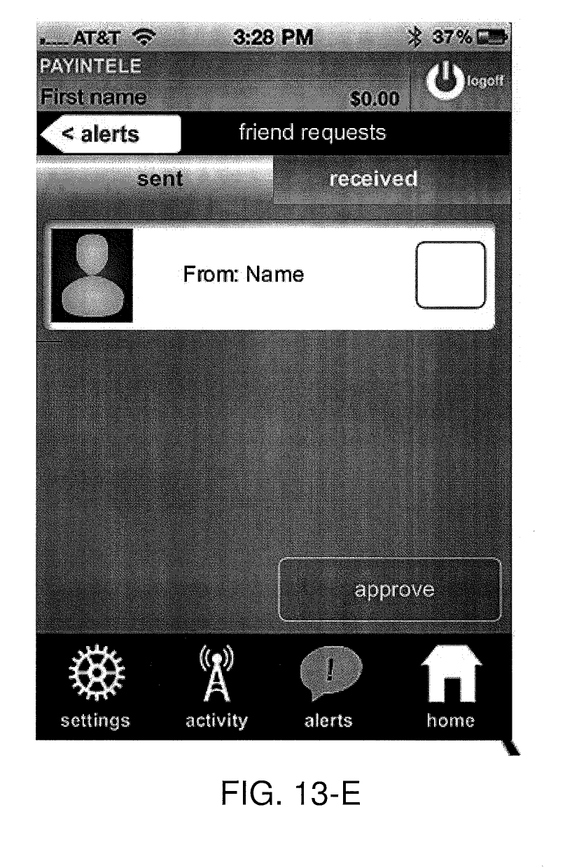

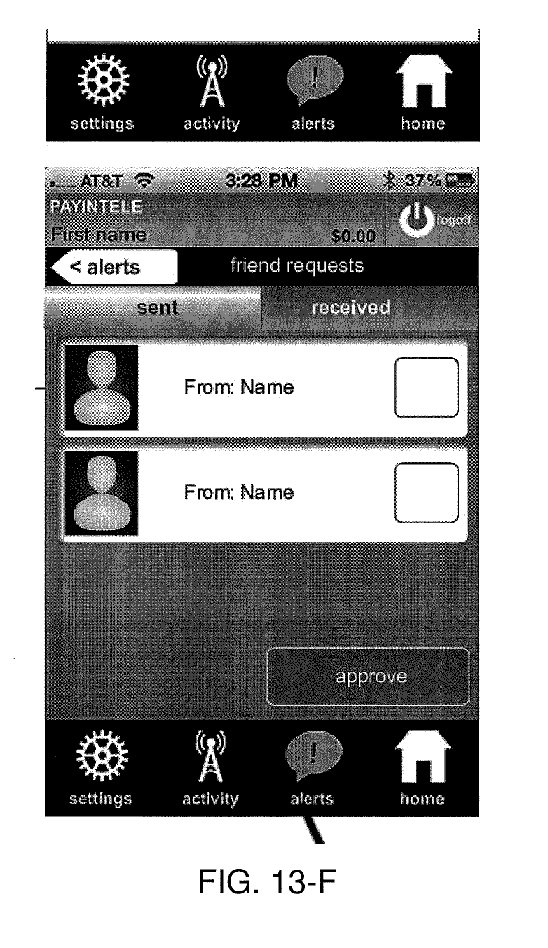

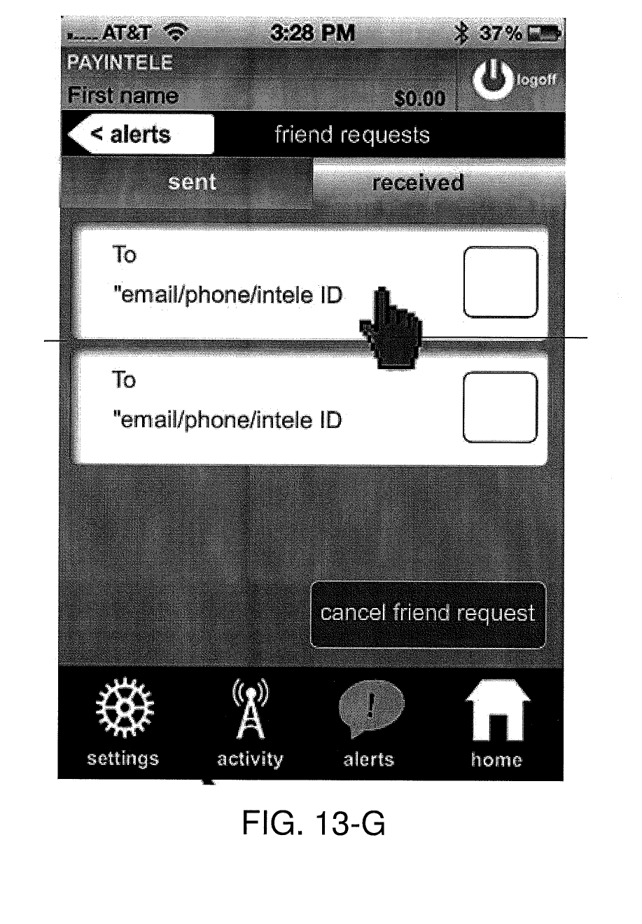

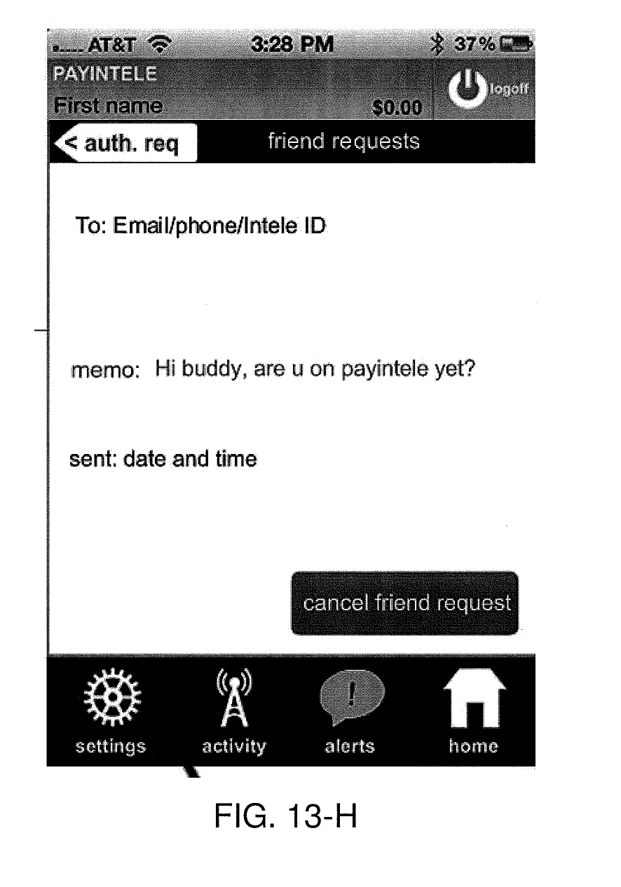

FIG. 13 illustrates a series of exemplary, self-explanatory user interface screens for a mobile device for issuing alerts and friend requests in accordance with an embodiment of the Payintele system.

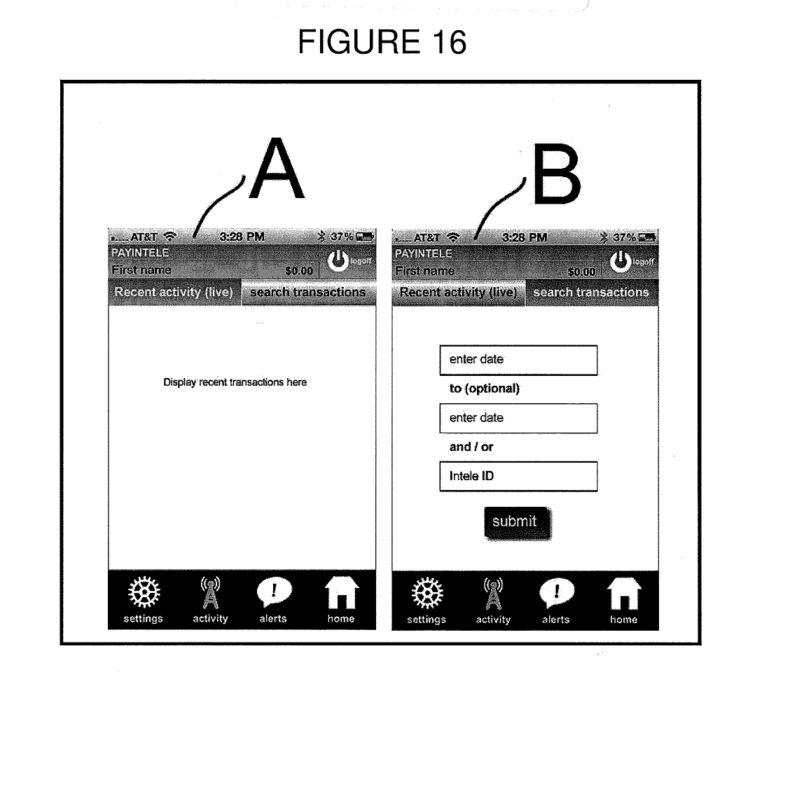

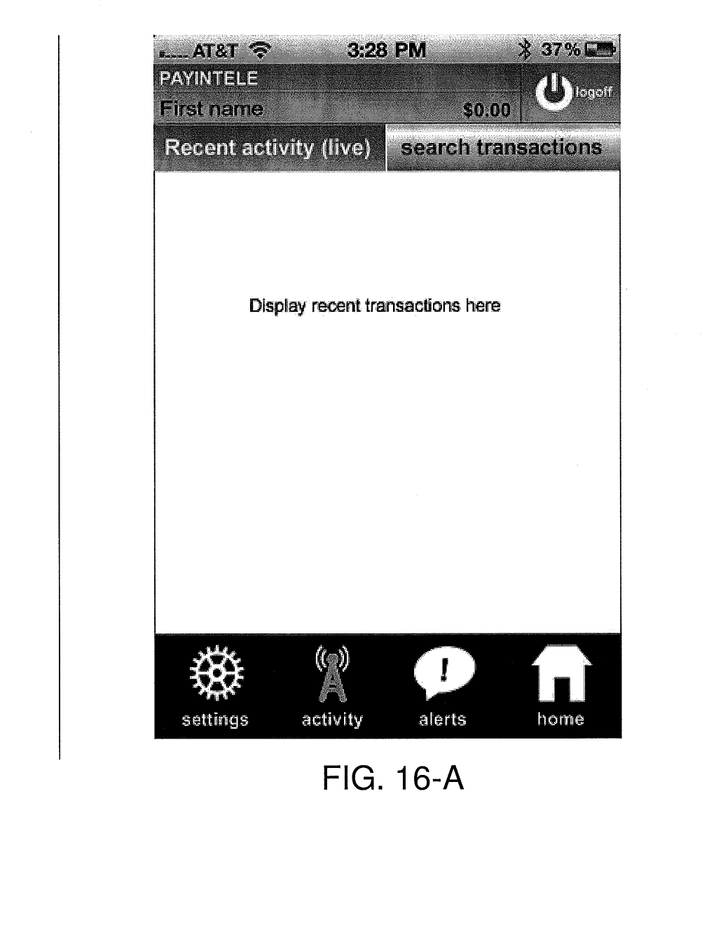

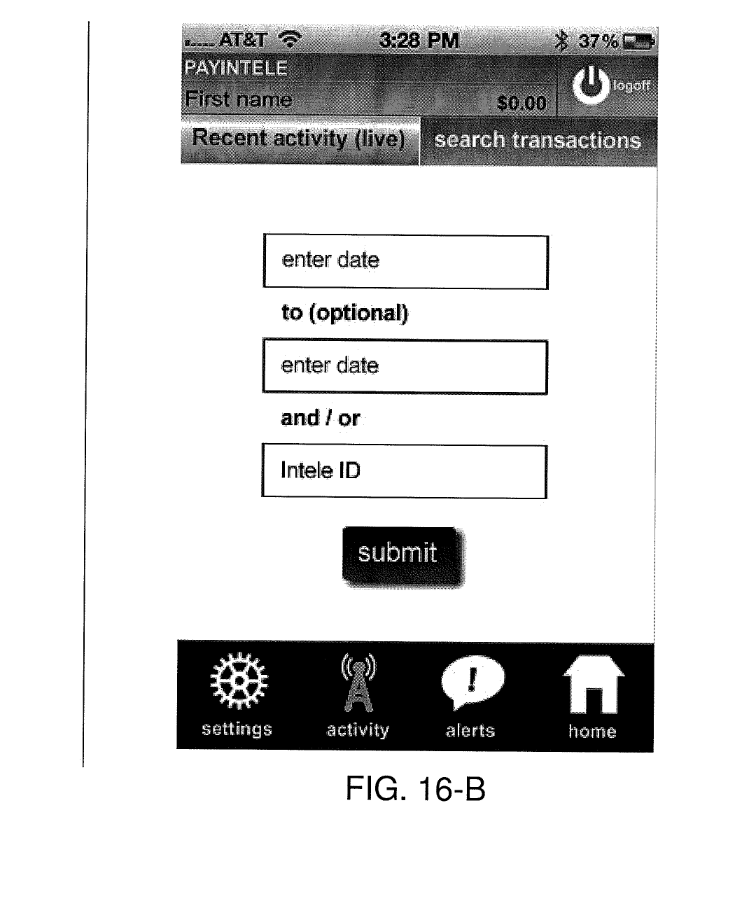

FIG. 16 illustrates a series of exemplary, self-explanatory user interface screens for a mobile device for reviewing recent transactions and searching transactions in accordance with an embodiment of the Payintele system.

FIGS. 17A and 17B collectively illustrate a series of exemplary, self-explanatory user interface screens for a mobile device for configuring account settings, automatic withdrawals, setting funding orders, and managing passwords in accordance with an embodiment of the Payintele system.

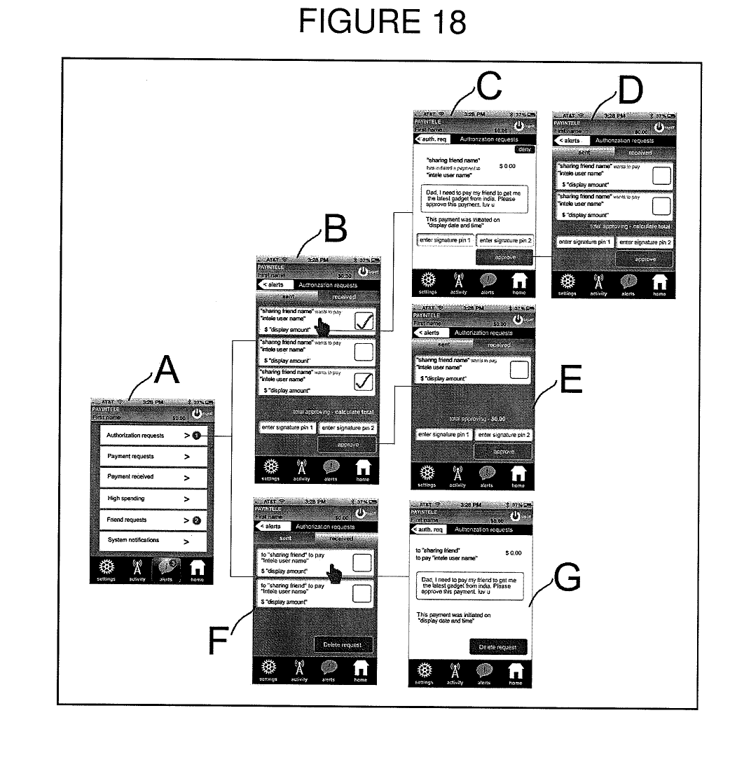

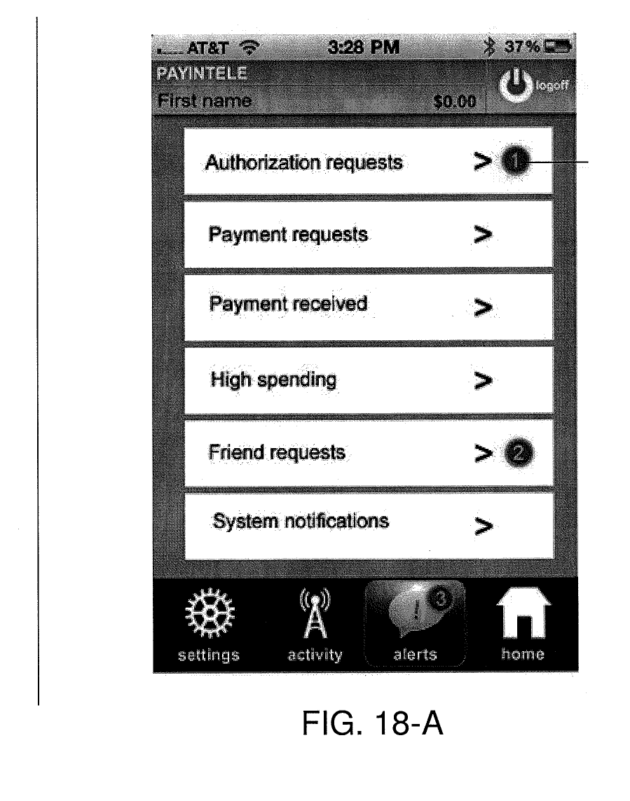

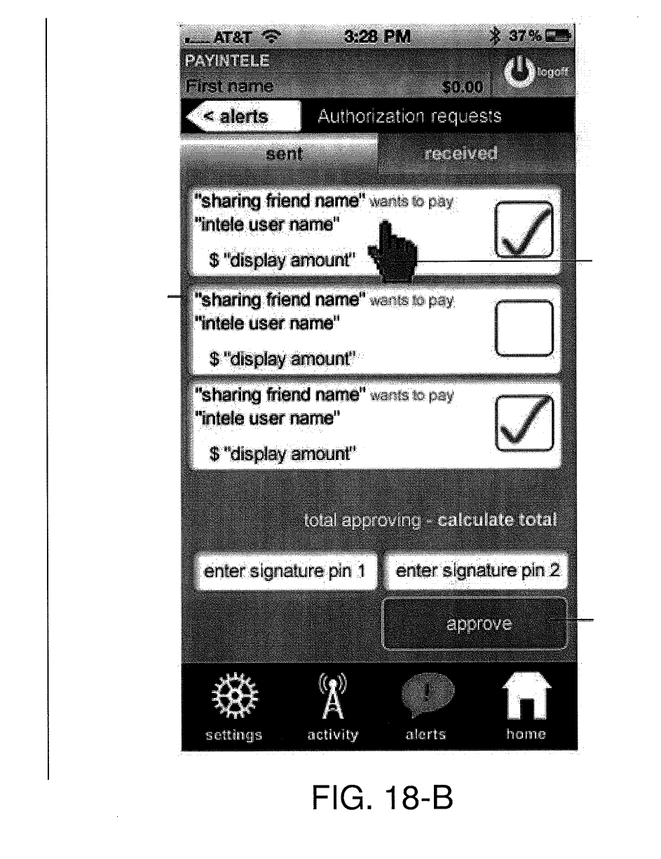

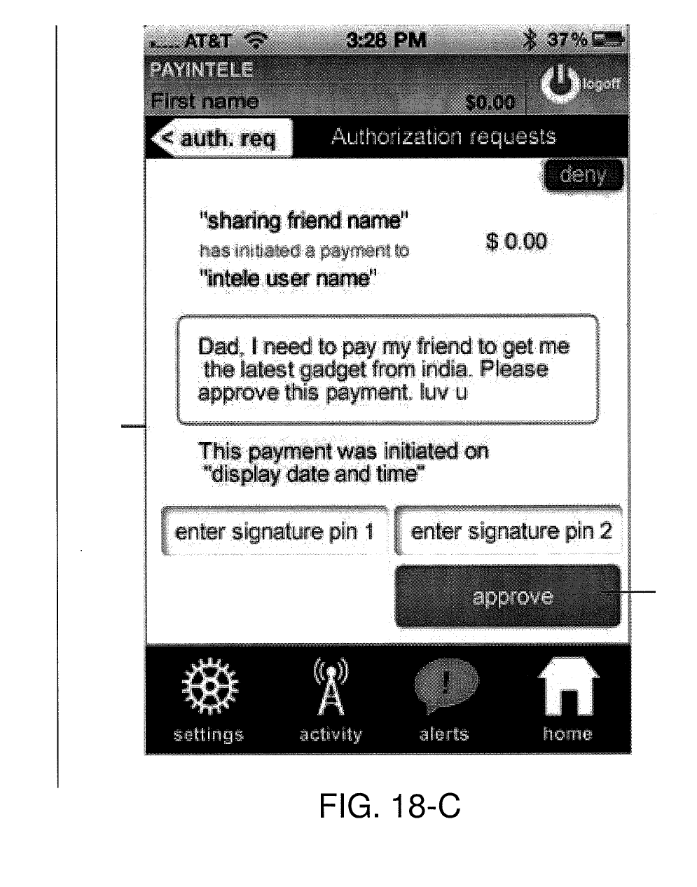

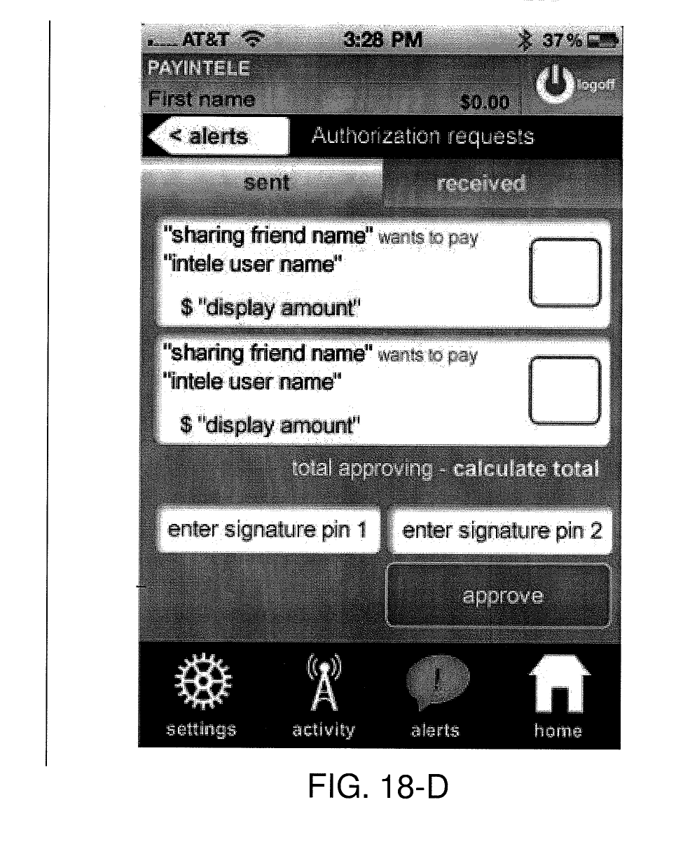

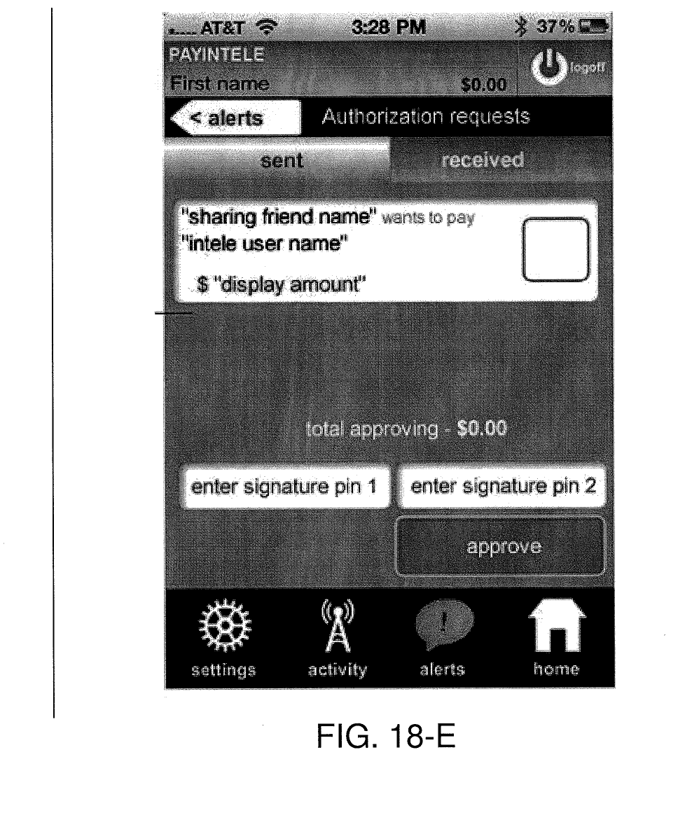

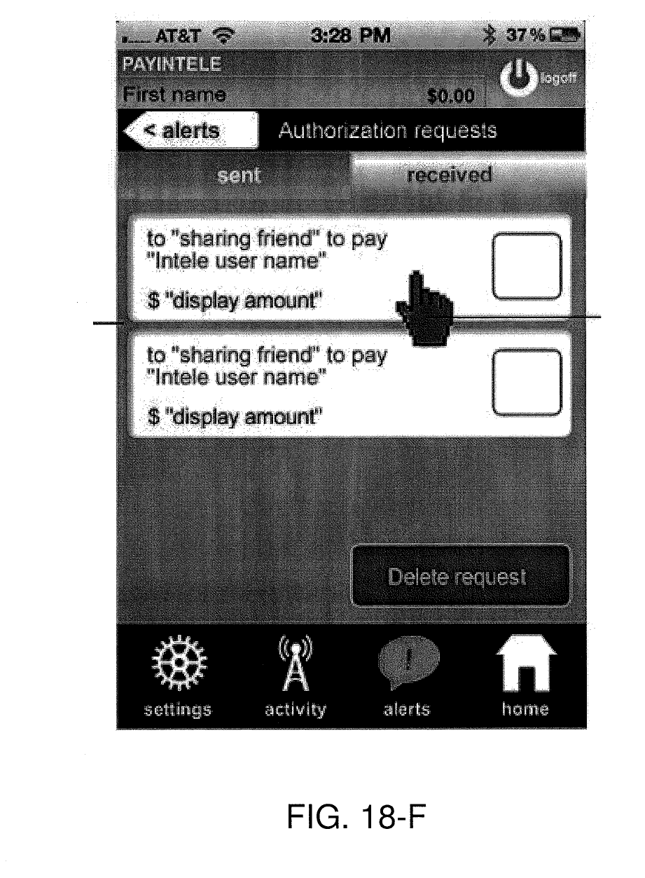

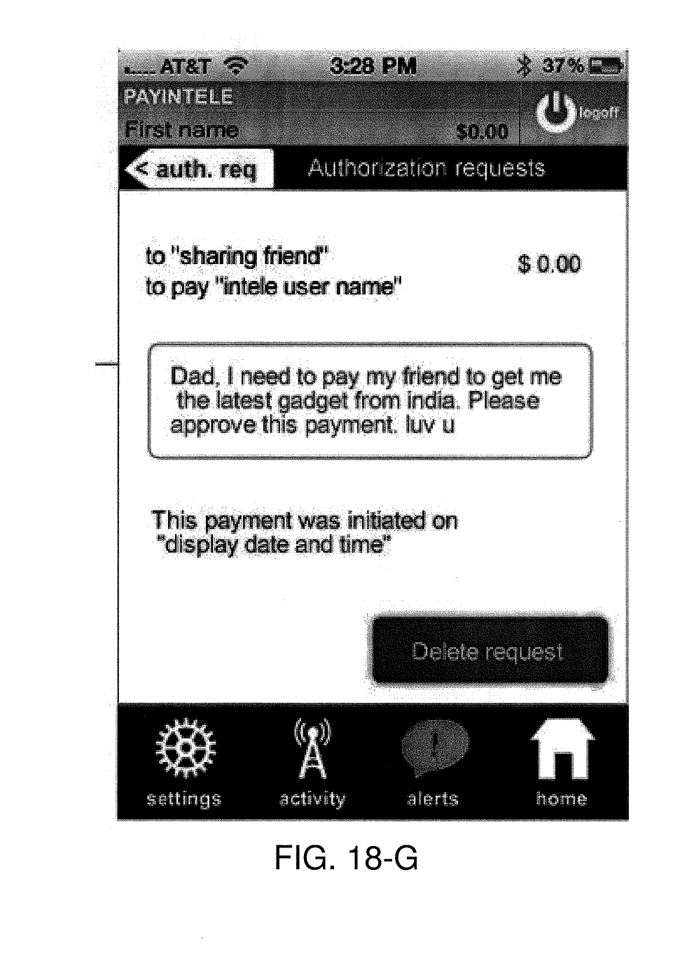

FIG. 18 illustrates a series of exemplary, self-explanatory user interface screens for issuing authorization requests for payment from one user (the person requesting authorization) to make a payment from an account for which he does not have authority to another user who does have authority to authorize payments from the account in accordance with one embodiment of a Payintele system. For instance, authorization requests are typically sent by employees of other members who are responsible to make a payment on another user's behalf. Example: An employee may schedule payment for building maintenance from the building owner's account, or the spouse may schedule a tax payment from the husband's account, however, the owner (or the husband in the case of latter) needs to authorize the transaction by entering his/her transaction PIN code. The authorization can be done by the account owners remotely via the application. Users for whom the account owner has granted restricted account sharing privileges may initiate such transactions. FIG. 18 illustrates exemplary, self-explanatory user interface screens for such transactions.

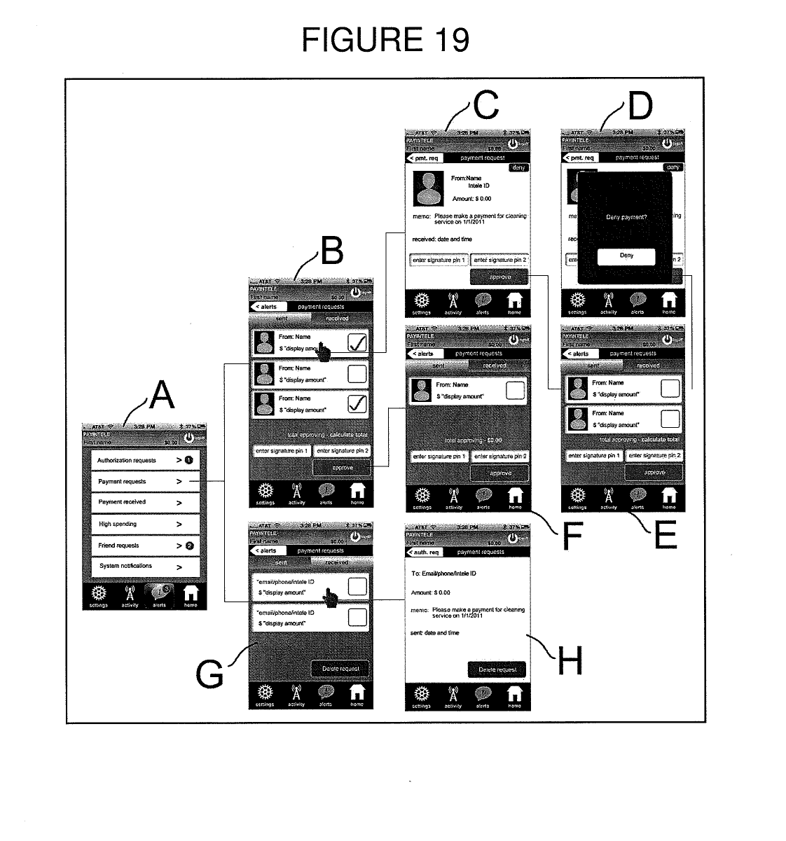

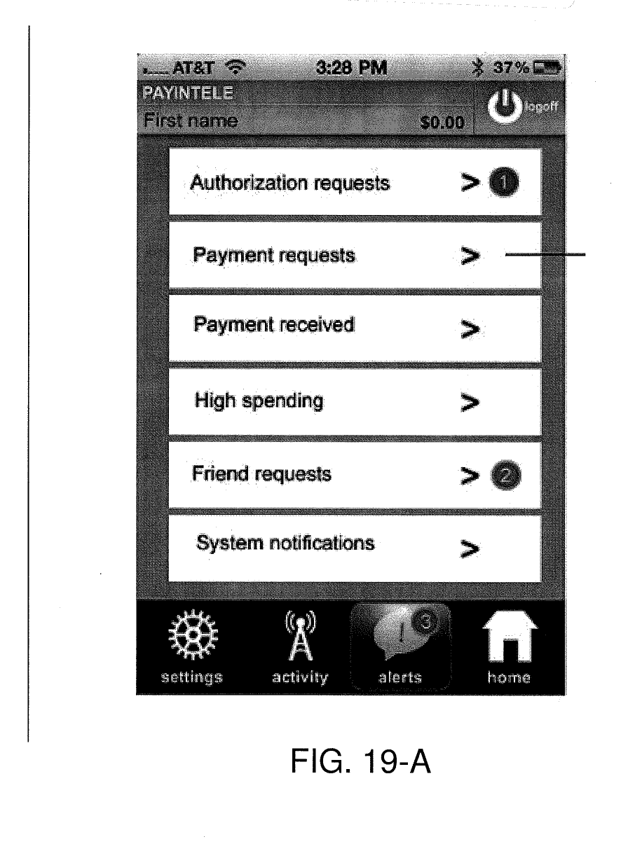

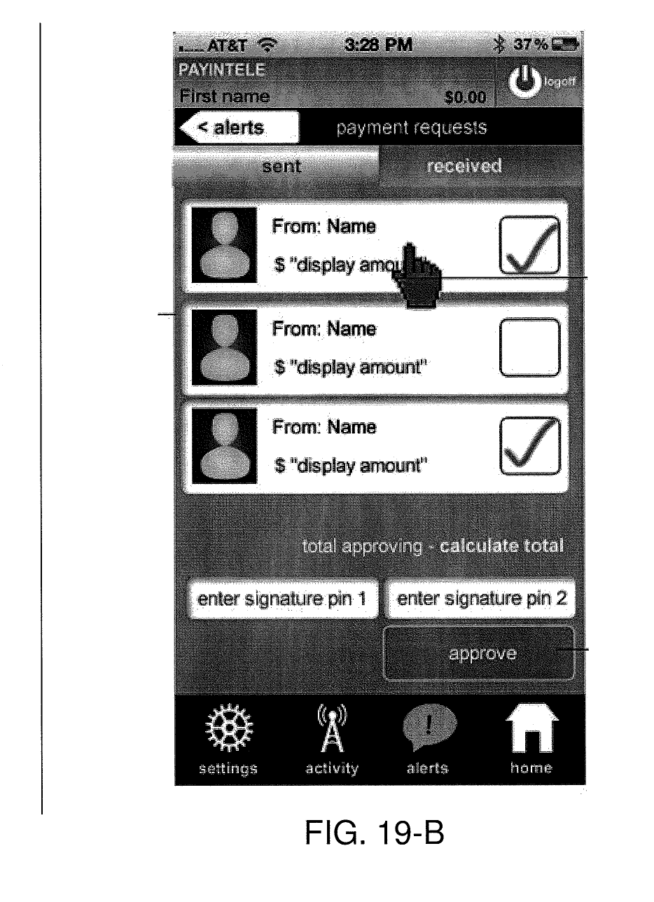

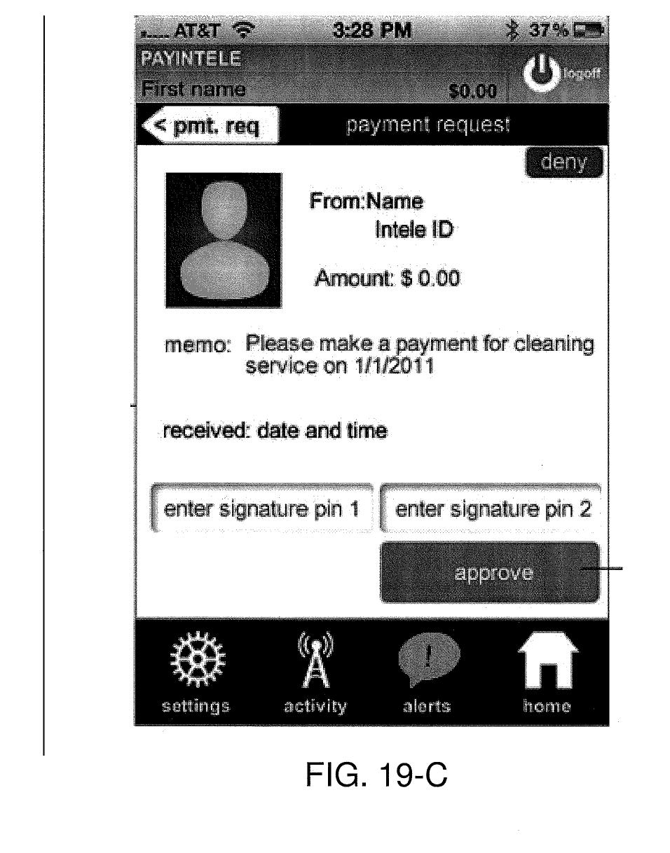

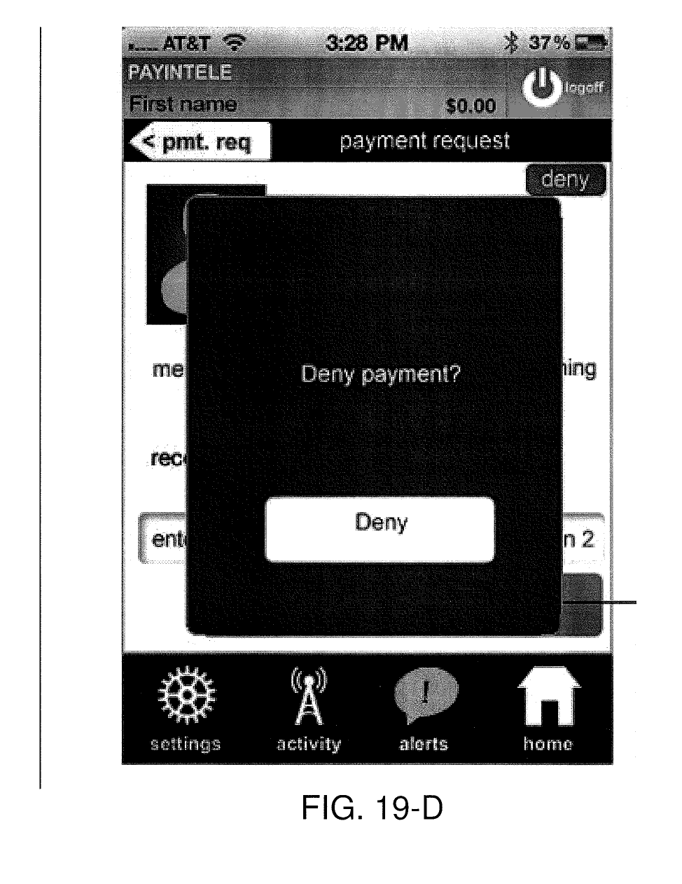

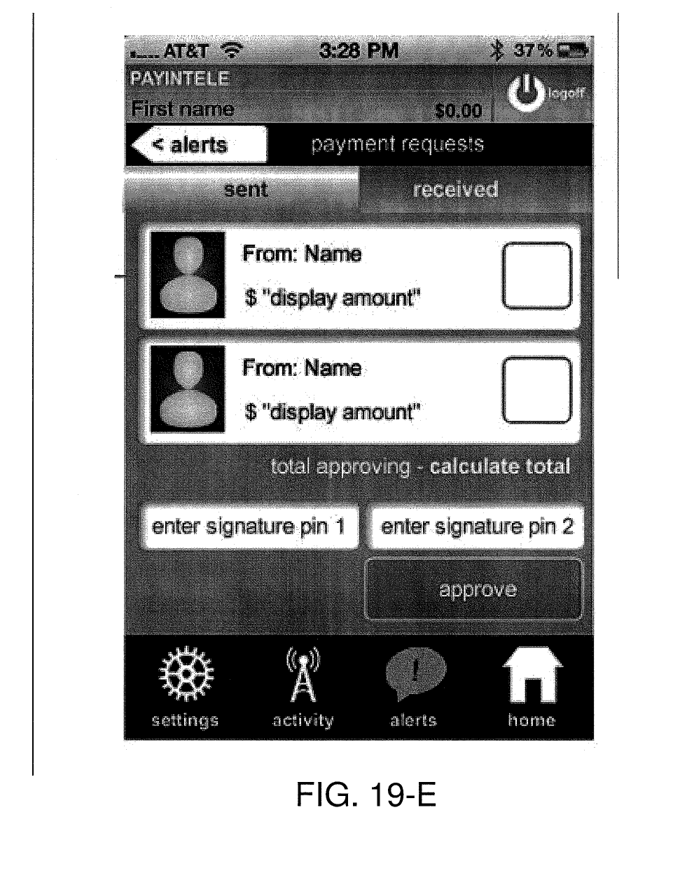

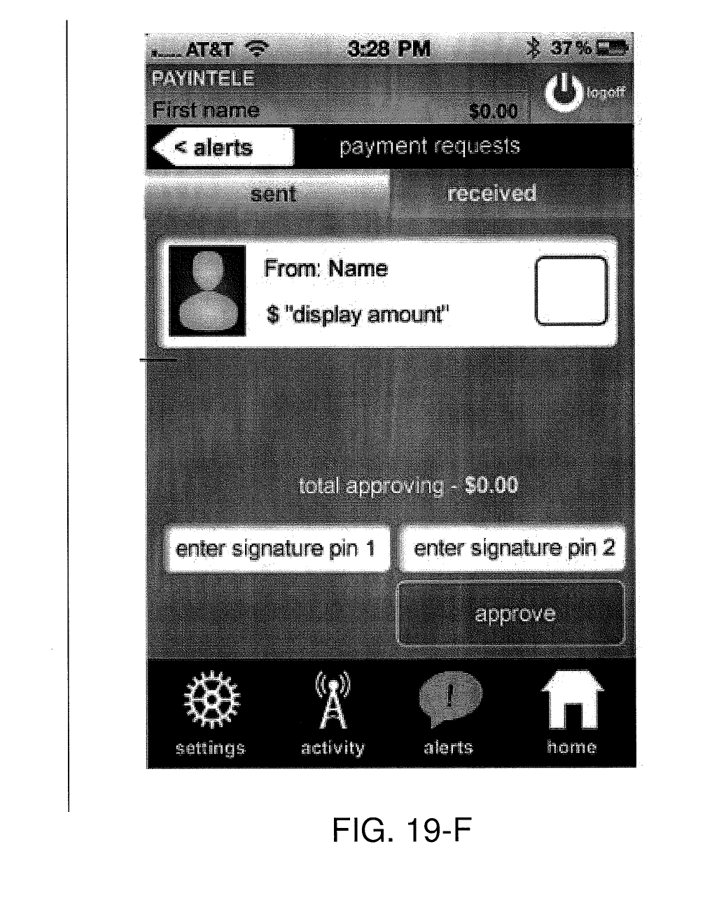

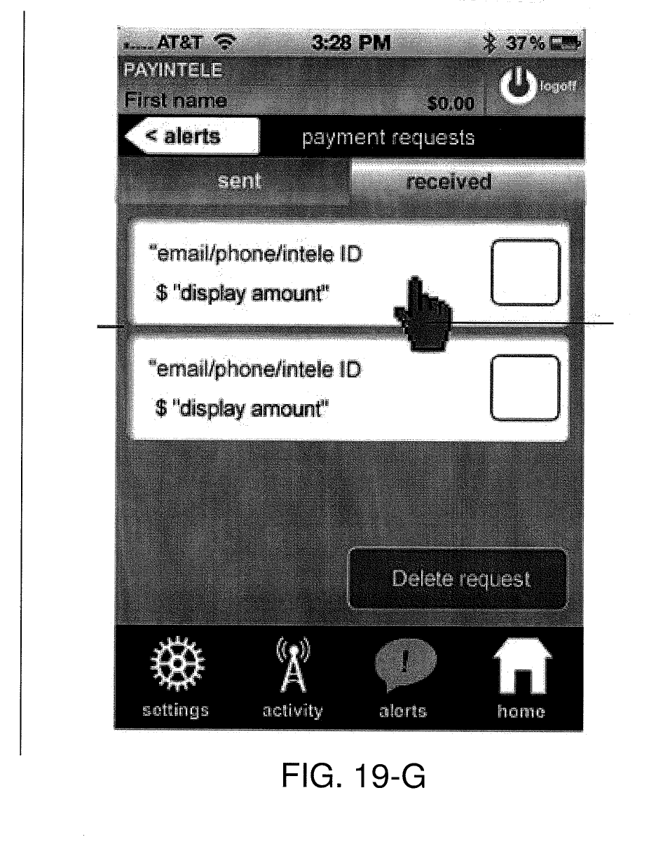

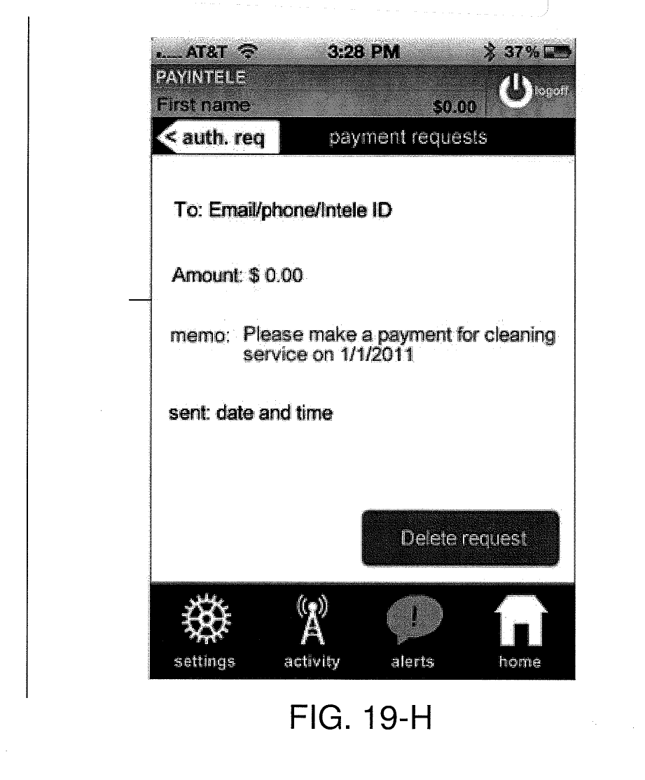

FIG. 19 illustrates a series of exemplary, self-explanatory user interface screens for a mobile device for issuing alerts in the form of payments requests for services in accordance with an embodiment of the Payintele system.

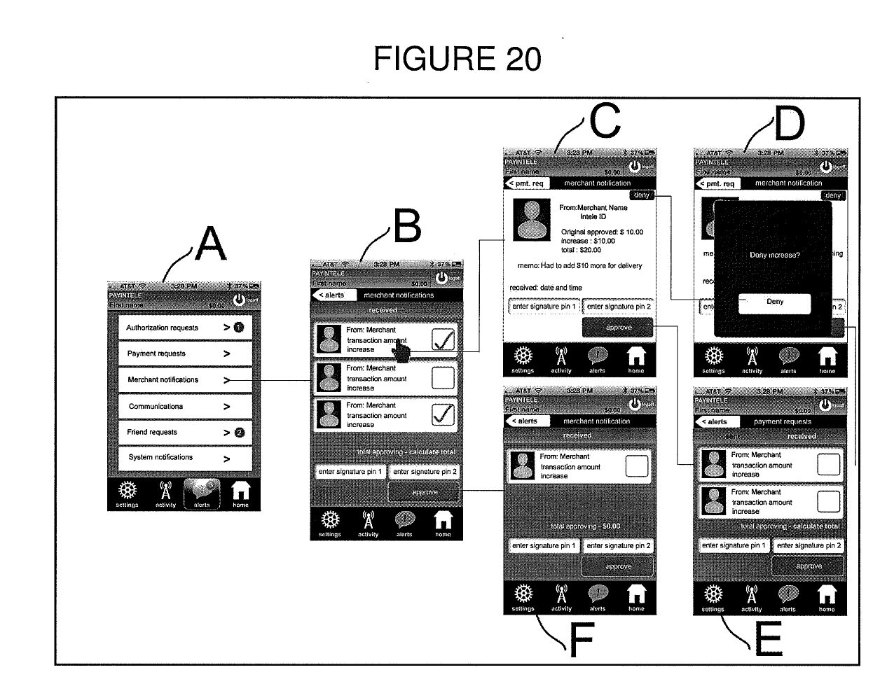

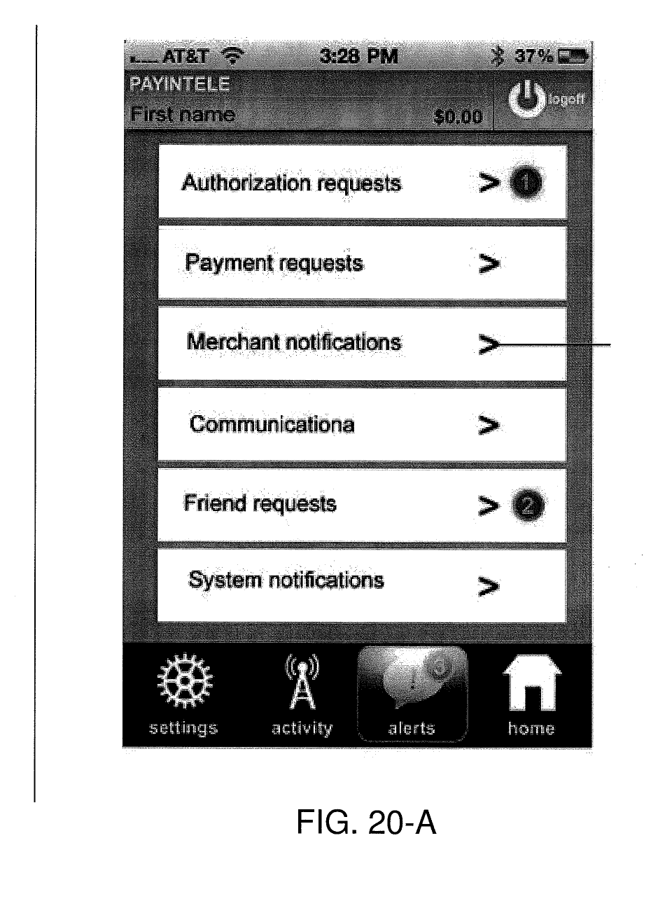

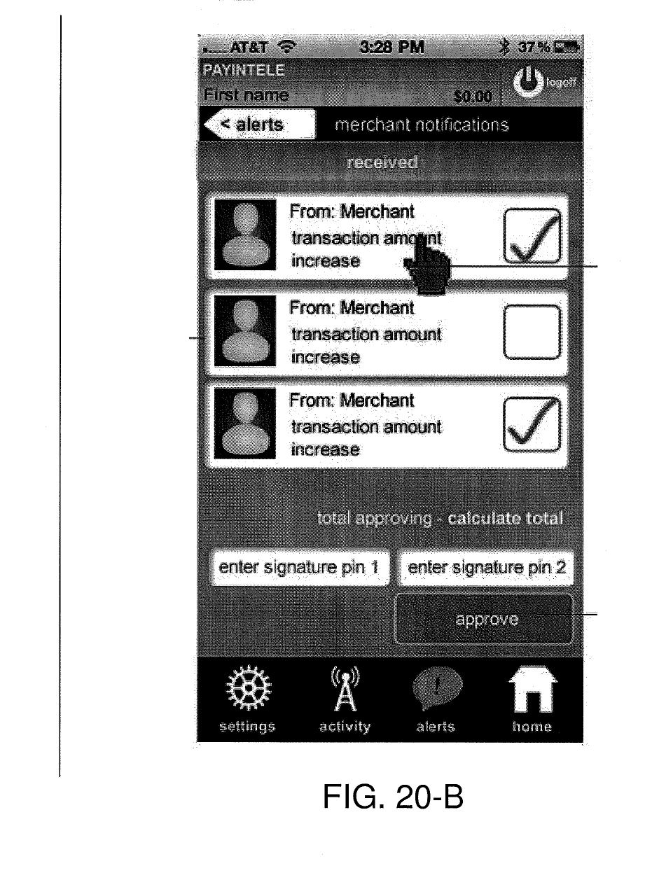

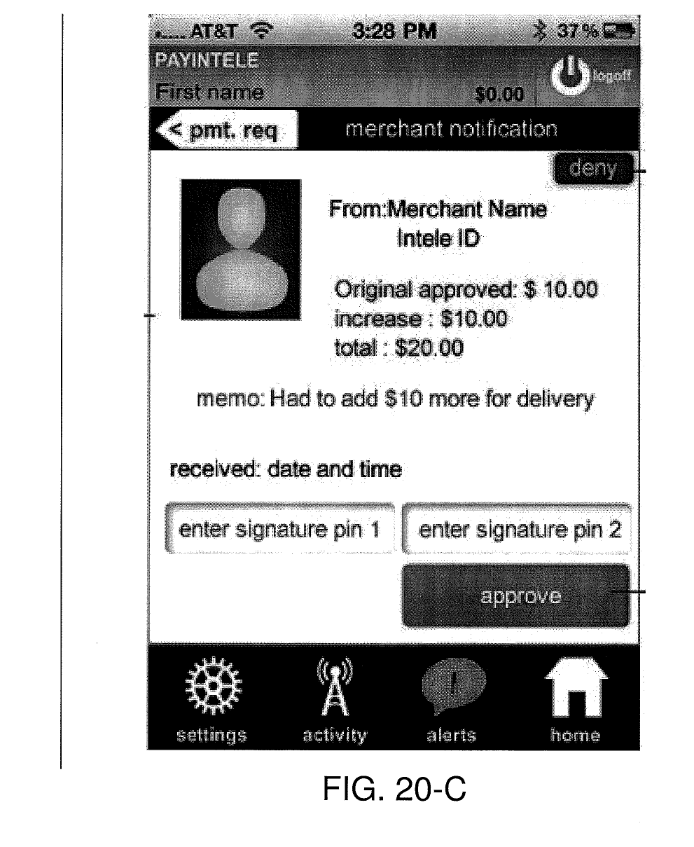

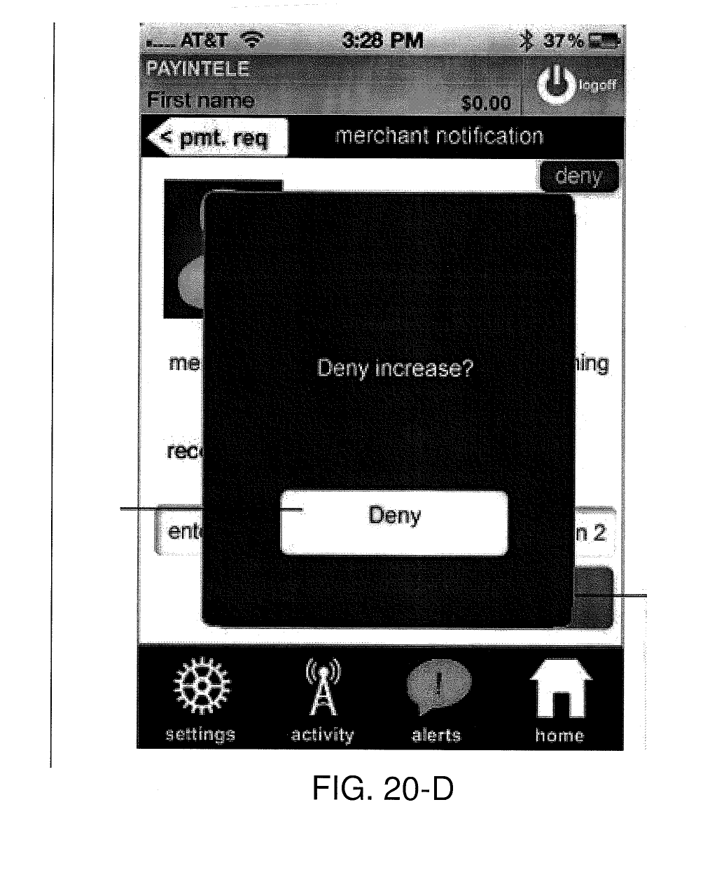

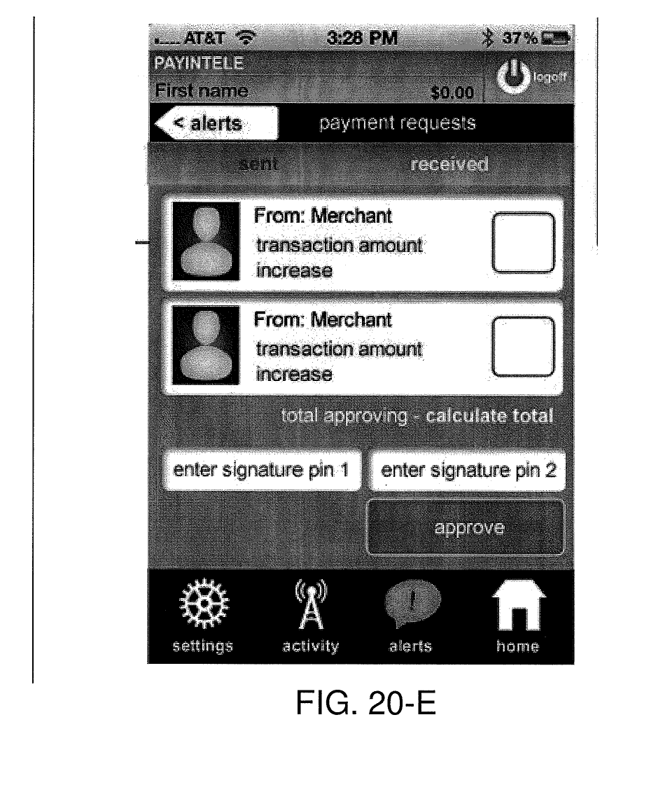

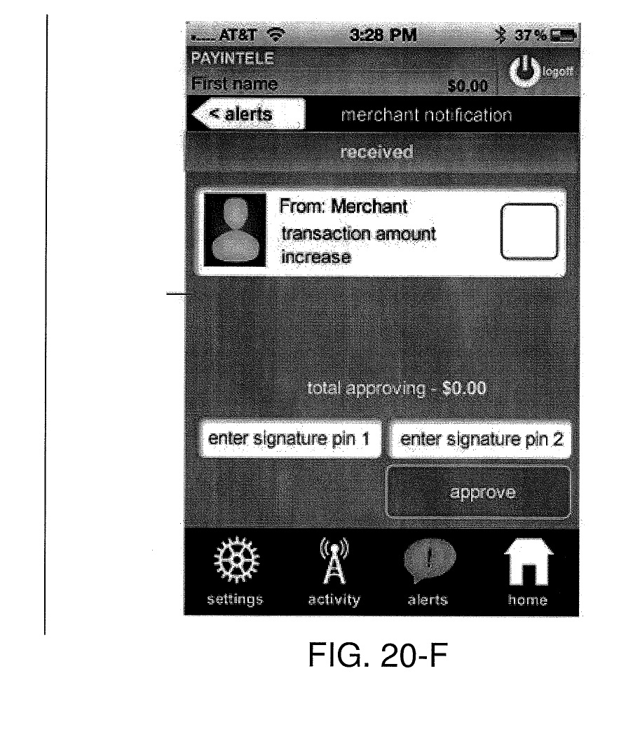

FIG. 20 illustrates a series of exemplary, self-explanatory user interface screens for a mobile device for issuing alerts in the form of authorization requests from merchants to increase a transaction amount of a previous transaction in accordance with an embodiment of the Payintele system.

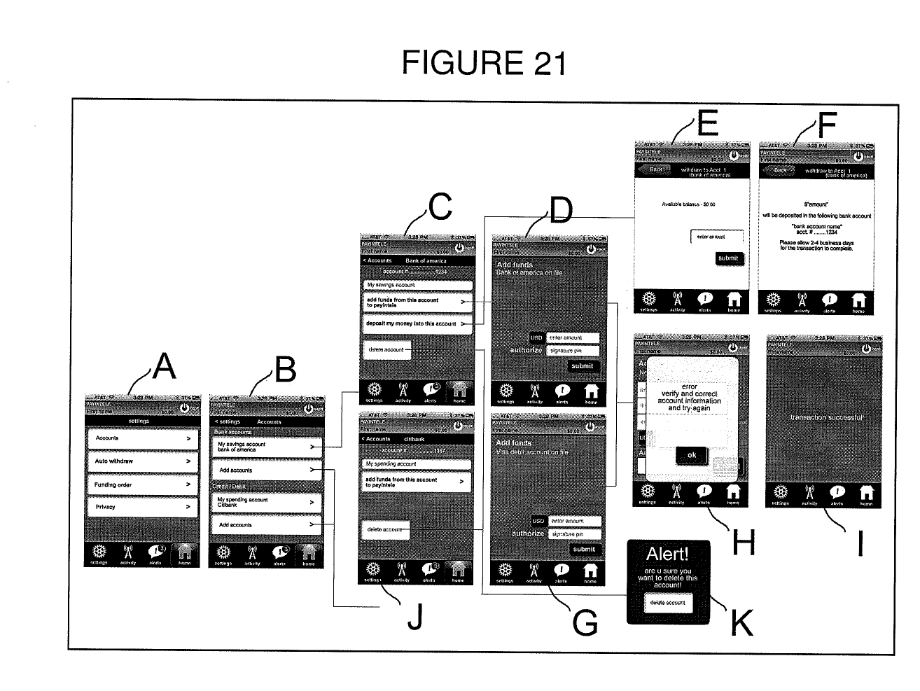

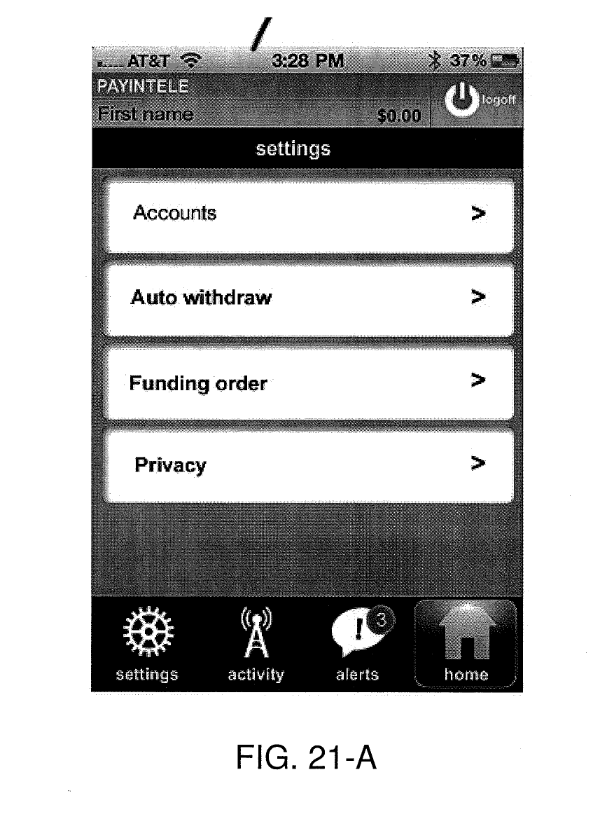

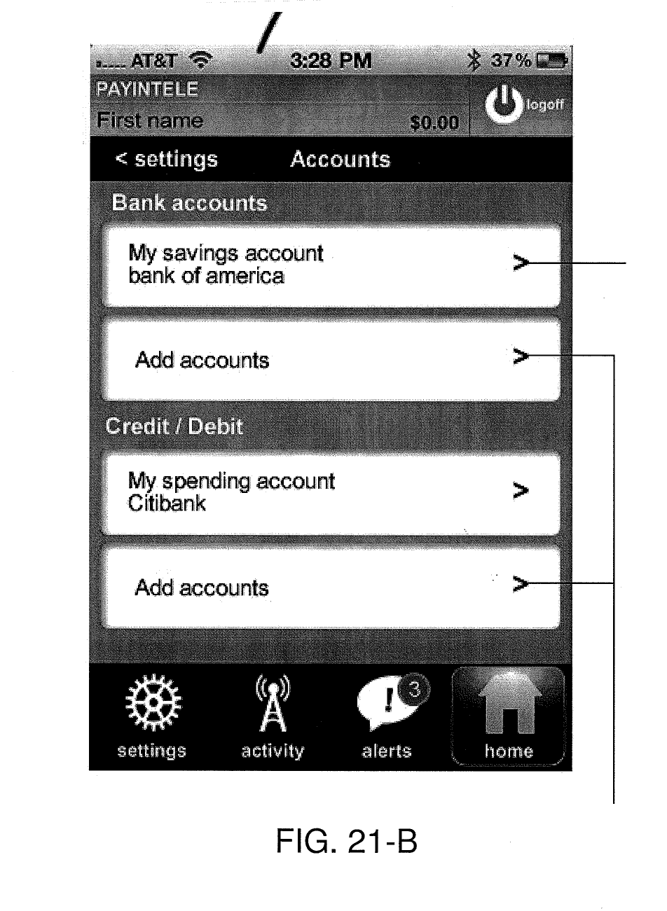

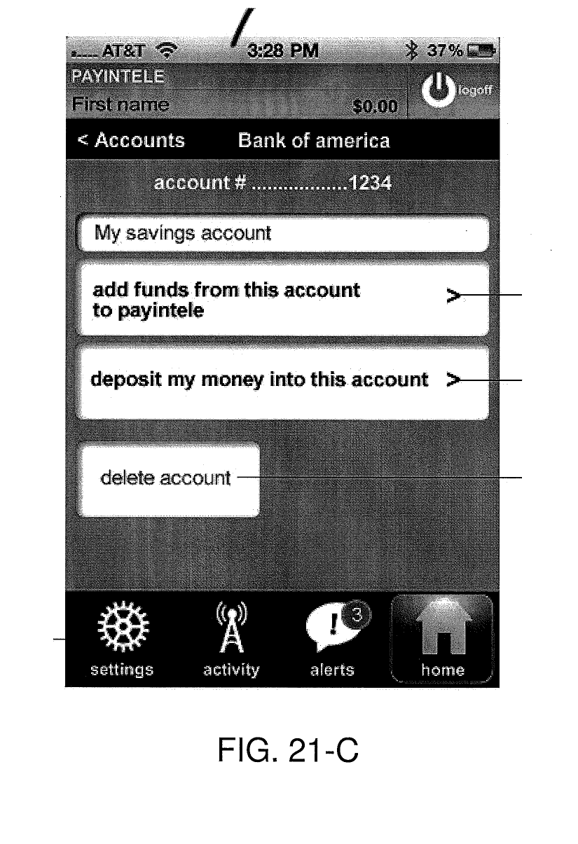

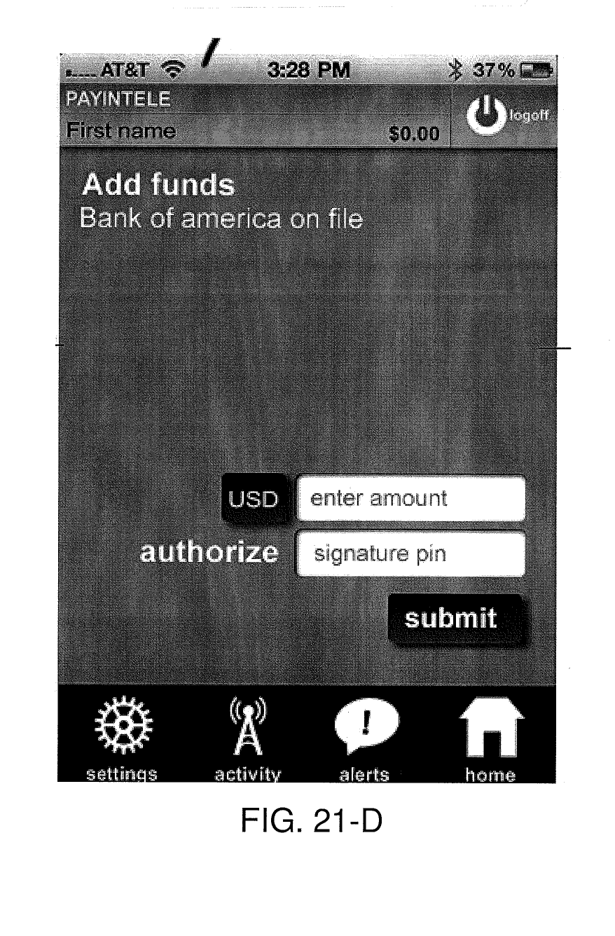

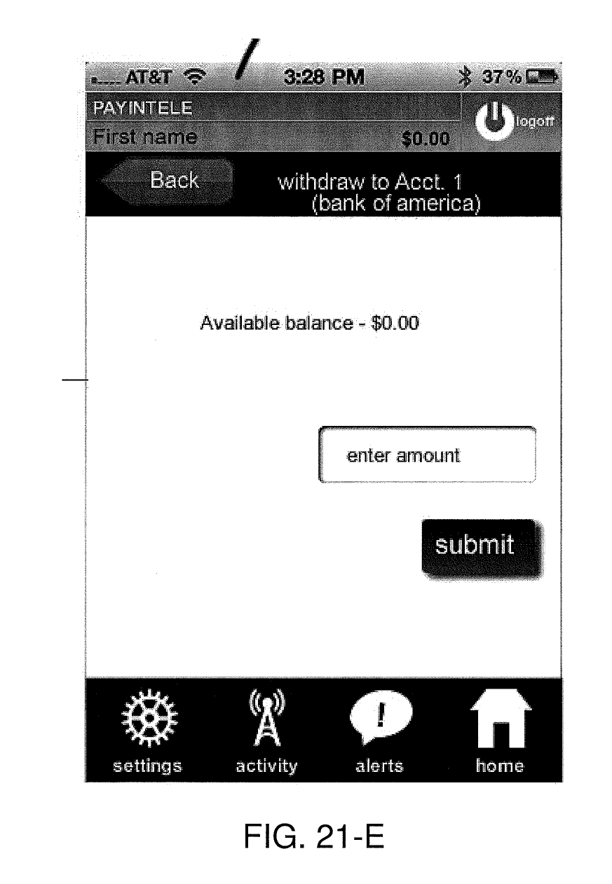

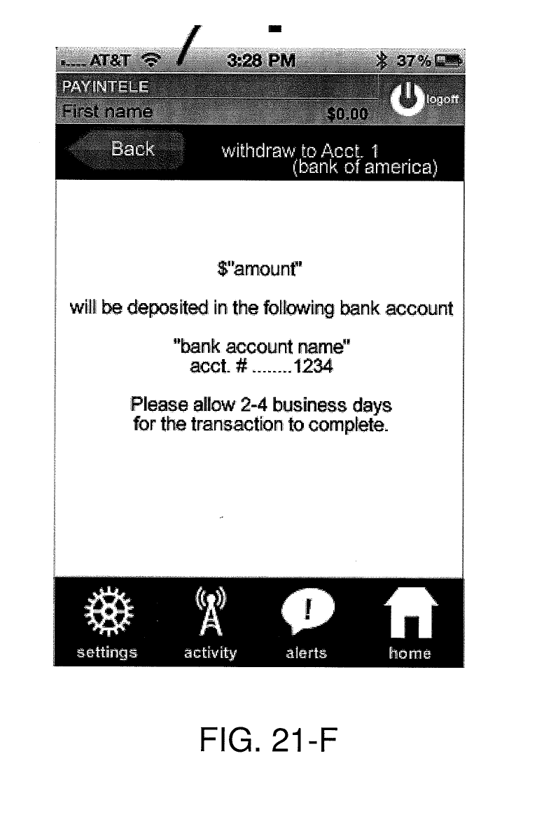

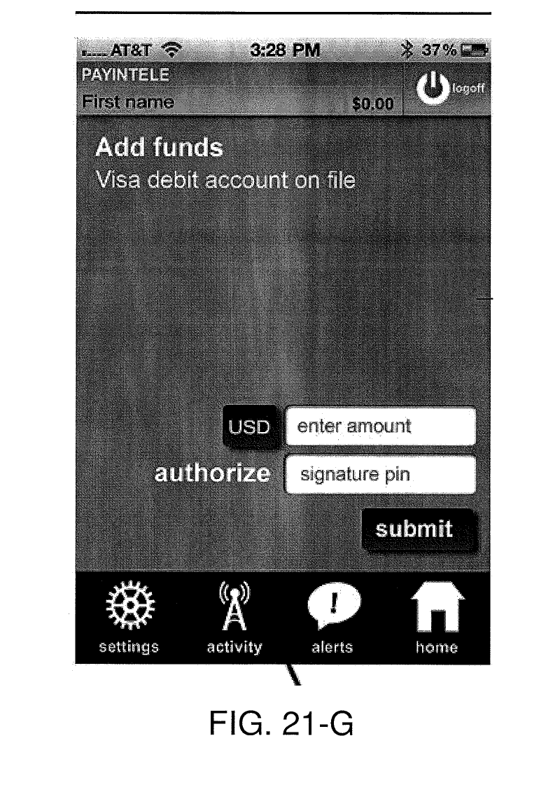

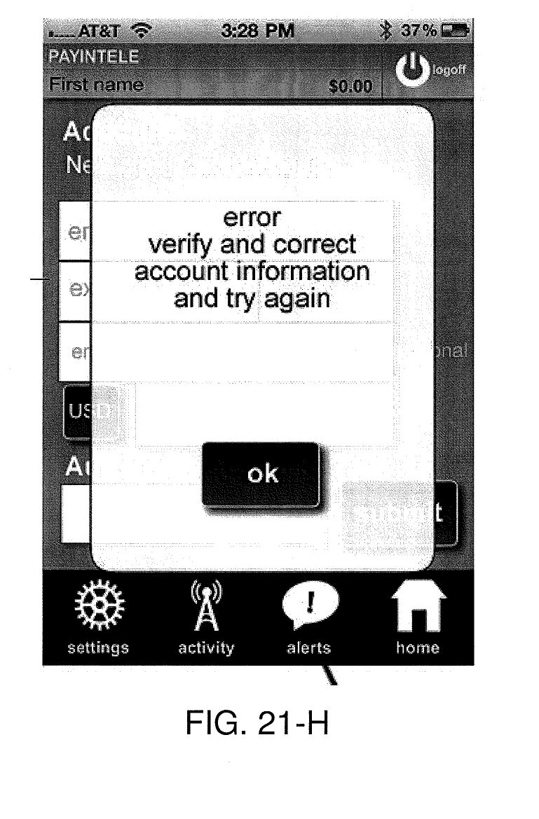

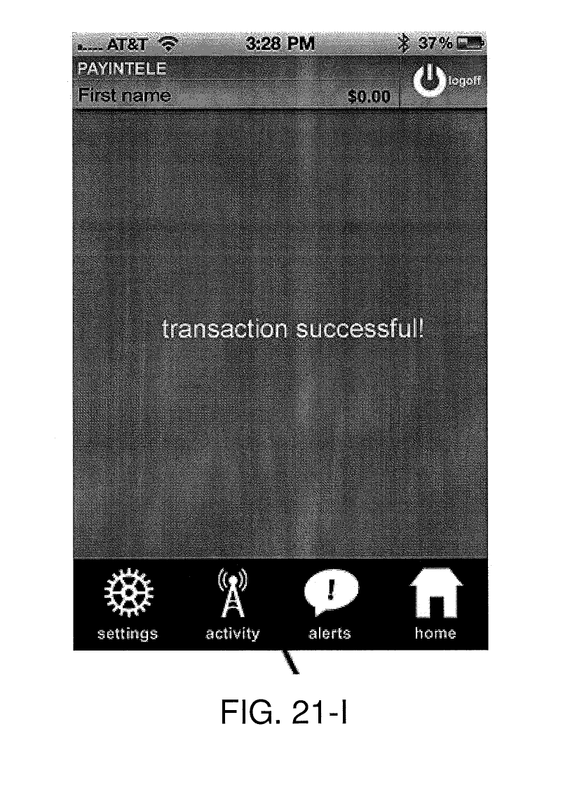

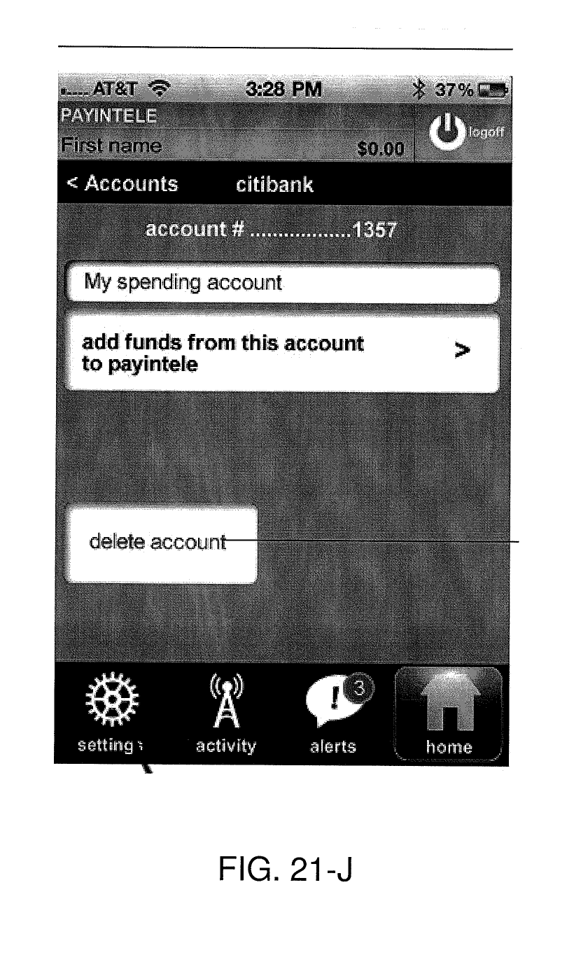

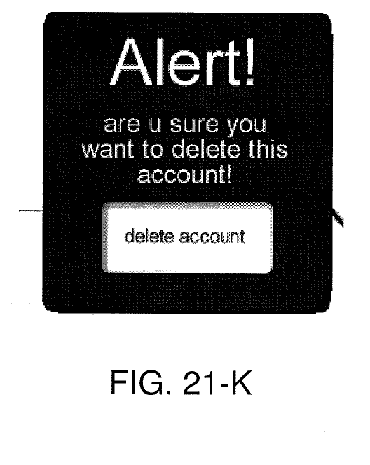

FIG. 21 illustrates a series of exemplary, self-explanatory user interface screens for a mobile device for linking external accounts to a Payintele account, managing external account settings, and adding funds from linked accounts in accordance with an embodiment of the Payintele system.

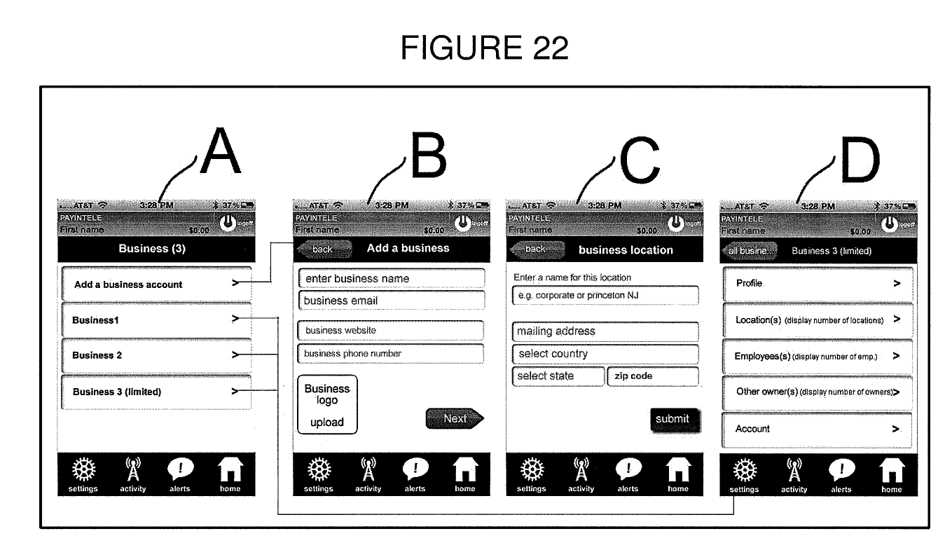

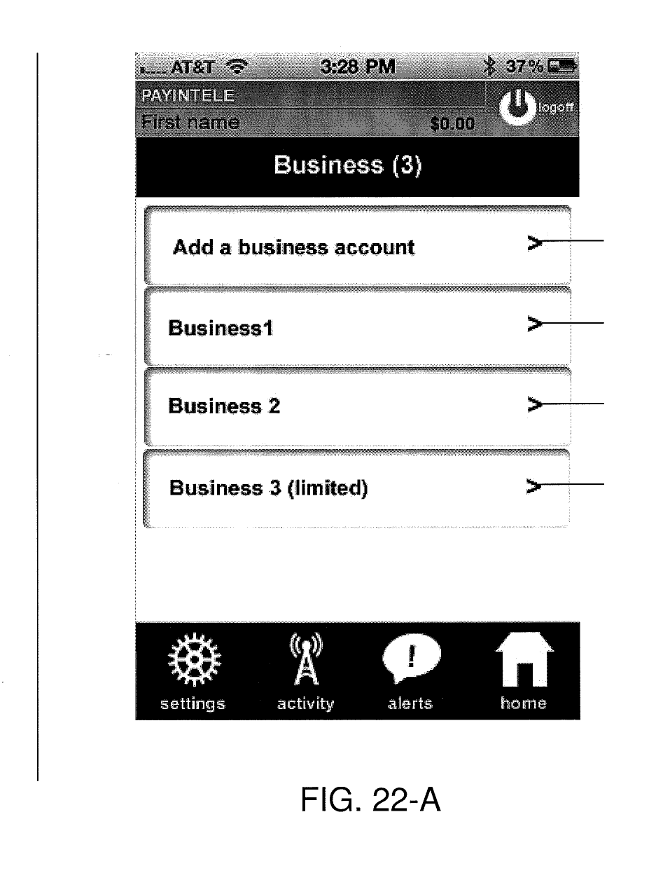

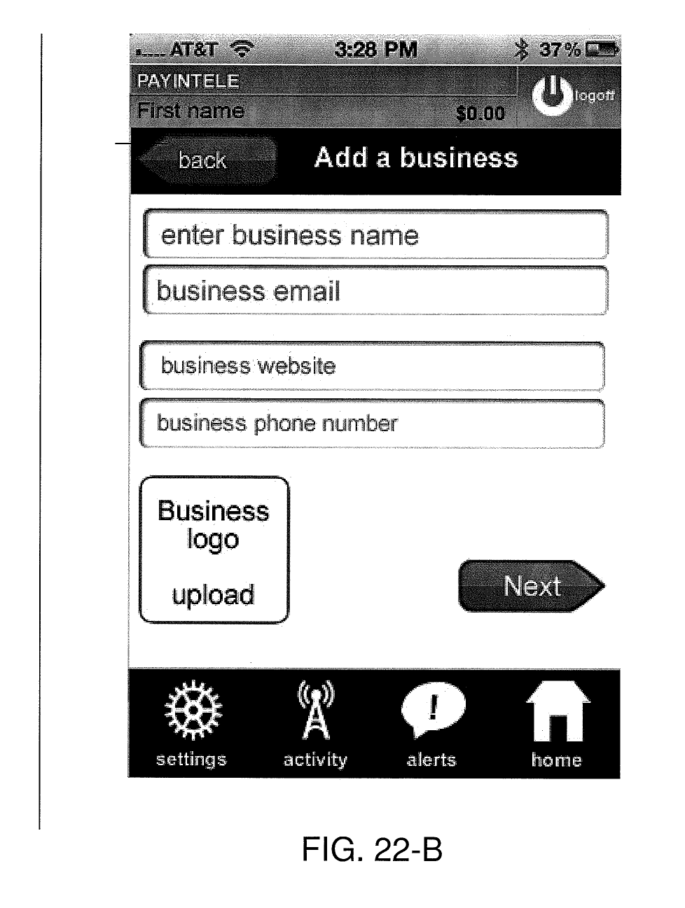

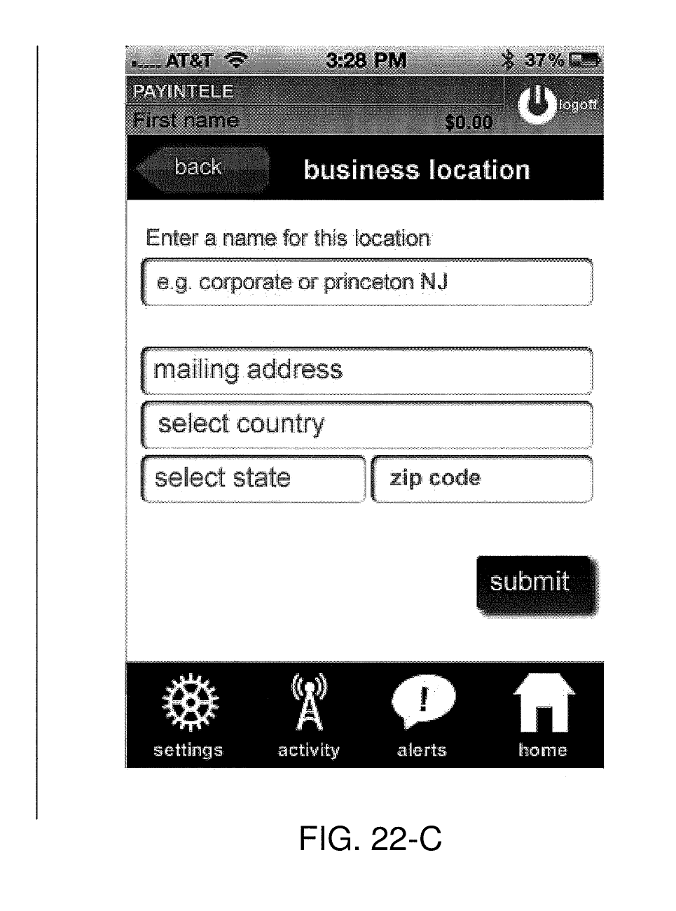

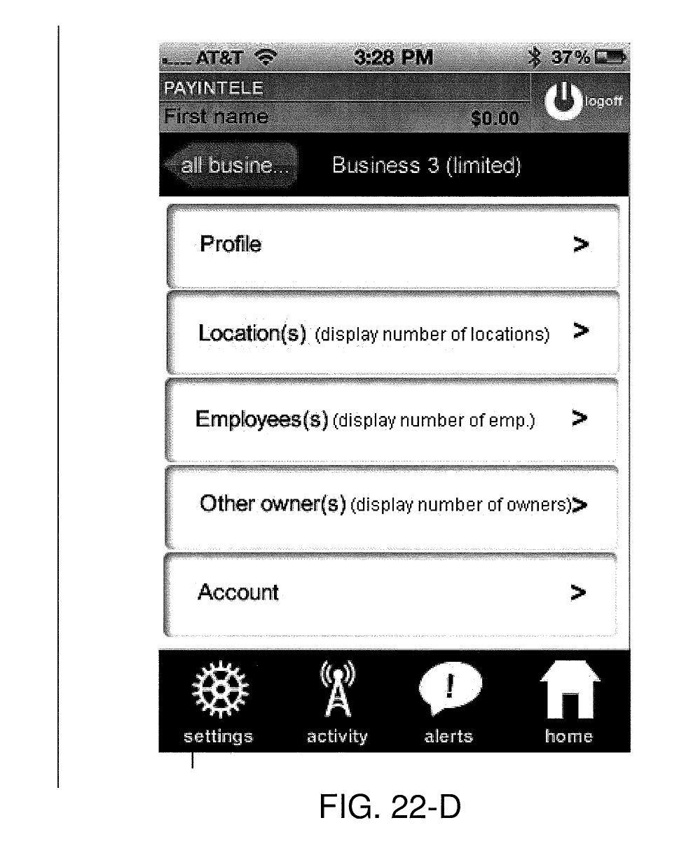

FIG. 22 illustrates a series of exemplary, self-explanatory user interface screens for a mobile device for adding a new business account associated with a Payintele account in accordance with an embodiment of the Payintele system.

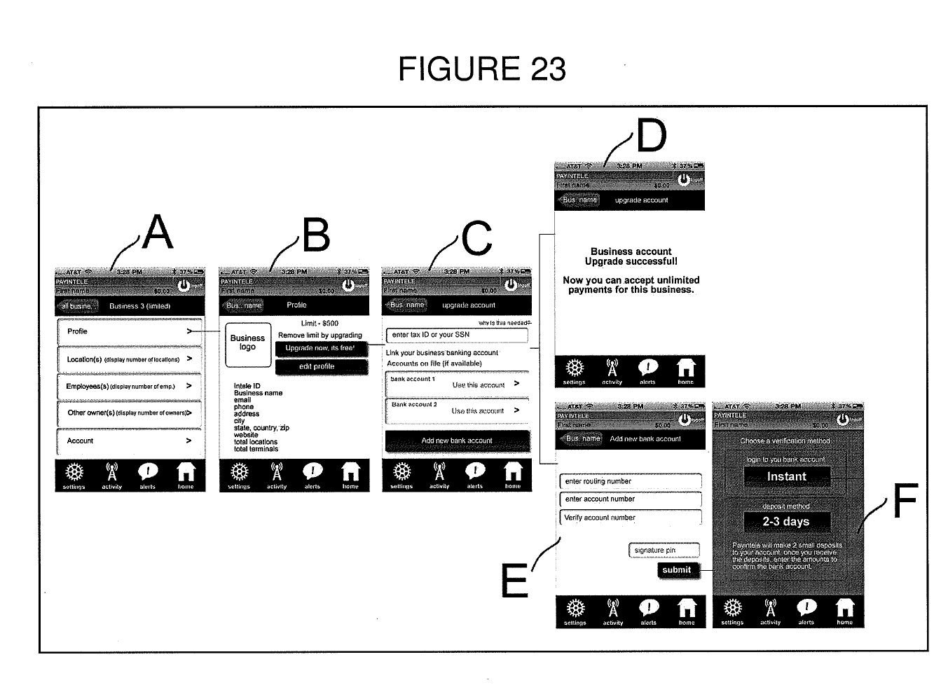

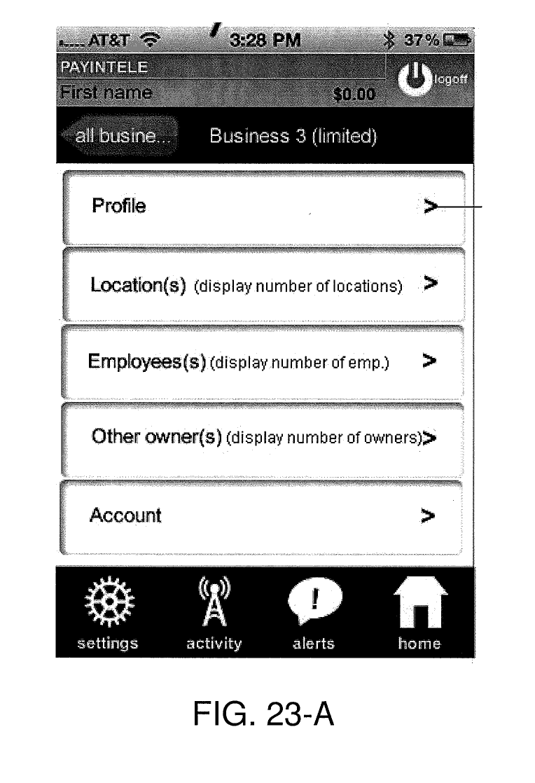

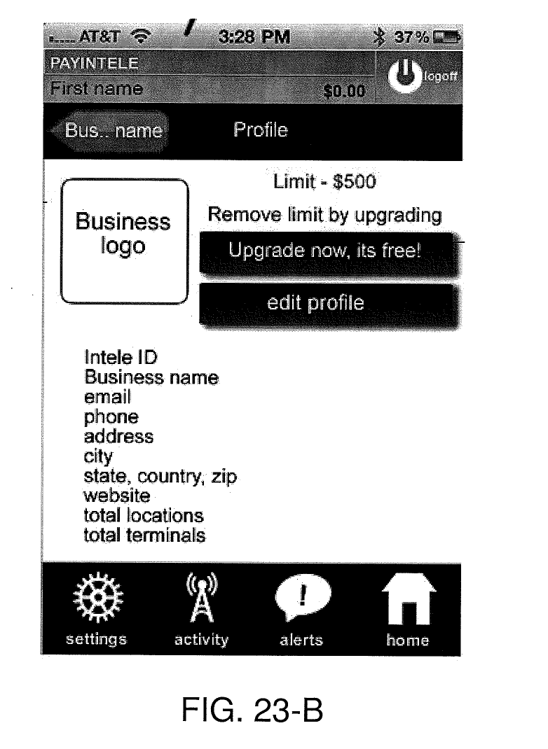

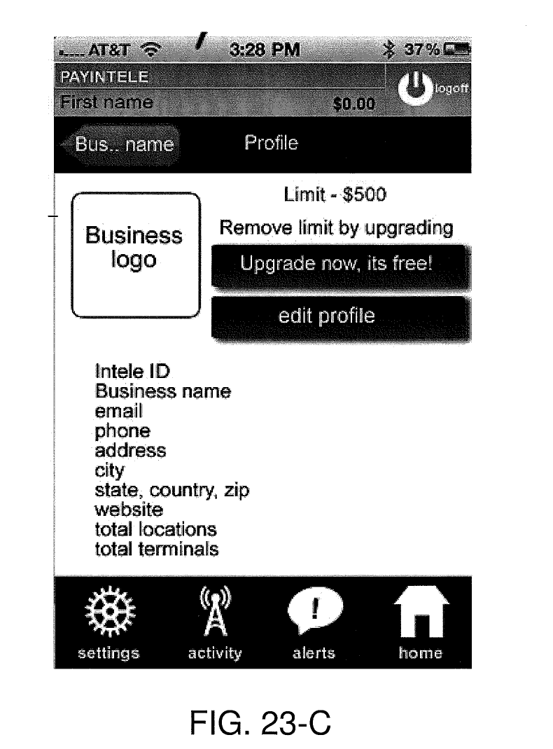

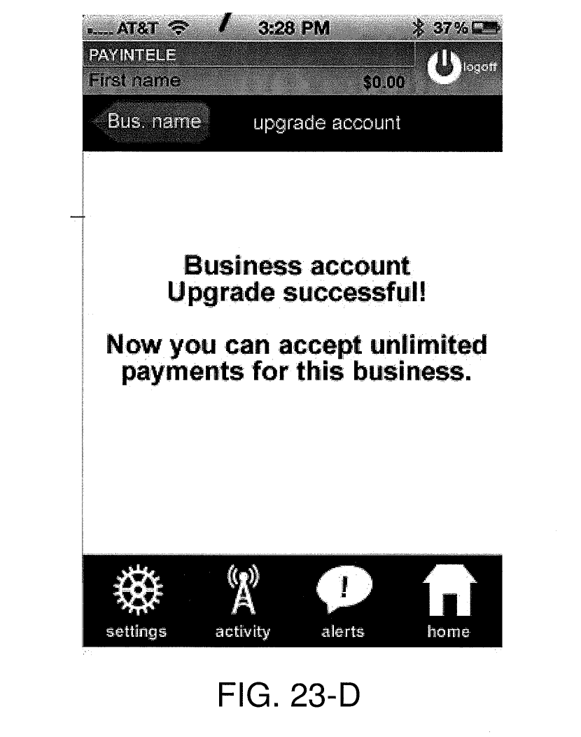

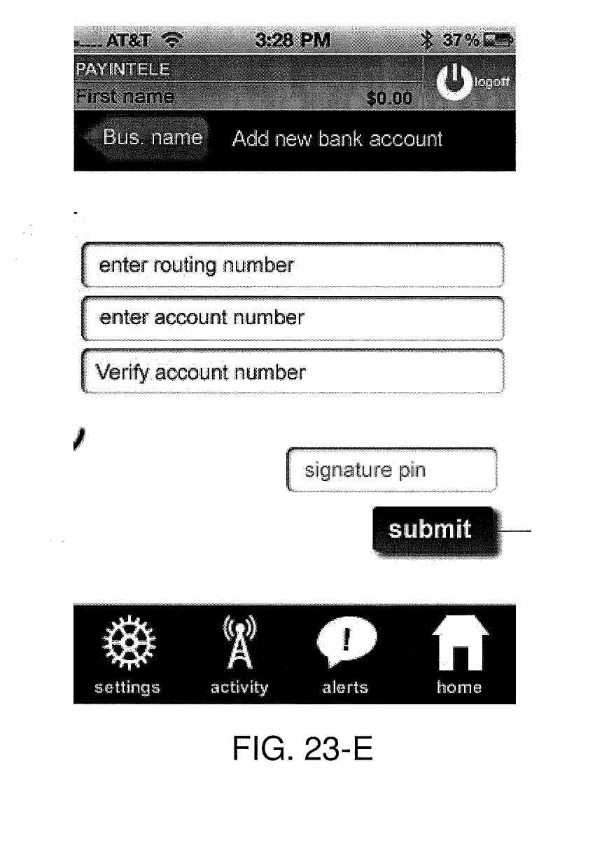

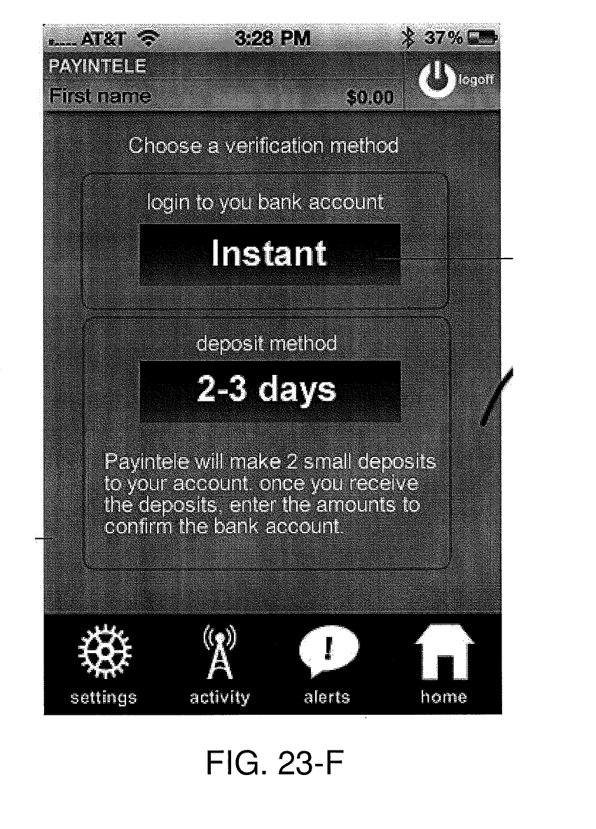

FIG. 23 illustrates a series of exemplary, self-explanatory user interface screens for a mobile device for creating a business profile and management interface, upgrading account status, and adding bank accounts in accordance with an embodiment of the Payintele system.

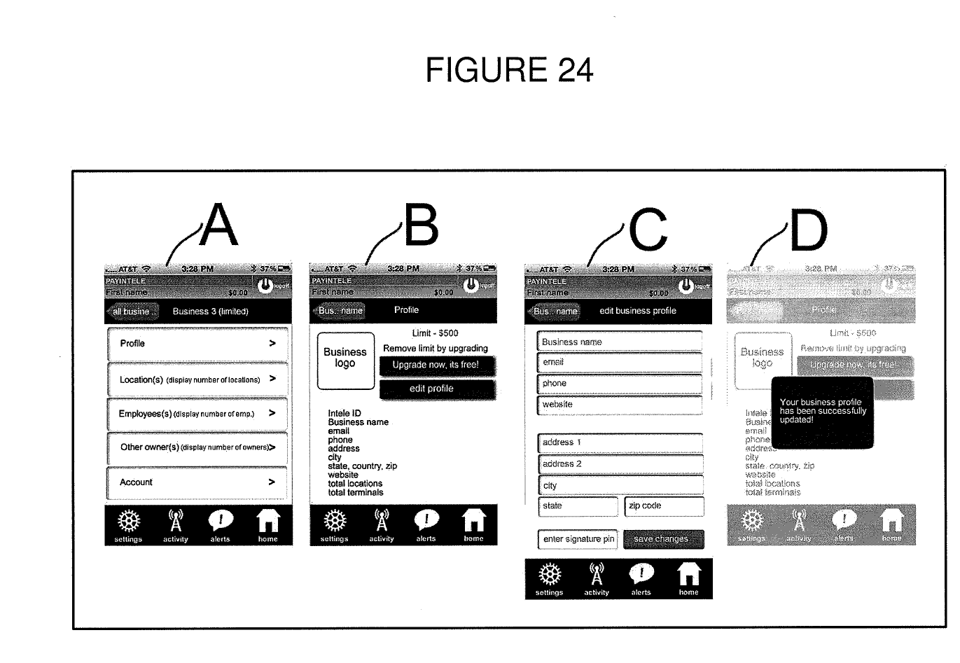

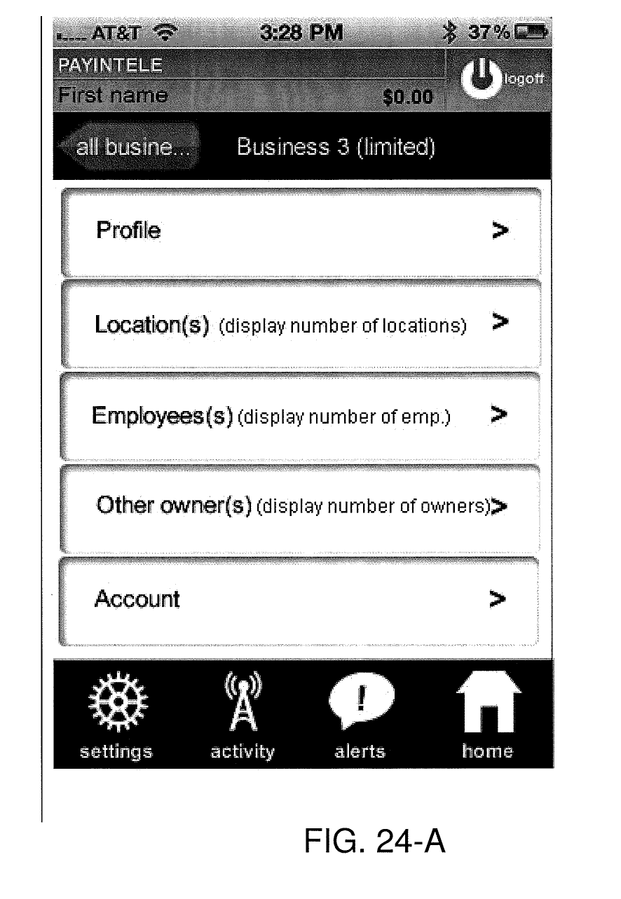

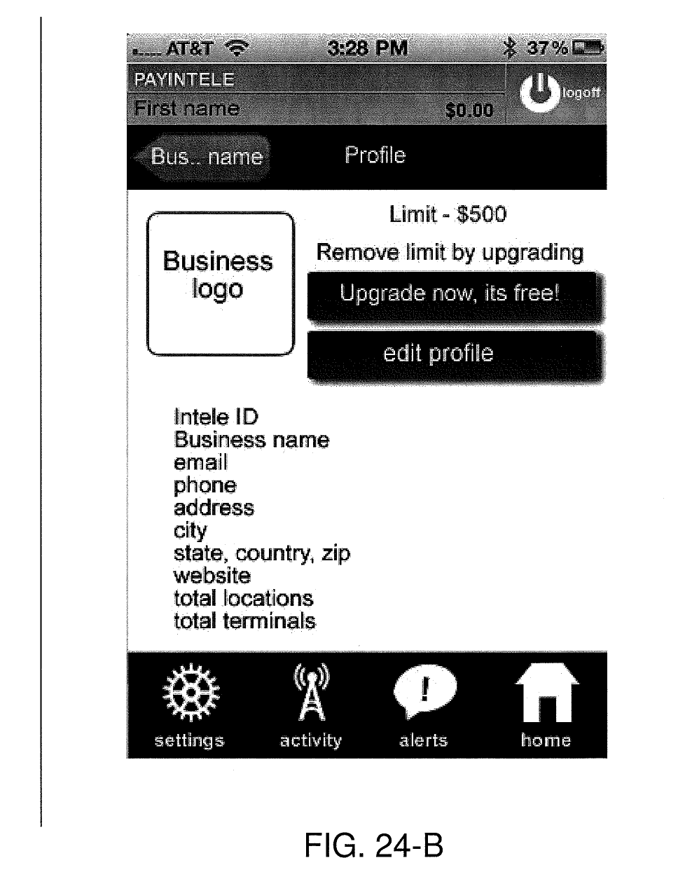

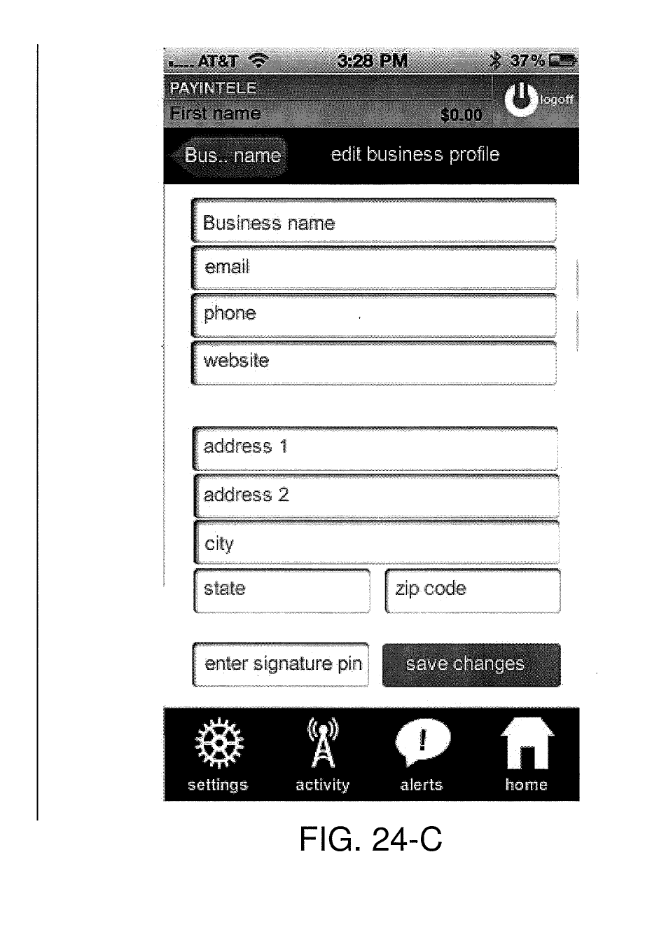

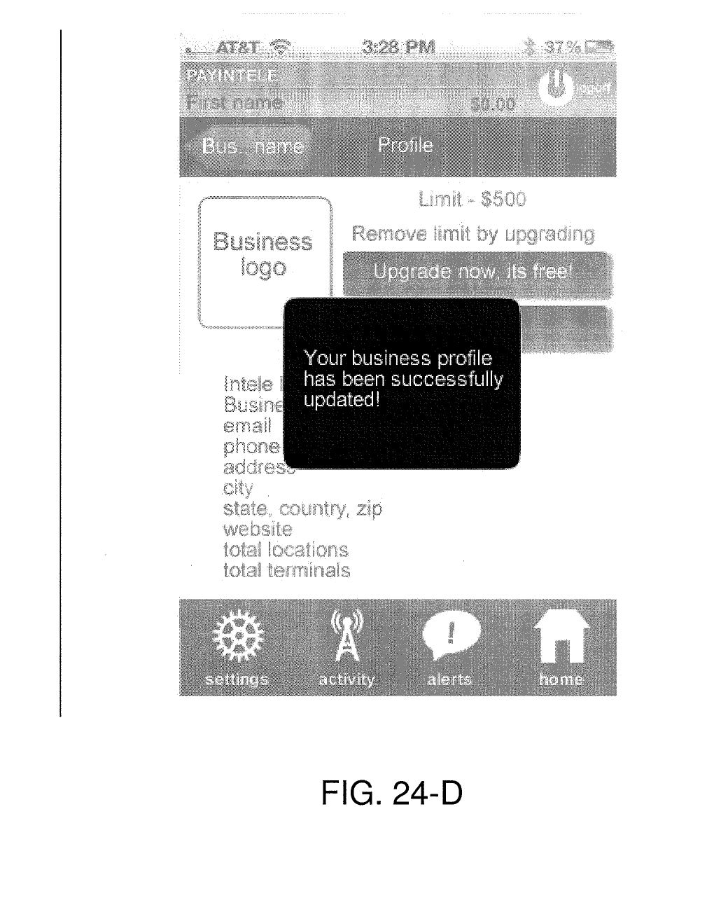

FIG. 24 illustrates a series of exemplary, self-explanatory user interface screens for a mobile device for editing a business profile interface in accordance with an embodiment of the Payintele system.

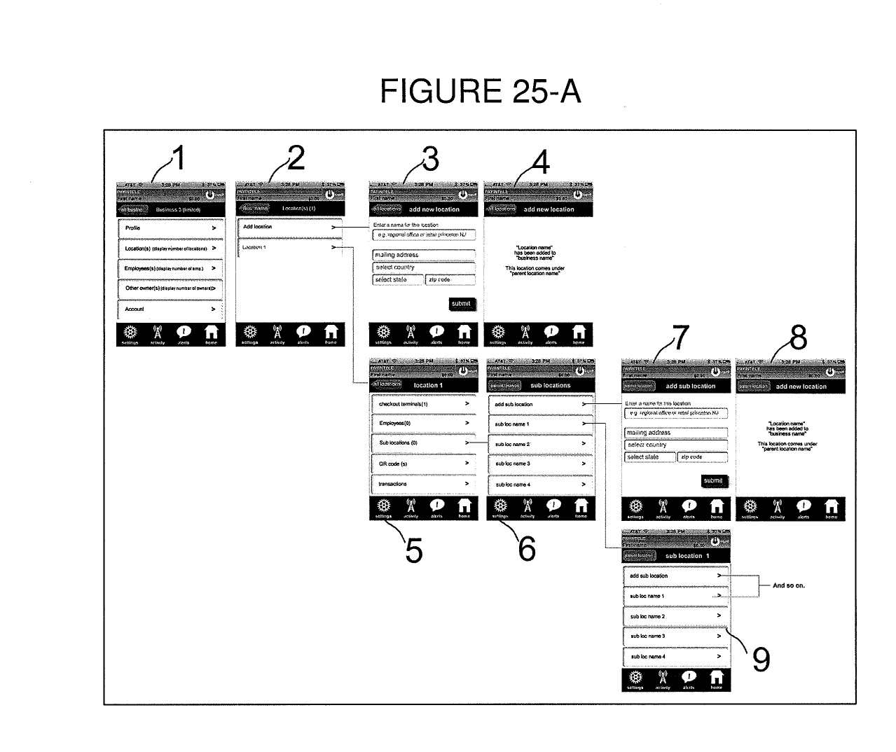

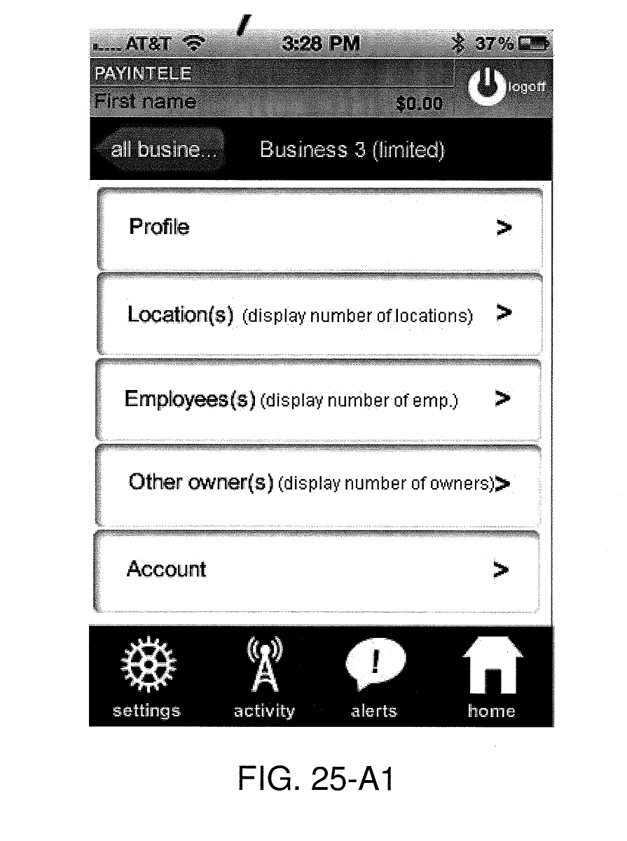

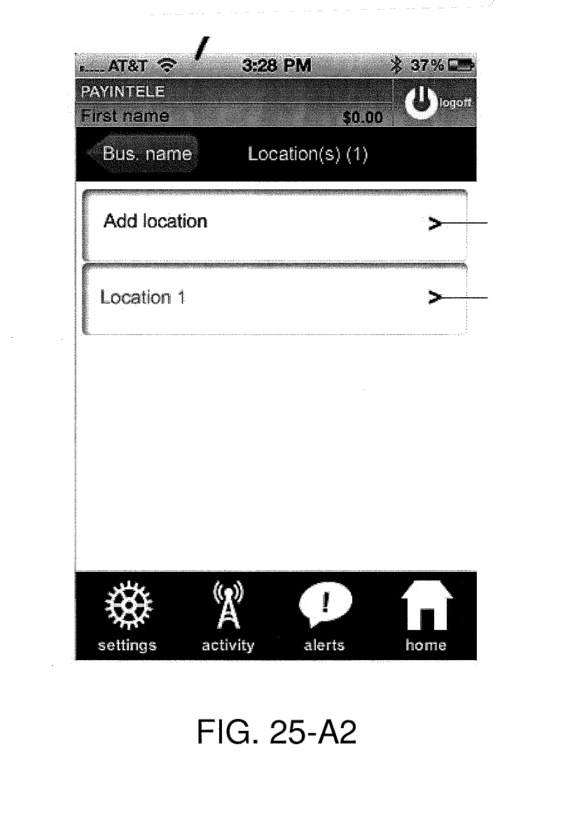

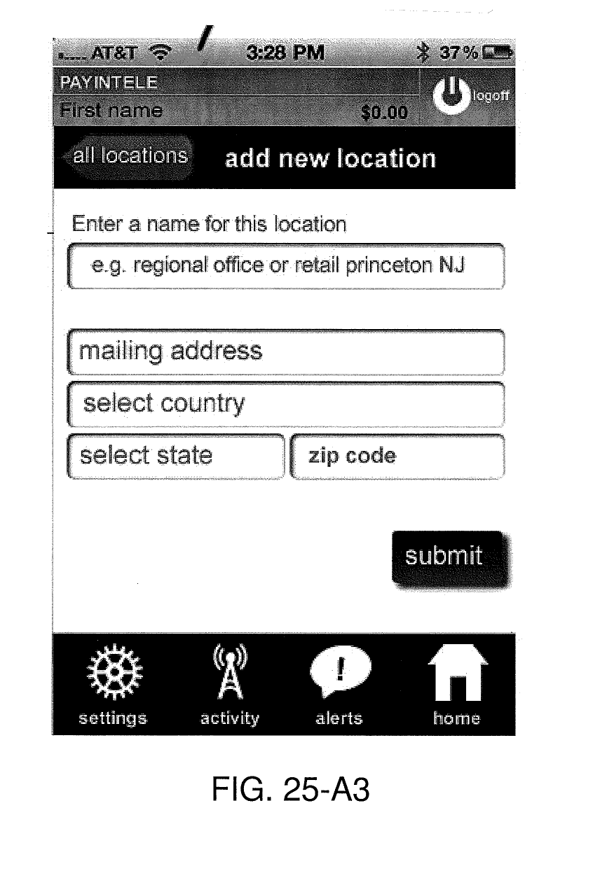

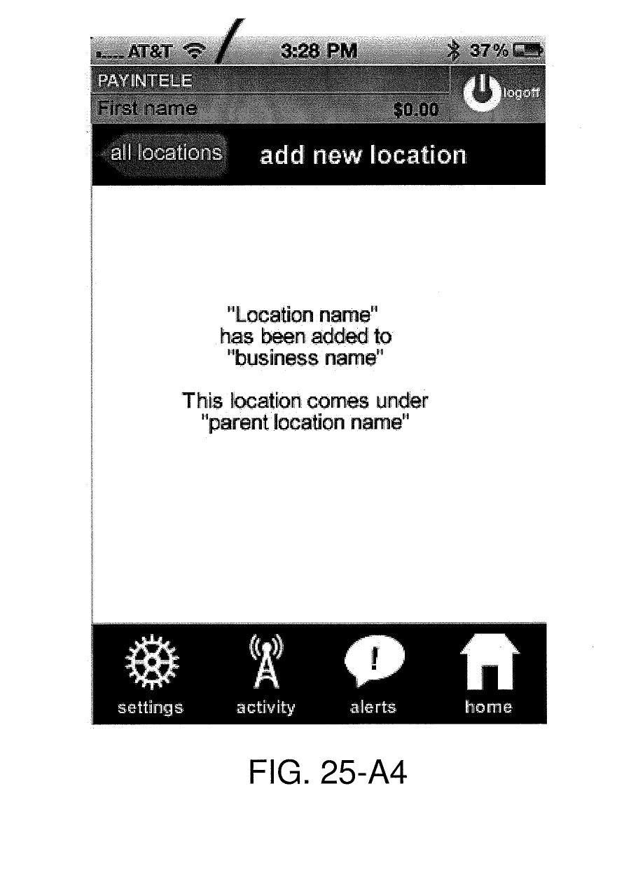

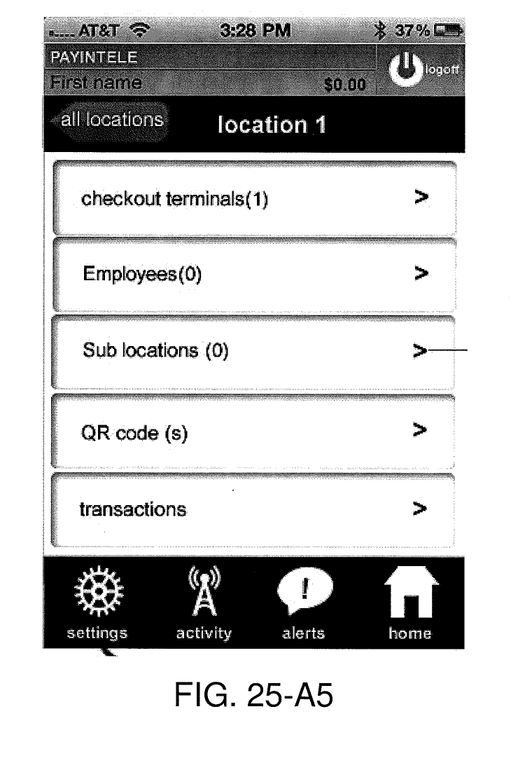

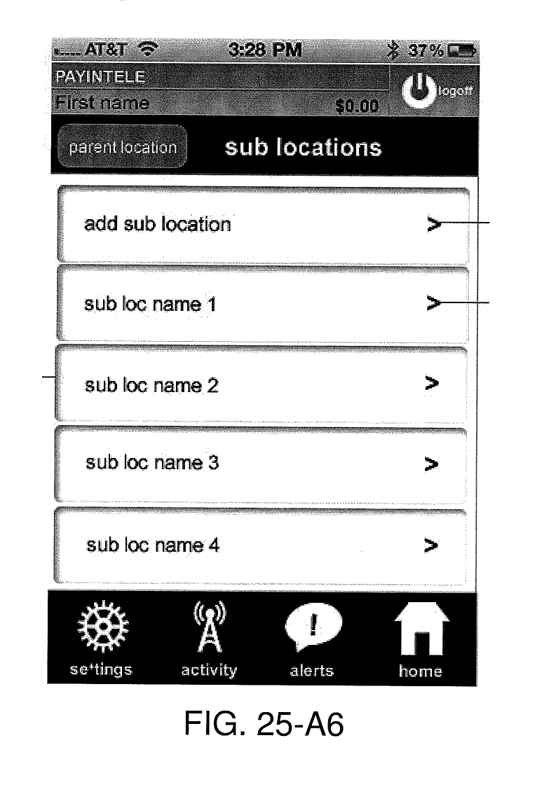

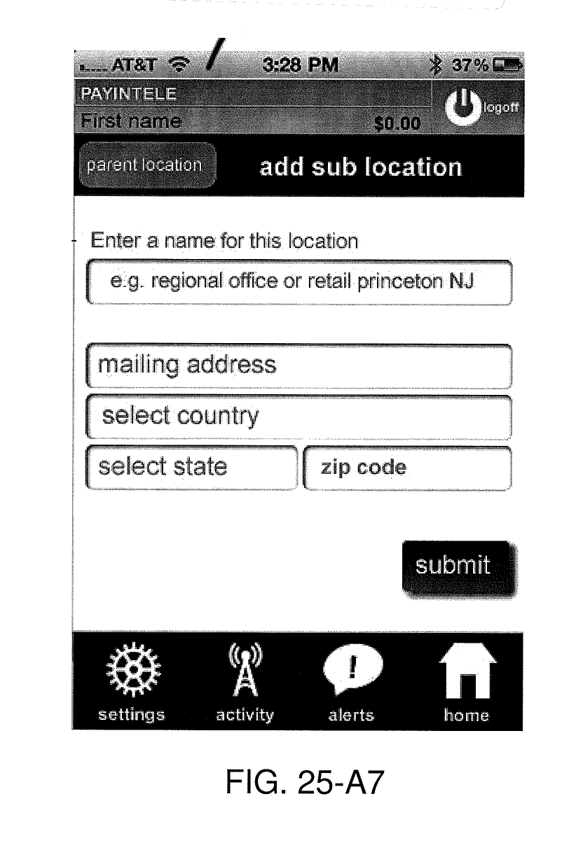

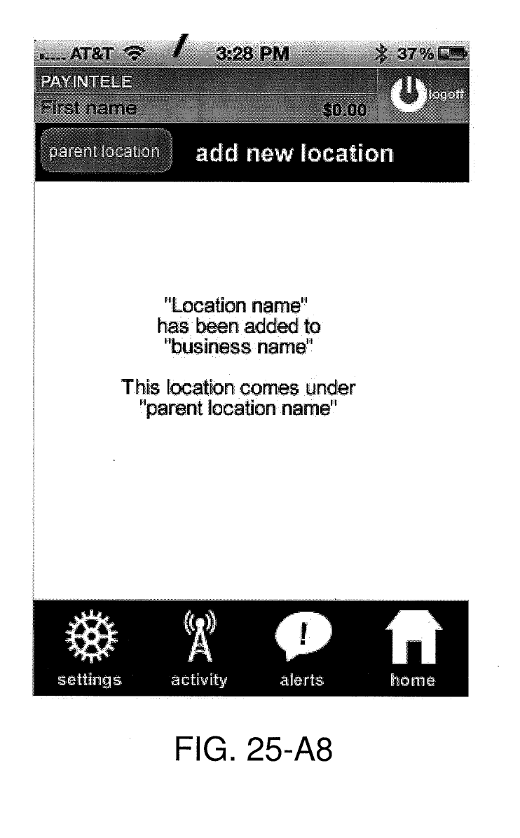

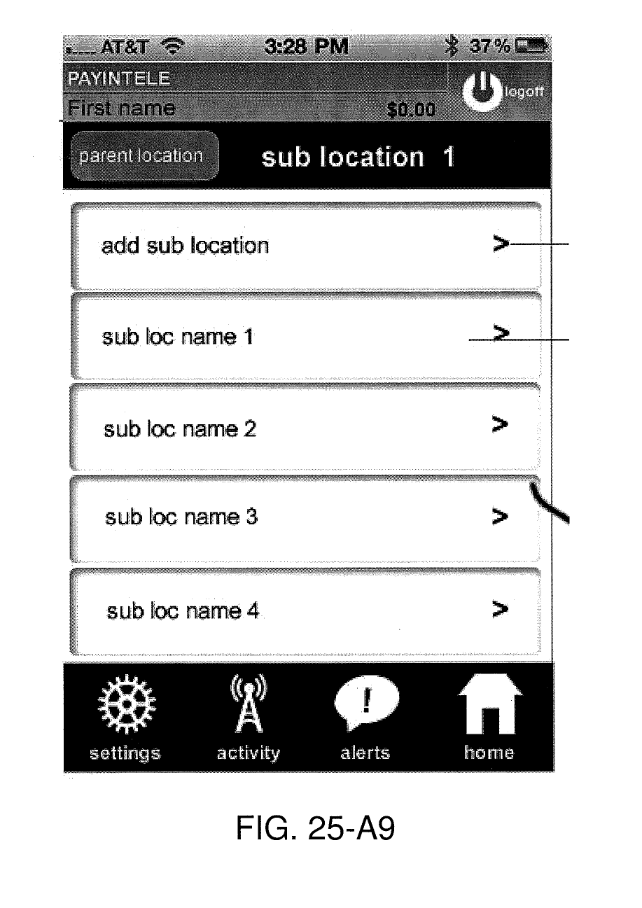

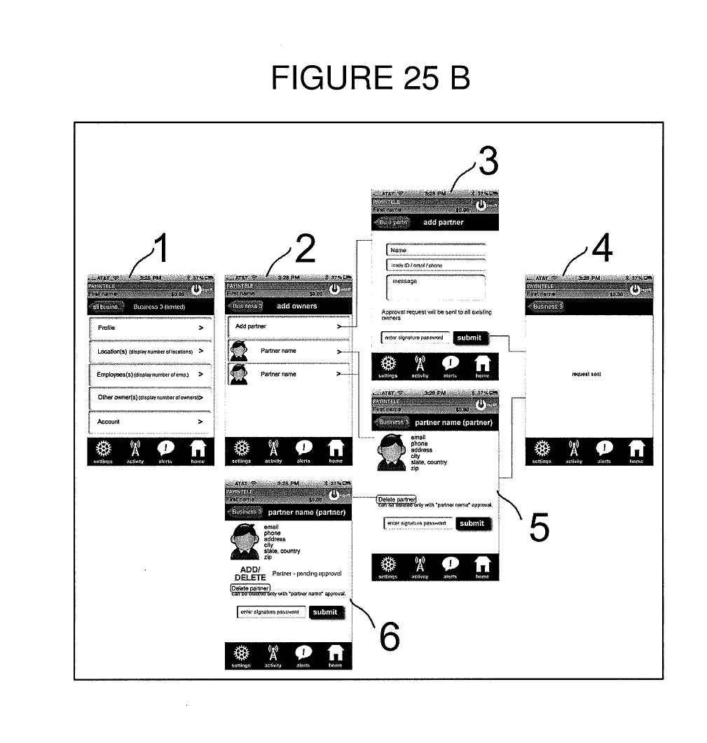

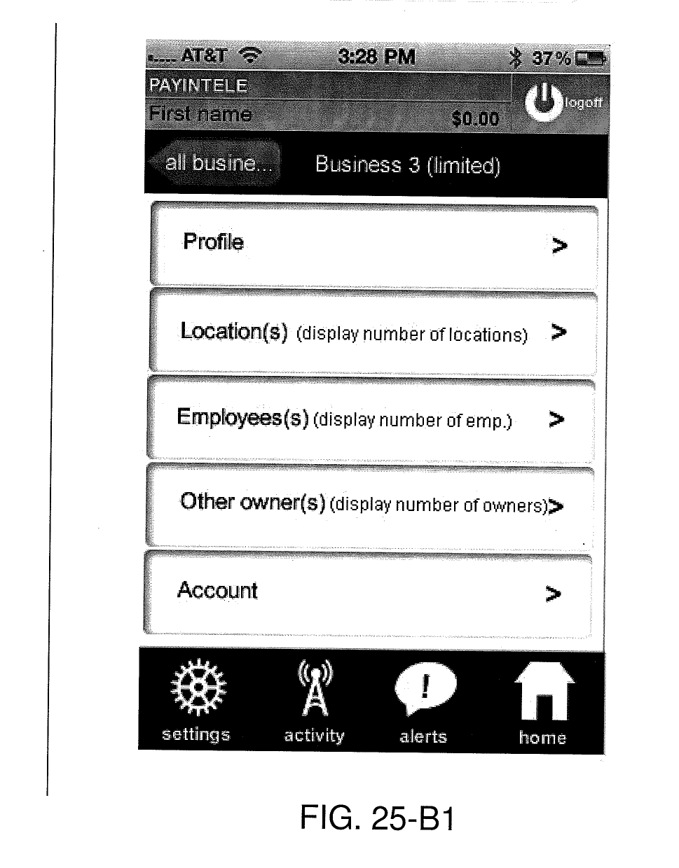

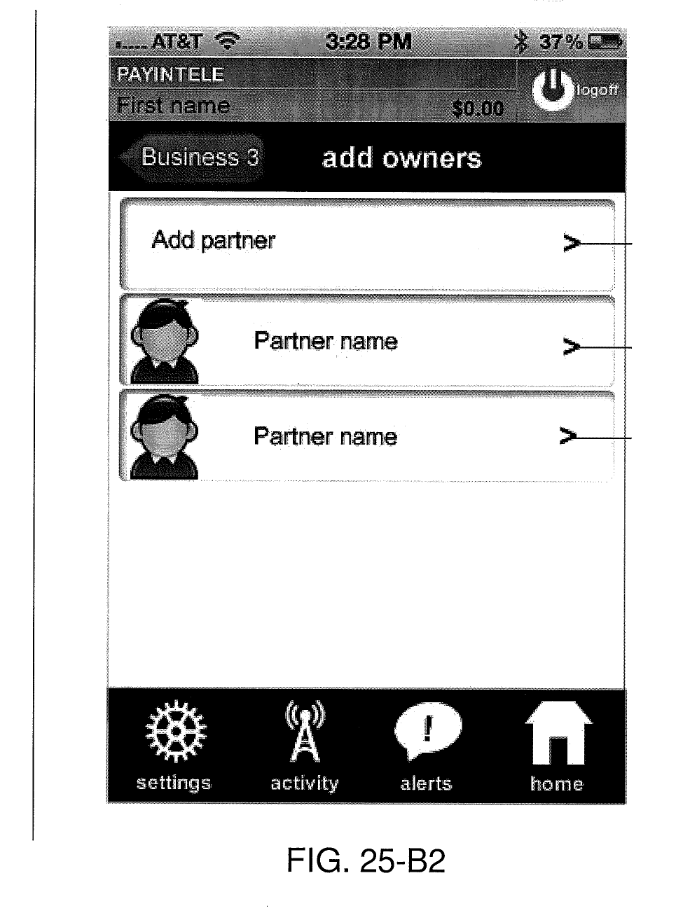

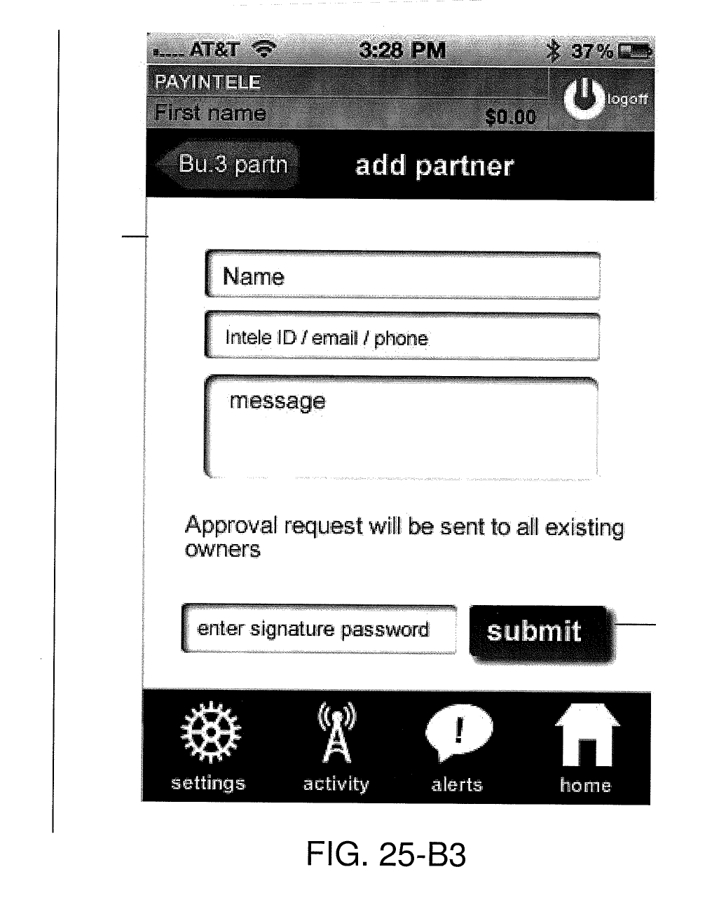

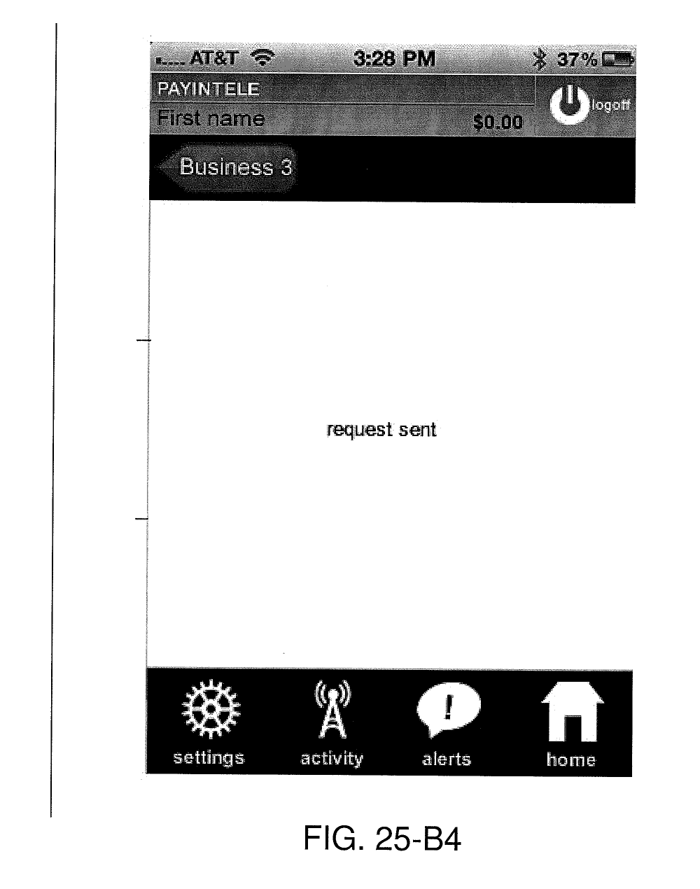

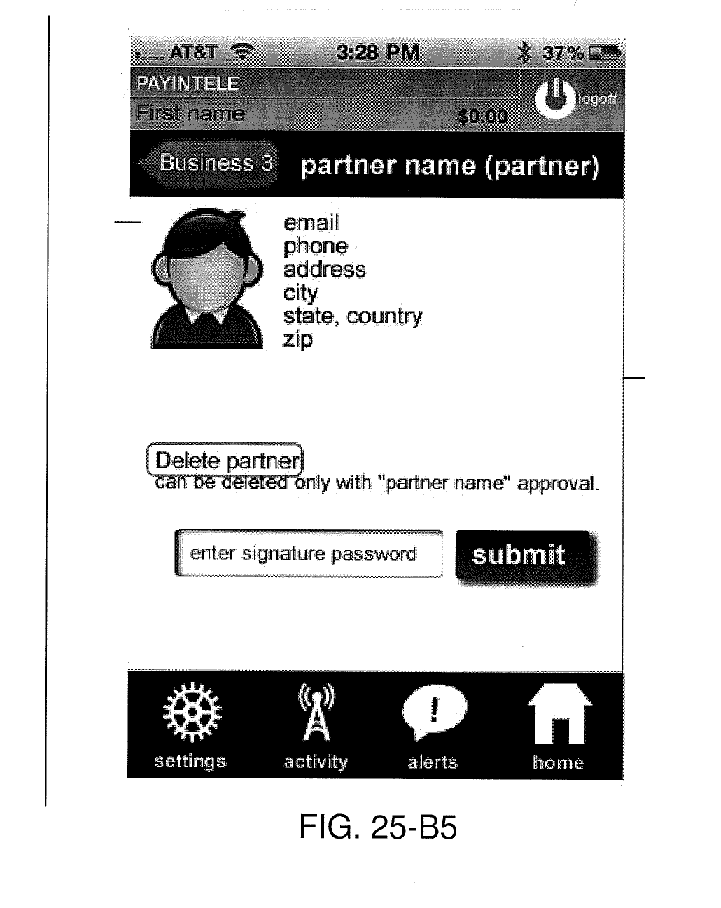

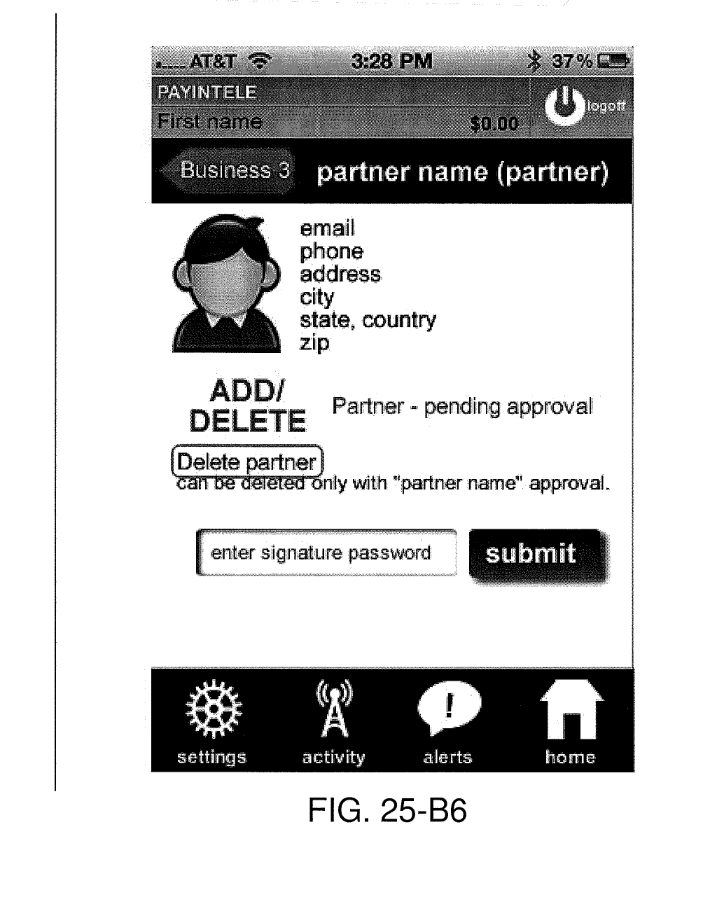

FIG. 25A illustrates a series of exemplary, self-explanatory user interface screens for a mobile device for adding a new business location, or sublocation in an existing business account in accordance with an embodiment of the Payintele system.

FIG. 25B illustrates a series of exemplary, self-explanatory user interface screens for a mobile device for adding business partners or additional account owners in accordance with an embodiment of the Payintele system.

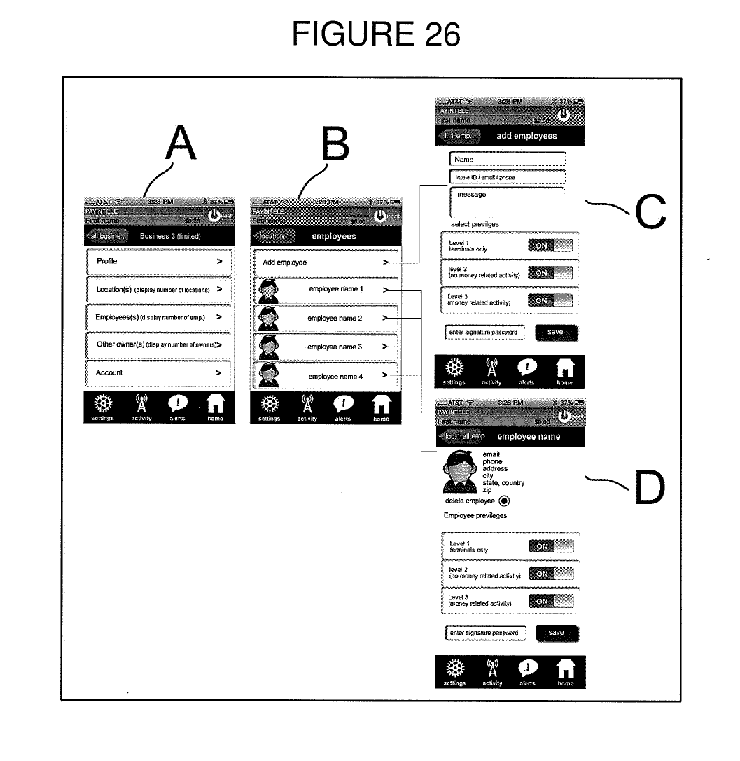

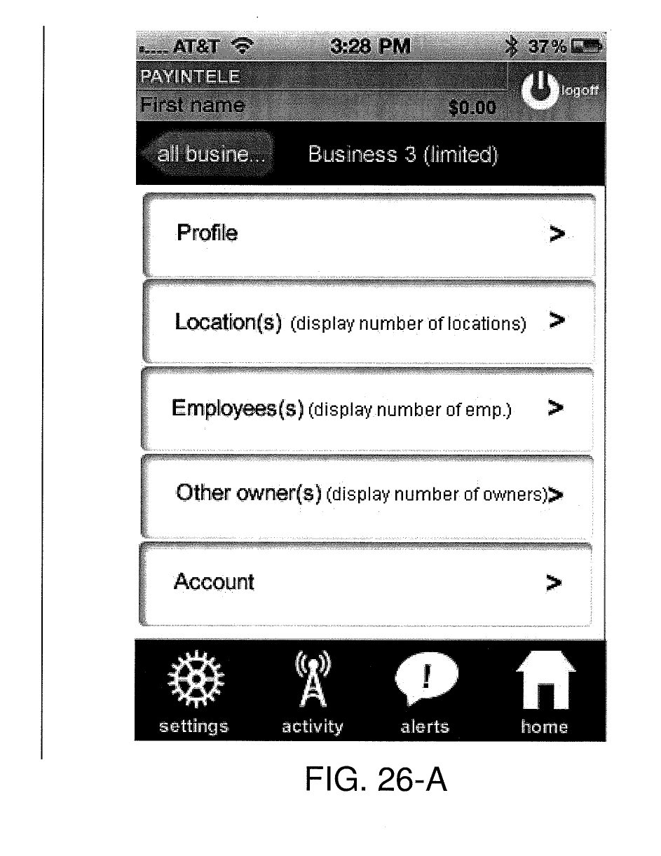

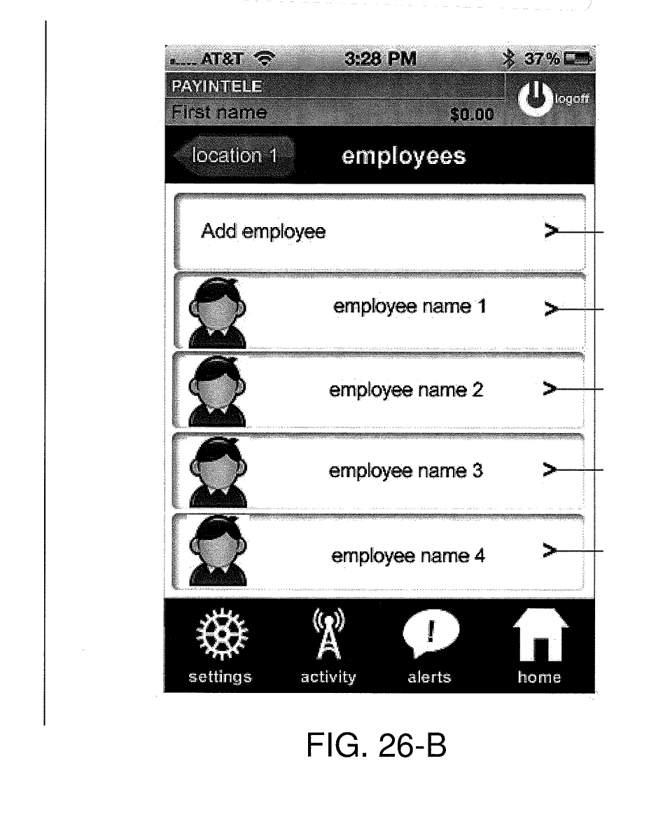

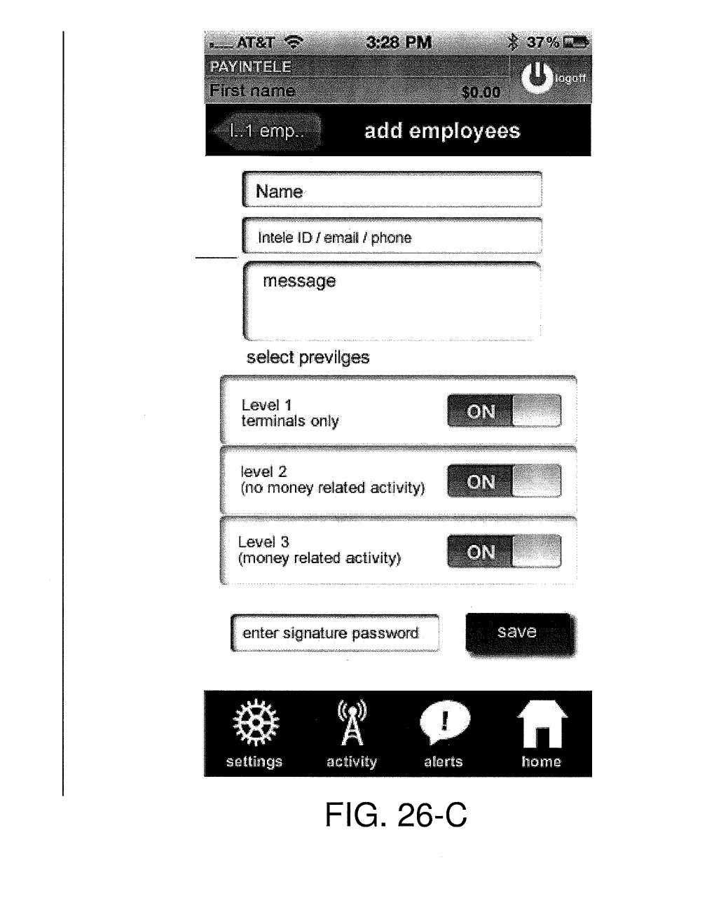

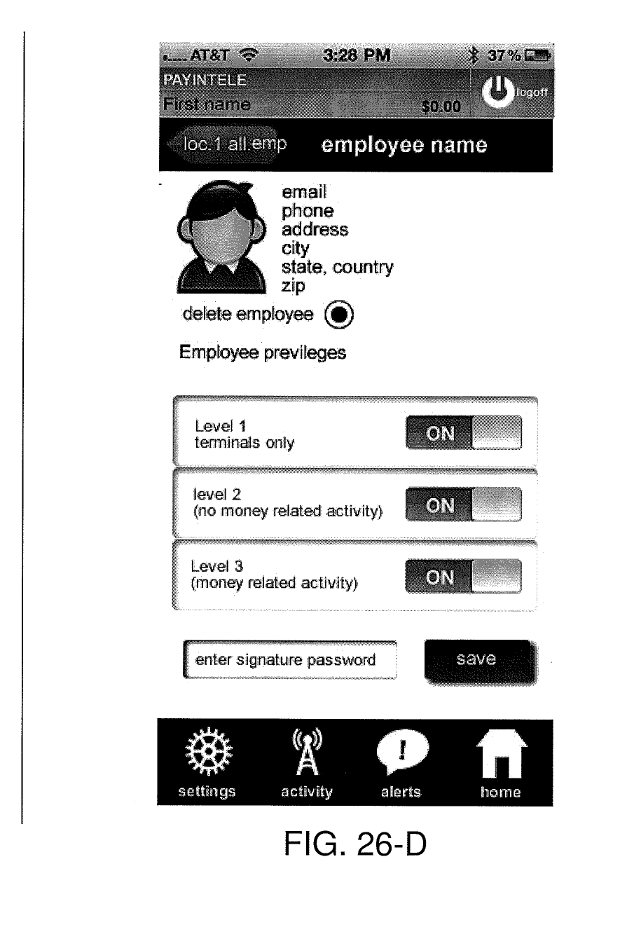

FIG. 26 illustrates a series of exemplary, self-explanatory user interface screens for a mobile device for adding employees to business accounts and/or subaccounts and managing employee privileges in accordance with an embodiment of the Payintele system.

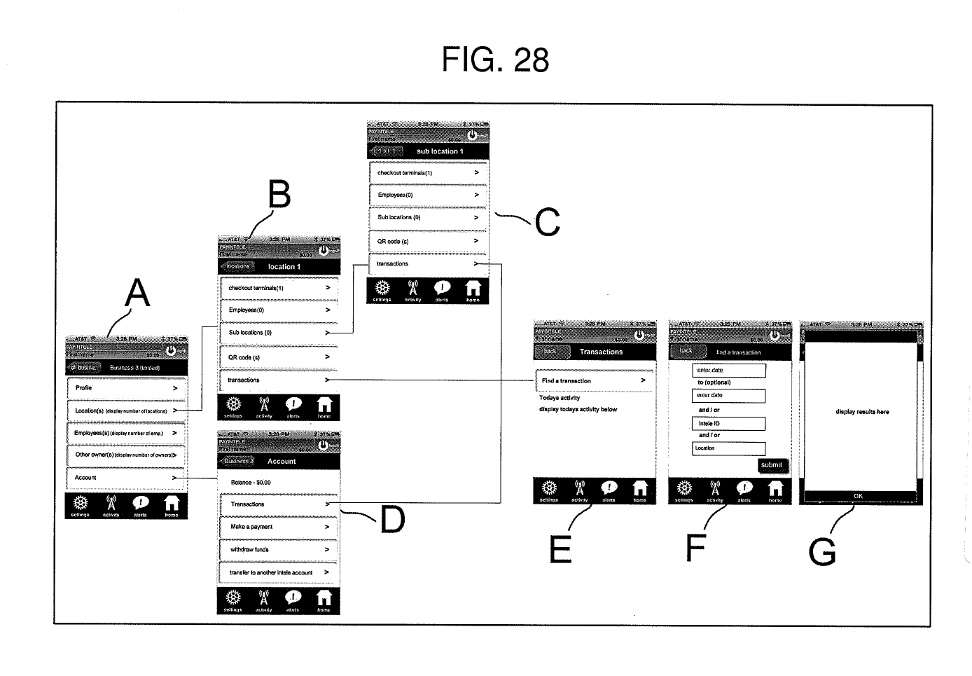

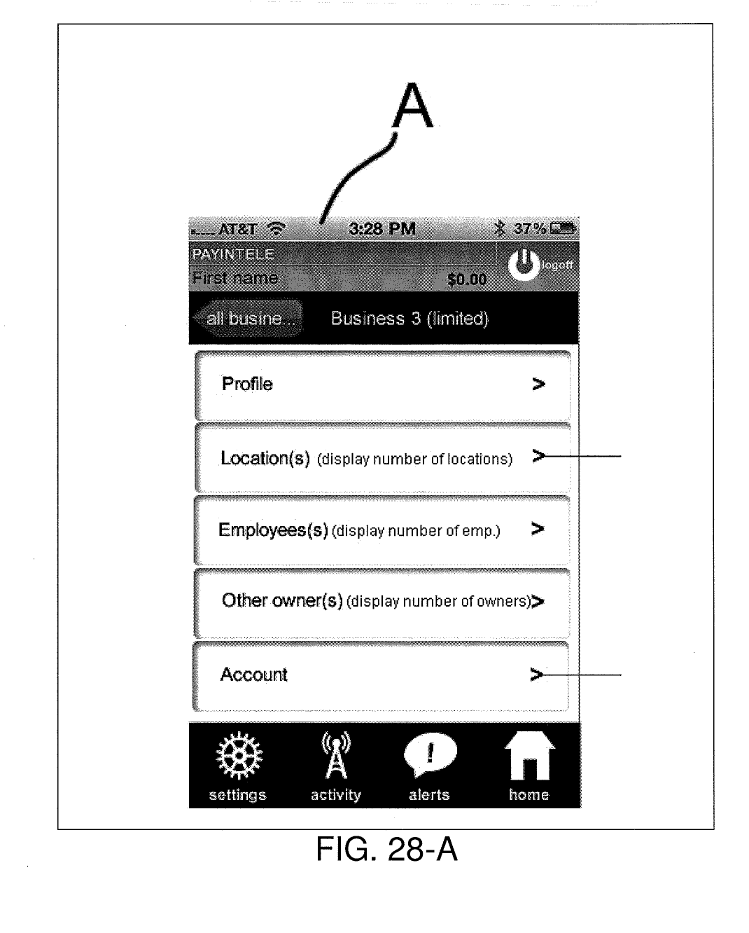

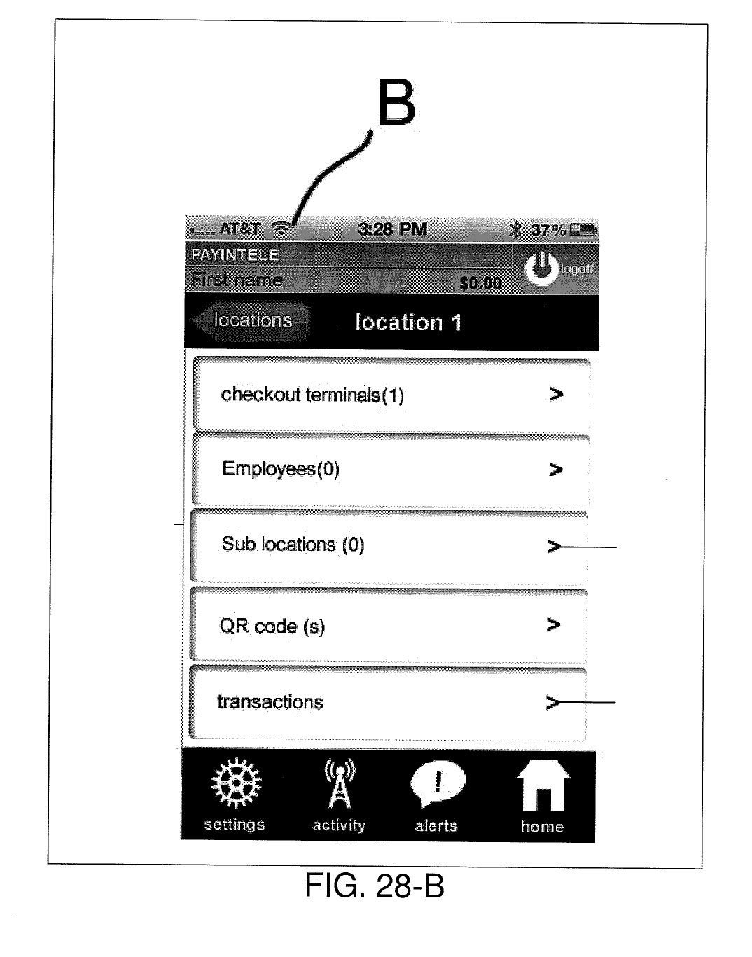

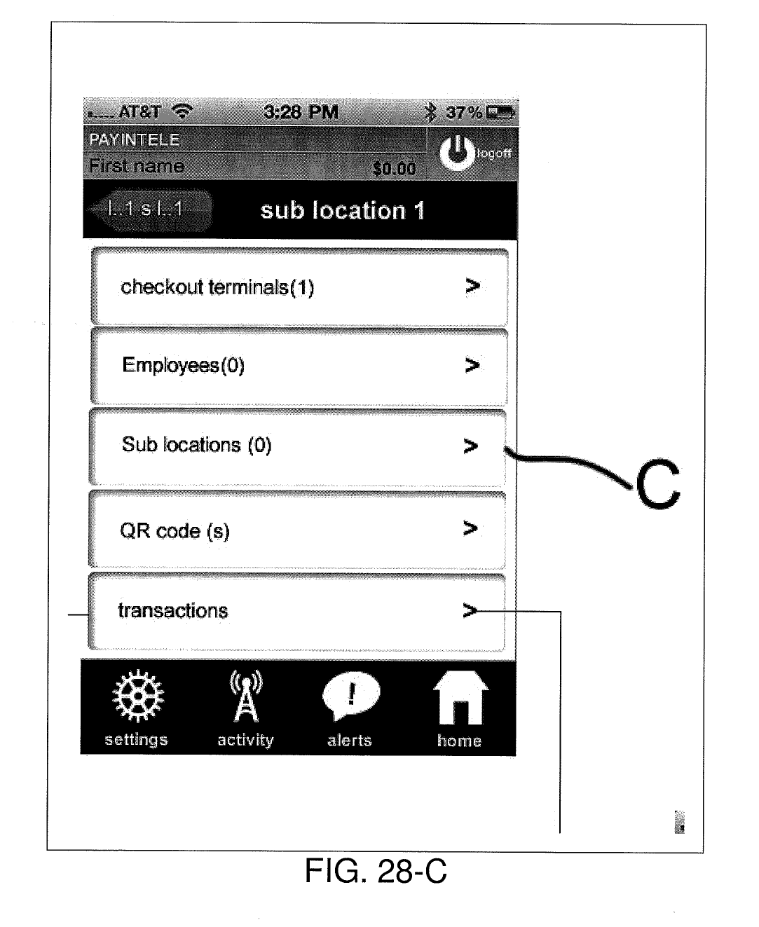

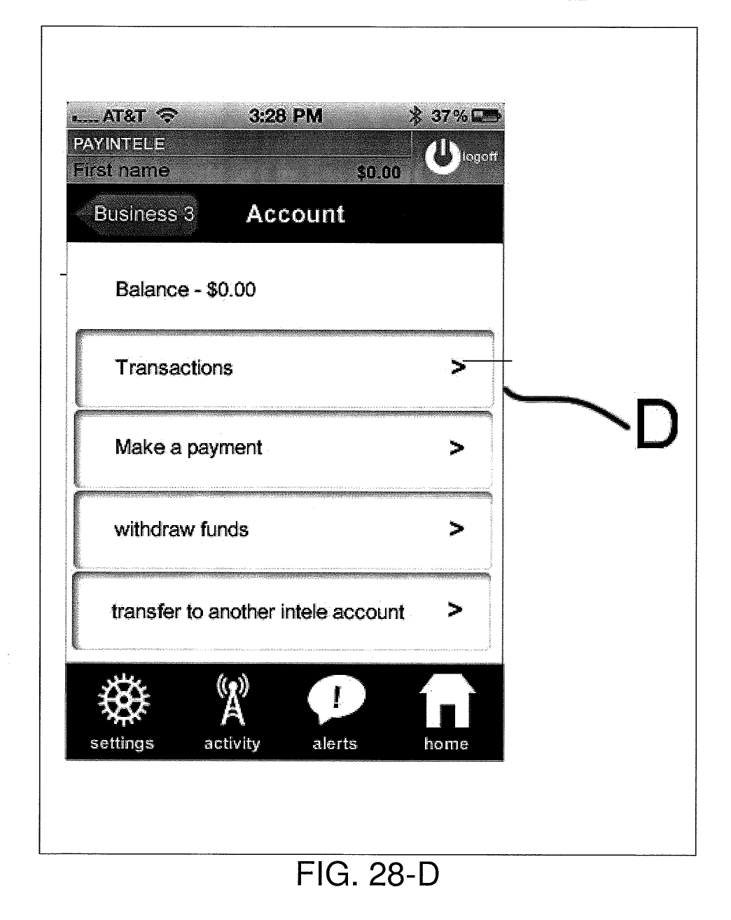

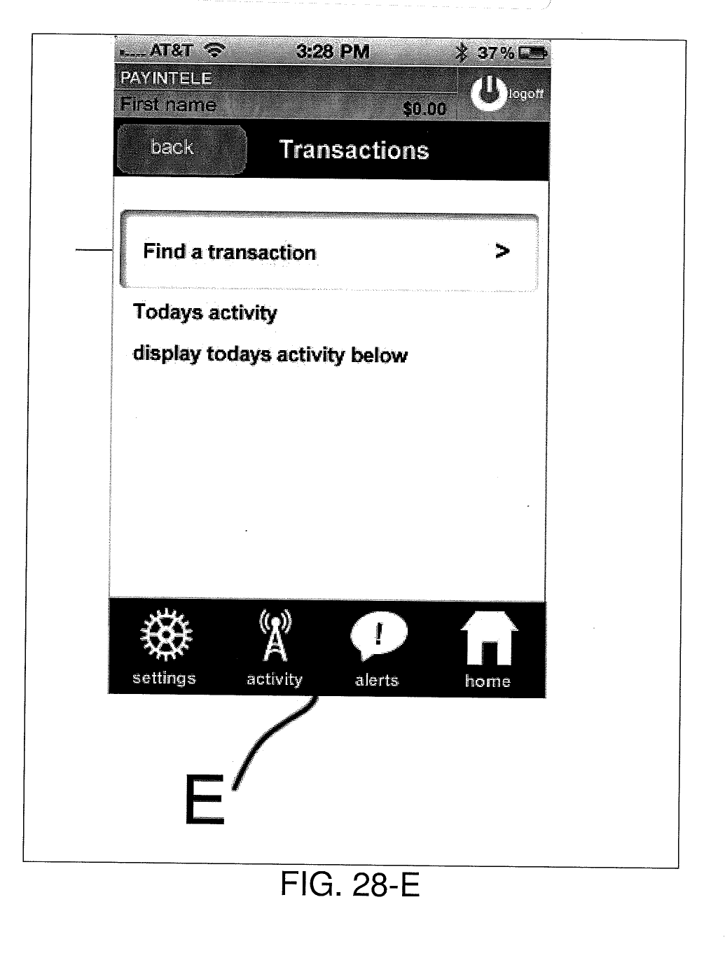

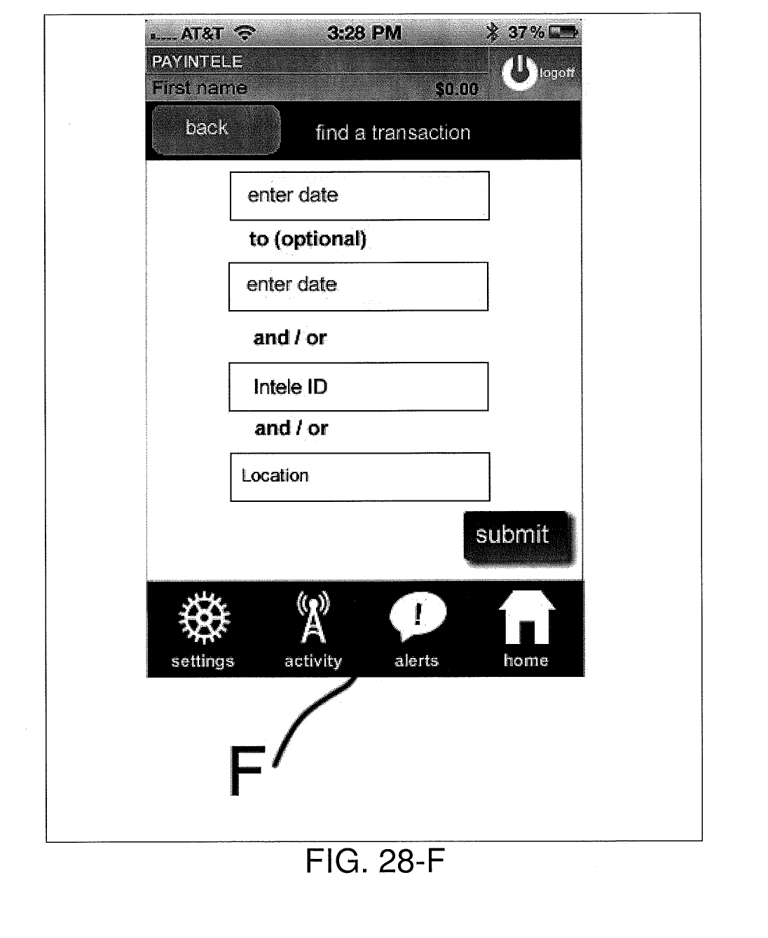

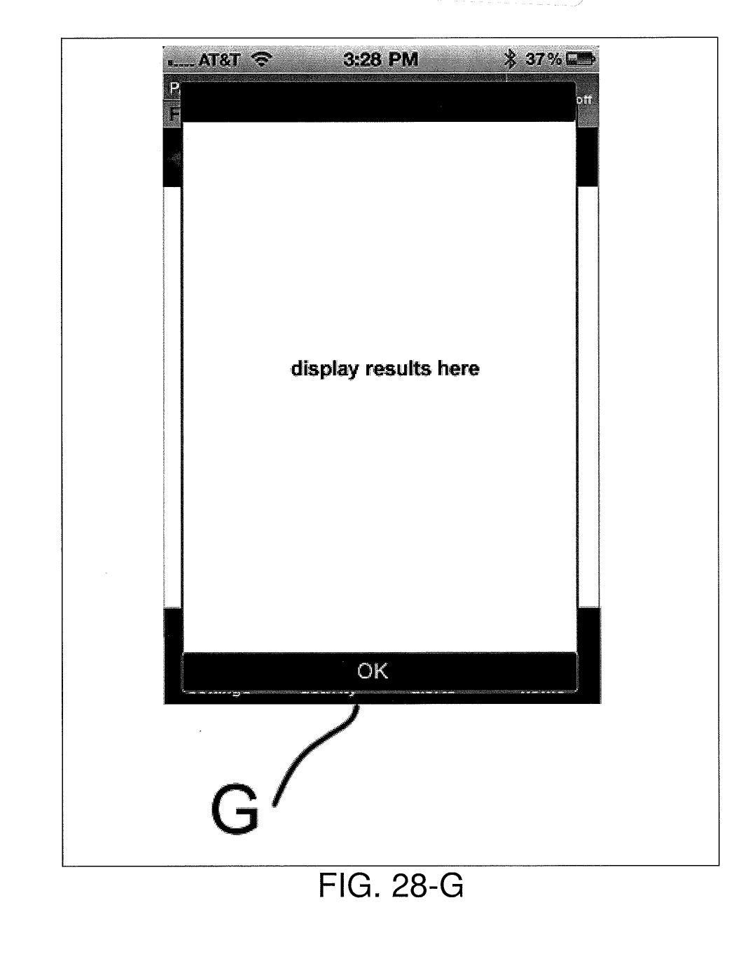

FIG. 28 illustrates a series of exemplary, self-explanatory user interface screens for a mobile device for searching previous business transactions in accordance with an embodiment of the Payintele system.

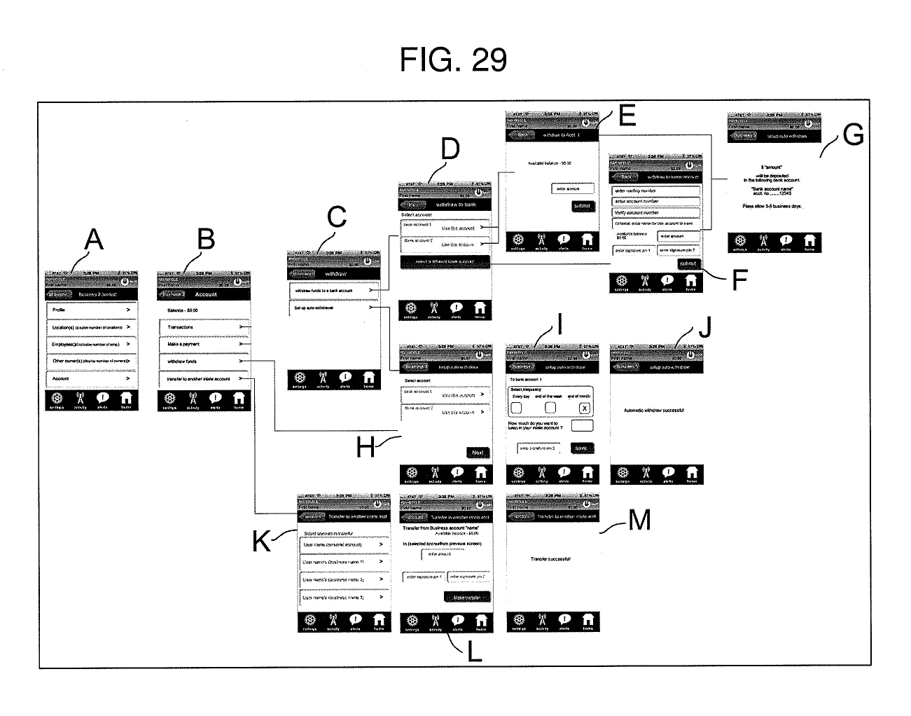

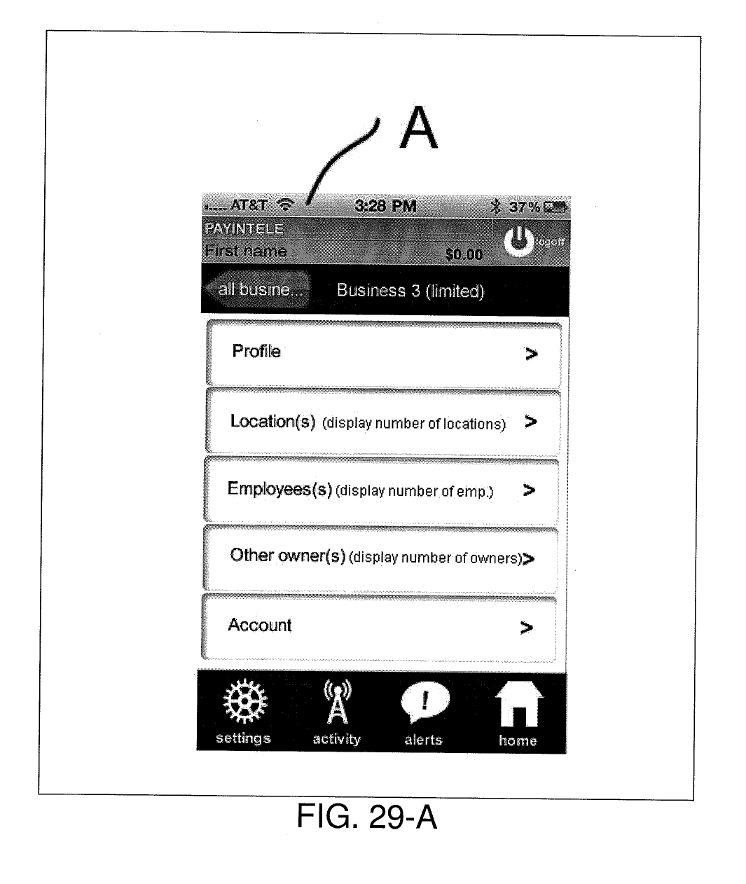

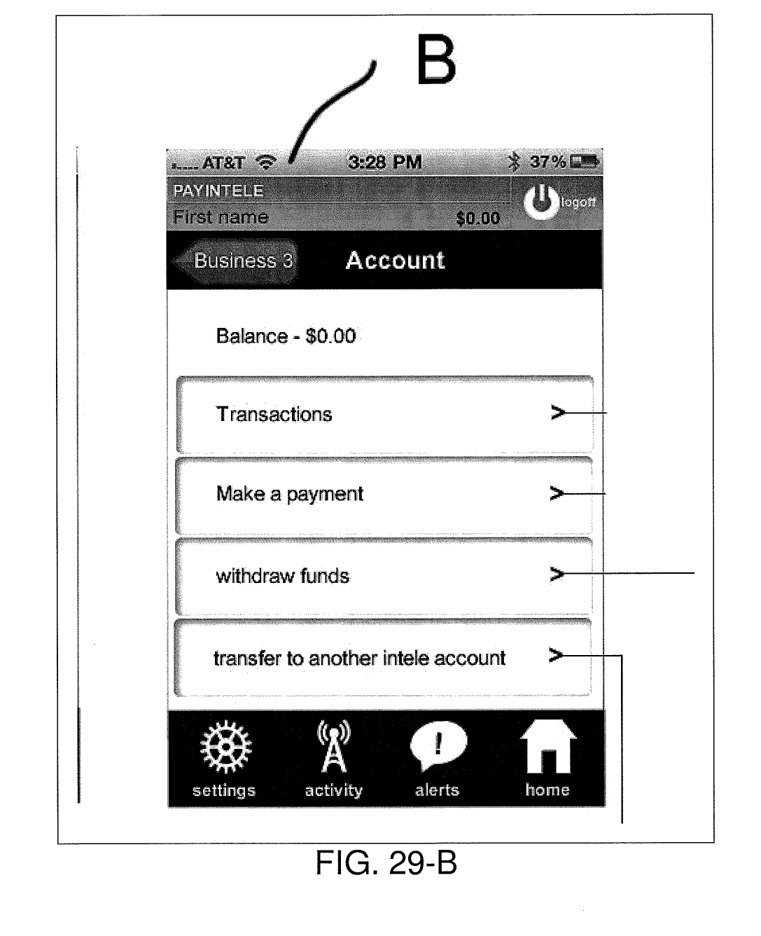

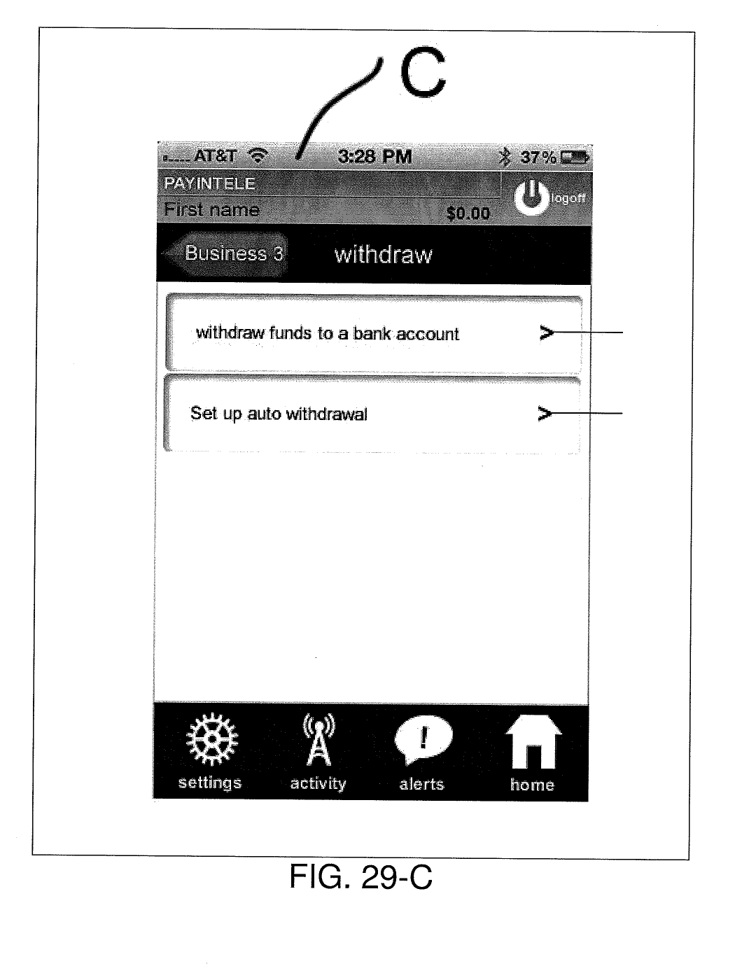

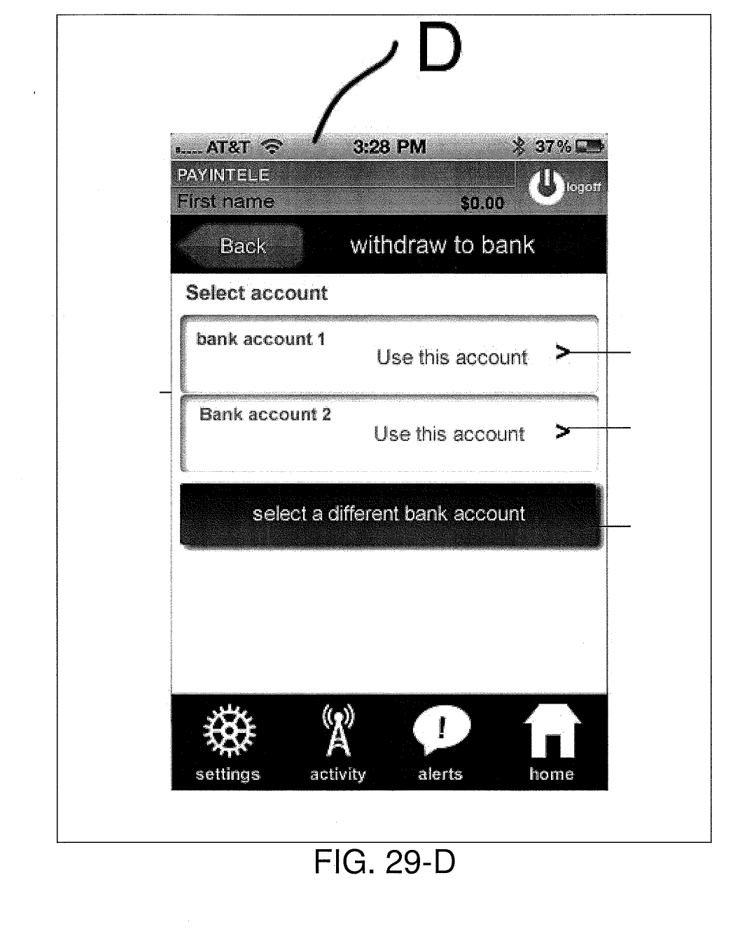

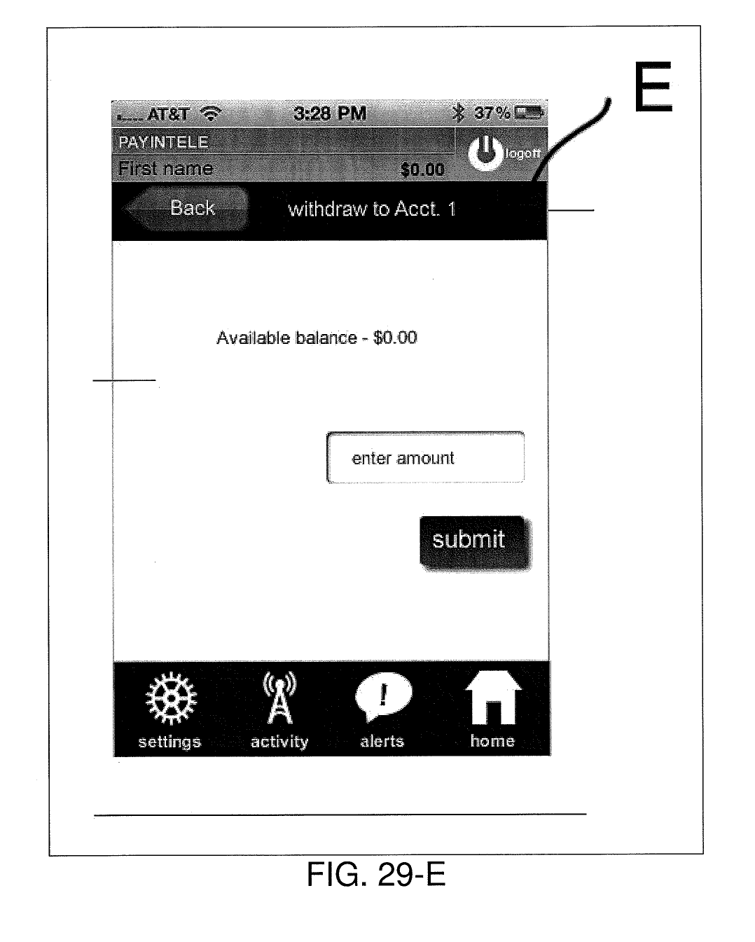

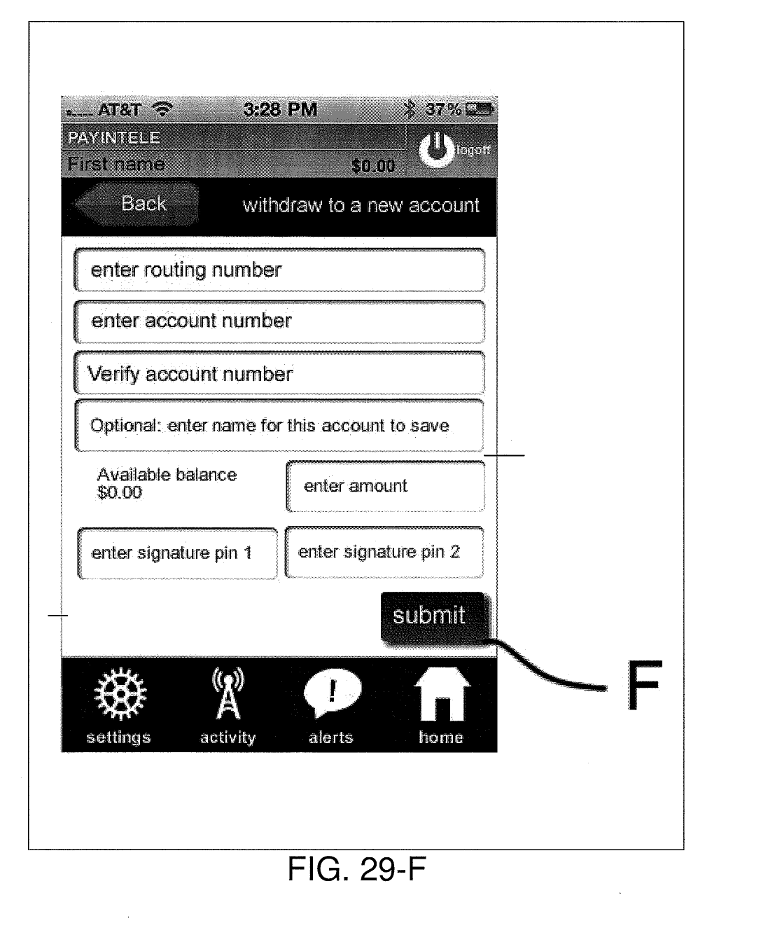

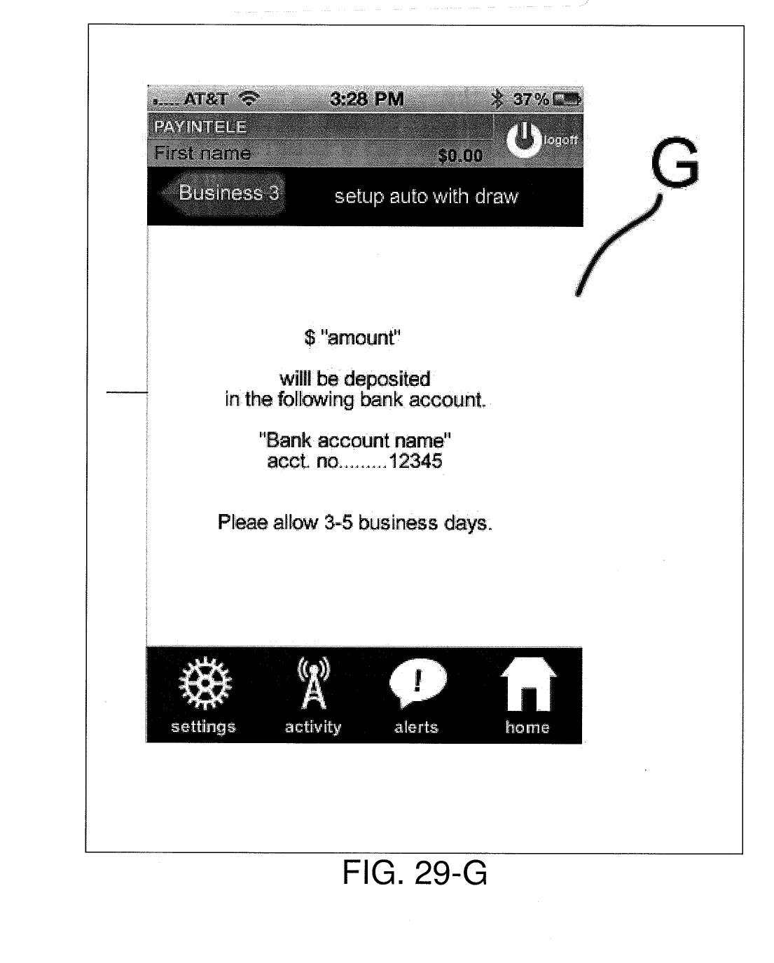

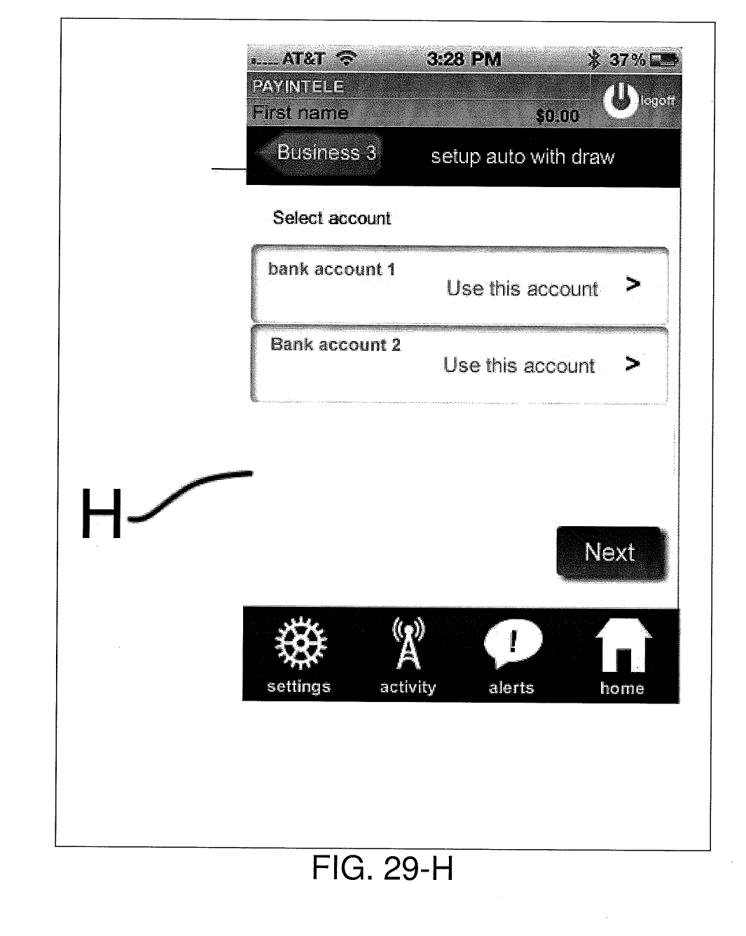

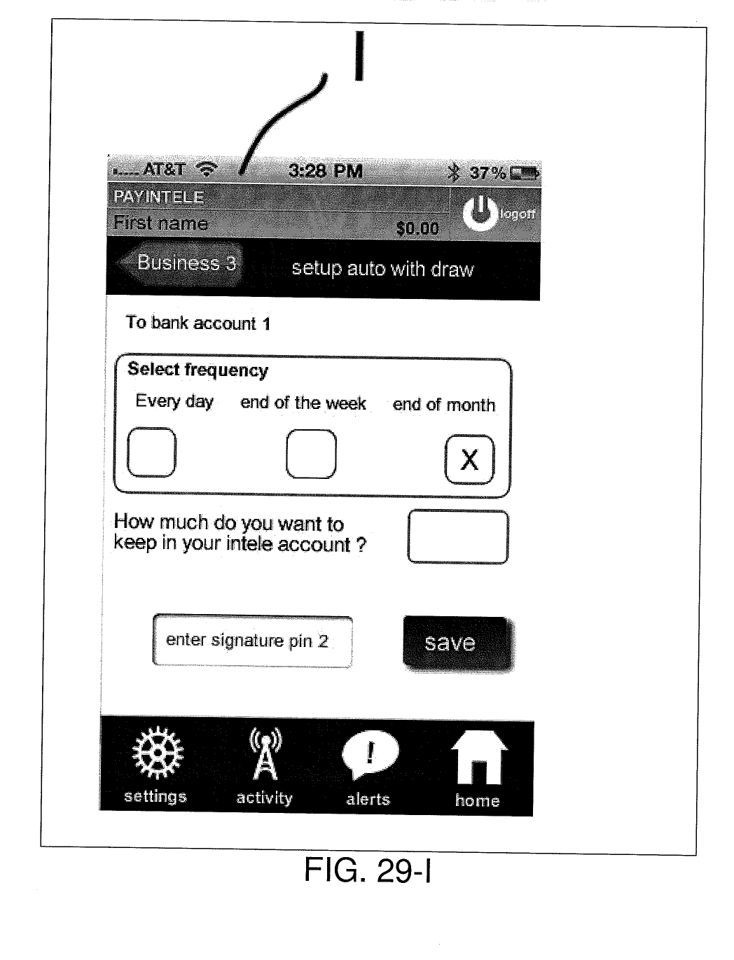

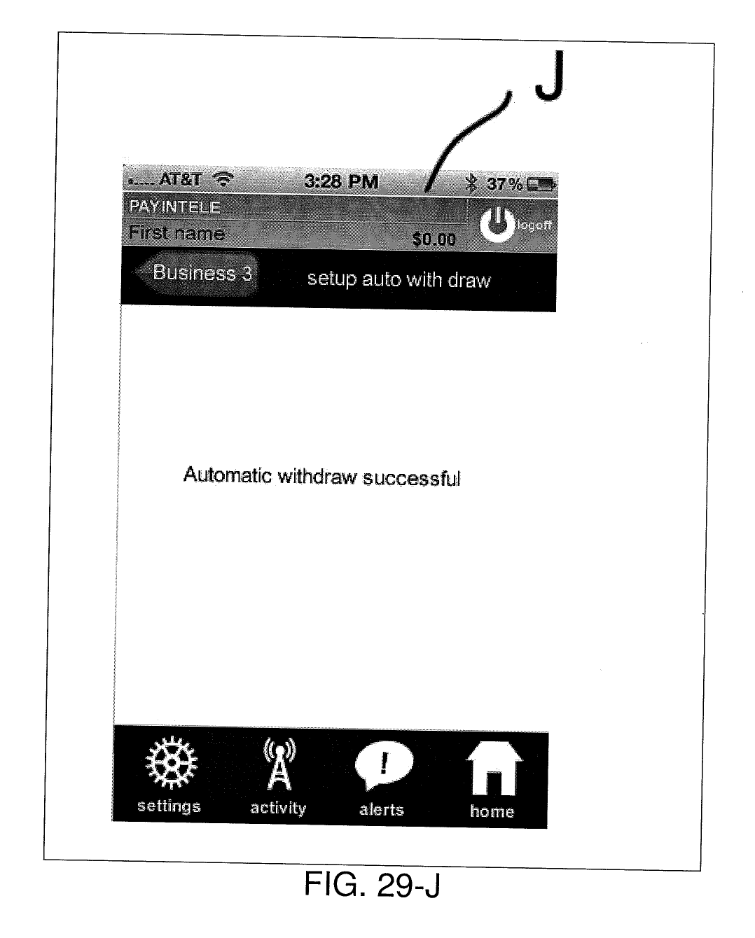

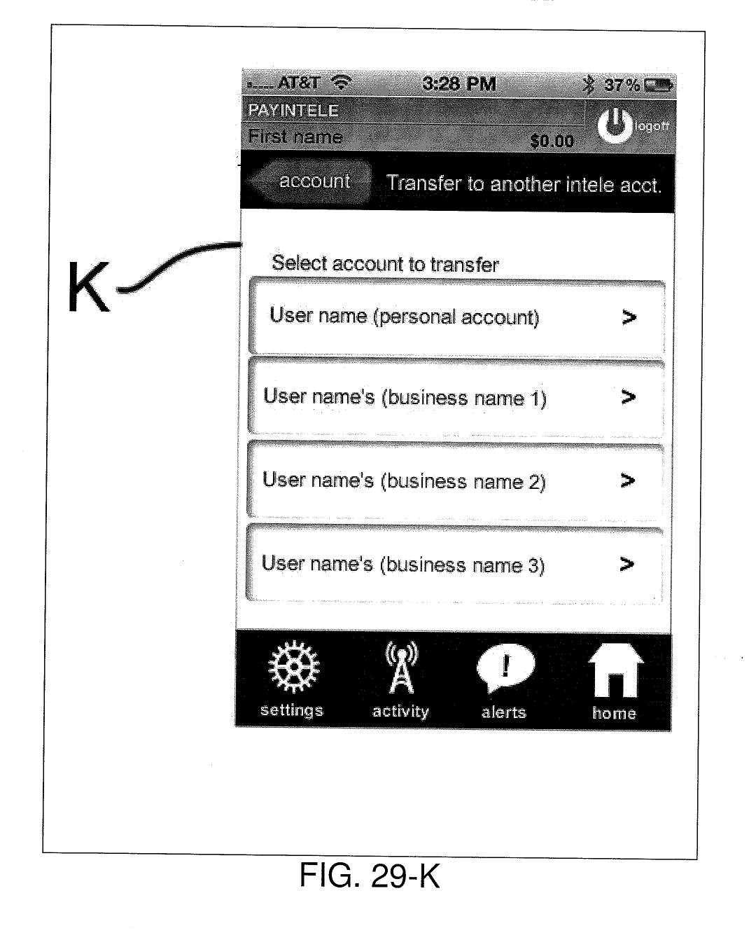

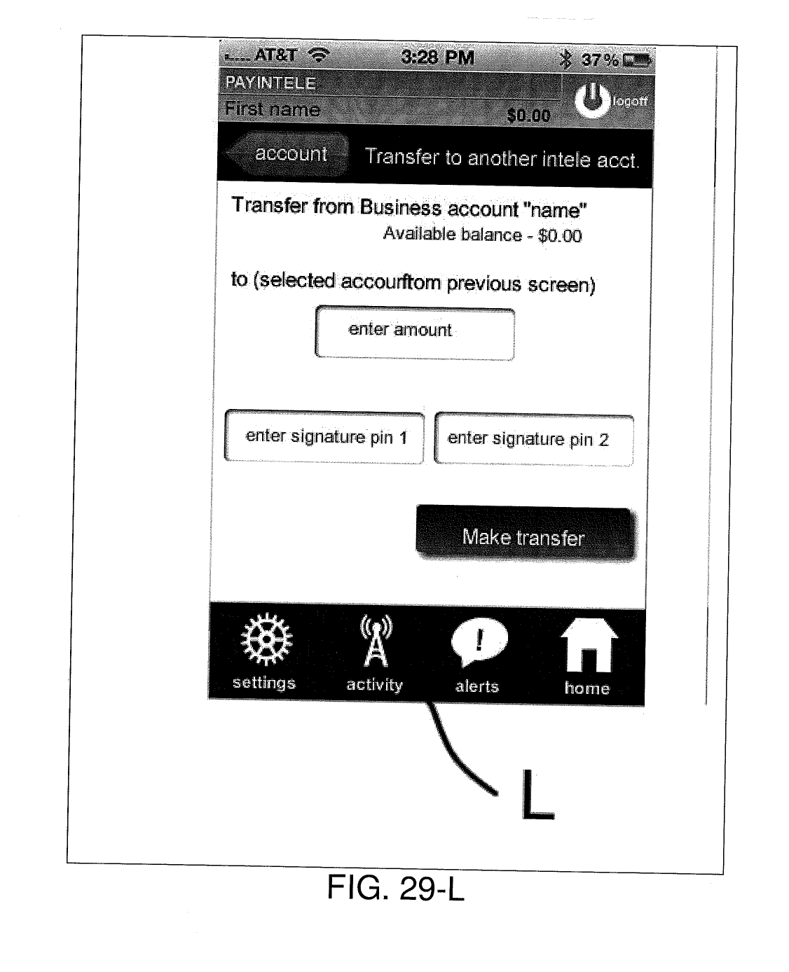

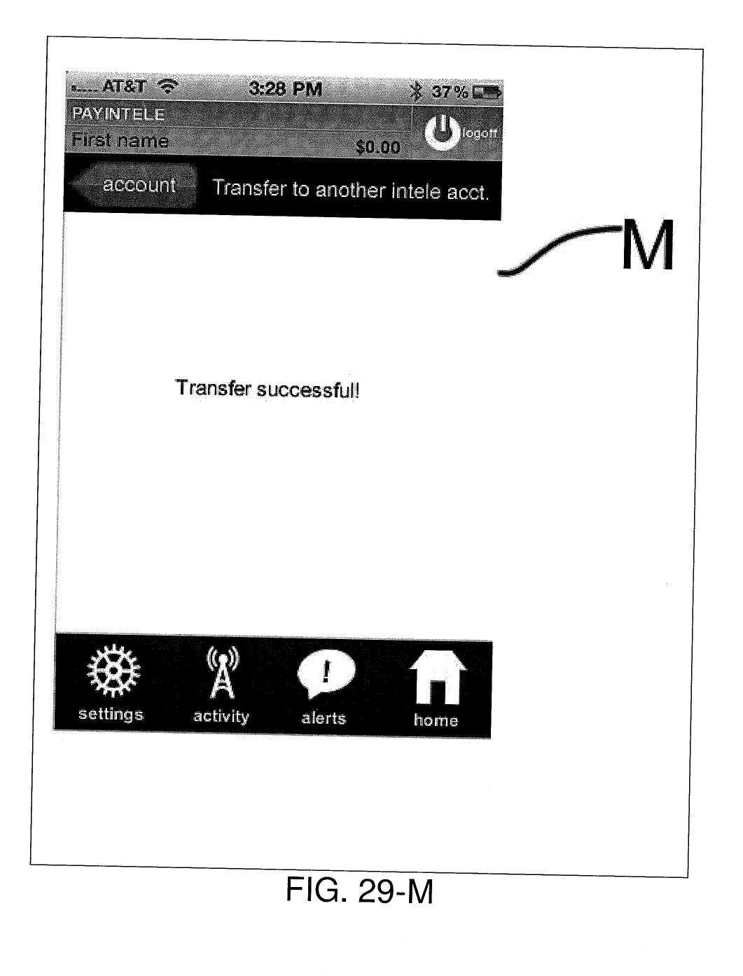

FIGS. 29A and 29B collectively illustrate a series of exemplary, self-explanatory user interface screens for a mobile device for setting business account settings, searching for transactions, making payment from business owner accounts, withdrawing funds, and transferring funds to another Payintele account under the same ownership in accordance with an embodiment of the Payintele system.

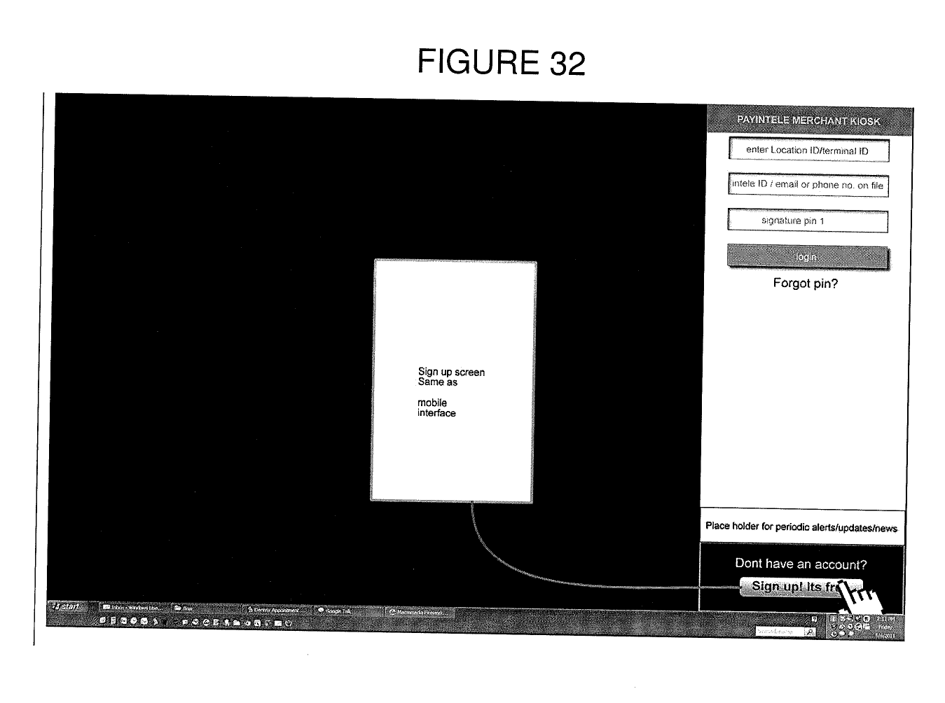

FIG. 32 illustrates an exemplary, self-explanatory user interface screen for a desktop computer for merchants for logging into the Payintele system in accordance with an embodiment of the Payintele system.

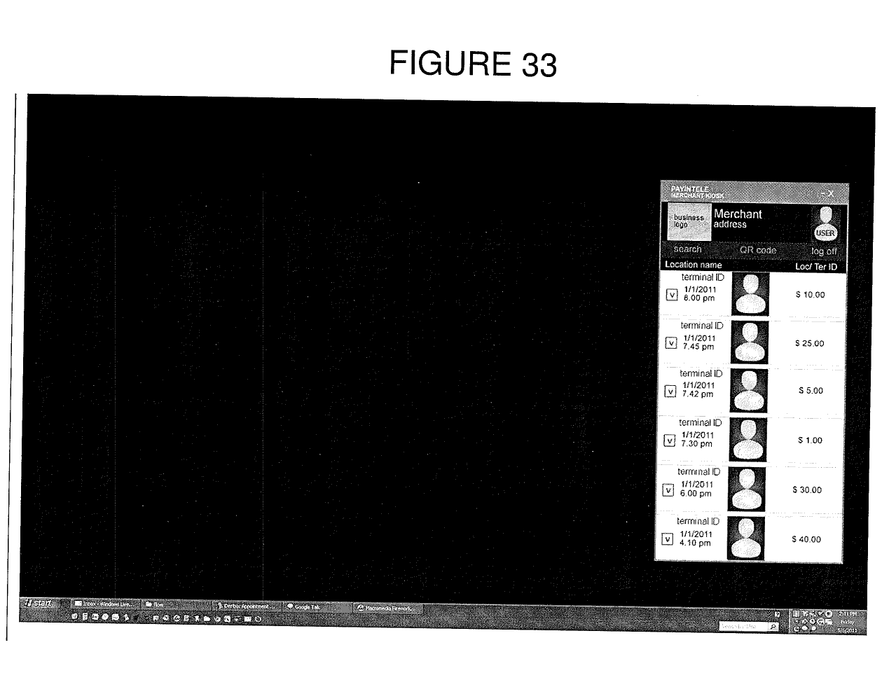

FIG. 33 illustrates an exemplary, self-explanatory user interface screen for a desktop computer for merchants for payment notification into the Payintele system in accordance with an embodiment of the Payintele system.

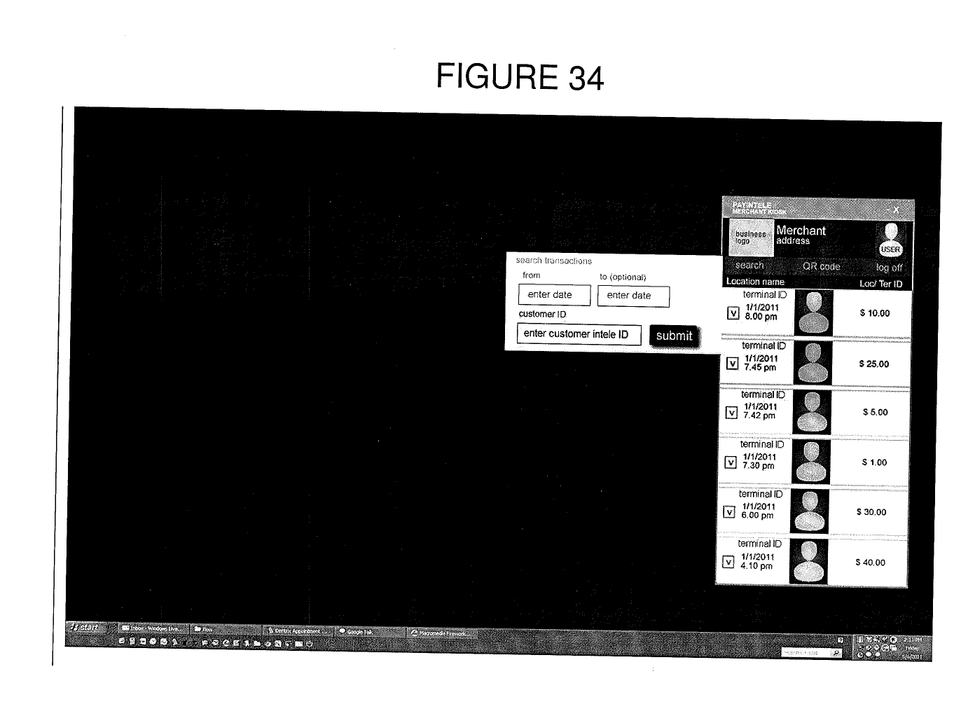

FIG. 34 illustrates an exemplary, self-explanatory user interface screen for a desktop computer for merchants for searching previous transactions in accordance with an embodiment of the Payintele system.

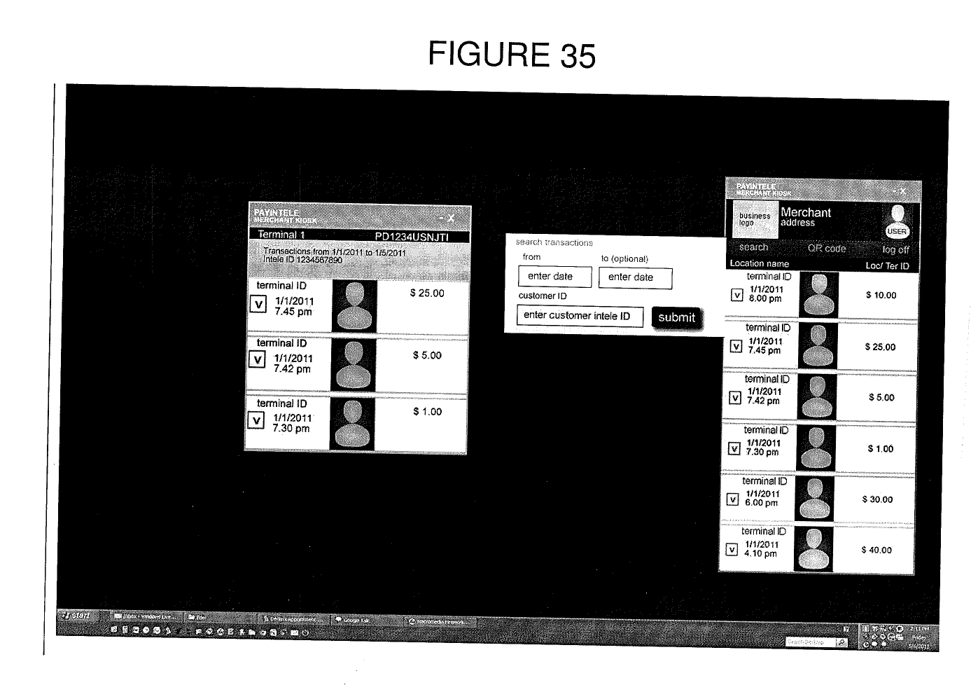

FIG. 35 illustrates an exemplary, self-explanatory user interface screen for a desktop computer for merchants for searching previous results in accordance with an embodiment of the Payintele system.

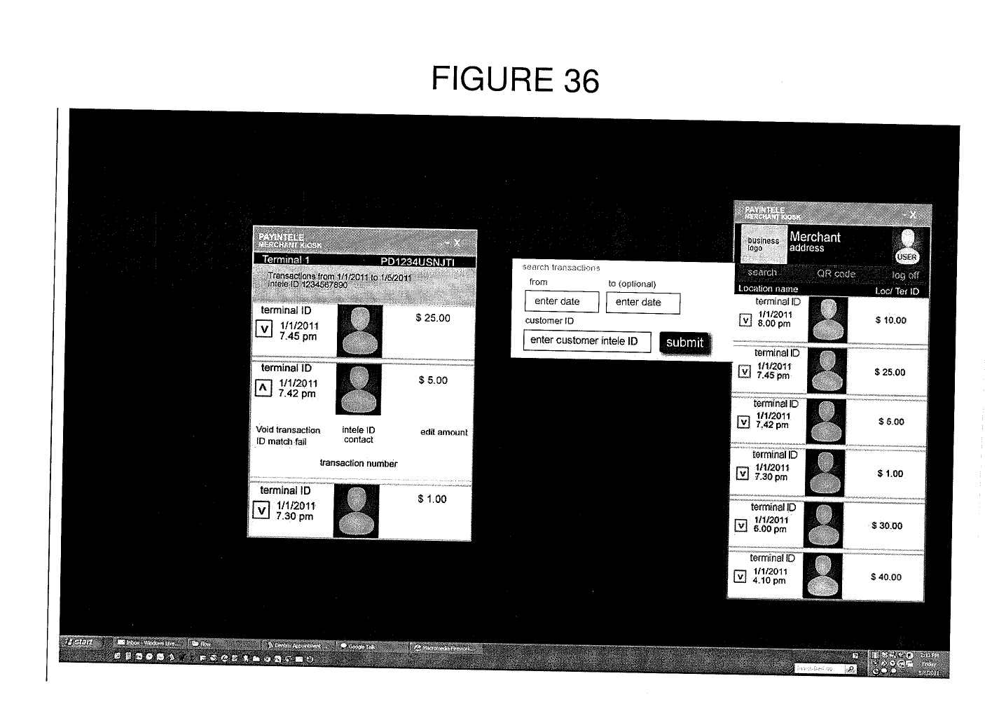

FIG. 36 illustrates an exemplary, self-explanatory user interface screen for a desktop computer for merchants for modifying transaction in accordance with an embodiment of the Payintele system.

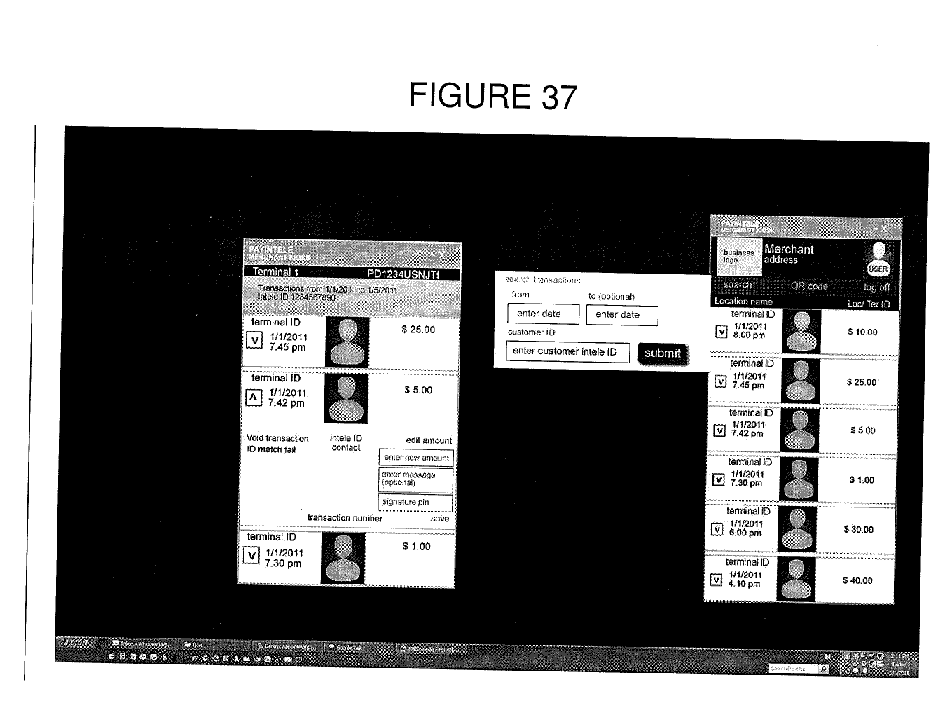

FIG. 37 illustrates an exemplary, self-explanatory user interface screen for a desktop computer for merchants for editing transactions in accordance with an embodiment of the Payintele system.

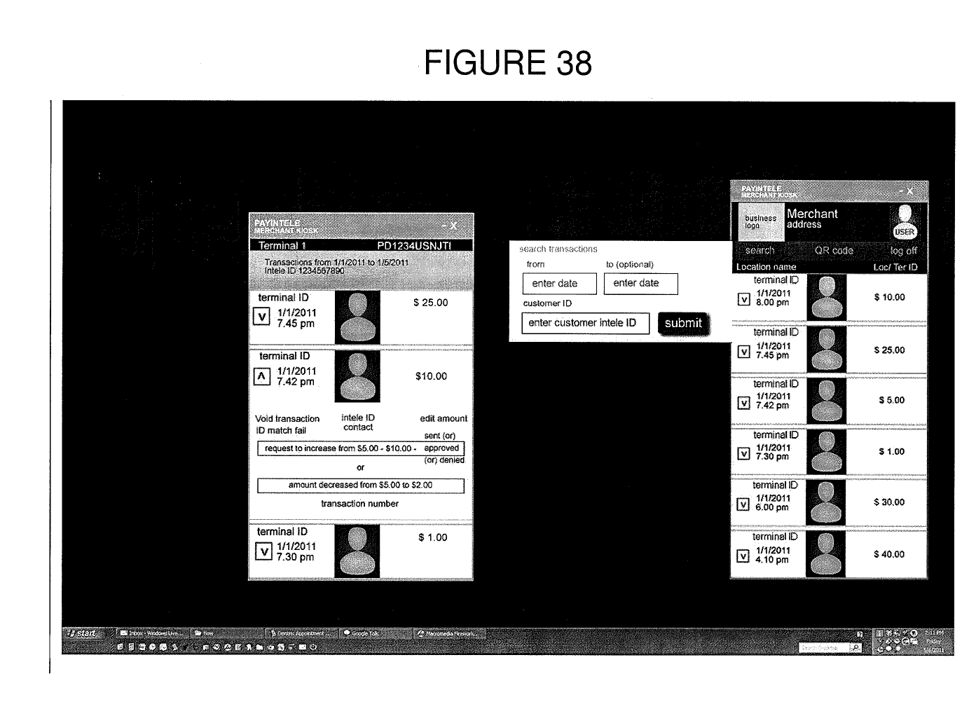

FIG. 38 illustrates an exemplary, self-explanatory user interface screen for a desktop computer for merchants for displaying the results of transaction modifications in accordance with an embodiment of the Payintele system.

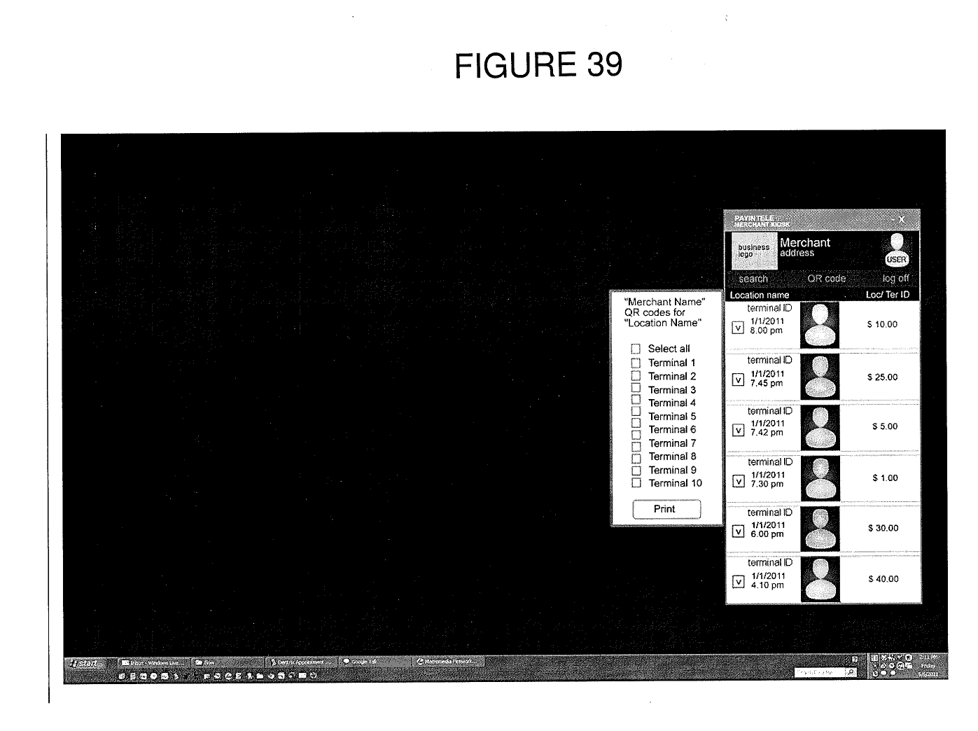

FIG. 39 illustrates an exemplary, self-explanatory user interface screen for a desktop computer for merchants for printing QR codes in accordance with an embodiment of the Payintele system.

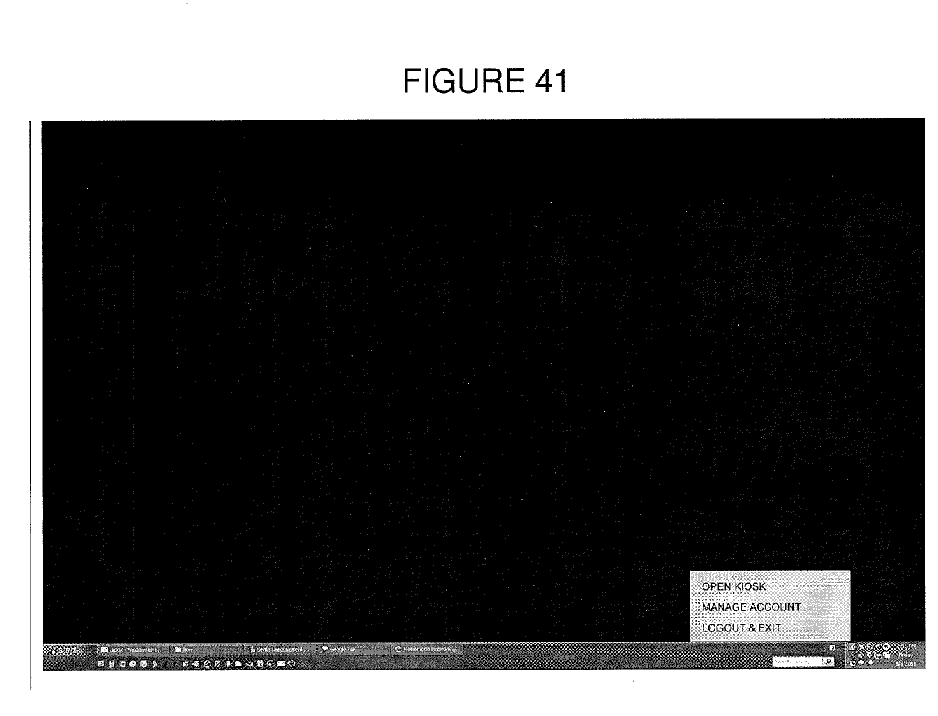

FIG. 41 illustrates an exemplary, self-explanatory user interface screen for a desktop computer for merchants for displaying notifications in accordance with an embodiment of the Payintele system.

FIG. 42 illustrates an exemplary, self-explanatory pop-up payment notification message for a desktop computer for merchants for when the Payintele software application is minimized to alert someone of one or more payments in accordance with an embodiment of the Payintele system.

FIG. 43 is a graphic illustration of a point-a-sale scenario in accordance with an embodiment of the Payintele system.

FIG. 44 illustrates an exemplary subaccount hierarchy in accordance with an embodiment of the Payintele system.

The above examples should be considered to be exemplary embodiments, and are in no way limiting of the present invention. Thus, while the description above refers to particular embodiments, it will be understood that many modifications may be made without departing from the spirit thereof. To keep the document concise and avoid repetition, some descriptions are not included under the title “Detailed Description” if the explanation is included with the drawings.

1. A method by which payments and other financial transactions can be made without exposing personal and financial information comprising:
a server, to store data and process transactions;
a graphical user interface, from which transaction requests can be executed by the users;
portable and non portable computing devices with internet connection such as a smart phone, a tablet, a laptop, a computer or other similar devices;
users, are persons that have already created an account as in claim 2;
a qr code, that can be scanned by the users instead of manually entering the receivers information and to automatically initiate a specific response that owner of the qr code intends as shown in drawings and described.
